(19) United States
(12) Patent Application Publication
(10) Pub. No.: US 2009/0143141 A1
(43) Pub. Date: Jun. 4, 2009

(54) Intelligent Multiplayer Gaming System With Multi-Touch Display

(75) Inventors: William R. Wells, Reno, NV (US); Dwayne A. Davis, Reno, NV (US); James W. Stockdale, Clio, CA (US); Harold E. Mattice, Gardnerville, NV (US); Roger William Harris, Reno, NV (US); Joseph Randy Hedrick, Reno, NV (US); Bryan D. Wolf, Reno, NV (US); Michael P. Khamis, Reno, NV (US); David N. Myers, Reno, NV (US); Binh T. Nguyen, Reno, NV (US); David Palmer, Reno, NV (US); Christiaan R. Champagne, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 12/265,627

(22) Filed: Nov. 5, 2008

Related U.S. Application Data
(63) Continuation-in-part of application No. 12/249,771, filed on Oct. 10, 2008.
Application No. 12/249,771 is a continuation-in-part of application No. 11/865,581, filed on Oct. 1, 2007.
Application No. 11/865,581 is a continuation-in-part of application No. 11/870,233, filed on Oct. 10, 2007.
Application No. 11/870,233 is a continuation-in-part of application No. 11/515,184, filed on Sep. 1, 2006.
Application No. 11/515,184 is a continuation-in-part of application No. 11/825,481, filed on Jul. 6, 2007.
Application No. 11/825,481 is a continuation-in-part of application No. 10/871,068, filed on Jun. 18, 2004.
Application No. 10/871,068 is a continuation-in-part of application No. 11/938,179, filed on Nov. 9, 2007.
Application No. 11/938,179 is a continuation-in-part of application No. 10/213,626, filed on Aug. 6, 2002.
Application No. 10/213,626 is a continuation-in-part of application No. 11/514,808, filed on Sep. 1, 2006.
Application No. 11/514,808 is a continuation-in-part of application No. 11/983,467, filed on Nov. 9, 2007.
Application No. 11/983,467 is a continuation-in-part of application No. 11/938,031, filed on Nov. 9, 2007.
Application No. 11/938,031 is a continuation-in-part of application No. 12/170,878, filed on Jul. 10, 2008.
(60) Provisional application No. 61/002,576, filed on Nov. 9, 2007.
(60) Provisional application No. 60/987,276, filed on Nov. 12, 2007.
(60) Provisional application No. 60/986,507, filed on Nov. 8, 2007.
(60) Provisional application No. 60/858,046, filed on Nov. 10, 2006.
(60) Provisional application No. 60/986,870, filed on Nov. 9, 2007.
(60) Provisional application No. 60/986,844, filed on Nov. 9, 2007.
(60) Provisional application No. 60/986,858, filed on Nov. 9, 2007.

(51) Int. Cl. A63F 13/00

(52) U.S. Cl. 463/37

(57) ABSTRACT

Various techniques are disclosed for facilitating gesture-based interactions with intelligent multi-player electronic gaming systems which include a multi-user, multi-touch input display surface capable of concurrently supporting contact-based and/or non-contact-based gestures performed by one or more users at or near the input display surface. Gestures may include single touch, multi-touch, and/or near-touch gestures. Some gaming system embodiments may include automated hand tracking functionality for identifying and/or tracking the hands of users interacting with the display surface. In some gaming system embodiments, the multi-user, multi-touch input display surface may be implemented using a multi-layered display (MLD) display device which includes multiple layered display screens. Various types of MLD-related display techniques disclosed herein may be advantageously used for facilitating gesture-based user interactions with a MLD-based multi-user, multi-touch input display surface and/or for facilitating various types of activities conducted at the gaming system, including, for example, various types of game-related and/or wager-related activities. According to various embodiments, users interacting with the multi-user, multi-touch input display surface may convey game play instructions, wagering instructions, and/or other types of instructions to the gaming system by performing various types of gestures at or over the multi-user, multi-touch input display surface. In some embodiments, the gaming system may include gesture processing functionality for: detecting users' gestures, identifying the user who performed a detected gesture, recognizing the gesture, interpreting the gesture, mapping the gesture to one or more appropriate function(s), and/or initiating the function(s). In at least some embodiments, such gesture processing may take into account various external factors, conditions, and/or information which, for example, may facilitate proper and/or appropriate gesture recognition, gesture interpretation, and/or gesture-function mapping.

### RELATED APPLICATION DATA

The present application claims priority under 35 U.S.C. § 119 to U.S. Provisional Application Ser. No. 61/002,576 (Attorney Docket No. IGT1P534P/P-1308APROV), naming WELLS et al. as inventors, entitled “INTELLIGENT STAND ALONE MULTIPLAYER GAMING TABLE WITH ELECTRONIC DISPLAY,” filed on Nov. 9, 2007, the entirety of which is incorporated herein by reference for all purposes.

The present application claims priority under 35 U.S.C. § 119 to U.S. Provisional Application Ser. No. 60/987,276 (Attorney Docket No. IGT1P534P2/P-1308APROV2), naming WELLS et al. as inventors, entitled “INTELLIGENT STAND ALONE MULTIPLAYER GAMING TABLE WITH ELECTRONIC DISPLAY,” filed on Nov. 12, 2007, the entirety of which is incorporated herein by reference for all purposes.

This application is a continuation-in-part, pursuant to the provisions of 35 U.S.C. 120, of prior U.S. patent application Ser. No. 12/249,771 (Attorney Docket No. IGT1P430C/P-1256C) entitled “AUTOMATED TECHNIQUES FOR TABLE GAME STATE TRACKING” by Harris et al., filed on Oct. 10, 2008, which claims benefit under 35 U.S.C. § 119 to U.S. Provisional Application Ser. No. 60/986,507 (Attorney Docket No. IGT1P430CP/P-1256CPROV), naming Burrill et al. as inventors, entitled “AUTOMATED TECHNIQUES FOR TABLE GAME STATE TRACKING,” filed on Nov. 8, 2007, each of which is incorporated herein by reference in its entirety for all purposes.

This application is a continuation-in-part, pursuant to the provisions of 35 U.S.C. 120, of prior U.S. patent application Ser. No. 11/865,581 (Attorney Docket No. IGT1P424/P-1245) entitled “MULTI-USER INPUT SYSTEMS AND PROCESSING TECHNIQUES FOR SERVING MULTIPLE USERS” by Mattice et al., filed on Oct. 1, 2007, the entirety of which is incorporated herein by reference for all purposes.

This application is a continuation-in-part, pursuant to the provisions of 35 U.S.C. 120, of prior U.S. patent application Ser. No. 11/870,233 (Attorney Docket No. IGT1P430A/P-1256A) entitled “AUTOMATED DATA COLLECTION SYSTEM FOR CASINO TABLE GAME ENVIRONMENTS” by MOSER et al., filed on Oct. 10, 2007, which claims benefit 35 U.S.C. § 119 to U.S. Provisional Application Ser. No. 60/858,046 (Attorney Docket No. IGT1P430P/P-1256PROV), naming Moser, et al. as inventors, and filed Nov. 10, 2006. Each of these applications is incorporated herein by reference in its entirety for all purposes.

This application is a continuation-in-part, pursuant to the provisions of 35 U.S.C. 120, of prior U.S. patent application Ser. No. 11/515,184, (Attorney Docket No. IGT1P266A/P-1085A), by Nguyen et al., entitled “INTELLIGENT CASINO GAMING TABLE AND SYSTEMS THEREOF”, filed on Sep. 1, 2006, the entirety of which is incorporated herein by reference for all purposes.

This application is a continuation-in-part, pursuant to the provisions of 35 U.S.C. 120, of prior U.S. patent application Ser. No. 11/825,481, (Attorney Docket No. IGT1P090X1/P-795CIP1), by Mattice, et al., entitled “GESTURE CONTROLLED CASINO GAMING SYSTEM,” filed Jul. 6, 2007, the entirety of which is incorporated herein by reference for all purposes.

This application is a continuation-in-part, pursuant to the provisions of 35 U.S.C. 120, of prior U.S. patent application Ser. No. 10/871,068, (Attorney Docket No. IGT1P090/P-795), by Parrott, et al., entitled “GAMING MACHINE USER INTERFACE”, filed Jun. 18, 2004, the entirety of which is incorporated herein by reference for all purposes.

This application is a continuation-in-part, pursuant to the provisions of 35 U.S.C. 120, of prior U.S. patent application Ser. No. 11/938,179, (Attorney Docket No. IGT1P459/P-1288), by Wells et al., entitled “TRANSPARENT CARD DISPLAY,” filed on Nov. 9, 2007, the entirety of which is incorporated herein by reference for all purposes.

This application is a continuation-in-part, pursuant to the provisions of 35 U.S.C. 120, of prior U.S. patent application Ser. No. 10/213,626 (Attorney Docket No. IGT1P604/P-528), published as U.S. Patent Publication No. US2004/0029636, entitled “GAMING DEVICE HAVING A THREE DIMENSIONAL DISPLAY DEVICE”, by Wells et al., and filed Aug. 6, 2002, the entirety of which is incorporated herein by reference for all purposes.

This application is a continuation-in-part, pursuant to the provisions of 35 U.S.C. 120, of prior U.S. patent application Ser. No. 11/514,808 (Attorney Docket No. IGT1P194/P-1020), entitled “GAMING MACHINE WITH LAYERED DISPLAYS”, by Wells et al., filed Sep. 1, 2006, the entirety of which is incorporated herein by reference for all purposes.

### BACKGROUND

The present disclosure relates generally to live intelligent multi-player electronic gaming systems utilizing multi-touch, multi-player interactive displays.

Casinos and other forms of gaming comprise a growing multi-billion dollar industry both domestically and abroad, with table games continuing to be an immensely popular form of gaming and a substantial source of revenue for gaming operators. Such table games are well known and can include, for example, poker, blackjack, baccarat, craps, roulette and other traditional standbys, as well as other more recently introduced games such as Caribbean Stud, Spanish 21, and Let It Ride, among others. Under a typical gaming event at a gaming table, a player places a wager on a game, whereupon a winning may be paid to the player depending on the outcome of the game. As is generally known, a wager may involve the use of cash or one or more chips, markers or the like, as well as various forms of gestures or oral claims. The game itself may involve the use of, for example, one or more cards, dice, wheels, balls, tokens or the like, with the rules of the game and any payouts or pay tables being established prior to game play. As is also known, possible winnings may be paid in cash, credit, one or more chips, markers, or prizes, or by other forms of payouts. In addition to table games, other games within a casino or other gaming environment are also widely known. For instance, keno, bingo, sports books, and ticket drawings, among others, are all examples of wager-based games and other events that patrons may partake of within a casino or other gaming establishment.

Although standard fully manual gaming tables have been around for many years, gaming tables having more “intelligent” features are becoming increasingly popular. For example, many gaming tables now have automatic card shufflers, LCD screens, biometric identifiers, automated chip tracking devices, and even cameras adapted to track chips and/or playing cards, among various other items and devices. Many items and descriptions of gaming tables having such added items and devices can be found at, for example, U.S. Pat. Nos. 5,613,912; 5,651,548; 5,735,742; 5,781,647; 5,957,776; 6,165,069; 6,179,291; 6,270,404; 6,299,534; 6,313,871; 6,532,297; 6,582,301; 6,651,985; 6,722,974; 6,745,887; 6,848,994; and 7,018,291, as well as U.S. Patent Application Publication Nos. 2002/0169021; 2002/0068635; 2005/0026680; 2005/0137005; and 20060058084, each of which is incorporated herein by reference, among many other varied references.

Such added items and devices certainly can add many desirable functions and features to a gaming table, although there are currently limits as to what may be accomplished. For example, many gaming table items and devices are designed to provide a benefit to the casino or gaming establishment, and are not particularly useful to a player and/or player friendly. Little to no player excitement or interest is derived from such items and devices. Thus, while existing systems and methods for providing gaming tables and hosting table games at such gaming tables have been adequate in the past, improvements are usually welcomed and encouraged. In light of the foregoing, it is desirable to provide a more interactive gaming table.

### SUMMARY

Various techniques are disclosed for facilitating gesture-based interactions with intelligent multi-player electronic gaming systems which include a multi-user, multi-touch input display surface capable of concurrently supporting contact-based and/or non-contact-based gestures performed by one or more users at or near the input display surface. Gestures may include single touch, multi-touch, and/or near-touch gestures. Some gaming system embodiments may include automated hand tracking functionality for identifying and/or tracking the hands of users interacting with the display surface. In some gaming system embodiments, the multi-user, multi-touch input display surface may be implemented using a multi-layered display (MLD) display device which includes multiple layered display screens. Various types of MLD-related display techniques disclosed herein may be advantageously used for facilitating gesture-based user interactions with a MLD-based multi-user, multi-touch input display surface and/or for facilitating various types of activities conducted at the gaming system, including, for example, various types of game-related and/or wager-related activities.

According to various embodiments, users interacting with the multi-user, multi-touch input display surface may convey game play instructions, wagering instructions, and/or other types of instructions to the gaming system by performing various types of gestures at or over the multi-user, multi-touch input display surface. In some embodiments, the gaming system may include gesture processing functionality for: detecting users' gestures, identifying the user who performed a detected gesture, recognizing the gesture, interpreting the gesture, mapping the gesture to one or more appropriate function(s), and/or initiating the function(s). In at least some embodiments, such gesture processing may take into account various external factors, conditions, and/or information which, for example, may facilitate proper and/or appropriate gesture recognition, gesture interpretation, and/or gesture-function mapping. For example, in some embodiments, the recognition, interpretation, and/or mapping of a gesture (e.g., to an appropriate set of functions) may be determined and/or may be based on one or more of the following criteria (or combinations thereof): contemporaneous game state information; current state of game play (e.g., which existed at the time when gesture detected); type of game being played at gaming system (e.g., as of the time when the gesture was detected); theme of game being played at gaming system (e.g., as of the time when the gesture was detected); number of persons present at the gaming system; number of persons concurrently interacting with the interacting with the multi-touch, multi-player interactive display surface (e.g., as of the time when the gesture was detected); current activity being performed by user who performed the gesture (e.g., as of the time when the gesture was detected); etc. Accordingly, in some embodiments, an identified gesture may be interpreted and/or mapped to a first set of functions if the gesture was performed by a player during play of a first game type (e.g., Blackjack) at the gaming system; whereas the same identified gesture may be interpreted and/or mapped to a second set of functions if the gesture was performed during play of a second game type (e.g., Poker) at the gaming system.

In accordance with a least one embodiment, various examples of different types of activity related instructions/functions which may be mapped to one or more gestures described herein may include, but are not limited to, one or more of the following (or combinations thereof):
Global instructions/functions (e.g., which may be performed during play of any game and/or other activity): YES and/or ACCEPT; NO and/or DECLINE; CANCEL and/or UNDO; REPEAT INSTRUCTION/FUNCTION; etc.
Wager-related instructions/functions (e.g., which may be performed during play of any game and/or other wager-related activity): INCREASE WAGER AMOUNT; DECREASE WAGER AMOUNT; CANCEL WAGER; CONFIRM PLACEMENT OF WAGER; PLACE WAGER; CLEAR ALL PLACED WAGERS; LET IT RIDE; etc.
Blackjack-related instructions/functions: DOUBLE DOWN; SURRENDER; BUY INSURANCE; SPLIT PAIR; HIT; STAND; etc.
Poker-related instructions/functions: ANTE IN; RAISE; CALL; FOLD; DISCARD SELECTED CARD(S); etc.
Card game-related instructions/functions: PEEK AT CARD(S); CUT DECK; DEAL CARD(S); SHUFFLED DECK(S); SELECT CARD; TAKE CARD FROM PILE; DEAL ONE CARD; PLAY SELECTED CARD; etc.
Craps-related instructions/functions: SELECT DICE; ROLL DICE; etc.
Baccarat-related instructions/functions: SQUEEZE DECK; SELECT CARD; etc.
Roulette-related instructions/functions: SPIN WHEEL; ROLL BALL; etc.
Pai Gow-related instructions/functions: SHUFFLE DOMINOS; SELECT DOMINOS; etc.
Sic Bo-related instructions/functions: SELECT DICE; ROLL DICE; etc.
Fantan-related instructions/functions: REMOVE OBJECT(S) FROM PILE; COVER PILE; UNCOVER PILE; PLAY A CARD; TAKE CARD FROM PILE; etc.
Slot-related instructions/functions: SPIN REELS; etc.

In accordance with a least one embodiment, various examples of different types of gestures which may be mapped to one or more activity related instructions/functions described herein may include, but are not limited to, one or more of the following (or combinations thereof):
One contact region, drag up movement. In at least one embodiment, this gesture may be interpreted as being characterized by an initial single region of contact, followed by a drag up movement, followed by a break of continuous contact.
One contact region, drag down movement. In at least one embodiment, this gesture may be interpreted as being characterized by an initial single region of contact, followed by a drag down movement, followed by a break of continuous contact.
One contact region, drag right movement. In at least one embodiment, this gesture may be interpreted as being characterized by an initial single region of contact, followed by a drag right movement, followed by a break of continuous contact.
One contact region, drag left movement. In at least one embodiment, this gesture may be interpreted as being characterized by an initial single region of contact, followed by a drag left movement, followed by a break of continuous contact.
One contact region, hold at least n seconds. In at least one embodiment, this gesture may be interpreted as being characterized by an initial single region of contact which is continuously maintained at about the same location or position (and/or in which the contact region is continuously maintained within a specified boundary) for a continuous time interval of at least n seconds, followed by a break of continuous contact.
One contact region; continuous “S”-shaped pattern drag down movements. In at least one embodiment, this gesture may be interpreted as being characterized by an initial single region of contact, followed by continuous drag down movements forming an “S”-shaped” pattern, followed by a break of continuous contact.
Double tap, one contact region. In at least one embodiment, this gesture may be interpreted as being characterized by a sequence of two consecutive one contact region “tap” gestures on the multi-touch input interface in which continuous contact with the multi-touch input interface is broken in between each tap.
Double tap, two contact region. In at least one embodiment, this gesture may be interpreted as being characterized by a sequence of two consecutive two contact region “tap” gestures on the multi-touch input interface in which continuous contact with the multi-touch input interface is broken in between each tap.

Two concurrent contact regions, drag up movement. In at least one embodiment, this gesture may be interpreted as being characterized by an initial two regions of contact, followed by concurrent drag up movements of both contact regions, followed by a break of continuous contact of at least one contact region.
Two concurrent contact regions, drag down movement. In at least one embodiment, this gesture may be interpreted as being characterized by an initial two regions of contact, followed by concurrent drag down movements of both contact regions, followed by a break of continuous contact of at least one contact region.
Two concurrent contact regions, drag right movement. In at least one embodiment, this gesture may be interpreted as being characterized by an initial two regions of contact, followed by concurrent drag right movements of both contact regions, followed by a break of continuous contact of at least one contact region.
Two concurrent contact regions, drag left movement. In at least one embodiment, this gesture may be interpreted as being characterized by an initial two regions of contact, followed by concurrent drag left movements of both contact regions, followed by a break of continuous contact of at least one contact region.
Two concurrent contact regions, “pinch” movement. In at least one embodiment, this gesture may be interpreted as being characterized by an initial two regions of contact, followed by a “pinch” movement, in which both contact regions are concurrently moved in respective directions towards each other, followed by a break of continuous contact of at least one contact region.
Two concurrent contact regions, “expand” movement. In at least one embodiment, this gesture may be interpreted as being characterized by an initial two regions of contact, followed by a “expand” movement, in which both contact regions are concurrently moved in respective directions away from the other, followed by a break of continuous contact of at least one contact region.
One contact region, continuous “rotate clockwise” movement. In at least one embodiment, this gesture may be interpreted as being characterized by an initial single region of contact, followed by a continuous “rotate clockwise” movement, followed by a break of continuous contact.
One contact region, continuous “rotate counter-clockwise” movement. In at least one embodiment, this gesture may be interpreted as being characterized by an initial single region of contact, followed by a continuous “rotate counter-clockwise” movement, followed by a break of continuous contact.
One contact region, continuous drag left movement, continuous drag right movement. In at least one embodiment, this gesture may be interpreted as being characterized by an initial single region of contact, followed by a continuous sequence of the following specific movements (e.g., which are performed in order, while maintaining continuous contact with the multi-touch input interface): drag left movement, then drag right movement, followed by a break of continuous contact.
One contact region, continuous drag right movement, continuous drag left movement. In at least one embodiment, this gesture may be interpreted as being characterized by an initial single region of contact, followed by a continuous sequence of the following specific movements (e.g., which are performed in order, while maintaining continuous contact with the multi-touch input interface): drag right movement, then drag left movement, followed by a break of continuous contact.

### BRIEF DESCRIPTION OF THE DRAWINGS

FIG. 1 shows a top perspective view of a multi-player gaming table system having a multi-touch electronic display in accordance with a specific embodiment.

FIG. 2 is a top plan view thereof.

FIG. 3 is a right side elevation view thereof.

FIG. 4 is a front elevation view thereof.

FIG. 5A shows a perspective view of an alternate example embodiment of a multi-touch, multi-player interactive display surface having a multi-touch electronic display surface.

FIG. 5B shows an example embodiment of a multi-touch, multi-player interactive display surface in accordance with various aspects described herein.

FIGS. 6A and 6B illustrate an example embodiment of schematic block diagram of various components/devices/connections which may be included as part of the intelligent wager-based gaming system.

FIG. 7A shows a simplified block diagram of an example embodiment of an intelligent wager-based gaming system 700.

FIGS. 7B and 7C illustrate different example embodiments of intelligent multi-player electronic gaming systems which have been configured or designed to include computer vision hand tracking functionality.

FIG. 7D illustrates a simplified block diagram of an example embodiment of a computer vision hand tracking technique which may be used for improving various aspects of relating to multi-touch, multi-player gesture recognition.

FIGS. 8A-D illustrate various examples of alternative candle embodiments.

FIGS. 9A-D illustrate various example embodiments of individual player station player tracking and/or audio/visual components.

FIGS. 10A-D illustrate example embodiments relating to integrated Player Tracking and/or individual player station audio/visual components.

FIG. 11 illustrates an example of a D-shaped intelligent multi-player electronic gaming system in accordance with a specific embodiment.

FIG. 12 is a simplified block diagram of an intelligent wager-based gaming system 1200 in accordance with a specific embodiment.

FIG. 13 shows a flow diagram of a Table Game State Tracking Procedure 1300 in accordance with a specific embodiment.

FIG. 14 shows an example interaction diagram illustrating various interactions which may occur between various components of an intelligent wager-based gaming system.

FIG. 15 shows an example of a gaming network portion 1500 in accordance with a specific embodiment.

FIG. 16 shows a flow diagram of a Flat Rate Table Game Session Management Procedure in accordance with a specific embodiment.

FIGS. 17-19 illustrate various example embodiments illustrating various different types of gesture detection and/or gesture recognition techniques.

FIG. 20 shows a simplified block diagram of an alternate example embodiment of an intelligent wager-based gaming system 2000.

FIGS. 21-22 illustrate example embodiments various portions of intelligent multi-player electronic gaming systems which may utilize one or more multipoint or multi-touch input interfaces.

FIGS. 23A-D different example embodiments of intelligent multi-player electronic gaming system configurations having a multi-touch, multi-player interactive display surfaces.

FIG. 24A shows an example embodiment of a Raw Input Analysis Procedure 2450.

FIG. 24B shows an example embodiment of a Gesture Analysis Procedure 2400.

FIGS. 25-38 illustrate various example embodiments of different gestures and gesture-function mappings which may be utilized at one or more intelligent multi-player electronic gaming systems described herein.

FIGS. 39A-P illustrate various example embodiments of different types of virtualized user interface techniques which may be implemented or utilized at one or more intelligent multi-player electronic gaming systems described herein.

FIG. 40A shows an example embodiment of a portion of a multiple layered, multi-touch, multi-player interactive display configuration which may be used for implementing one more multi-touch, multi-player interactive display device/system embodiments.

FIG. 40B shows a multi-layered display device arrangement suitable for use with a intelligent multi-player electronic gaming system in accordance with another embodiment.

FIGS. 41A and 41B show example embodiments of various types of content and display techniques which may be used for displaying various content on each of the different display screens of a multiple layered, multi-touch, multi-player interactive display configuration which may be used for implementing one more multi-touch, multi-player interactive display device/system embodiments described herein.

### DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or Figures that form a part of the present disclosure, and in which are shown, by way of illustration, specific embodiments of one or more of the invention(s). It should be understood, however, that such features are not limited to usage in the one or more particular embodiments or Figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

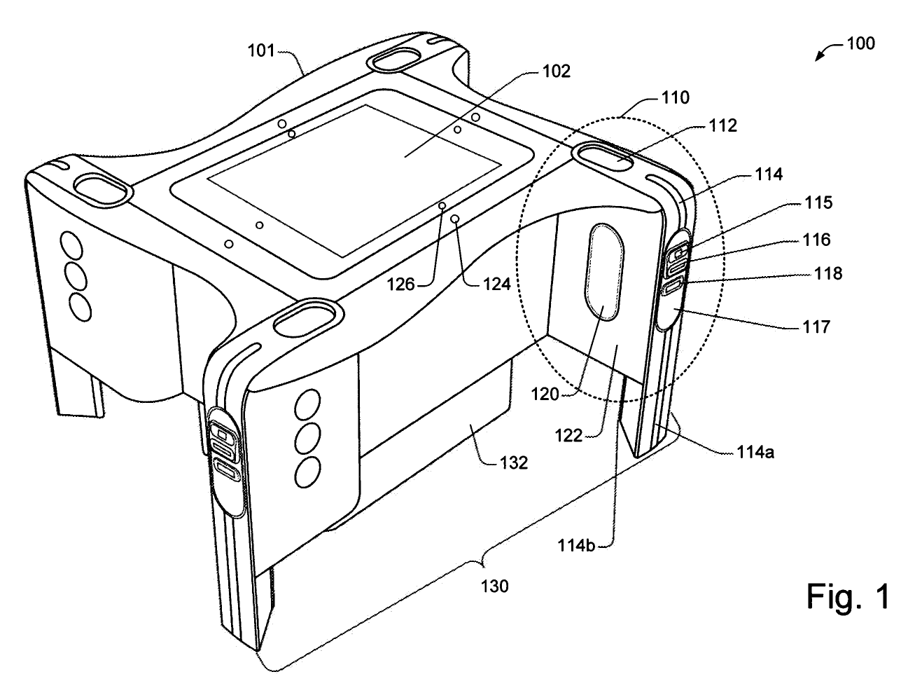

FIG. 1 shows a top perspective view of a multi-player gaming table system 100 with an electronic display in accordance with a specific embodiment. As illustrated in the example of FIG. 1, gaming table system 100 includes an intelligent multi-player electronic gaming system 101 which includes a main table display system 102, and a plurality of individual player stations 130. In at least one embodiment, the various devices, components, and/or systems associated with a given player station may collectively be referred to as a player station system.

In at least one embodiment, the intelligent multi-player electronic gaming system may include at least a portion of functionality similar to that described with respect to the various interactive gaming table embodiments disclosed in U.S. patent application Ser. No. 11/938,179, (Attorney Docket No. IGT1P459/P-1288), by Wells et al., entitled “TRANSPARENT CARD DISPLAY,” filed on Nov. 9, 2007, previously incorporated herein by reference in its entirety for all purposes. In some embodiments the main table display system 102 may be implemented using over-head video projection systems and/or below the table projection systems. The projection system may also be orientated to the side of the table or even within the bolster. Using mirrors, many different arrangements of projection systems are possible. Examples of various projection systems that may be utilized herein are described in U.S. patent application Ser. Nos. 10/838,283 (US Pub no. 20050248729), 10/914,922 (US Pub. No. 20060036944), 10/951,492 (US Pub no. 20060066564), 10/969,746 (US Pub. No. 20060092170), 11/182,630 (US Pub no. 20070015574), 11/350,854 (US Pub No. 20070201863), 11/363,750 (US Pub no. 20070188844), 11/370,558 (US Pub No. 20070211921), each of which is incorporated by reference in its entirety and for all purposes. In some embodiments, video displays, such as LCDs (Liquid Crystal Display), Plasma, OLEDs (Organic Light Emitting Display), Transparent (T) OLEDs, Flexible (F)OLEDs, Active matrix (AM) OLED, Passive matrix (PM) OLED, Phosphorescent (PH) OLEDs, SEDs (surface-conduction electron-emitter display), an EPD (ElectroPhoretic display), FEDs (Field Emission Displays) or other suitable display technology may be embedded in the upper surface 102 of the interactive gaming table 100 to display video images viewable in each of the video display areas. EPD displays may be provided by E-ink of Cambridge, Mass. OLED displays of the type list above may be provided by Universal Display Corporation, Ewing, N.J.

In at least one embodiment, main table display system 102 may include multi-touch technology for supporting multiple simultaneous touch points, for enabling concurrent real-time multi-player interaction. In at least one embodiment, the main table display system and/or other systems of the intelligent multi-player electronic gaming system may include at least a portion of technology (e.g., multi-touch, surface computing, object recognition, gesture interpretation, etc.) and/or associated components thereof relating to Microsoft Surface™ technology developed by Microsoft Corporation of Redmond, Wash.

According to various embodiments, each player station system of the intelligent multi-player electronic gaming system 101 may include, but is not limited to, one or more of the following (or combinations thereof):
funds center system 110
microphone(s) (e.g., 124)
camera(s) (e.g., 126)
speaker(s) 120
drink holder 112
candle(s) and/or light pipe(s) 114, 114a, 114b
ticket I/O device 116
bill acceptor 118
input devices (e.g., multi-switched input device 115)
access door 122
etc.

As illustrated in the example embodiment of FIG. 1, each leg of the table houses a “funds center” system (e.g., 110) with it's own external and internal components which are associated with a respective player station (e.g., 130) at the table. In at least one embodiment, the housing and interfaces of each funds center system may be configured or designed as a modular component that is interchangeable with other funds center systems of the intelligent multi-player electronic gaming system and/or of other intelligent multi-player electronic gaming systems. In one embodiment, each funds center system may be configured or designed to have substantially similar or identical specifications and/or components. Similarly, in some embodiments, other components and/or systems of the intelligent multi-player electronic gaming system may be configured or designed as a modular component that is interchangeable with other similar components/systems of the same intelligent multi-player electronic gaming system and/or of other intelligent multi-player electronic gaming systems.

In at least one embodiment, the funds center system and/or other components The modular legs may be swapped out and/or replaced without having to replace other components relating to “funds centers” associated with the other player stations.

In at least one embodiment, game feedback may be automatically dynamically generated for individual players, and may be communicated to the intended player(s) via visual and/or audio mechanisms.

For example, in one embodiment, game feedback for each player may include customized visual content and/or audio content which, for example, may be used to convey real-time player feedback information (e.g., to selected players), attraction information, etc.

In at least one embodiment, the intelligent multi-player electronic gaming system may include illumination components, such as, for example, candles, LEDs, light pipes, etc., aspects of which may be controlled by candle control system 469. According to different embodiments, illumination components may be included on the table top, legs, sides (e.g., down lighting on the sides), etc., and may be used for functional purposes, not just aesthetics.

For example, in one embodiment, the light pipes may be operable to automatically and dynamically change colors based on the occurrences of different types of events and/or conditions. For example, in at least one embodiment, the light pipes may be operable to automatically and dynamically change colors and/or display patterns to indicate different modes and/or states at the gaming table, such as, for example: game play mode, bonus mode, service mode, attract mode, game type in play, etc. In a lounge of such tables, where core games are being played by multiple players and/or at multiple tables, it may be useful to be able to visually recognize the game(s) in play at any one the table. For example, blue lights may indicate a poker game; green lights may indicate a blackjack game; flickering green lights may indicate that a player just got blackjack; an orange color may indicate play of a bonus mode, etc. For example, in one embodiment, 6 tables each displaying a strobing orange light may indicate to an observer that all 6 are in the same bonus round.

In addition to providing a natural, organic way of interacting with the multi-touch display surface, additional benefits are provided by using a light change on a light pipe to prompt a player to their turn, and/or to prompt attention to a particular game state or other event/condition.

In one embodiment, various colors may be displayed around the table when a player is hot or when the players at the table are winning more then the house. Something to reflect a “hot” table. Sound may also be used to tie to celebrations when people are winning. The notion of synchronizing sound and light to a game celebration provides useful functionality. Additionally, the table may be able to provide tactile feedback too. For example, the chairs may be vibrated around the table game based on game play, bonus mode, etc. According to different embodiments, vibration maybe on the seat, surface and/or around the table wrapper. This may be coupled with other types of sound/light content. Collectively these features add to the overall experience and can be much more than just an extension of a conventional “candle.”

In at least one embodiment, the intelligent multi-player electronic gaming system may also be configured or designed to display various types of information relating to the performances of one or more players at the gaming system. For example, in one embodiment where the intelligent multi-player electronic gaming system is configured as an electronic baccarat gaming table, game history information (e.g., player wins/loss, house wins/loss, draws) may be displayed on an electronic display of the electronic baccarat gaming table, which may be viewable to bystanders. Similarly, in at least one embodiment, a player's game history relating to each (or selected) player(s) occupying a seat/station at the gaming table may also be displayed. For example, in at least one embodiment, the display of the player's game history may include a running history of the player's wins/losses (e.g., at the current gaming table) as a function of time. This may allow side wagerers to quickly identify “hot” or “lucky” players by visually observing the player's displayed game history data.

In at least one embodiment, the gaming table may include wireless audio, video and/or data communication to various types of mobile or handheld electronic devices. In one embodiment, incorporating Bluetooth™ or Wi-Fi for a wireless device integration (audio channel, or whatever) provides additional functionality, such as, for example, the ability for a game to wirelessly “recognize” a player when they walk up, and automatically customize aspects of the player's player station system (e.g., based on the player's predefined preferences) to create an automated, unique, real-time customized experience for the player. For example, in one embodiment, the player walks up, and light pipes (e.g., associated with the player's player station) automatically morph to the player's favorite color, the player's wireless Bluetooth™ headset automatically pairs with the audio channel associated with the player's player station, etc.

According to a specific embodiment, the intelligent multi-player electronic gaming system may be operable to enable a secondary game to be played by one player at the intelligent multi-player electronic gaming system concurrently while a primary game is being played by other players. In at least one embodiment, both the primary and secondary games may be simultaneously or concurrently displayed on the main gaming table display.

In one embodiment, a single player secondary game may be selected by a player on a multiple player electronic table game surface from a plurality of casino games concurrent to game play activity on the primary multiplayer electronic table game. In one embodiment, the player is given the opportunity to select a secondary single player game during various times such as, for example, while other players are playing the multiplayer primary table game. This facilitates keeping the player interested during multiplayer games where the pace of the game is slow and/or where the player has time between primary play decisions to play the secondary game.

For example, in one embodiment, while the player is waiting for his or her turn, the player may engage in play of a selected secondary game. During the play of the single player secondary game, if the primary multiplayer game requires the player to make a decision (and/or to provide input relating to the primary table game), the secondary single player game state may automatically saved and/or made to temporarily disappear or fade from the display, for example, to avoid any delay or distraction from the primary multiplayer game decision. Once the game decision has been made, the secondary single player game may automatically reappear within the players play area, whereupon that player may continue where he/she left off. In other embodiments, display of the secondary game may be closed, removed, minimized, sent to the background, made translucent, etc. to allow for and/or direct attention of the player to primary game play.

Examples of single player secondary games may include, but are not limited to, one or more of the following (or combinations thereof): keno, bingo, slot games, card games, and/or other similar single player wager based games. In an alternative embodiment, the secondary game may include a skill-based game such as trivia, brickbreaker, ka-boom, chess, etc. In one embodiment, the secondary game play session may be funded on a per session basis. In other embodiments, the secondary game play session may be funded on a flat rate bases, or per game. In one embodiment, rewards relating to the secondary game play session may or may not be awarded based on player's game performance. Other embodiments include multiple player secondary games where the player may engage in game play with a group of players.

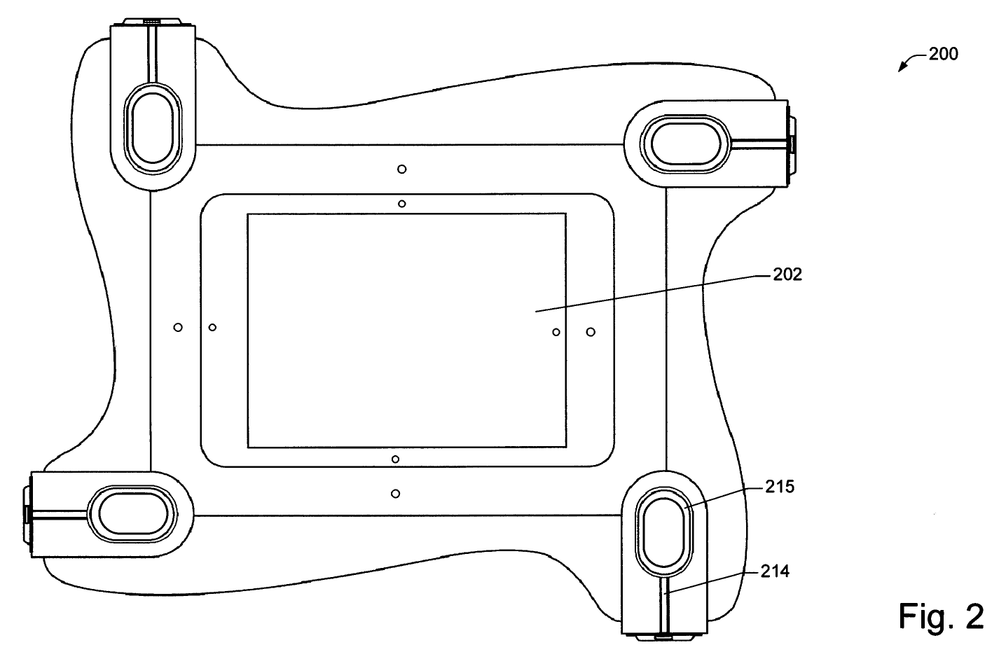

FIG. 2 shows a top view of a multi-player gaming table system with an electronic display in accordance with an alternate embodiment. In the example of FIG. 2, illumination elements (e.g., light pipes, LEDs, etc) may also be included around the drink holder region 215 of each player station.

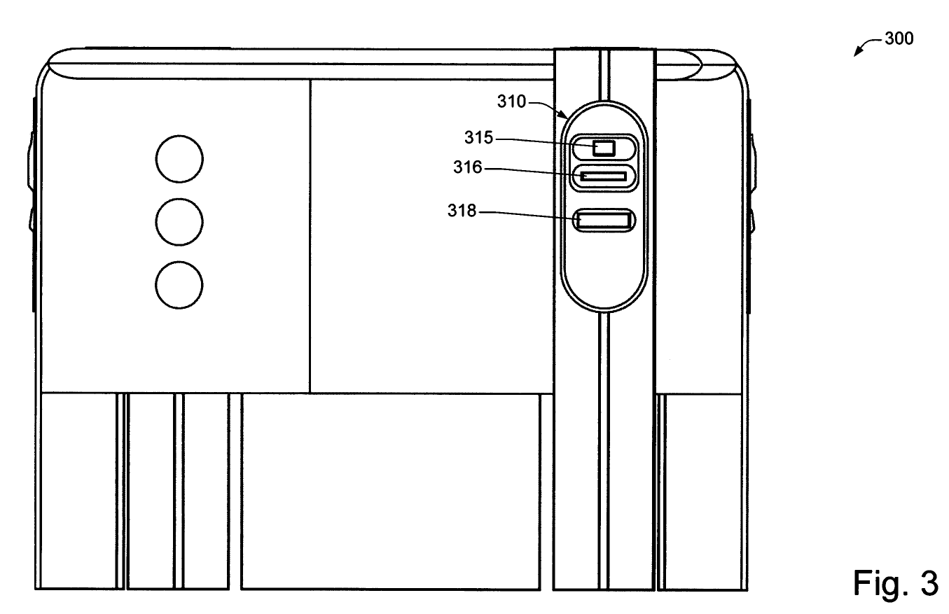

FIG. 3 shows a side view of a multi-player gaming table system with an electronic display in accordance with a specific embodiment. As illustrated in the example of FIG. 3, funds center portion 310 includes interfaces for input 315, ticket I/O 316, bill acceptor 318, and/or other desired components such as, for example, player tracking card I/O, credit card I/O, room key I/O, coin acceptor, etc.

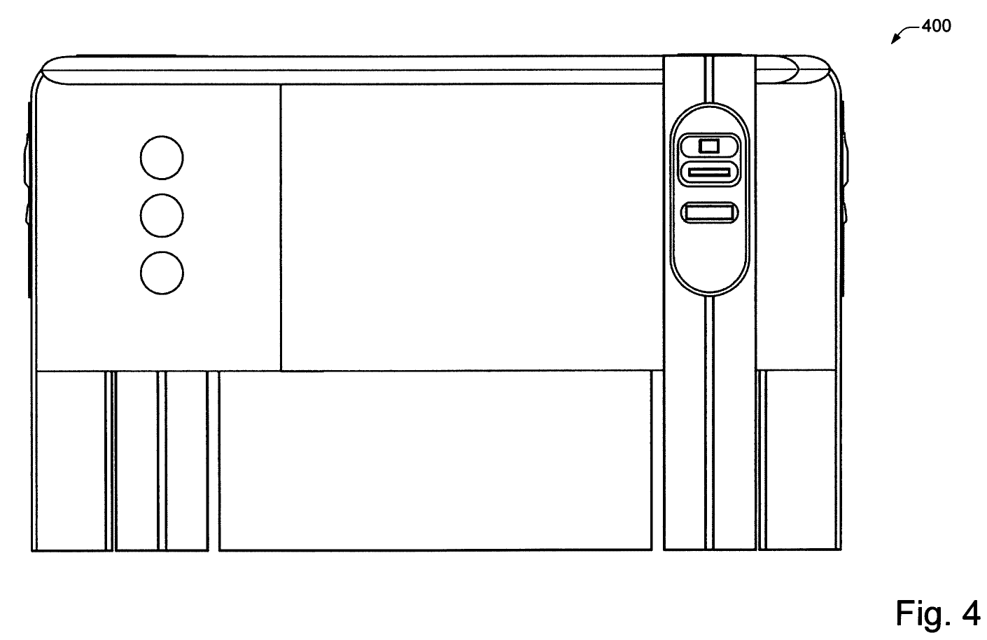

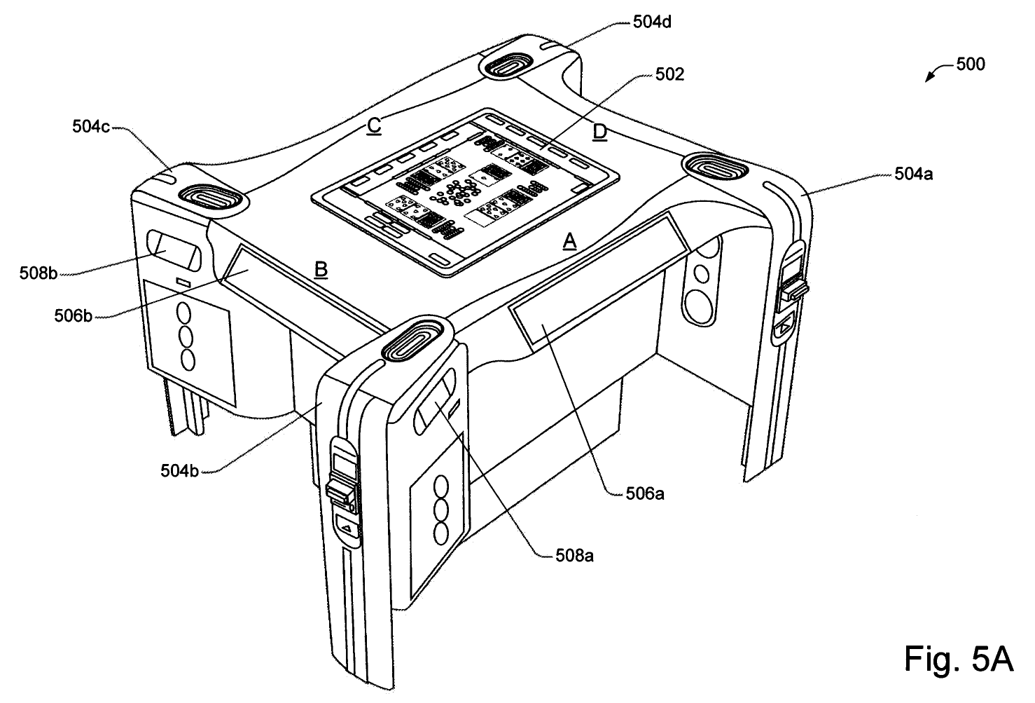

FIG. 4 shows a different side view of a multi-player gaming table system with an electronic display in accordance with a specific embodiment.

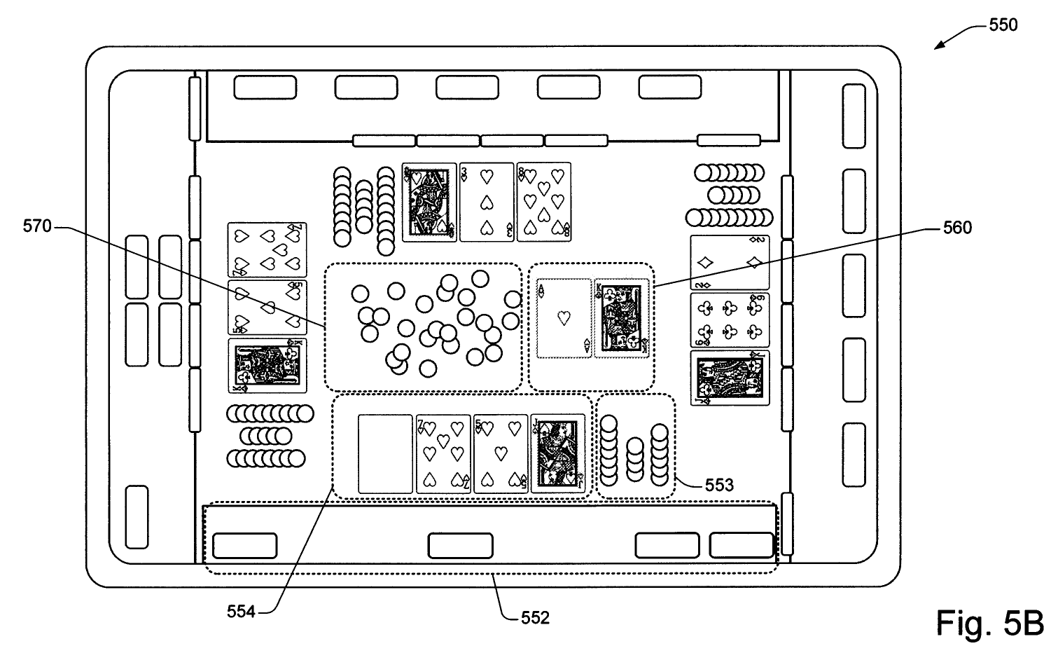

FIG. 5A shows an perspective view of an alternate example embodiment of a multi-touch, multi-player interactive display surface having a multi-touch electronic display surface. In the example of FIG. 5A, the intelligent multi-player electronic gaming system 500 is configured as a multi-player electronic table gaming system which includes 4 player stations (e.g., A, B, C, D), with each player station having a respective funds center system (e.g., 504a, 504b, 504c, 504d). In one embodiment, a rectangular shaped intelligent multi-player electronic gaming system may include 2 player stations of relatively narrower width (e.g., B, D) than the other 2 player stations (e.g., A, C).

As illustrated in the example embodiment of FIG. 5A, electronic table gaming system 500 includes a main display 502 which may be configured or designed as a multi-touch, multi-player interactive display surface having a multipoint or multi-touch input interface. According to different embodiments, various regions of the multi-touch, multi-player interactive display surface may be allocated for different uses which, for example, may influence the content which is displayed in each of those regions. For example, as described in greater detail below with respect to FIG. 5B, the multi-touch, multi-player interactive display surface may include one or more designated multi-player shared access regions, one or more designated personal player regions, one or more designated dealer or house regions, and or other types of regions of the multi-touch, multi-player interactive display surface which may be allocated for different uses by different persons interacting with the multi-touch, multi-player interactive display surface.

Additionally, as illustrated in the example embodiment of FIG. 5A, each player station may include an auxiliary display (e.g., 506a, 506b) which, for example, may be located or positioned below the gaming table surface. In this way, content displayed on a given auxiliary display (e.g., 506a) associated with a specific player/player station (e.g., Player Station A), may not readily be observed by the other players at the electronic table gaming system.

In at least one embodiment, each auxiliary display at a given player station may be provided for use by the player occupying that player station. In at least one embodiment, an auxiliary display (e.g., 506a) may be used to display various types of content and/or information to the player occupying that player station (e.g., Player Station A). For example, in some embodiments, auxiliary display 506a may be used to display (e.g., to the player occupying Player Station A) private information, confidential information, sensitive information, and/or any other type of content or information which the player may deem desirable or appropriate to be displayed at the auxiliary display. Additionally, in at least some embodiments, as illustrated in the example embodiment of FIG. 5A, each player station may include a secondary auxiliary display (e.g., 508a, 508b).

FIG. 5B shows an example embodiment of a multi-touch, multi-player interactive display surface 550 in accordance with various aspects described herein. For example, in at least one embodiment, multi-touch, multi-player interactive display surface 550 may be representative of content which, for example, may be displayed at display surface 502 of FIG. 5A.

As mentioned previously, various regions of the multi-touch, multi-player interactive display surface 550 may be automatically, periodically and/or dynamically allocated for different uses which, for example, may influence the content which is displayed in each of those regions. In at least some embodiments, regions of the multi-touch, multi-player interactive display surface 550 may be automatically and dynamically allocated for different uses based upon the type of game currently being played at the electronic table gaming system.

According to various embodiments, the multi-touch, multi-player interactive display surface may be configured to include one or more of the following types of regions (or combinations thereof):
One or more regions designated for use as a multi-player shared access region (e.g., 570). For example, in one embodiment, a multi-player shared access may be configured to permit multiple different users (e.g., players) to simultaneously or concurrently interact with the same shared-access region of the multi-touch, multi-player interactive display surface. An example of a multi-player shared access region is represented by common wagering 570, which, for example, may be accessed (e.g., serially and/or concurrently) by one or more players at the electronic table gaming system for placing one or more wagers.
One or more regions designated for use as a common display region in which multi-player shared-access is not available (e.g., 560). For example, in one embodiment, a common display region may be configured to present to gaming related content (e.g., common cards which are considered to be part of each player's hand) and/or wagering related content which is not intended to be accessed or manipulated by any of the players.
One or more regions (e.g., 552, 554, 553) designated for use as a personal player region. In at least one embodiment, each personal player region may be associated with a specific player at the electronic table gaming system, and may be configured to display personalized content relating to the specific player associated with that specific personal player region. For example, a personal player region may be used to display personalized game related content (e.g., cards of a player's hand), personalized wager related content (e.g., player's available wagering assets), and/or any other types of content relating to the specific player associated with that specific personal player region. In at least one embodiment, the multi-touch, multi-player interactive display surface may include a plurality of different personal player regions which are associated with a specific player at the electronic table gaming system. One or more of these personal player regions may be configured to permit the player to interact with and/or modify the content displayed within those specific player regions, while one or more of the player's other personal player regions may be configured only to allow the player to observe the content within those personal player regions, and may not permit the player to interact with and/or modify the content displayed within those specific player regions. In some embodiments, a personal player region may be configured to allow the associated player to interact with and/or modify only a portion of the content displayed within that particular personal player region.
One or more regions (e.g., 552, 553) designated for use as a personal player region and configured to permit the player to interact with and/or modify the content displayed within that specific player region.
One or more regions (e.g., 554) designated for use as a personal player region and configured not to permit the player to interact with and/or modify the content displayed within that specific player region.
One or more regions designated for use as a dealer or house region (e.g., 560). For example, in one embodiment, a dealer or house region may be configured to present to gaming related content (e.g., common cards which are considered to be part of each player's hand) and/or wagering related content which may be accessed and/or manipulated by the dealer or house, but which may not be accessed or manipulated by any of the players at the electronic table gaming system.
One or more regions designated for use as other types of regions of the multi-touch, multi-player interactive display surface which may be used for displaying content related to different types of activities and/or services available at the electronic table gaming system.

It will be appreciated that the shape of the various intelligent multi-player electronic gaming system embodiments described herein is not limited to 4-sided gaming tables such as that illustrated in FIGS. 1-5, for example. According to different embodiments, the shape of the intelligent multi-player electronic gaming system may vary, depending upon various criteria (e.g., intended uses, floor space, cost, etc.). Various possible intelligent multi-player electronic gaming system shapes may include, but are not limited to, one or more of the following (or combinations thereof): round, circular, semi-circular, ring-shaped, triangular, square, oval, elliptical, pentagonal, hexagonal, D-shaped, star shaped, C-shaped, etc.

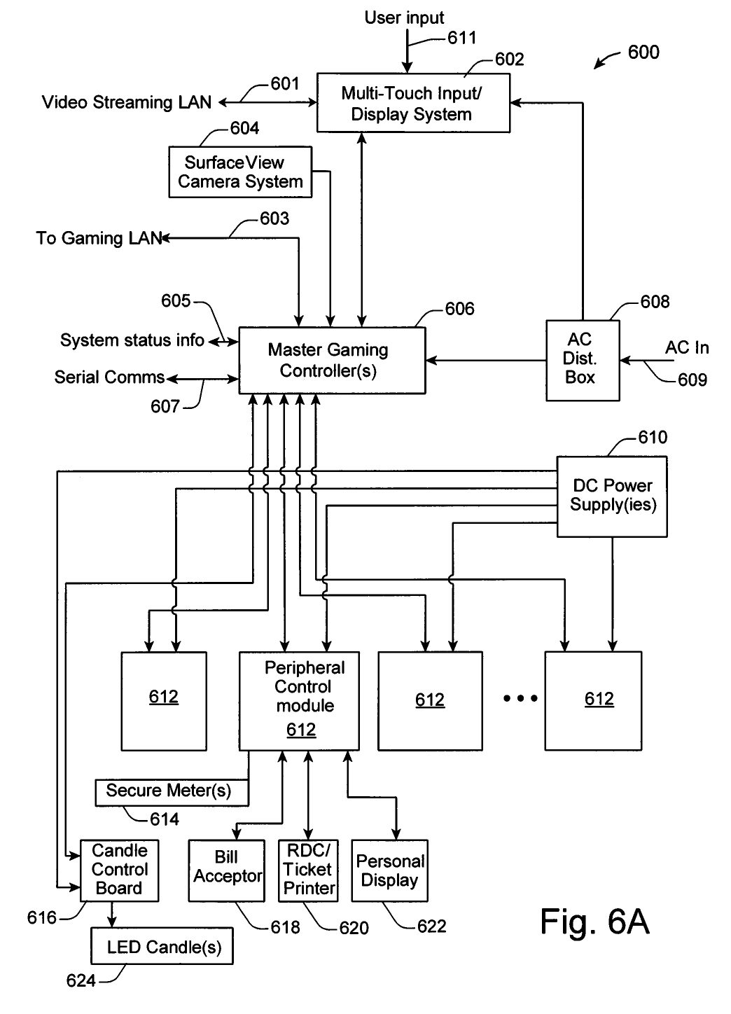

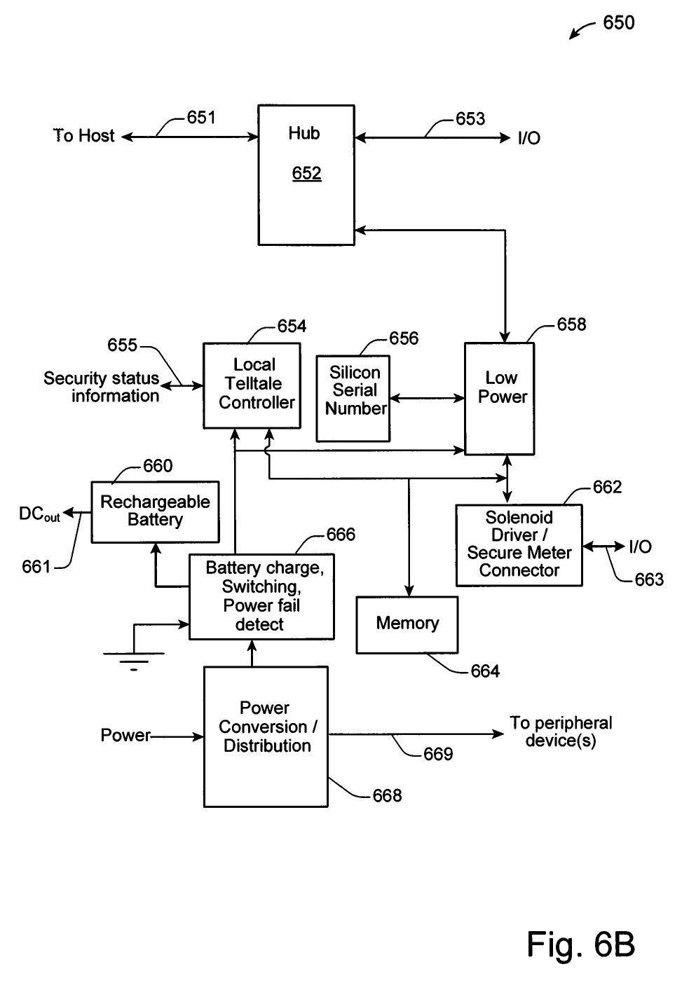

FIGS. 6A and 6B illustrate specific example embodiments of schematic block diagrams representing various types of components, devices, and/or signal paths which may be provided for implementing various aspects of one or more intelligent multi-player electronic gaming system embodiments described herein.

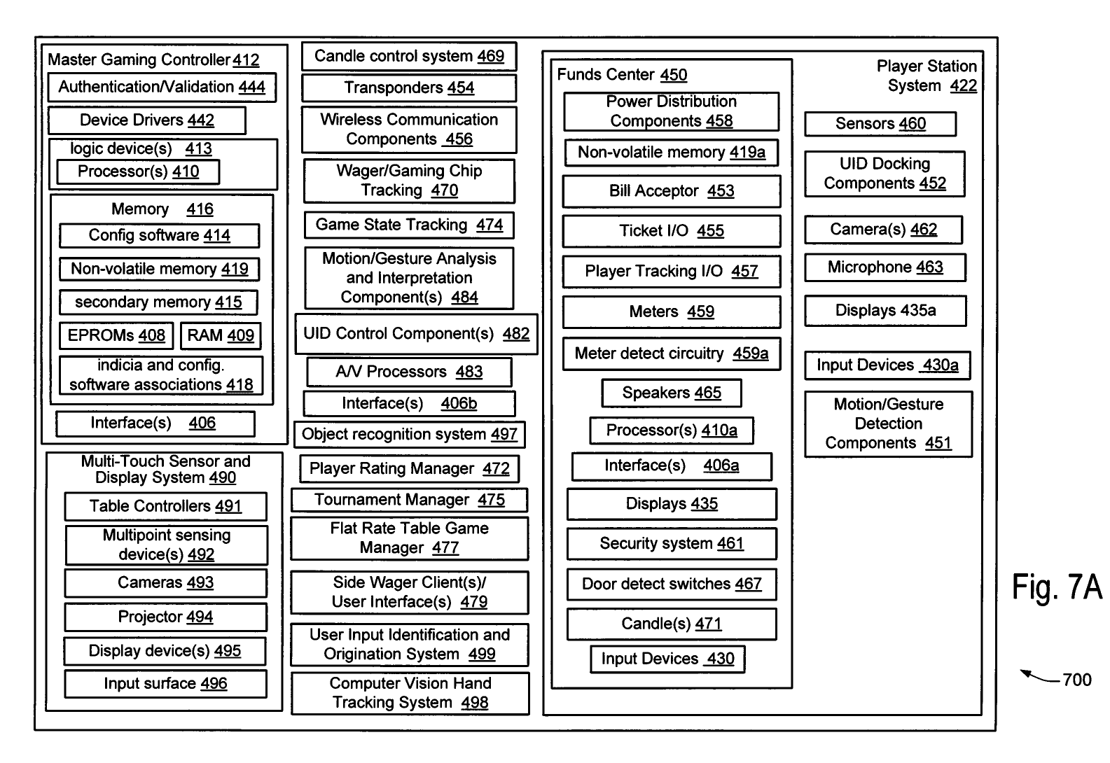

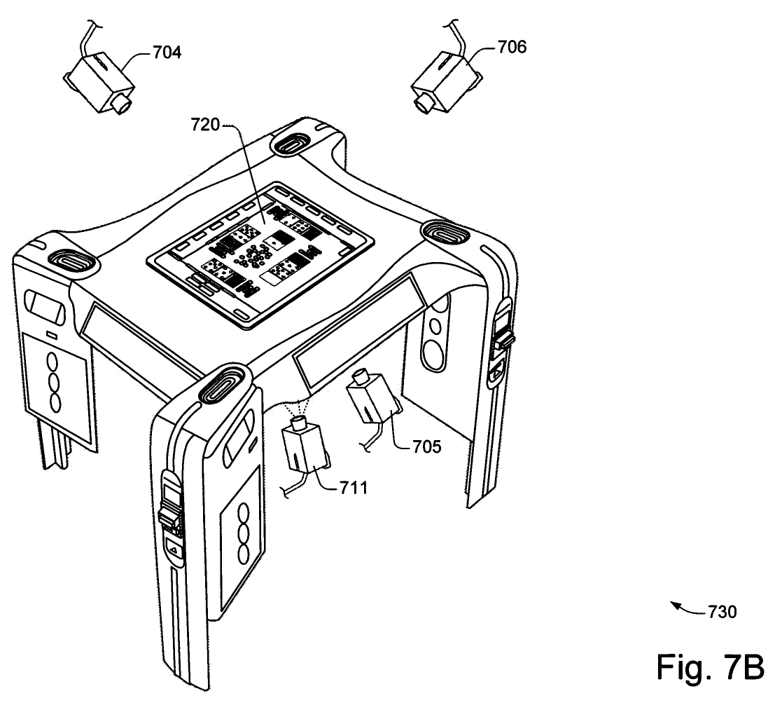

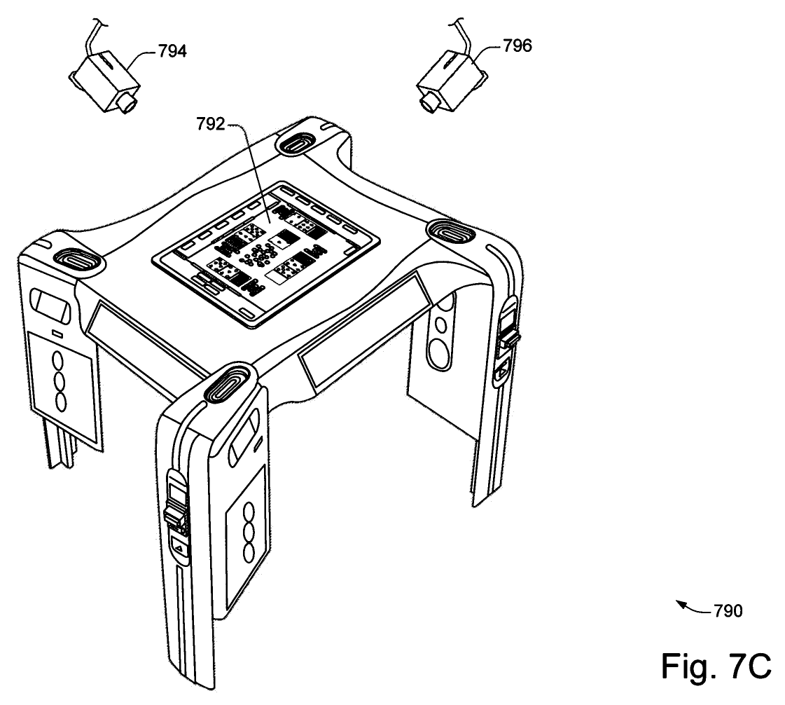

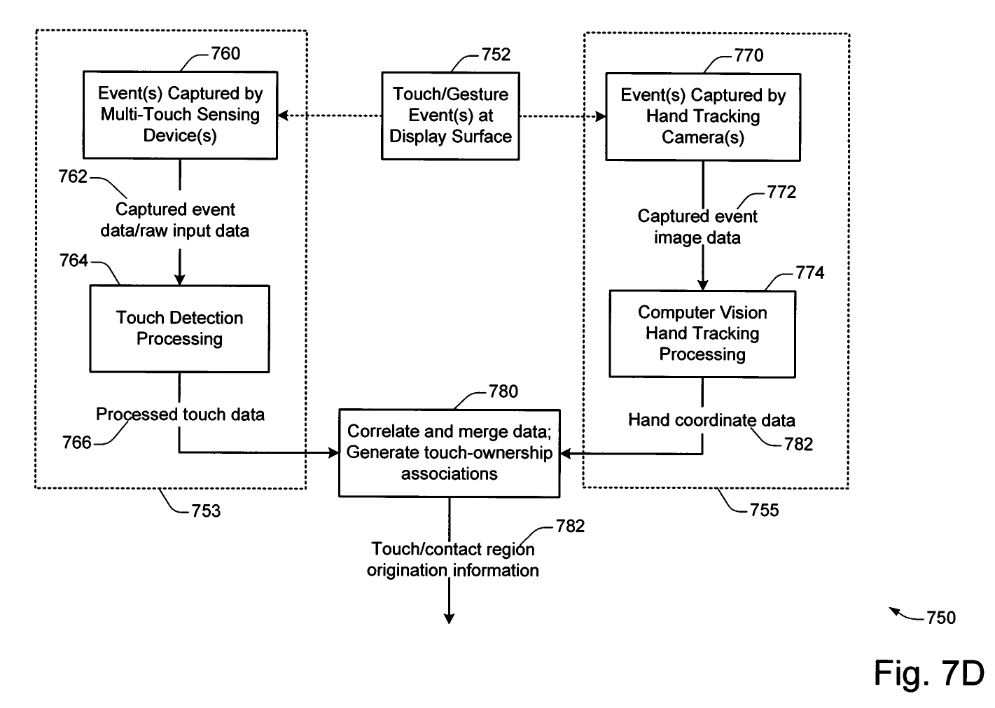

FIG. 7A is a simplified block diagram of an exemplary intelligent multi-player electronic gaming system 700 in accordance with a specific embodiment. As illustrated in the embodiment of FIG. 7A, intelligent multi-player electronic gaming system 700 includes at least one processor 410, at least one interface 406, and memory 416. Additionally, as illustrated in the example embodiment of FIG. 7A, intelligent multi-player electronic gaming system 700 includes at least one master gaming controller 412, a multi-touch sensor and display system 490, multiple player station systems (e.g., player station system 422, which illustrates an example embodiment of one of the multiple player station systems), and/or various other components, devices, systems such as, for example, one or more of the following (or combinations thereof):
Candle control system 469 which, for example, may include functionality for determining and/or controlling the appearances of one or more candles, light pipes, etc.;
Transponders 454;
Wireless communication components 456;
Gaming chip/wager token tracking components 470;
Games state tracking components 474;
Motion/gesture analysis and interpretation components 484;
User input device (UID) control components 482;
Audio/video processors 483 which, for example, may include functionality for detecting, analyzing and/or managing various types of audio and/or video information relating to various activities at the intelligent multi-player electronic gaming system;
Various interfaces 406b (e.g., for communicating with other devices, components, systems, etc.);
Object recognition system 497 which, for example, may include functionality for identifying and recognizing one or more objects placed on or near the main table display surface;
Player rating manager 473;
Tournament manager 475;
Flat rate table game manager 477;
Side wager client(s)/user interface(s) 479 which may be operable for enabling players at the gaming table to access and perform various types of side wager related activities;
User input identification and origination system 499 which, for example, may be operable to perform one or more functions for determining and/or identifying an appropriate origination entity (such as, for example, a particular player, dealer, and/or other user interacting with the multi-touch, multi-player interactive display surface of an intelligent multi-player electronic gaming system) to be associated with each (or selected ones of) the various contacts, movements, and/or gestures detected at or near the multi-touch, multi-player interactive display surface;
Computer Vision Hand Tracking System 498 which, for example, may be operable to track users' hands on or over the multi-touch, multi-player interactive display surface and/or determine the different users' hand coordinates while gestures are being performed by the users on or over the display surface.
etc.

In at least one embodiment, user input identification/origination system 499 may be operable to determine and/or identify an appropriate origination entity (e.g., a particular player, dealer, and/or other user at the gaming system) to be associated with each (or selected ones of) the various contacts, movements, and/or gestures detected at or near the multi-touch, multi-player interactive display surface. In one embodiment, the user input identification/origination system may be operable to function in a multi-player environment, and may include functionality for initiating and/or performing one or more of the following functions (or combinations thereof):
concurrently detecting multiple different input data from different players at the gaming table;
determining a unique identifier for each active player at the gaming table;
automatically determining, for each input detected, the identity of the player (or other person) who provided that input;
automatically associating each detected input with an identifier representing the player (or other person) who provided that input;
etc.

In some embodiments, the user input identification/origination system may be operatively coupled to one or more cameras (e.g., 493, 462, etc.) and/or other types of sensor devices described herein (such as, for example, microphones 463, sensors 460, multipoint sensing device(s) 496, etc.) for use in identifying a particular user who is responsible for performing one or more of the touches, contacts and/or gestures detected at or near the multi-touch, multi-player interactive display surface.

In at least one embodiment, object recognition system 497 may include functionality for identifying and recognizing one or more objects placed on or near the main table display surface. It may also determine and/or recognize various characteristics associated with physical objects placed on the multi-touch, multi-player interactive display surface such as, for example, one or more of the following (or combinations thereof): positions, shapes, orientations, and/or other detectable characteristics of the object.

One or more cameras (e.g., 493, 462, etc.) may be utilized with a machine vision system to identify shapes and orientations of physical objects placed on the multi-touch, multi-player interactive display surface. In some embodiments, cameras may also be mounted below the multi-touch, multi-player interactive display surface (such as, for example, in situations where the presence of an object may be detected from the beneath the display surface. In at least one embodiment, the cameras may operable to detect visible and/or infrared light. Also, a combination of visible and infrared light detecting cameras may be utilized. In another embodiment, a stereoscopic camera may be utilized.

In response to detecting a physical object placed on the first surface, the intelligent multi-player electronic gaming system may be operable to open a video display window at a particular region of the multi-touch, multi-player interactive display. In a particular embodiment, the physical object may include a transparent portion that allows information displayed in the video display window (e.g., which may be opened directly under or below the transparent object) to be viewed through the physical object.

In at least one embodiment, at least some of the physical objects described herein may include light-transmissive properties that vary within the object. For instance, in some embodiments, half of an object may be transparent and the other half may be opaque, such that video images rendered below the object may be viewed through the transparent half of the object and blocked by the opaque portion. In another example, the outer edges of object may be opaque while within the outer edges of object that are opaque, the object may be transparent, such that video images rendered below it may be viewed through the transparent portion. In yet another example, the object may include a plurality of transparent portions surrounded by opaque or translucent portions to provide multiple viewing windows through the object.

In some embodiments, one or more objects may include an RFID tag that allows the transmissive properties of the object, such as locations of transparent and non-transparent portions of the object or in the case of overhead projection, portions adapted for viewing projected images and portions not adapted for viewing projected images, to be identified.

In at least some embodiments, one or more objects may comprise materials that allow them to be more visible to a particular camera, such as including an infrared reflective material in an object to make it more visible under infrared light. Further, in one embodiment, the multi-touch, multi-player interactive display surface may comprise a non-infrared reflecting material for enhancing detection of infrared reflecting objects placed on the display surface (e.g., via use of an infrared camera or infrared sensor). In addition, the intelligent multi-player electronic gaming system may include light emitters, such as an infrared light source, that helps to make an object more visible to a particular type of a camera/sensor.

The intelligent multi-player electronic gaming system may include markings, such as, for example, shapes of a known dimension, that allow the object detection system to self-calibrate itself in regards to using image data obtained from a camera for the purposes of determining the relative position of objects. In addition, the objects may include markings that allow information about the objects to be obtained. The markings may be symbol patterns like a bar-code or symbols or patterns that allow object properties to be identified. These symbols or patterns may be on a top, bottom, side or any surface of an object depending on where cameras are located, such as below or above the objects. The orientation of pattern or markings and how a machine vision system may perceive them from different angles may be known. Using this information, it may be possible to determine an orientation of objects on the display surface.

For example, in at least one embodiment, the object recognition system 497 may include a camera that may be able to detect markings on a surface of the object, such as, for example, a barcode and/or other types of displayable machine readable content which may be detected and/or recognized by an appropriately configured electronic device. The markings may be on a top surface, lower surface or side and may vary according to a shape of the object as well as a location of data acquisition components, such as cameras, sensors, etc. Such markings may be used to convey information about the object and/or its associations. For example, in one embodiment one portion of markings on the object may represent an identifier which may be used for uniquely identifying that particular object, and which may be used for determining or identifying other types of information relating to and/or associated with that object, such as, for example, an identity of an owner (or current possessor) of the object, historical data relating to that object (such as, for example, previous uses of the object, locations and times relating to previous uses of the object, prior owners/users of the object, etc.), etc. In some embodiments, the markings may be of a known location and orientation on the object and may be used by the object recognition system 497 to determine an orientation of the object.

In at least one embodiment, multi-touch sensor and display system 490 may include one or more of the following (or combinations thereof):
Table controllers 491;
Multipoint sensing device(s) 492 (e.g., multi-touch surface sensors/components);
Cameras 493;
Projector(s) 494;
Display device(s) 495;
Input/touch surface 496;
Etc.

In at least one embodiment, multi-touch sensor and display system 490 may include one or more of the following (or combinations thereof):
Display controllers 491;
Multipoint sensing device(s) 492 (e.g., multi-touch surface sensors/components);
Cameras 493;
Projector(s) 494;
Display surface(s) 495;
Input/touch surface 496;
Etc.

In at least one embodiment, one or more of the multipoint sensing device(s) 492 may be implemented using any suitable multipoint or multi-touch input interface (such as, for example, a multipoint touchscreen) which is capable of detecting and/or sensing multiple points touched simultaneously on the device 492 and/or multiple gestures gestured on the device 492. Thus, for example, in at least one embodiment, input/touch surface 496 may include at least one multipoint sensing device 492 which, for example, may be positioned over or in front of one or more of the display device(s) 495, and/or may be integrated with one or more of the display device(s).

For example, in one example embodiment, multipoint sensing device(s) 492 may include one or more multipoint touchscreen products available from CAD Center Corporation of Tokyo, Japan (such as, for example, one or more multipoint touchscreen products marketed under the trade name “NEXTRAX™.” For example, in one embodiment, the multipoint sensing device(s) 492 may be implemented using a multipoint touchscreen configured as an optical-based device that triangulates the touched coordinate(s) using infrared rays (e.g., retroreflective system) and/or an image sensor.

In another example embodiment, multipoint sensing device(s) 492 may include a frustrated total internal reflection (FTIR) device, such as that described in the article, “Low-Cost Multi-Touch Sensing Through Frustrated Total Internal Reflection,” by Jefferson Y. Han, published by ACM New York, N.Y., Proceedings of the 18th Annual ACM Symposium on User Interface Software and Technology 2005, at 115-118, the entirety of which is incorporated herein by reference for all purposes.

For example, in one embodiment, a multipoint sensing device may be implemented as a FTIR-based multipoint sensing device which includes a transparent substrate (e.g., acrylic), an LED array, a projector (e.g., 494), a video camera (e.g., 493), a baffle, and a diffuser secured by the baffle. The projector and the video camera may form the multi-touch, multi-player interactive display surface of the intelligent multi-player electronic gaming system. In one embodiment, the transparent substrate is edge-lit by the LED array (which, for example, may include high-power infrared LEDs or photodiodes placed directly against the edges of the transparent substrate). The video camera may include a band-pass filter to isolate infrared frequencies which are desired to be detected, and may be operatively coupled to the gaming system controller. The rear-projection projector may be configured or designed to project images onto the transparent substrate, which diffuses through the diffuser and rendered visible. Pressure can be sensed by the FTIR device by comparing the pixel area of the point touched. For example, a light touch will register a smaller pixel area by the video camera than a heavy touch by the same finger tip.

FTIR-based multipoint sensing device should preferably be capable of sensing or detecting multiple concurrent touches. For example, in one embodiment, when the fingers of a player touch or may contact with regions on the transparent substrate, an infrared light bouncing around inside the transparent substrate may be scattered in various directions, and these optical disturbances may be detected by the video camera (or other suitable sensor(s)). Gestures can also be recorded by the video camera, and data representing the multipoint gestures may be transmitted to the gaming system controller for further processing. In at least one embodiment, the data may include various types of characteristics relating to the detected gesture(s) such as, for example, velocity, direction, acceleration, pressure of a gesture, etc.

In other embodiments, a multipoint sensing device may be implemented using a transparent self-capacitance or mutual-capacitance touchscreen, such as that disclosed in PCT Publication No. WO2005/114369A3, entitled “Multipoint Touchscreen”, by HOTELLING et al, the entirety of which is incorporated herein by reference for all purposes.

In other embodiments, a multipoint sensing device may be implemented using a multi-user touch surface such as that described in U.S. Pat. No. 6,498,590, entitled “MULTI-USER TOUCH SURFACE” by Dietz et al., the entirety of which is incorporated herein by reference for all purposes. For example, in one embodiment the multi-touch sensor and display system 490 may be implemented using one of the MERL DiamondTouch™ table products developed by Mitsubishi Electric Research Laboratories, and distributed by Circle Twelve Inc., of Framingham, Mass.

For example, in at least one embodiment, the intelligent multi-player electronic gaming system may be implemented as an electronic gaming table having a multi-touch display surface. The electronic gaming table may be configured or designed to transmit wireless signals to all or selected regions of the surface of the table. The table display surface may be configured or designed to include an array of embedded antennas arranged in a selectable in a grid array. In some embodiments, each user at the electronic gaming table may be provided with a chair which is operatively coupled to a sensing receiver. In other embodiments, users at the electronic gaming table may be provided with other suitable mechanisms (e.g., floor pads, electronic wrist bracelets, etc.) which may be operatively coupled to (e.g., via wired and/or wireless connections) one or more designated sensing receivers. In one embodiment, when a user touches the table surface, signals are capacitively coupled from directly beneath the touch point, through the user, and into a receiver unit associated with that user. The receiver can then determine which parts of the table surface the user is touching.

Other touch sensing technologies are suitable for use as the multipoint sensing device(s) 492, including resistive sensing, surface acoustic wave sensing, pressure sensing, optical sensing, and the like. Also, other mechanisms may be used to display the graphics on the display surface 302 such as via a digital light processor (DLP) projector that may be suspended at a set distance in relation to the display surface.

In at least one embodiment, at least some gestures detected by the intelligent multi-player electronic gaming system may include gestures where all or a portion of a player's hand and/or arm are resting on a surface of the interactive table. In some instances, the detection system may be operable to detect a hand gesture when the hand is a significant distance from the surface of the table. During a hand motion as part of a gesture that is detected for some embodiments, a portion of the player's hand such as a finger may remain in contact continuously or intermittently with the surface of the interactive table or may hover just above the table. In some instances, the detection system may require a portion of the player's hand to remain in contact with the surface for the gesture to be recognized.

In at least one embodiment, video images may be generated using one or more projection devices (e.g., 494) which may be positioned above, on the side(s) and/or below the multi-touch display surface. Examples of various projection systems that may be utilized herein are described in U.S. patent application Ser. Nos. 10/838,283 (US Pub no. 20050248729), 10/914,922 (US Pub. No. 20060036944), 10/951,492 (US Pub no. 20060066564), 10/969,746 (US Pub. No. 20060092170), 11/182,630 (US Pub no. 20070015574), 11/350,854 (US Pub No. 20070201863), 11/363,750 (US Pub no. 20070188844), 11/370,558 (US Pub No. 20070211921), each of which is incorporated by reference in its entirety and for all purposes.

According to various embodiments, display surface(s) 495 may include one or more display screens utilizing various types of display technologies such as, for example, one or more of the following (or combinations thereof): LCDs (Liquid Crystal Display), Plasma, OLEDs (Organic Light Emitting Display), TOLED (Transparent Organic Light Emitting Display), Flexible (F)OLEDs, Active matrix (AM) OLED, Passive matrix (PM) OLED, Phosphor-escent (PH) OLEDs, SEDs (surface-conduction electron-emitter display), EPD (ElectroPhoretic display), FEDs (Field Emission Displays) and/or other suitable display technology. EPD displays may be provided by E-ink of Cambridge, Mass. OLED displays of the type list above may be provided by Universal Display Corporation, Ewing, N.J.

In at least one embodiment, master gaming controller 412 may include one or more of the following (or combinations thereof):
Authentication/validation components 444;
Device drivers 442;
Logic devices 413, which may include one or more processors 410;
Memory 416, which may include one or more of the following (or combinations thereof): configuration software 414, non-volatile memory 415, EPROMS 408, RAM 409, associations 418 between indicia and configuration software, etc.;
Interfaces 406;
Etc.

In at least one embodiment, player station system 422 may include one or more of the following (or combinations thereof):
Sensors 460;
User input device (UID) docking components 452;
One or more cameras 462;
One or more microphones 463;
Secondary display(s) 435a;
Input devices 430a;
Motion/gesture detection components 451;
Funds center system 450;
Etc.

In at least one embodiment, funds center system 450 may include one or more of the following (or combinations thereof):
Power distribution components 458;
Non-volatile memory 419a (and/or other types of memory);
Bill acceptor 453;
Ticket I/O 455;
Player tracking i/o 457;
Meters 459 (e.g., hard and/or soft meters);
Meter detect circuitry 459a;
Speakers 465;
Processor(s) 410a;
Interface(s) 406a;
Display(s) 435;
Independent security system 461;
Door detect switches 467;
Candles, light pipes, etc. 471;
Input devices 430;
Etc.

In one implementation, processor 410 and master gaming controller 412 are included in a logic device 413 enclosed in a logic device housing. The processor 410 may include any conventional processor or logic device configured to execute software allowing various configuration and reconfiguration tasks such as, for example: a) communicating with a remote source via communication interface 406, such as a server that stores authentication information or games; b) converting signals read by an interface to a format corresponding to that used by software or memory in the intelligent multi-player electronic gaming system; c) accessing memory to configure or reconfigure game parameters in the memory according to indicia read from the device; d) communicating with interfaces, various peripheral devices 422 and/or I/O devices; e) operating peripheral devices 422 such as, for example, card readers, paper ticket readers, etc.; f) operating various I/O devices such as, for example, displays 435, input devices 430; etc. For instance, the processor 410 may send messages including game play information to the displays 435 to inform players of cards dealt, wagering information, and/or other desired information.

In at least one embodiment, player station system 422 may include a plurality of different types of peripheral devices such as, for example, one or more of the following (or combinations thereof): transponders 454, wire/wireless power supply devices, UID docking components, player tracking devices, card readers, bill validator/paper ticket readers, etc. Such devices may each comprise resources for handling and processing configuration indicia such as a microcontroller that converts voltage levels for one or more scanning devices to signals provided to processor 410. In one embodiment, application software for interfacing with one or more player station system components/devices may store instructions (such as, for example, how to read indicia from a portable device) in a memory device such as, for example, non-volatile memory, hard drive or a flash memory.

In at least one implementation, the intelligent multi-player electronic gaming system may include card readers such as used with credit cards, or other identification code reading devices to allow or require player identification in connection with play of the card game and associated recording of game action. Such a user identification interface can be implemented in the form of a variety of magnetic card readers commercially available for reading a user-specific identification information. The user-specific information can be provided on specially constructed magnetic cards issued by a casino, or magnetically coded credit cards or debit cards frequently used with national credit organizations such as VISA, MASTERCARD, AMERICAN EXPRESS, or banks and other institutions.

The intelligent multi-player electronic gaming system may include other types of participant identification mechanisms which may use a fingerprint image, eye blood vessel image reader, or other suitable biological information to confirm identity of the user. Still further it is possible to provide such participant identification information by having the dealer manually code in the information in response to the player indicating his or her code name or real name. Such additional identification could also be used to confirm credit use of a smart card, transponder, and/or player's personal user input device (UID).

The intelligent multi-player electronic gaming system 700 also includes memory 416 which may include, for example, volatile memory (e.g., RAM 409), non-volatile memory 419 (e.g., disk memory, FLASH memory, EPROMs, etc.), unalterable memory (e.g., EPROMs 408), etc. The memory may be configured or designed to store, for example: 1) configuration software 414 such as all the parameters and settings for a game playable on the intelligent multi-player electronic gaming system; 2) associations 418 between configuration indicia read from a device with one or more parameters and settings; 3) communication protocols allowing the processor 410 to communicate with peripheral devices 422 and I/O devices 411; 4) a secondary memory storage device 415 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the intelligent multi-player electronic gaming system to communicate with local and non-local devices using such protocols; etc. In one implementation, the master gaming controller 412 communicates using a serial communication protocol. A few examples of serial communication protocols that may be used to communicate with the master gaming controller include but are not limited to USB, RS-232 and Netplex (a proprietary protocol developed by IGT, Reno, Nev.).

A plurality of device drivers 442 may be stored in memory 416. Example of different types of device drivers may include device drivers for intelligent multi-player electronic gaming system components, device drivers for player station system components, etc. Typically, the device drivers 442 utilize a communication protocol of some type that enables communication with a particular physical device. The device driver abstracts the hardware implementation of a device. For example, a device drive may be written for each type of card reader that may be potentially connected to the intelligent multi-player electronic gaming system. Examples of communication protocols used to implement the device drivers include Netplex, USB, Serial, Ethernet 475, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 416 by the processor 410 to allow communication with the device. For instance, one type of card reader in intelligent multi-player electronic gaming system 700 may be replaced with a second type of card reader where device drivers for both card readers are stored in the memory 416.

In some embodiments, the software units stored in the memory 416 may be upgraded as needed. For instance, when the memory 416 is a hard drive, new games, game options, various new parameters, new settings for existing parameters, new settings for new parameters, device drivers, and new communication protocols may be uploaded to the memory from the master gaming controller 412 or from some other external device. As another example, when the memory 416 includes a CD/DVD drive including a CD/DVD designed or configured to store game options, parameters, and settings, the software stored in the memory may be upgraded by replacing a first CD/DVD with a second CD/DVD. In yet another example, when the memory 416 uses one or more flash memory 419 or EPROM 408 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the intelligent multi-player electronic gaming system 700 may also include various authentication and/or validation components 444 which may be used for authenticating/validating specified intelligent multi-player electronic gaming system components such as, for example, hardware components, software components, firmware components, information stored in the intelligent multi-player electronic gaming system memory 416, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Player station system components/devices 422 may also include other devices/component(s) such as, for example, one or more of the following (or combinations thereof): sensors 460, cameras 462, control consoles, transponders, personal player (or user) displays 453a, wireless communication component(s), power distribution component(s) 458, user input device (UID) docking component(s) 452, player tracking management component(s), game state tracking component(s), motion/gesture detection component(s) 451, etc.

Sensors 460 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; detecting the presence and/or identity of UIDs, detecting player (and/or dealer) movements/gestures, etc.

In one implementation, at least a portion of the sensors 460 and/or input devices 430 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the intelligent multi-player electronic gaming system player displays (and/or UID displays) may include input functionality for allowing players to provide their game play decisions/instructions (and/or other input) to the dealer using the touch keys and/or other player control sensors/buttons. Additionally, such input functionality may also be used for allowing players to provide input to other devices in the casino gaming network (such as, for example, player tracking systems, side wagering systems, etc.)

Wireless communication components 456 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication—Interface and Protocol (NFCIP-1)”, published by ECMA International (www.ecma-international.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least 4 devices using such wireless communication protocols.

Power distribution components 458 may include, for example, components or devices which are operable for providing wireless power to other devices. For example, in one implementation, the power distribution components 458 may include a magnetic induction system which is adapted to provide wireless power to one or more portable UIDs at the intelligent multi-player electronic gaming system. In one implementation, a UID docking region may include a power distribution component which is able to recharge a UID placed within the UID docking region without requiring metal-to-metal contact.

In at least one embodiment, motion/gesture detection component(s) 451 may be configured or designed to detect user (e.g., player, dealer, and/or other persons) movements and/or gestures and/or other input data from the user. In some embodiments, each player station 422 may have its own respective motion/gesture detection component(s). In other embodiments, motion/gesture detection component(s) 451 may be implemented as a separate sub-system of the intelligent multi-player electronic gaming system which is not associated with any one specific player station.

In at least one embodiment, motion/gesture detection component(s) 451 may include one or more cameras, microphones, and/or other sensor devices of the intelligent multi-player electronic gaming system which, for example, may be used to detect physical and/or verbal movements and/or gestures of one or more players (and/or other persons) at the gaming table. Additionally, according to specific embodiments, the detected movements/gestures may include contact-based gestures/movements (e.g., where a user makes physical contact with the multi-touch surface of the intelligent multi-player electronic gaming system) and/or non-contact-based gestures/movements (e.g., where a user does not make physical contact with the multi-touch surface of the intelligent multi-player electronic gaming system).

In one embodiment, the motion/gesture detection component(s) 451 may be operable to detect gross motion or gross movement of a user (e.g., player, dealer, etc.). The motion detection component(s) 451 may also be operable to detect gross motion or gross movement of a user's appendages such as, for example, hands, fingers, arms, head, etc. Additionally, in at least one embodiment, the motion/gesture detection component(s) 451 may further be operable to perform one or more additional functions such as, for example: analyze the detected gross motion or gestures of a participant; interpret the participant's motion or gestures (e.g., in the context of a casino game being played at the intelligent multi-player electronic gaming system) in order to identify instructions or input from the participant; utilize the interpreted instructions/input to advance the game state; etc. In other embodiments, at least a portion of these additional functions may be implemented at the master gaming controller 412 and/or at a remote system or device.

In at least one embodiment, motion/gesture analysis and interpretation component(s) 484 may be operable to analyze and/or interpret information relating to detected player movements and/or gestures. For example, in at least one embodiment, motion/gesture analysis and interpretation component(s) 484 may be operable to perform one or more of the following types of operations (or combinations thereof):
recognize one or more gestures performed by users interacting with the intelligent multi-player electronic gaming system;
map various types of raw input data (e.g., detected by the multi-touch sensor and display system 490) to one or more gestures;
identify groupings of two or more contact regions (e.g., detected by the multi-touch sensor and display system 490) as being associated with each other for the purpose of gesture recognition/identification/interpretation;
determine and/or identify the number or quantity of contact regions associated with a gesture performed by a user interacting with the intelligent multi-player electronic gaming system;
determine and/or identify the shapes and/or sizes of contact regions relating to a gesture performed by a user interacting with the intelligent multi-player electronic gaming system;
determine and/or identify the locations of the contact regions associated with a gesture performed by a user interacting with the intelligent multi-player electronic gaming system;
determine and/or identify the arrangement (e.g., relative arrangement) of contact regions associated with a gesture performed by a user interacting with the intelligent multi-player electronic gaming system;
map one or more contact regions (e.g., associated with a gesture performed by a user interacting with the intelligent multi-player electronic gaming system) to one or more digits (e.g., fingers, thumbs, etc.) of the user's hand(s);
map an identified gesture (e.g., performed by a user interacting with the intelligent multi-player electronic gaming system) to one or more function(s) (such as, for example, a specific user input instruction that is to be received and processed by the gaming controller);
create an association between an identified gesture (e.g., performed by a user interacting with the intelligent multi-player electronic gaming system) and the user (e.g., origination entity) who performed that gesture;
create an association between an identified function (e.g., which has been mapped to a gesture performed by a user interacting with the intelligent multi-player electronic gaming system) and the user (e.g., origination entity) who performed the gesture relating to the identified function;
cause one or more function(s) to be initiated on behalf of a given user at the gaming system, for example, in response to an input gesture performed by the user;
cause one or more function(s) to be initiated on behalf of a given user at the gaming system, for example, in response to an input gesture performed by the user;
provide a specific set of input instructions (e.g., which have been identified as originating from a specific user at the gaming system) to the gaming controller 412 in response to an input gesture performed by the user;
identify continuous contacts/touches;
detect contacts, touches and/or near touches and provide identification and tracking of detected contacts, touches and/or near touches;
etc.

According to various embodiments, one method of utilizing the intelligent multi-player electronic gaming system may comprise: 1) initiating in the master gaming table controller the wager-based game for at least a first active player; 2) receiving in the master gaming table controller information from the object detection system indicating a first physical object is located in a first video display area associated with the first active player where the first physical object includes a transparent portion that allows information generated in the first video display area to be viewed through the transparent portion; 3) determining in the master gaming controller one of a position, a shape, an orientation or combinations thereof of the transparent portion in the first video display area, 4) determining in the master gaming table controller one of a position, a shape, an orientation or combinations thereof of a first video display window in the first video display area to allow information generated in the first video display window to be viewable through the transparent portion of the first physical object; 5) controlling in the master gaming controller a display of first video images in the first video display window where the first video images may include information associated with the first active player; 6) controlling in the master gaming controller a display of second video images of including information related to the play the wager-based game in the first video display area; and 7) determining in the master gaming controller the results of the wager-based game for the first active player.

In particular embodiments, the first physical object may be moved during game play, such as during a single wager-based game or from a first position/orientation in a first play of the wager-based game to a second position/orientation in a second play of the wager-based game. The position/orientation of the first physical object may be altered by a game player or a game operator, such as a dealer. Thus, the method may also comprise during the play of the wager-based game, determining in the master gaming controller one of a second position and a second orientation of the transparent portion in the first video display area and determining in the master gaming table controller one of a second position and a second orientation of the first video display window in the first video display area to allow information generated in the first video display window to be viewable through the transparent portion of the first physical object.

In particular embodiments, the second video images may include one or more game objects. The one or more game objects may also be displayed in the first video window and may include but are not limited to a chip, a marker, a die, a playing card or a marked tile. In general, the game objects may comprise any game piece associated with the play of wager-based table game. The game pieces may appear to be 3-D dimensional in the rendered video images.

When placed on the first surface, a footprint of the first physical object on the first surface may be one of a rectangular shaped or a circular shaped. In general, the foot print of the first physical object may be any shape. The foot print of the first physical object may be determined using the object detection system.

The method may further comprise determining in the master table gaming controller an identity of the first active player and displaying in the first video display window player tracking information associated with the first active player. The identity of the first active player may be determined using information obtained from the first physical object. In particular embodiments, the information obtained from the first physical object may be marked or written on the first physical object and read using a suitable detection device or the information may be stored in a memory on first physical object, such as with an RFID tag and read using a suitable reading device.

In another example embodiment, the method may further comprise, 1) determining in the master table gaming controller the information displayed in the first video display window includes critical game information, 2) storing to a power-hit tolerant non-volatile memory the critical game information, the position, the shape, the orientation or the combinations thereof of the first video display window and information regarding one or more physical objects, such as but not limited to there locations and orientation on the first surface, 3) receiving in the master table gaming controller a request to display the critical game information previously displayed in the first video display window; 4) retrieving from the power-hit tolerant non-volatile memory the critical game information and the position, the shape, the orientation or the combinations thereof of the first video display window; 5) controlling in the master table gaming controller the display of the critical game information in the first video display window using the position, the shape, the orientation or the combinations thereof retrieved from the power-hit tolerant non-volatile memory and 6) providing information regarding the one or more physical objects, such that there placement and location on the first surface may be recreated when the one or more physical objects are available.

In yet other embodiments, the method may comprise 1) providing the first physical object wherein the first physical object includes a first display; 2) selecting in the master gaming controller information to display to the first active player, 3) generating in the master gaming controller video images including the information selected for the first active player in the first video display window; 4) sending from the master gaming controller to the first physical object the information selected for first active player to allow the information selected for the first active player to be displayed at the same time on the first display and the first video display window. The information selected for the first active player may be an award, promotional credits or an offer.

According to different embodiments, at least a portion of the various gaming table devices, components and/or systems illustrated in the example of FIG. 7A may be configured or designed to include at least some functionality similar to the various gaming table devices, components and/or systems illustrated and/or described in one or more of the following references:

U.S. Provisional Patent Application Ser. No. 60/986,507, (Attorney Docket No. IGT1P430CP/P-1256CPROV), by Burrill et al., entitled “AUTOMATED TECHNIQUES FOR TABLE GAME STATE TRACKING,” filed on Nov. 8, 2007, previously incorporated herein by reference in its entirety for all purposes;

U.S. patent application Ser. No. 11/938,179, (Attorney Docket No. IGT1P459/P-1288), by Wells et al., entitled “TRANSPARENT CARD DISPLAY,” filed on Nov. 9, 2007, previously incorporated herein by reference in its entirety for all purposes;

U.S. patent application Ser. No. 11/825,481 (Attorney Docket No. IGT1P090X1/P-795CIP1), by Mattice, et al., entitled “GESTURE CONTROLLED CASINO GAMING SYSTEM”, previously incorporated herein by reference in its entirety for all purposes; and

U.S. patent application Ser. No. 11/363,750 (U.S. Publication No. 20070201863), by Wilson, et al., entitled “COMPACT INTERACTIVE TABLETOP WITH PROJECTION-VISION”, herein incorporated by reference in its entirety for all purposes.

As mentioned previously, at least some embodiments of a multi-touch, multi-player interactive display system may be operatively coupled to one or more cameras and/or other types of sensor devices described herein for use in identifying a particular user who is responsible for performing one or more of the touches, contacts and/or gestures detected at or near the multi-touch, multi-player interactive display surface. For example, in one such embodiment, the multi-touch, multi-player interactive display system may be implemented as a FTIR-based multi-person, multi-touch display system which has been modified to include computer vision hand tracking functionality via the use of one or more visible spectrum cameras mounted over the multi-touch, multi-person display surface. An example of such a system is described in the article entitled, “Enhancing Multi-user Interaction with Multi-touch Tabletop Displays Using Hand Tracking,” by Dohse et al, Proceedings of the First International Conference on Advances in Computer-Human Interaction, published 2008 by IEEE Computer Society, Washington, D.C., Pages 297-302, the entirety of which is incorporated herein by reference for all purposes.

FIG. 7B illustrates an example embodiment of a projection-based intelligent multi-player electronic gaming system 730 which has been configured or designed to include computer vision hand tracking functionality. In one embodiment, gaming system may include a multi-touch, multi-player interactive display surface implemented using FTIR-based multi-person, multi-touch display system which has been modified to include computer vision hand tracking functionality via the use of one or more visible spectrum cameras (e.g., 704, 706) mounted over the multi-touch, multi-person display surface 720.

In the example embodiment illustrated in FIG. 7B, at least one projection device 711 may be positioned under or below the display surface at 720 and utilized to project (e.g., from below) content onto the display surface (e.g., via use of one or more mirrors) to thereby create a rear-projection tabletop display. Touch points or contact regions (e.g., cause by users contacting or near contacting the top side of the display surface 720) may be tracked via use of an infrared camera 705.

Using one or more of the overhead cameras 704 (and optionally camera 706), users' hands on or over the display surface may be tracked using computer hand vision tracking techniques (which, for example, may be implemented using skin color segmentation techniques, RGB filtering techniques, etc.). Data from the overhead camera(s) may be used to determine the different users' hand coordinates while gestures are being performed by the users on or over the display surface. By synchronizing and/or correlating the users' hand coordinate data with the corresponding contact region data (e.g., captured by infrared camera 705) appropriate contact region-origination entity (e.g., touch-ownership) associations may be determined and assigned.

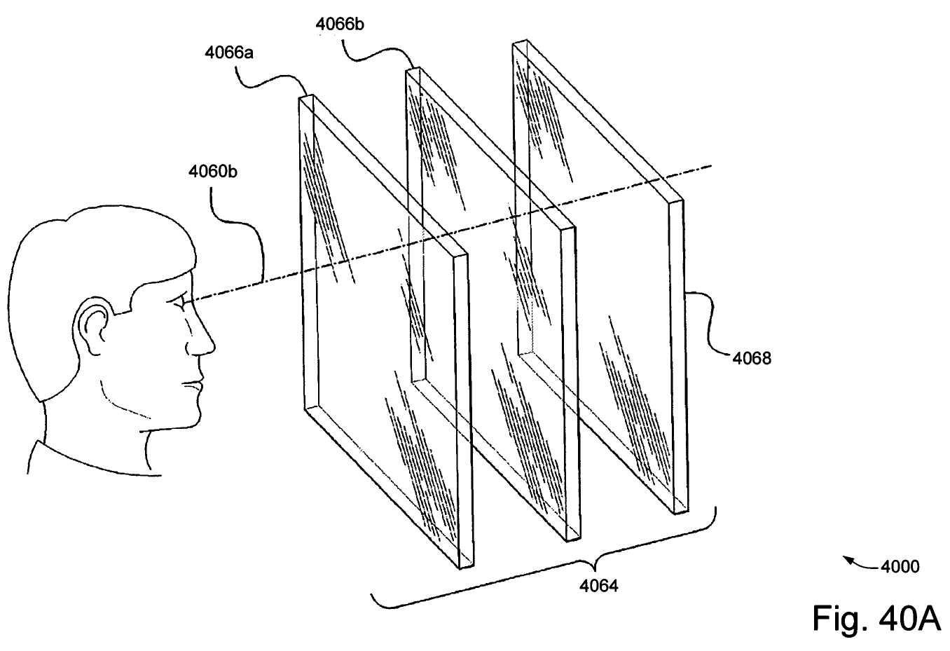

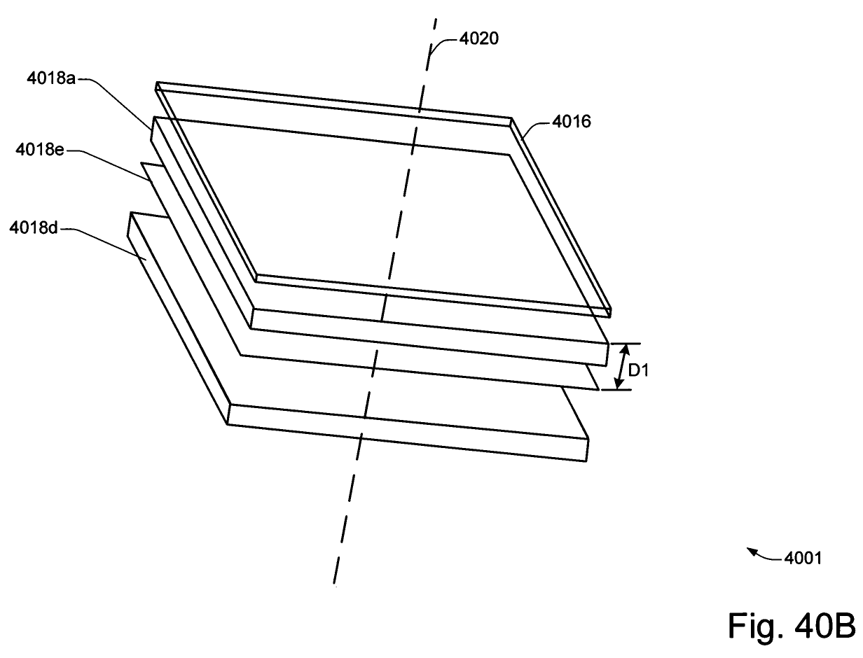

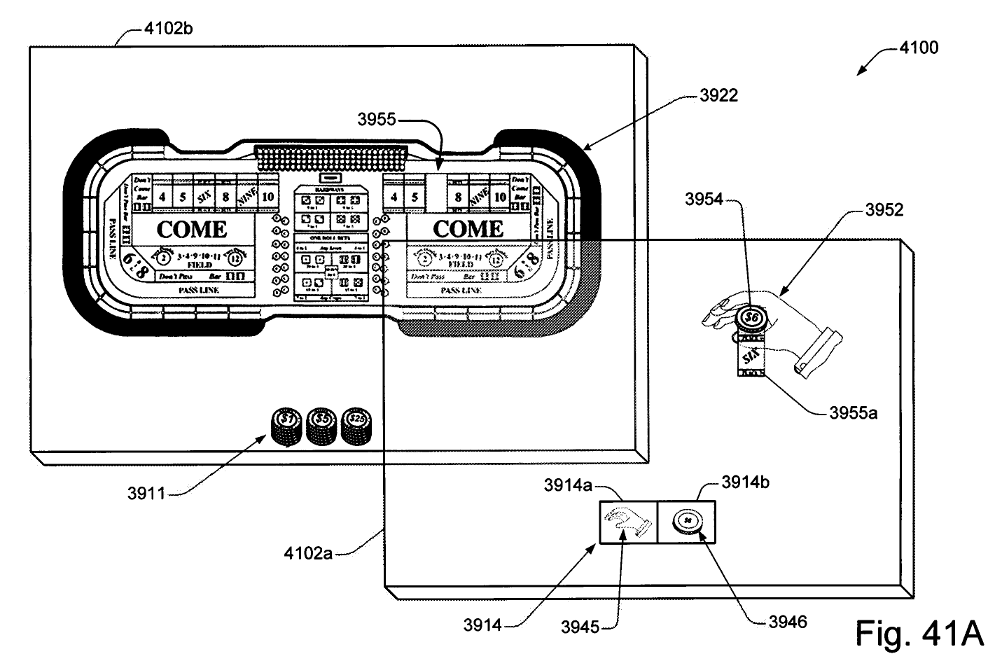

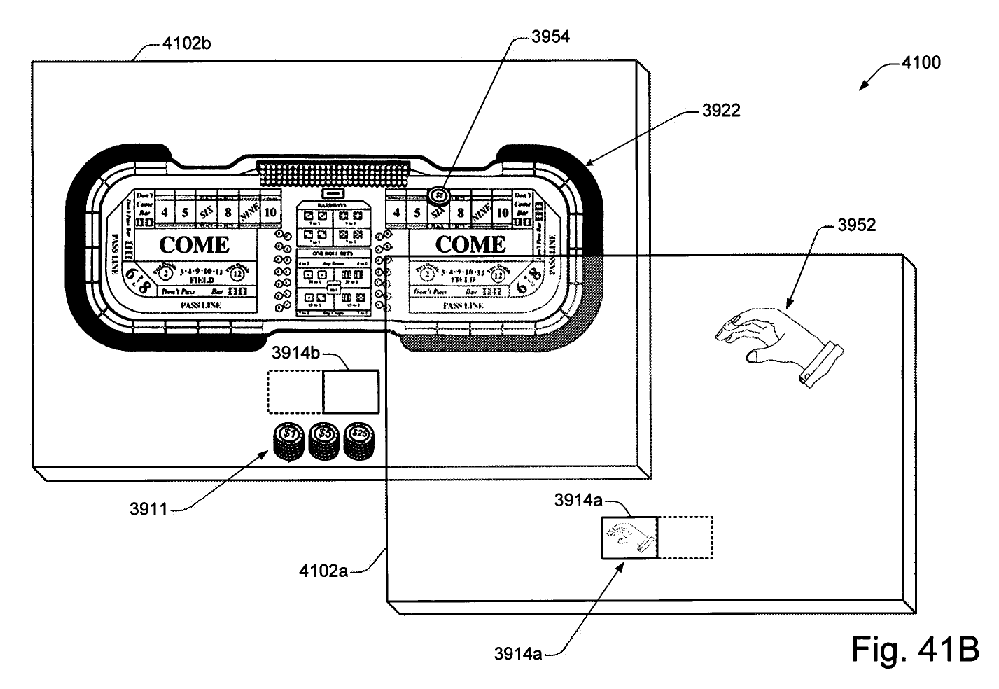

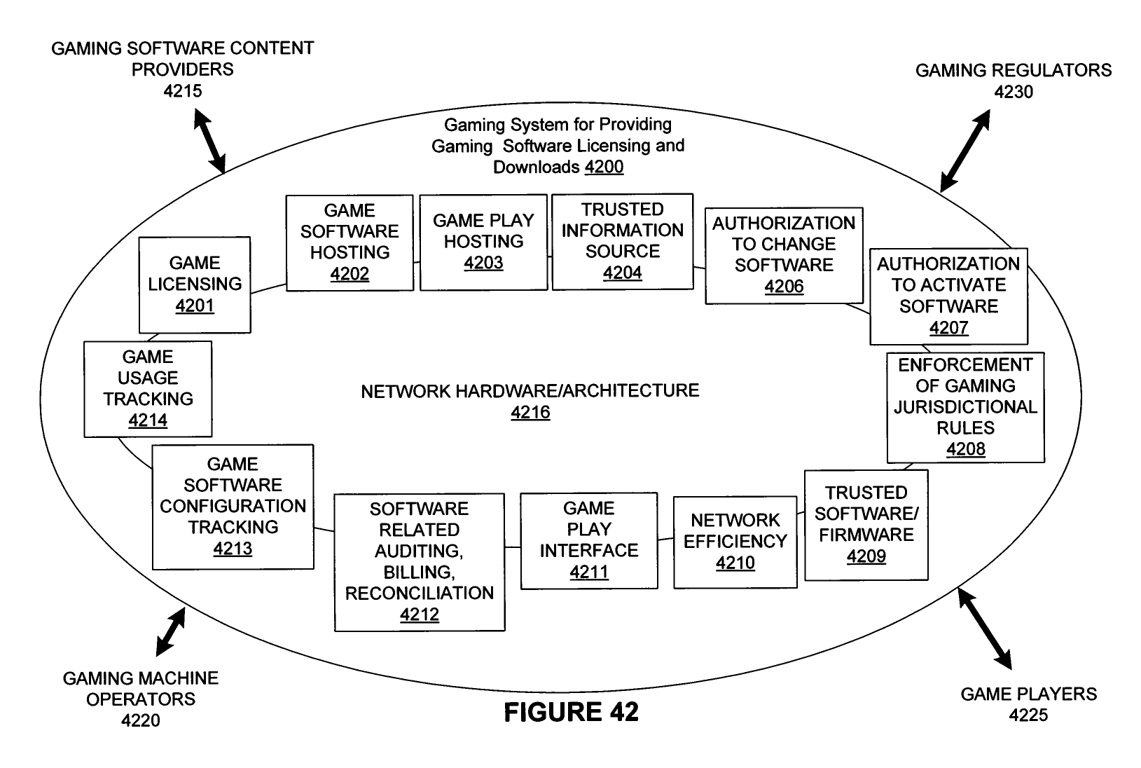

Similar techniques may also be two other types of intelligent multi-player electronic gaming systems utilizing other types of multi-touch, multi-player interactive display technologies. For example, as illustrated in the example embodiment of FIG. 7C, for example, a video display-based intelligent multi-player electronic gaming system 790 is illustrated which includes a multi-touch, multi-player interactive display surface 792. In one embodiment, display surface 792 may be implemented using a single, continuous video display screen (e.g., LCD display screen, OLED display screen, etc.), over which one or more multipoint or multi-touch input interfaces may be provided. In other embodiments, display surface 792 may be implemented using a multi-layered display system (e.g., which includes 2 or more display screens) having at least one multipoint or multi-touch input interface. Various examples of multi-layered display device arrangements are illustrated and described, for example, with respect to FIGS. 40A-41B.

As illustrated in the example embodiment of FIG. 7C, intelligent multi-player electronic gaming systems 790 is operatively coupled to one or more cameras (e.g., 794 and/or 796) for use in identifying a particular user who is responsible for performing one or more of the touches, contacts and/or gestures detected at or near the multi-touch, multi-player interactive display surface. In at least one embodiment, gaming system 790 may be configured or designed to include computer vision hand tracking functionality via the use of one or more visible spectrum cameras (e.g., 796, 794) mounted over the multi-touch, multi-person display surface 792.

Using one or more of the overhead cameras (e.g., 796, 794), users' hands on or over the display surface may be tracked using computer hand vision tracking techniques. Data captured from the overhead camera(s) may be used to determine the different users' hand coordinates while gestures are being performed by the users on or over the display surface. By synchronizing and/or correlating the users' hand coordinate data with the corresponding contact region data (e.g., captured by infrared camera 705) appropriate contact region-origination entity (e.g., touch-ownership) associations may be determined and assigned.

FIG. 7D illustrates a simplified block diagram of an example embodiment of a computer vision hand tracking technique which may be used for enhancing or improving various aspects of relating to multi-touch, multi-player gesture recognition at one or more intelligent multi-player electronic gaming systems.

In the example embodiment of FIG. 7D, it is assumed that an intelligent multi-player electronic gaming system comprises a multi-touch, multi-player interactive display system (753) which includes one or more multipoint or multi-touch sensing device(s) 760. Additionally, it is assumed that the intelligent multi-player electronic gaming system includes a computer vision hand tracking system 755 to one or more cameras 770 (e.g., visible spectrum camera) mounted over the multi-touch, multi-person display surface, as illustrated, for example, in FIG. 7C.

Touch/Gesture event(s) occurring (752) at, over, or near the display surface may be simultaneously captured by both multi-touch sensing device 760 and hand tracking camera 770. In at least one embodiment, the data captured by each of the devices may be separately and concurrently processed (e.g., in parallel). For example, as illustrated in the example embodiment of FIG. 7D, the touch/gesture event data 762 captured by multi-touch sensing device 760 may be processed at touch detection processing component(s) 764 while, concurrently, the touch/gesture event data 772 captured by hand tracking camera 770 may be processed at computer vision hand tracking component(s) 774.

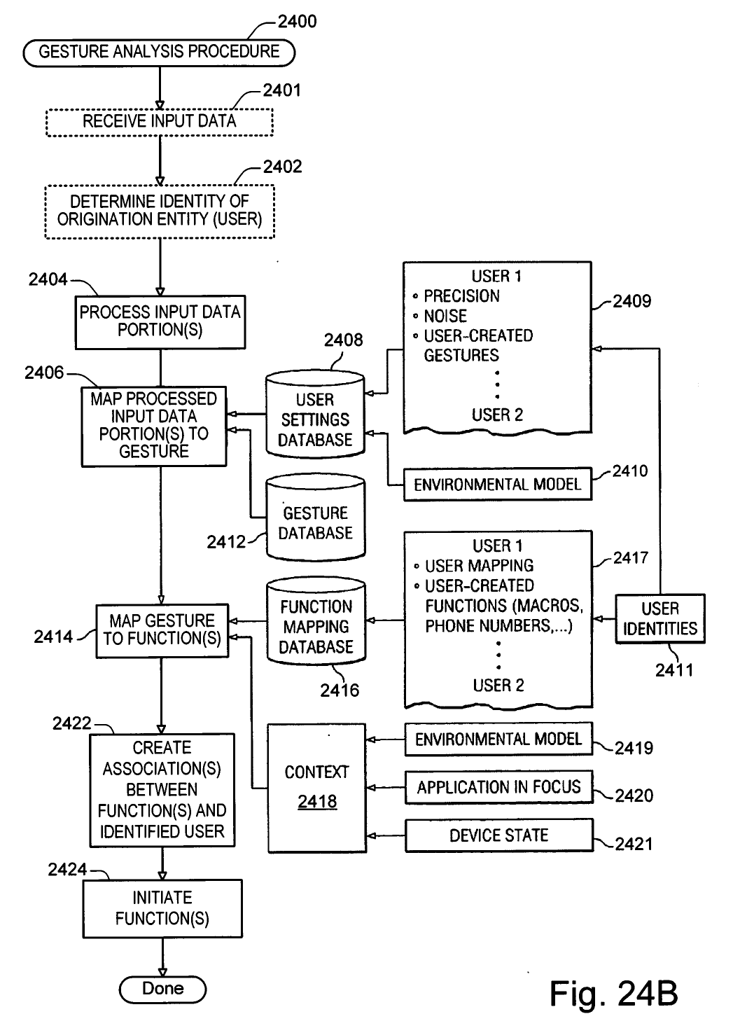

Output from each of the different processing systems may then be merged, synchronized, and/or correlated 780. For example, as illustrated in the example embodiment of FIG. 7D, the process touch data 766 and the processed hand coordinate data 782 may be merged, synchronized, and/or correlated, for example, in order to determine, assign and/or generate appropriate contact region-origination entity (e.g., touch-ownership) associations. In at least one embodiment, the output touch/contact region origination information 782 may be passed to a gesture analysis processing component (such as that illustrated in described, for example, with respect to FIG. 24B) for gesture recognition, interpretation and/or gesture-function mapping.

According to various embodiments, the use of computer vision hand tracking techniques described and/or referenced herein may provide additional benefits, features and/or advantages to one or more intelligent multi-player electronic gaming system embodiments. For example, use of computer vision hand tracking techniques at an intelligent multi-player electronic gaming system may provide one or more of the following benefits, advantages, and/or features (or combinations thereof): facilitating improved collaboration among players, enabling expansion of possible types of multi-user interactions, improving touch tracking robustness, enabling increased touch sensitivity, providing improved non-contact gesture interpretation, etc. Additionally, use of the computer vision hand tracking system provides the ability for the gaming table system to track multiple users by establishing identities for each user when they make their initial actions with the display surface, and provides the ability to continuously track each of the users while that user remains present at the gaming system. Additionally, in at least one embodiment, the gesture/touch-hand associations provided by the computer vision hand tracking system may be used to provide additional activity-specific and/or user-specific functions. Further, in some embodiments, via use of computer vision hand tracking techniques, one or more embodiments of intelligent multi-player electronic gaming systems described herein may be operable to recognize multiple touches created by the same hand, and, when appropriate to interpret multiple touches created by the same hand being associated with same gesture event. In this way, one or more touches and/or gestures detected at or near the multi-touch, multi-player interactive display surface may be assigned a respective history and/or may be associated with one or more previously detected touches/gestures.

Other types of features which may be provided at one or more intelligent multi-player electronic gaming systems which include computer vision hand tracking functionality may include one or more of the following (or combinations thereof):

In at least one embodiment, players could be directed to wear and identification article such as, for example, a ring, wristband, or other type of article on their hands (and/or wrist, finger(s), etc.) to facilitate automated hand recognition and/or automated hand tracking operations performed by the computer vision hand tracking component(s). In one embodiment, the article(s) worn on each player's hands may include one or more patterns and/or colors unique to that particular player. In one embodiment, the article(s) worn on each player's hands may be a specific pre-designated color (such as, for example, a pure color) which is different from the colors of the articles worn by the other players. The computer vision hand tracking system may be specifically configured or designed to scan and recognize the various pre-designated colors assigned to each player or user at the gaming system. In one embodiment, if the computer visually recognizes the presence of a pre-designated color or pattern near a touch, it may determine that the touch was performed by the player associated with that specific color. Locating the color within the shadow or outline of a hand or arm can further establish that the touch is valid. In at least one embodiment, a barcode or other recognizable image, in a predetermined optic frequency may also be used, rather than a visually different color. According to different embodiments, the colors, barcodes, and/or patterns may be visible and/or non-visible to a human observer. Further, in at least one embodiment, when the hand, body part, and/or identification article is detected with no recognizable colors and/or marks (e.g., patterns, barcodes, etc.), the system may automatically respond, for example, by performing one or more actions such as, for example: triggering a security event, issuing a warning, disabling touches, etc. Similarly, when the presence of a hand, body part, and/or identification article is detected with multiple colors and/or marks the system may also automatically respond by performing one or more actions such as, for example: triggering a security event, issuing a warning, disabling touches, etc.

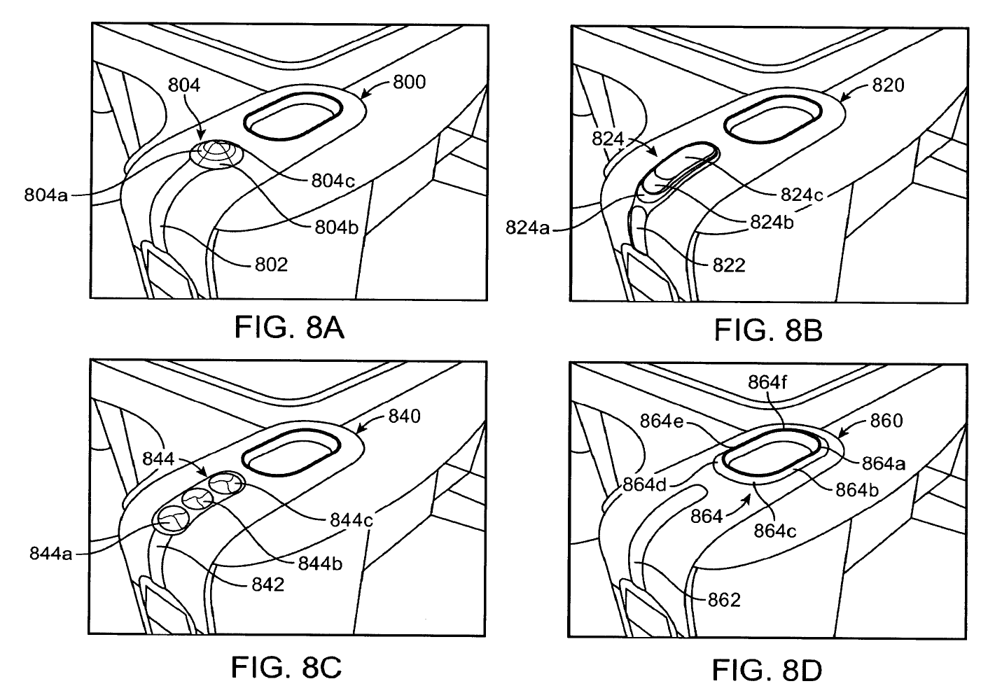

FIGS. 8A-D illustrate various example embodiments of alternative candle/illumination components which, for example, may provide various features, benefits and/or advantages such as, for example, one or more of the following (or combinations thereof):

FIG. 8A—Organic Sprout 804 with multiple different levels of color/illumination 804a, 804b, 804c

FIG. 8B—Flowing Obrounds 824 with multiple different layers of color/illumination 824a, 824b, 824c

FIG. 8C—Dedicated Stages 844 with multiple different zones of color/illumination 844a, 844b, 844c

FIG. 8D—Cup Holder Surround 864 with multiple different regions of color/illumination 864a-f

It will be appreciated that the various embodiments of the candle/illumination components described herein provide improved techniques for achieving improved 360 degree visibility, while also maintaining an eco-techno aesthetic of the intelligent multi-player electronic gaming system.

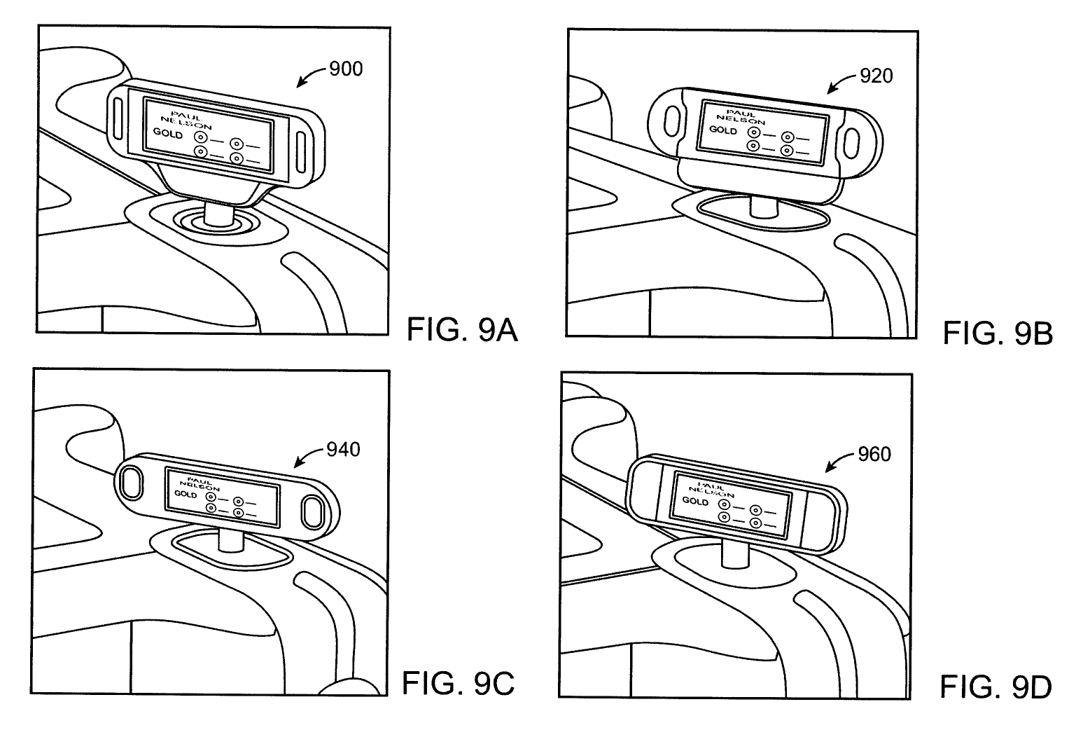

FIGS. 9A-D illustrate various example embodiments of different player station player tracking and/or audio/visual components. As illustrated in the example embodiments of FIGS. 9A-D, one or more of the following features/advantages/benefits may be provided:
Viewing angle range (e.g., 0-15 deg) for privacy concerns
Speaker locations—below vs side. Impacts height or length.
Speaker emphasis—visual surface area & detailing.
Front lens cover over existing LCD bezel assy. More integrated to unit.
Cup holder cover.
Vendor logo placement.
Card Reader integration to “funds center” on leg.

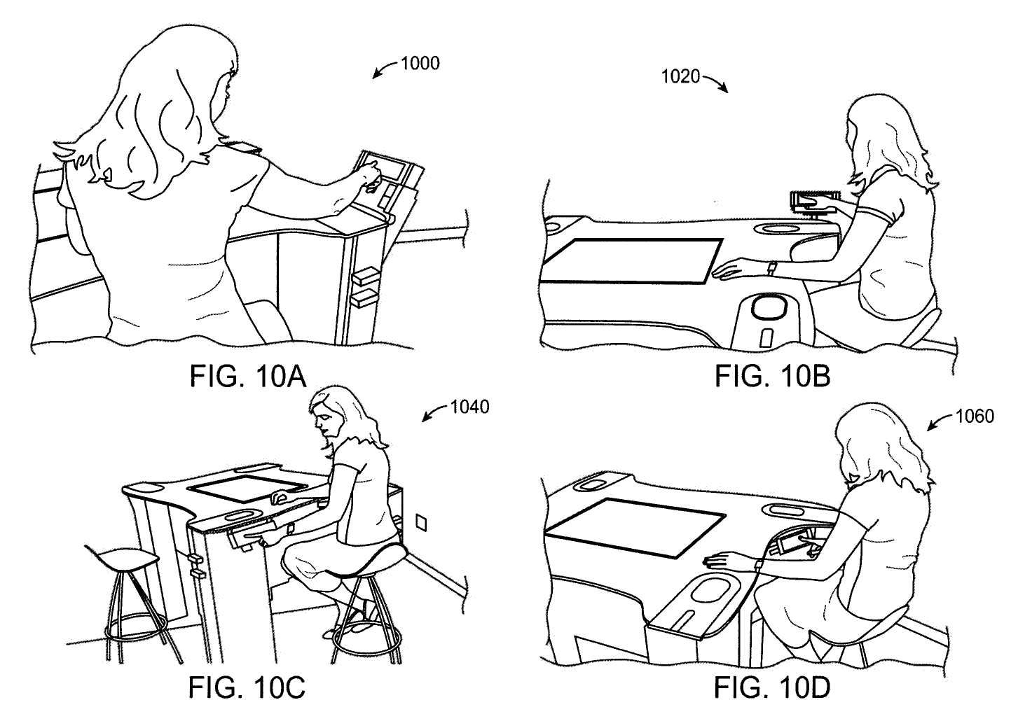

FIGS. 10A-D illustrate example embodiments relating to integrated Player Tracking and/or individual player station audio/visual components. For example, FIG. 10A shows a first example embodiment illustrating a secondary player station display via support arm/angle. FIG. 10B shows another example embodiment illustrating a secondary player station display via support arm/“T.” FIG. 10C shows a first example embodiment illustrating a secondary player station display via integrated/left. FIG. 10D shows another example embodiment illustrating a secondary player station display via integrated/right.

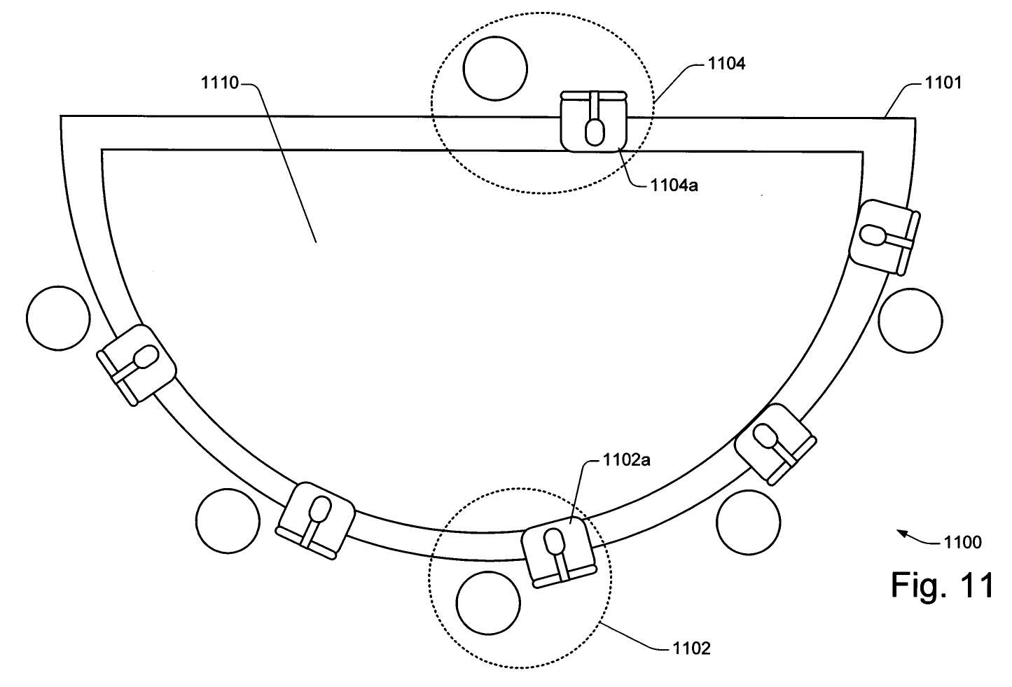

FIG. 11 illustrates an example of a gaming table system 1100 which includes a D-shaped intelligent multi-player electronic gaming system 1101 in accordance with a specific embodiment. As illustrated in the example of FIG. 11, the intelligent multi-player electronic gaming system may include a plurality of individual player stations (e.g., 1102), with each player station including its own respective funds center system (e.g., 1102a). In the example of FIG. 11, the intelligent multi-player electronic gaming system also includes a dealer station 1104 and associated funds center 1104a. In at least one embodiment, gaming table system 1100 includes a main table display system 1110 which includes features and/or functionality similar to that of main table display 102 of FIG. 1. In the example of FIG. 11, main table display 1110 has a shape (e.g., D-shape) which is similar to the shape of the intelligent multi-player electronic gaming system body.

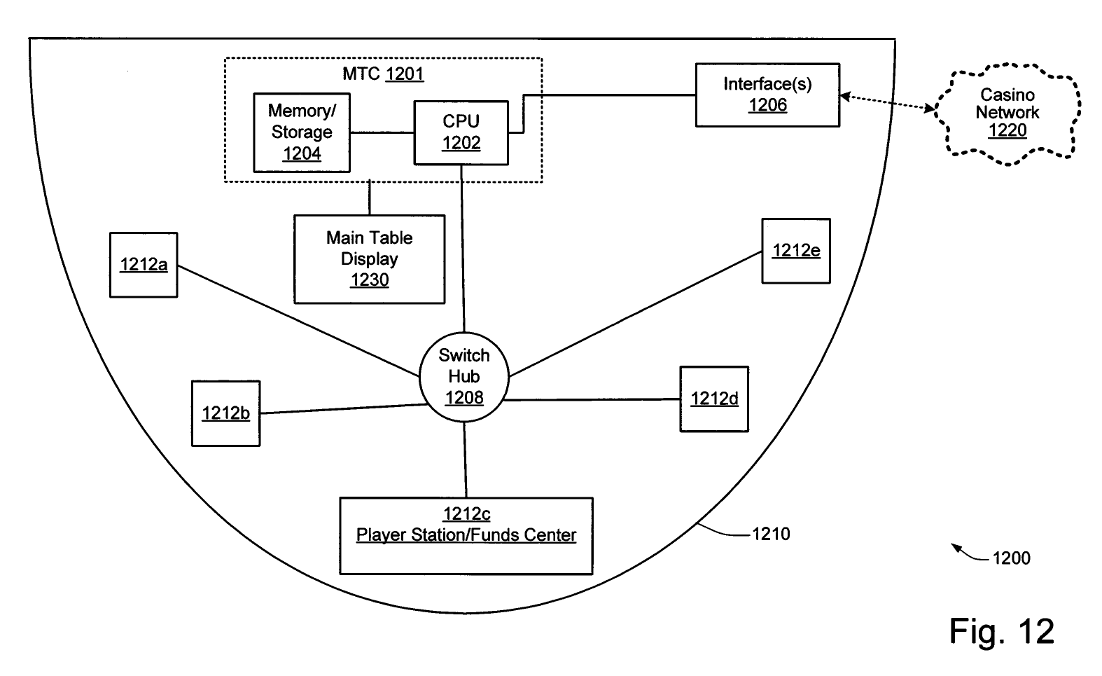

FIG. 12 is a simplified block diagram of an intelligent multi-player electronic gaming system 1200 in accordance with a specific embodiment. As illustrated in the embodiment of FIG. 12, intelligent multi-player electronic gaming system 1200 includes (e.g., within gaming table housing 1210) a master table controller (MTC) 1201, a main multi-player, multi-touch table display system 1230 and a plurality of player station systems/fund centers (e.g., 1212a-e) which, for example, may be connected to the MTC 1201 via at least one switch or hub 1208. In at least one embodiment, master table controller 1201 may include at least one processor or CPU 1202, and memory 1204. Additionally, as illustrated in the example of FIG. 12, intelligent multi-player electronic gaming system 1200 may also include one or more interfaces 1206 for communicating with other devices and/or systems in the casino network 1220.

In at least one embodiment, a separate player station system may be provided at each player station at the gaming table. According to specific embodiments, each player station system may include a variety of different electronic components, devices, and/or systems for providing various types of functionality. For example, as shown in the embodiment of FIG. 12, player station system 1212c may comprise a variety of different electronic components, devices, and/or systems such as, for example, one or more of the various components, devices, and/or systems illustrated and/or described with respect to FIG. 7A.

Although not specifically illustrated in FIG. 12, each of the different player station systems 1212a-e may include components, devices and/or systems similar to that of player station system 1212c.

According to one embodiment, gaming table system 1200 may be operable to read, receive signals, and/or obtain information from various types of media (e.g., player tracking cards) and/or other devices such as those issued by the casino. For example, media detector/reader may be operable to automatically detect wireless signals (e.g., 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.) from one or more wireless devices (such as, for example, an RFID-enabled player tracking card) which, for example, are in the possession of players at the gaming table. The media detector/reader may also be operable to utilize the detected wireless signals to determine the identity of individual players associated with each of the different player tracking cards. The media detector/reader may also be operable to utilize the detected wireless signals to access additional information (e.g., player tracking information) from remote servers (e.g., player tracking server).

In at least one embodiment, each player station may include a respective media detector/reader.

In at least one embodiment, gaming table system 1200 may be operable to detect and identify objects (e.g., electronic objects and/or non-electronic objects) which are placed on the main table display 1230. For example, in at least one embodiment, one or more cameras of the gaming table system may be used to monitor and/or capture images of objects which are placed on the surface of the main table display 1230, and the image data may be used to identify and/or recognize various objects detected on or near the surface of the main table display. Additional details regarding gaming table object recognition techniques are described, for example, in U.S. patent application Ser. No. 11/938,179, (Attorney Docket No. IGT1P459/P-1288), by Wells et al., entitled “TRANSPARENT CARD DISPLAY,” filed on Nov. 9, 2007, previously incorporated herein by reference in its entirety.

In at least one embodiment, Gaming table system 1200 may also be operable to determine and create ownership or possessor associations between various objects detected at the gaming table and the various players (and/or casino employees) at the gaming table. For example, in one embodiment, when a player at gaming table system 1200 places an object (e.g., gaming chip, money, token, card, non-electronic object, etc.) on the main table display, the gaming table system may be operable to: (1) identify and recognize the object; (2) identify the player at the gaming table system who placed the object on the main table display; and (3) create an “ownership” association between the detected object and the identified player (which may be subsequently stored and used for various tracking and/or auditing purposes).

According to a specific embodiment, the media detector/reader may also be operable to determine the position or location of one or more players at the gaming table, and/or able to identify a specific player station which is occupied by a particular player at the gaming table.

As used herein, the terms “gaming chip” and “wagering token” may be used interchangeably, and, in at least one embodiment, may refer to a chip, coin, and/or other type of token which may be used for various types of casino wagering activities, such as, for example, gaming table wagering.

In at least one embodiment, intelligent multi-player electronic gaming system 1200 may also include components and/or devices for implementing at least a portion of gaming table functionality described in one or more of the following patents, each of which is incorporated herein by reference in its entirety for all purposes: U.S. Pat. No. 5,735,742, entitled “GAMING TABLE TRACKING SYSTEM AND METHOD”; and U.S. Pat. No. 5,651,548, entitled “GAMING CHIPS WITH ELECTRONIC CIRCUITS SCANNED BY ANTENNAS IN GAMING CHIP PLACEMENT AREAS FOR TRACKING THE MOVEMENT OF GAMING CHIPS WITHIN A CASINO APPARATUS AND METHOD.”

For example, in one embodiment, intelligent multi-player electronic gaming system 1200 may include a system for tracking movement of gaming chips and/or for performing other valuable functions. The system may be fully automated and operable to automatically monitor and record selected gaming chip transactions at the gaming table. In one embodiment, the system may employ use of gaming chips having transponders embedded therein. Such gaming chips may be electronically identifiable and/or carry electronically ascertainable information about the gaming chip. The system may further have ongoing and/or “on-command” capabilities to provide an instantaneous or real-time inventory of all (or selected) gaming chips at the gaming table such as, for example, gaming chips in the possession of a particular player, gaming chips in the possession of the dealer, gaming chips located within a specified region (or regions) of the gaming table, etc. The system may also be capable of reporting the total value of an identified selection of gaming chips.

In at least one embodiment, information tracked by the gaming table system may then reported or communicated to various remote servers and/or systems, such as, for example, a player tracking system. According to a specific embodiment, a player tracking system may be used to store various information relating to casino patrons or players. Such information (herein referred to as player tracking information) may include player rating information, which, for example, generally refers to information used by a casino to rate a given player according to various criteria such as, for example, criteria which may be used to determine a player's theoretical or comp value to a casino.

Additionally, in at least one embodiment, a player tracking session may be used to collect various types of information relating to a player's preferences, activities, game play, location, etc. Such information may also include player rating information generated during one or more player rating sessions. Thus, in at least one embodiment, a player tracking session may include the generation and/or tracking of player rating information for a given player.

Automated Table Game State Tracking

According to specific embodiments, a variety of different game states may be used to characterize the state of current and/or past events which are occurring (or have occurred) at a selected gaming table. For example, in one embodiment, at any given time in a game, a valid current game state may be used to characterize the state of game play (and/or other related events, such as, for example, mode of operation of the gaming table, etc.) at that particular time. In at least one embodiment, multiple different states may be used to characterize different states or events which occur at the gaming table at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the gaming table may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming table. Examples of such entities may include, but are not limited to, one or more of the following (or combination thereof): master table controller system, table display system, player station system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the gaming table may be operable to automatically monitor game play activities at the gaming table, and/or to automatically identify key events which may trigger a transition of game state from one state to another as a game progresses. For example, in the case of Blackjack, a key event may include one or more events which indicate a change in the state of a game such as, for example: a new card being added to a card hand, the split of a card hand, a card hand being moved, a new card provided from a shoe, removal or disappearance of a card by occlusion, etc.

Depending upon the type of game being played at the gaming table, examples of other possible key events may include, but are not limited to, one or more of the following (or combination thereof):
start of a new hand/round;
end of a current hand/round;
start of a roulette wheel spin;
game start event;
game end event;
initial wager period start;
initial wager period end;
initial deal period start;
initial deal period end;
player card draw/decision period start;
player card draw/decision period end;
subsequent wager period start;
subsequent wager period end;
rake period start;
rake period end;
payout period start;
payout period end;
start of card burning period;
end of card burning period;
etc.

Another inventive feature described herein relates to automated techniques for facilitating table game state tracking.

Conventional techniques for tracking table game play states are typically implemented using manual (e.g., human implemented) mechanisms. For example, in many cases, game states are part of the processes observed by a floor supervisor and manually tracked. Accordingly, one aspect is directed to various techniques for implementing and/or facilitating automated table game state tracking at live casino table games.

It will be appreciated that there are a number of differences between game play at electronic gaming machines and game play at live table games. Once such difference relates to the fact that, typically, only one player at a time can engage in game play conducted at an electronic gaming machine, whereas multiple players may engage in simultaneous game play at a live table game.

In at least one embodiment, a live table game may be characterized as a wager-based game which is conducted at a physical gaming table (e.g., typically located on the casino floor). In at least one embodiment, a live table game may be further characterized in that multiple different players may be concurrent active participants of the table game at any given time. In at least one embodiment, a live table game may be further characterized in that the game outcome for any given active player of the table game may be affected by the game play decisions/actions of the other active players of the table game. In various embodiments of live card-based table games, the table game may be further characterized in that the hand/cards dealt to any given active player of the table game may be affected by the game play decisions/actions of the other active players of the table game.

According to specific embodiments, a variety of different game states may be used to characterize the state of current and/or past events which are occurring (or have occurred) at a selected gaming table. For example, in one embodiment, at any given time in a game, at least one valid current game state may be used to characterize the state of game play (and/or other related events/conditions, such as, for example, mode of operation of the gaming table, and/or other events disclosed herein) at particular instance in time at a given gaming table.

In at least one embodiment, multiple different states may be used to characterize different states or events which occur at the gaming table at any given time. In one embodiment, when faced with ambiguity of game state, a single state embodiment may be used to force a decision such that one valid current game state may be selected or preferred. In a multiple state embodiments, multiple possible game states may exist concurrently or simultaneously at any given time in a table game, and at the end of the game (and/or at any point in the middle of the game), the gaming table may be operable to automatically analyze the different game states and select one of them, based on specific criteria, to represent the current or dominant game state at that time. Thus, for example, when faced with ambiguity of game state, the multiple state embodiment(s) may allow all potential game states to exist and move forward, thus deferring the decision of choosing one game state to a later point in the game. The multiple game state embodiment(s) may also be more effective in handling ambiguous data and/or ambiguous game state scenarios.

According to specific embodiments, a variety of different components, systems, and/or other electronic entities may be used (e.g., either singly or in combination) to track the progress of game states may which occur at a given gaming table. Examples of such entities may include, but are not limited to, one or more of the following (or combination thereof): master table controller, local game tracking component(s) (e.g., residing locally at the gaming table), remote game tracking component(s), etc. According to a specific embodiment, local game tracking components at the gaming table may be operable to automatically monitor game play, wagering, and/or other activities at the gaming table, and/or may be operable to automatically identify key conditions and/or events which may trigger a transition of game state at the gaming table from one state to another as a game progresses. Depending upon the type of game being played at the gaming table, examples of possible key events/conditions may include, but are not limited to, one or more of the following (or combinations thereof):
start of a new hand/round;
end of a current hand/round;
start of a roulette wheel spin;
game start event;
game end event;
initial wager period start;
initial wager period end;
initial deal period start;
initial deal period end;
player card draw/decision period start;
player card draw/decision period end;
subsequent wager period start;
subsequent wager period end;
rake period start;
rake period end;
payout period start;
payout period end;
buy-in event;
win event (e.g., game win, bonus win, side wager win, etc.);
push event;
new hand start event;
hand end event;
new round start event;
round end event;
etc.

According to different embodiments, the various automated table game state tracking techniques described herein may be utilized to automatically detect and/or track game states (and/or other associated states of operation) at a variety of different types of “live” casino table games.

Various examples of live table games may include, but are not limited to, one or more of the following (or combinations thereof): blackjack, craps, poker (including different variations of poker), baccarat, roulette, pai gow, sic bo, fantan, and/or other types of wager-based table games conducted at gaming establishments (e.g., casinos).

It will be appreciated that there are numerous distinctions between a live table game which is played using an electronic display, and a video-based game played on an electronic gaming machine.

In at least one embodiment, a live table game may be characterized as a wager-based game which is conducted at a physical gaming table (e.g., typically located on the casino floor). In at least one embodiment, a live table game may be further characterized in that multiple different players may be concurrent active participants of the table game at any given time. In at least one embodiment, a live table game may be further characterized in that the game outcome for any given active player of the table game may be affected by the game play decisions/actions of the other active players of the table game. In various embodiments of live card-based table games, the table game may be further characterized in that the hand/cards dealt to any given active player of the table game may be affected by the game play decisions/actions of the other active players of the table game.

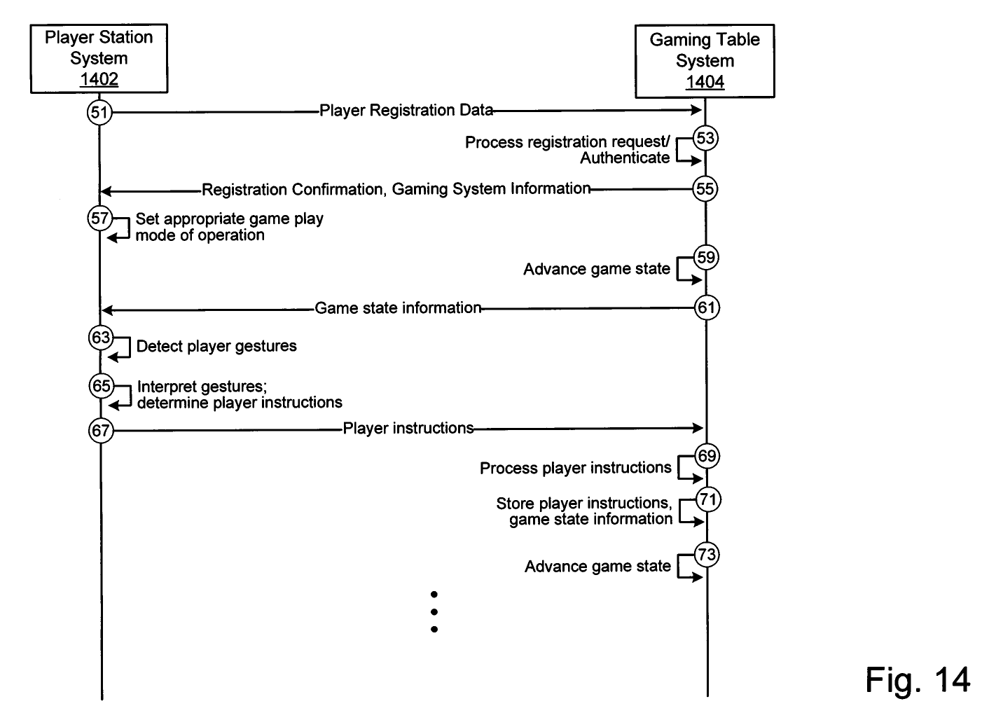

FIG. 14 shows an example interaction diagram illustrating various interactions which may occur between various components of an intelligent multi-player electronic gaming system such as that illustrated in FIG. 7A. For purposes of illustration, it is assumed in the example of FIG. 14 that a player occupying a player station (e.g., 1212c, FIG. 12) of an intelligent multi-player electronic gaming system desires to utilize his player station system 1402 for use in conducting live table game play activities at the intelligent multi-player electronic gaming system.

In at least one embodiment, when the player station system 1402 detects or identifies a player as occupying the player station, player station system 1402 may send (51) a registration request message to the gaming table system 1404, in order to allow the player station system to be used for game play activities (and/or other activities) conducted at gaming table system 1404. In at least one embodiment, the registration request message may include different types of information such as, for example: player/user identity information, player station system identity information, authentication/security information, player tracking information, biometric identity information, PIN numbers, device location, etc.

According to specific embodiments, various events/conditions may trigger the player station system to automatically transmit the registration request message to gaming table system 1404. Examples of such events/conditions may include, but are not limited to, one or more of the following (or combinations thereof):
appropriate input detected at player station system (e.g., player pushes button, performs gesture, etc.);
communication received from gaming table system;
specified time constraints detected as being satisfied;
gaming chip(s) placed detected within player's assigned wagering region;
presence of player detected at player station;
detection of player's first wager being placed;
player location or position detected as satisfying predefined criteria;
appropriate floor supervisor input detected;
player identity determined (e.g., through the use of directional RFID; through placement of player tracking media on a designated spot at a table game; etc.);
etc.

As shown at (53) the gaming table system 1404 may process the registration request. In at least one embodiment, the processing of the registration request may include various types of activities such as, for example, one or more of the following (or combinations thereof): authentication activities and/or validation activities relating to the player station system and/or player; account verification activities; etc.

At (55) it is assumed that the registration request has been successfully processed at gaming table system 1404, and that a registration confirmation message is sent from the gaming table system 1402 to player station system 1402. In at least one embodiment, the registration confirmation message may include various types of information such as, for example: information relating to the gaming table system 1404; information relating to game type(s), game theme(s), denomination(s), paytable(s); min/max wager amounts available after the gaming table system; current game state at the gaming table system; etc.

As shown at (57), the player station system may change or update its current mode or state of operation to one which is appropriate for use with the gaming activity being conducted at gaming table system 1404. In at least one embodiment, the player station system may utilize information provided by the gaming table system to select or determine the appropriate mode of operation of the player station system. For example, in one embodiment, the gaming table system 1404 may correspond to a playing card game table which is currently configured as a blackjack game table.

The gaming table system may provide table game information to the player station system which indicates to the player station system that the gaming table system 1404 is currently configured as a Blackjack game table. In response, the player station system may configure its current mode of operation for blackjack game play and/or gesture recognition/interpretation relating to blackjack game play.

In at least one embodiment, interpretation of a player's gestures and/or movements at the player station system may be based, at least in part, on the current mode of operation of the player station system. Thus, for example, in one embodiment, the same gesture implemented by a player may be interpreted differently by the player station system, for example, depending upon the type of game currently being played by the player.

At (59) it is assumed that gaming table system 1404 advances its current game state (e.g., starts a new game/hand, ends a current game/hand, deals cards, accepts wagers, etc.). At (61) the gaming table system 1404 may provide updated game state information to the player station system 1402. In at least one embodiment, the updated game state information may include information relating to a current or active state of game play which is occurring at the gaming table system.

In the present example, it is assumed, at (63), that player the current game state at gaming table system 1404 requires input from the player associated with player station system 1402. In at least one embodiment, the player may perform one or more gestures using the player station system relating to the player's current game play instructions. For example, in one embodiment where the player is participating in a blackjack game at the gaming table system, and it is currently the player's turn to play, the player may perform a “hit me” gesture at the player station system to convey that the player would like to be dealt another card. According to different embodiments, a gesture may be defined to include one or more player movements such as, for example, a sequence of player movements.

At (65) the player station system may detect the player's gestures, and may interpret the detected gestures in order to determine the player's intended instructions and/or other intended input. In at least one embodiment, the detected gestures (of the player) and/or movements of the player station system may be analyzed and interpreted with respect to various criteria such as, for example, one or more of the following (or combinations thereof): game system information; current game state; current game being played (if any); player's current hand (e.g., cards currently dealt to player); wager information; player identity; player tracking information; player's account information; player station system operating mode; game rules; house rules; proximity to other objects; and/or other criteria described herein.

In at least one alternate embodiment, analysis and/or interpretation of the player's gestures (and/or other player station system movements) may be performed by a remote entity such as, for example, gaming table system 1404. In at least one of such embodiments, the player station system may be operable to transmit information related to the player's gestures and/or other movements of the player station system to the gaming table system for interpretation/analysis.

At (67) it is assumed that the player station system has determined the player's instructions (e.g., based on the player's gesture(s) using the player station system), and transmits player instruction information to the gaming table system. In at least one embodiment, the player construction information may include player instructions relating to gaming activities occurring at gaming table system 1404.

As shown at (69), the gaming table system may process the player instructions received from player station system 1402. Additionally, if desired, the information relating to the player's instructions, as well as other desired information (such as current game state information, etc.) may be stored (71) in a database (e.g., local and/or remote database(s)). Such information may be subsequently used, for example, for auditing purposes, player tracking purposes, etc.

At (73) the current game state of the game being played at gaming table system 1404 may be advanced, for example, based at least in part upon the player's instructions provided via player station system 1402. In at least one embodiment, the game state may not advance until specific conditions have been satisfied. For example, at a table game of blackjack using virtual cards, a player may perform a “hit me” gesture with a player station system during the player's turn to cause another card to be dealt to that player. However, the dealing of the next virtual may not occur until the dealer performs a “deal next card” gesture.

In at least one embodiment, flow may continue (e.g., following an advancement of game state) in a manner similar to the operations described with respect to reference characters 61-73 of FIG. 14, for example.

In alternate embodiments, various operations illustrated and described with respect to FIG. 14 may be omitted and/or additional operations added. For example, in at least one embodiment, the player station system may be configured or designed to engage in uni-directional communication with the gaming table system. For example, in one embodiment, the player station system may be operable to transmit information (e.g., gesture information, player instructions, etc.) to the gaming table system 1404, but may not be operable to receive various types of information (e.g., game state information, registration information, etc.) from the gaming table system. Accordingly, in such an embodiment, at least a portions of the operations illustrated in FIG. 14 (e.g., 51, 53, 55, 57, 59, 61, etc.) may be omitted.

According to at least some embodiments, various player station systems and/or gaming table systems (e.g., gaming machines, game tables, etc.) may include non-contact input interfaces which allow players to use physical and/or verbal gestures, movements, voice commands and/or other natural modes of communicating information to selected systems and/or devices.

According to specific embodiments, the inputs allowed via the non-contact interfaces may be regulated in each gaming jurisdiction in which such non-contact interfaces are deployed, and may vary from gaming jurisdiction to gaming jurisdiction. For example, for a voice interface, certain voice commands may be allowed/required in one jurisdiction but not another. In at least one embodiment, gaming table systems may be configurable such that by inputting the gaming jurisdiction where the gaming table system is located (or by specifying it in a software package shipped with the player station system/gaming table system), the player station system/gaming table system may self-configure itself to comply with the regulations of the jurisdiction where it is located.

Another aspect of player station system and/or gaming table system operations that may also by regulated by a gaming jurisdiction is providing game history retrieval capabilities. For instance, for dispute resolution purposes, it is often desirable to be able to replay information from a past game, such as the outcome of a previous game on the player station system and/or gaming table system. With the non-contact interfaces, it may be desirable to store information regarding inputs made through a non-contact interface and provide a capability of playing information regarding the input stored by the player station system and/or gaming table system.

In at least one embodiment, user gesture information relating to gross motion/gesture detection, motion/gesture interpretation and/or interpreted player input (e.g., based on the motion/gesture interpretations) may be recorded and/or stored in an indexed and/or searchable manner which allows the user gesture information to be easily accessed and retrieved for auditing purposes. For example, in at least one embodiment, player gestures and/or player input interpreted there from may be stored along with concurrent game state information to provide various types of audit information such as, for example, game audit trail information, player input audit trail information, etc.

In one embodiment, the game audit trail information may include information suitable for enabling reconstruction of the steps that were executed during selected previously played games as they progressed through one game and into another game. In at least one embodiment, the game audit trail information may include all steps of a game. In at least one embodiment, player input audit trail information may include information describing one or more players' input (e.g., game play gesture input) relating to one or more previously played games. In at least one embodiment, the game audit trail information may be linked with player input audit trail information in a manner which enables subsequent reconstruction of the sequence of game states which occurred for one or more previously played game(s), including reconstruction of the player(s) instructions (and/or other game play input information) which triggered the transition of each recorded game state. In at least one embodiment, the gaming table system may be implemented as a player station system.

In other embodiments, the gaming table system may include a player station system which is operable to store various types of audit information such as, for example: game history data, user gesture information relating to gross motion/gesture detection, motion/gesture interpretation, game audit trail information, and/or player input audit trail information.

As an example, for a non-contact gesture recognition interface that detects and interprets player movements/gestures, a player station system and/or gaming table system may store player input information relating to detected player gestures (or portions thereof) and/or interpreted player instructions (e.g., based on the detected player movements/gestures) that have been received from one or more players during a game played at the player station system and/or gaming table system, along with other information described herein. An interface may be provided on the player station system and/or gaming table system that allows the player input information to be recalled and output for display (e.g., via a display at the player station system and/or gaming table system). In a game outcome dispute, a casino operator may use a playback interface at the player station system and/or gaming table system to locate and review recorded game history data and/or player input information relating to the disputed event.

According to specific embodiments, various player station systems and/or gaming table systems may include non-contact input interfaces which may be operable to detect (e.g., via the non-contact input interfaces) and interpret various types of player movements, gestures, vocal commands and/or other player activities. For instance, as described in more detail herein, the non-contact input interfaces may be operable to provide eye motion recognition, hand motion recognition, voice recognition, etc. Additionally, the various player station systems and/or gaming table systems may further be operable to analyze and interpret the detected player motions, gestures, voice commands, etc. (collectively referred to herein as “player activities”), in order determine appropriate player input instructions relating to the detected player activities.

In at least one embodiment, at least one gaming table system described herein may be operable to monitor and record the movements/gestures of a player during game play of one or more games. The recorded information may be processed to generate player profile movement information which may be used for determining and/or verifying the player's identity. In one embodiment, the player profile movement information may be used to verify the identity of a person playing a particular game at the gaming table system. In one embodiment, the player profile movement information may be used to enable and/or disable (and/or allow/prevent access to) selected gaming and/or wagering features of the gaming table system. For example, in at least one embodiment, the player profile movement information may be used to characterize a known player's movements and to restrict game play if the current or real-time movement profile of that player changes abruptly or does not match a previously defined movement profile for that player.

Table Game State Examples

As noted previously, different types of live table games may have associated therewith different types of events/conditions which may trigger the change of one or more game states. For purposes of illustration, examples of different types of live table games are described below, along with examples of their associated events/conditions.

Blackjack

In at least one embodiment, a table game state tracking system may be operable to automatically monitor game play, wagering, and/or other activities at a blackjack gaming table, and/or may be operable to automatically identify key conditions and/or events which may trigger a transition of one or more states (e.g., table state(s), game state(s), wagering state(s), etc.) at the gaming table from one state to another.

For example, in the case of a blackjack table game, such key events or conditions may include one or more of the conditions/events criteria stated above, and/or may include, but are not limited to, one or more of the following (or combinations thereof):
side bet event (e.g., double down, insurance, surrender, split, etc.);
dealer change;
reshuffle;
beginning of deck/shoe;
dead game state;
start of hand;
start of round;
start of game;
start of player's hand;
start of player's round;
player bust event;
dealer bust event;
push event;
player blackjack;
dealer blackjack;
player “hit me” event;
player “stand” event;
misdeal;
buy-in event;
marker-in event;
credit-in event;
house tray fill event (e.g., dealer's chip tray re-stocked with additional gaming chips);
promotion event;
bonus win event;
new card being added to a player's hand;
new card dealt from a shoe/deck;
removal or disappearance of a card by occlusion,
tip event (e.g., player tips dealer);
toke event (e.g., dealer receives tip from player and allows tip to be placed as wager, based on outcome of player's hand);
tournament play event;
re-buy event;
etc.

According to different embodiments, selected game state(s) which occur at a blackjack table game may be tracked at various levels such as, for example, one or more of the following (or combinations thereof): table level, individual the player level, dealer level; etc. In at least one embodiment, multiple states of activity at the blackjack gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Craps

In at least one embodiment, a table game state tracking system may be operable to automatically monitor game play, wagering, and/or other activities at a craps gaming table, and/or may be operable to automatically identify key conditions and/or events which may trigger a transition of one or more states (e.g., table state(s), game state(s), wagering state(s), etc.) at the gaming table from one state to another.

For example, in the case of a craps table game, such key events or conditions may include one or more of the conditions/events criteria stated above, and/or may include, but are not limited to, one or more of the following (or combinations thereof):
dice roll event;
change of shooter;
wagering not permitted;
wagering permitted;
wagers locked;
change of dice;
early termination of shooter;
dice off table;
dice rolling;
dice stopped;
dice hit back wall;
dice roll exceeds minimum threshold criteria;
bet lock event;
game start event (e.g., new shooter=new game start);
game end event (such as, for example: dice roll=7, shooter hits number, etc.)
etc.

According to different embodiments, selected game state(s) which occur at a craps table game may be tracked at various levels such as, for example, one or more of the following (or combinations thereof): table level, individual the player level, dealer level; etc. In at least one embodiment, multiple states of activity at the craps gaming table may be tracked simultaneously or concurrently. For example, in some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Poker

In at least one embodiment, a table game state tracking system may be operable to automatically monitor game play, wagering, and/or other activities at a poker gaming table, and/or may be operable to automatically identify key conditions and/or events which may trigger a transition of one or more states (e.g., table state(s), game state(s), wagering state(s), etc.) at the gaming table from one state to another.

For example, in the case of a poker table game (which, for example, may correspond to one of a variety of different poker game types such as, for example, Hold'em Poker Games, Draw Poker Games, Guts Poker Games, Stud Poker Games, and/or other carnival type card-based casino table games), such key events or conditions may include one or more of the conditions/events criteria stated above, and/or may include, but are not limited to, one or more of the following (or combinations thereof):
player fold;
player call;
player ante-in;
push event;
etc.

According to different embodiments, selected game state(s) which occur at a poker table game may be tracked at various levels such as, for example, one or more of the following (or combinations thereof): table level, individual the player level, dealer level; etc. In at least one embodiment, multiple states of activity at the poker gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Baccarat

In at least one embodiment, a table game state tracking system may be operable to automatically monitor game play, wagering, and/or other activities at a baccarat gaming table, and/or may be operable to automatically identify key conditions and/or events which may trigger a transition of one or more states (e.g., table state(s), game state(s), wagering state(s), etc.) at the gaming table from one state to another.

For example, in the case of a baccarat table game, such key events or conditions may include one or more of the conditions/events criteria stated above, and/or may include, but are not limited to, one or more of the following (or combinations thereof):
side bet event;
shoe count;
shoe change;
card dealt;
shoe shuffle;
free hand condition (e.g., actual game with no wagers);
tie/push event;
bonus event;
promotion event;
etc.

According to different embodiments, selected game state(s) which occur at a baccarat table game may be tracked at various levels such as, for example, one or more of the following (or combinations thereof): table level, individual the player level, dealer level; etc. In at least one embodiment, multiple states of activity at the baccarat gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Roulette

In at least one embodiment, a table game state tracking system may be operable to automatically monitor game play, wagering, and/or other activities at a roulette gaming table, and/or may be operable to automatically identify key conditions and/or events which may trigger a transition of one or more states (e.g., table state(s), game state(s), wagering state(s), etc.) at the gaming table from one state to another.

For example, in the case of a roulette table game, such key events or conditions may include one or more of the condition/event criteria stated above, and/or may include, but are not limited to, one or more of the following (or combinations thereof):
wager lock event;
wheel spin event;
ball drop event;
game outcome event;
etc.

According to different embodiments, selected game state(s) which occur at a roulette table game may be tracked at various levels such as, for example, one or more of the following (or combinations thereof): table level, individual the player level, dealer level; etc. In at least one embodiment, multiple states of activity at the roulette gaming table may be tracked simultaneously or concurrently. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Pai Gow

In at least one embodiment, a table game state tracking system may be operable to automatically monitor game play, wagering, and/or other activities at a Pai Gow gaming table, and/or may be operable to automatically identify key conditions and/or events which may trigger a transition of one or more states (e.g., table state(s), game state(s), wagering state(s), etc.) at the gaming table from one state to another.

For example, in the case of a Pai Gow table game, such key events or conditions may include one or more of the condition/event criteria stated above, and/or may include, but are not limited to, one or more of the following (or combinations thereof):
hand setting decision event (e.g., player makes high/low hand decision);
etc.

According to different embodiments, selected game state(s) which occur at a Pai Gow table game may be tracked at various levels such as, for example, one or more of the following (or combinations thereof): table level, individual the player level, dealer level; etc. In at least one embodiment, multiple states of activity at the Pai Gow gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Sic Bo

In at least one embodiment, a table game state tracking system may be operable to automatically monitor game play, wagering, and/or other activities at a Sic Bo gaming table, and/or may be operable to automatically identify key conditions and/or events which may trigger a transition of one or more states (e.g., table state(s), game state(s), wagering state(s), etc.) at the gaming table from one state to another. For example, in the case of a Sic Bo table game, such key events or conditions may include one or more of the condition/event criteria stated above.

According to different embodiments, selected game state(s) which occur at a Sic Bo table game may be tracked at various levels such as, for example, one or more of the following (or combinations thereof): table level, individual the player level, dealer level; etc. In at least one embodiment, multiple states of activity at the Sic Bo gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

Fantan,

In at least one embodiment, a table game state tracking system may be operable to automatically monitor game play, wagering, and/or other activities at a Fantan gaming table, and/or may be operable to automatically identify key conditions and/or events which may trigger a transition of one or more states (e.g., table state(s), game state(s), wagering state(s), etc.) at the gaming table from one state to another. For example, in the case of a Fantan table game, such key events or conditions may include one or more of the condition/event criteria stated above.

According to different embodiments, selected game state(s) which occur at a Fantan table game may be tracked at various levels such as, for example, one or more of the following (or combinations thereof): table level, individual the player level, dealer level; etc. In at least one embodiment, multiple states of activity at the Fantan gaming table may be tracked simultaneously or concurrently. For example, in one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

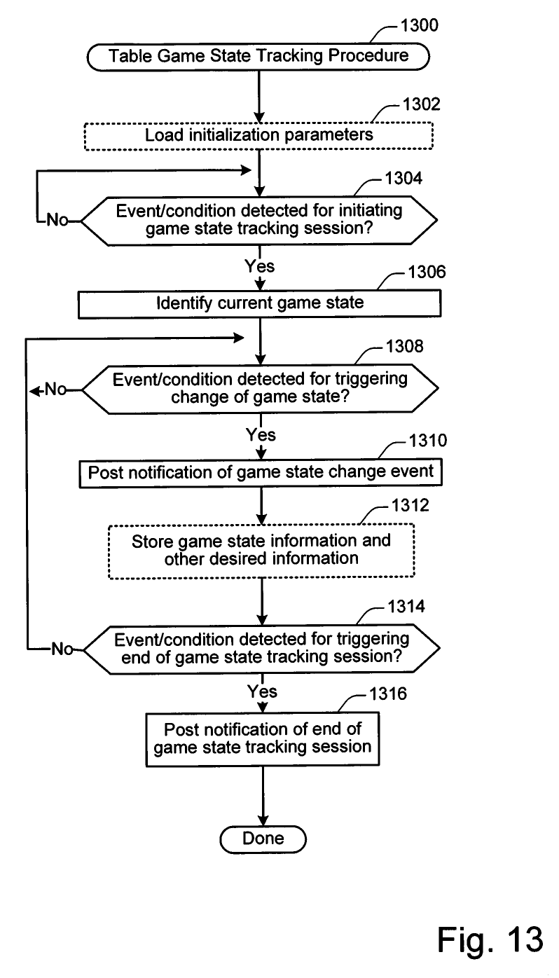

FIG. 13 shows a flow diagram of a Table Game State Tracking Procedure 1300 in accordance with a specific embodiment. In at least one embodiment, at least a portion of the Table Game State Tracking Procedure functionality may be implemented by a master table controller (e.g., 412) and/or by other components/devices of a gaming table system. Further, in at least some embodiments, portions of the Table Game State Tracking Procedure functionality may also be implemented at other devices and/or systems of the casino gaming network.

In at least one embodiment, the Table Game State Tracking Procedure may be operable to automatically determine and/or track one or more states (e.g., table state(s), game state(s), wagering state(s), etc.) relating to operations and/or activities occurring at a gaming table. For example, in at least one embodiment, the Table Game State Tracking Procedure may be operable to facilitate monitoring of game play, wagering, and/or other activities at a gaming table, and/or may be operable to facilitate automatic identification of key conditions and/or events which may trigger a transition of one or more states at the gaming table.

According to specific embodiments, multiple instances or threads of the Table Game State Tracking Procedure may be concurrently implemented for tracking various types of state changes which may occur at one or more gaming tables. For example, in one embodiment, multiple instances or threads of the Table Game State Tracking Procedure may be concurrently implemented for tracking various types of state changes at various levels such as, for example, one or more of the following (or combinations thereof): table level, individual the player level, dealer level; etc. In one embodiment, separate instances of the Table Game State Tracking Procedure may be concurrently initiated for tracking table game state information relating to each respective, active player at the gaming table. In some embodiments, a single instance of the Table Game State Tracking Procedure may be operable to track table game state information relating to all (or selected) states which may occur at (and/or may be associated with) the gaming table. In one embodiment, this may include, for example, tracking table game state information relating to multiple players at the gaming table.

As shown at 1302 of FIG. 13, initial configuration of a given instance of the Table Game States Tracking Procedure may be performed using one or more initialization parameters. In at least one embodiment, at least a portion of the initialization parameters may be stored in local memory of the gaming table system. In some embodiments, other portions of the initialization parameters may be stored in memory of remote systems. Examples of different initialization parameters may include, but are not limited to, one or more of the following (or combinations thereof):
game rule criteria (e.g., game rules corresponding to one or more games which may be played at the gaming table);
game type criteria (e.g., type of game currently being played at the gaming table);
min/max wager limit criteria;
paytable criteria (e.g., paytable information relating to current game being played at gaming table);
state change triggering criteria (e.g., criteria relating to events and/or conditions which may trigger a state change at the gaming table);
filtering criteria (e.g., criteria which may be used to filter information tracked and/or processed by the Table Game State Tracking Procedure);
etc.

In at least one embodiment the filtering criteria may be used to configure the Table Game States Tracking Procedure to track only selected types of state changes which satisfies specified filter criteria. For example different embodiments of the Table Game States Tracking Procedure may be operable to generate and/or track game state information relating to one or more of the following (or combinations thereof): a specified player, a specified group of players, a specified game theme, one or more specified types of state information (e.g., table state(s), game state(s), wagering state(s), etc.), etc.

As shown at 1304, at least one event and/or condition may be detected for initiating a game state tracking session at the gaming table. In at least one embodiment, such event(s) and/or condition(s) may include one or more different types of key events/conditions as previously described herein. Further, in at least one embodiment, the types of events/conditions which may trigger initiation of a game state tracking session may depend upon the type of game(s) being played at the gaming table. For example, in one embodiment one instance of a game state tracking session for a table game may be automatically initiated upon the detection of a start of a new game at the gaming table.

As shown at 1306, a current state of game play at the gaming table may be automatically determined or identified. In at least one embodiment, the start of the game state tracking session may be automatically delayed until the current state of game play at the gaming table has been determined or identified.

At 1308, a determination may be made as to whether one or more events/conditions have been detected for triggering a change of state (e.g., change of game state) at the gaming table. In at least one embodiment, such event(s) and/or condition(s) may include one or more different types of key events/conditions as previously described herein. Additionally, in at least some embodiments, such event(s) and/or condition(s) may include one or more different types of gestures (e.g., verbal instructions, physical gestures such as hand motions, etc.) and/or other actions performed by the dealer and/or by player(s) at the gaming table. In at least one embodiment, such gestures may be detected, for example, by one or more audio detection mechanisms (e.g., at the gaming table system and/or player UIDs) and/or by one or more motion detection mechanisms (e.g., at the gaming table system and/or player UIDs) described herein.

Further, in at least one embodiment, the types of events/conditions which may be detected for triggering a change of game state at the gaming table may be filtered or limited only to selected types of events/conditions which satisfy specified filter criteria. For example, in one embodiment, filter criteria may specify that only events/conditions are to be considered which affect the state of game play from the perspective of a given player at the gaming table.

In at least one embodiment, if a suitable event/condition has been detected for triggering a change of game state at the gaming table, notification of the game state change event/condition (and/or corresponding game state change) may be posted (1010) to one or more other components/devices/systems in the gaming network. For example, in one embodiment, if a suitable event/condition has been detected for triggering a change of game state at the gaming table, notification of the game state change event may be provided to the master table controller 412 (and/or other entities), which may then take appropriate action in response to the game state change event.

In at least one embodiment, such appropriate action may include storing (1014) the game state change information and/or other desired information (e.g., game play information, game history information, timestamp information, wager information, etc.) in memory, in order, for example, to allow such information to be subsequently accessed and/or reviewed for audit purposes. In at least one embodiment, the storing of the game state change information and/or other desired information may be performed by entities and/or processes other than the Table Game State Tracking Procedure.

At 1314, a determination may be made as to whether one or more events/conditions have been detected for triggering an end of an active game state tracking session at the gaming table. In at least one embodiment, such event(s) and/or condition(s) may include one or more different types of key events/conditions as previously described herein. Additionally, in at least some embodiments, such event(s) and/or condition(s) may include one or more different types of gestures (e.g., verbal instructions, physical gestures such as hand motions, etc.) and/or other actions performed by the dealer and/or by player(s) at the gaming table. In at least one embodiment, such gestures may be detected, for example, by one or more audio detection mechanisms (e.g., at the gaming table system and/or player UIDs) and/or by one or more motion detection mechanisms (e.g., at the gaming table system and/or player UIDs) described herein.

Further, in at least one embodiment, the types of events/conditions which may be detected for triggering an end of a game state tracking session may be filtered or limited only to selected types of events/conditions which satisfy specified filter criteria.

In at least one embodiment, if a suitable event/condition has been detected for triggering an end of a game state tracking session at the gaming table, appropriate action may be taken to end and/or close the game state tracking session. Additionally, in at least one embodiment, notification of the end of the game state tracking session may be posted (1010) to one or more other components/devices/systems in the gaming network, which may then take appropriate action in response to the event notification.

In at least one embodiment, if a suitable event/condition has not been detected for triggering an end of a game state tracking session at the gaming table, the Table Game State Tracking Procedure may continue to monitor activities at (or relating to) the gaming table.

Flat Rate Gaming Table Play

Various aspects are directed to methods and apparatus for operating, at a live casino gaming table, a table game having a flat rate play session costing a flat rate price. In one embodiment, the flat rate play session may span multiple plays on the gaming table over a pre-established duration. In at least one embodiment, a given gaming table may be operable to simultaneously or concurrently host both flat rate game play and non-flat rate game play to different players at the gaming table. In one embodiment, the gaming table may include an intelligent multi-player electronic gaming system which is operable to identify price parameters, and/or operable to determine a flat rate price of playing a flat rate table game session based on those price parameters. In one embodiment, the identifying of the price parameters may include determining a player's preferred and/or selected price parameters. In some embodiments, some price parameters may include operator selected price parameters.

In one embodiment, if a player elects to participate in a flat rate table game session (e.g., having an associated flat rate price), the player may provide the necessary funds to the dealer (or other authorized casino employees/machines), or, in some embodiments, may make his or her credit account available for automatic debit. In one embodiment, when the player initiates the flat rate table game play session, the gaming table system may automatically track the duration remaining in the flat rate table game play session, and may automatically suspend, resume, and/or end the flat rate table game play session upon the occurrence and/or detection of appropriate conditions and/or a events.

According to one embodiment, during play of the flat rate table game play session, payouts may be made either directly to the player in the form of coins and/or wagering tokens, and/or indirectly in the form of credits to the player's credit account. In one embodiment, payouts awarded to the player may have one or more limitations and/or restrictions associated therewith. In accordance with one embodiment, a player may enter into a contract, wherein the contract specifies the flat rate play session as described above.

In at least one embodiment, the term “flat rate play session” may be defined as a period of play wherein an active player at a table game need not make funds available for continued play during the play session. In one embodiment, the flat rate play session may span multiple plays (e.g., games, hands and/or rounds) of a given table game. These multiple plays may be aggregated into intervals or segments of play. According to specific embodiments, the term “interval” as used herein may include, but are not limited to, one or more of the following (or combinations thereof): time, amount wagered, hands/rounds/games played, and/or any other segment in which table game play may be divided. For example, two hours, fifty hands/rounds of play, 500 cards dealt, twenty wins, total amount wagered exceeds $500, etc. In at least one embodiment, a given gaming table may be operable to simultaneously or concurrently host both flat rate game play and non-flat rate game play to different players at the gaming table.

Specific embodiments of flat rate play sessions conducted on electronic gaming machines are described, for example, in U.S. Pat. No. 6,077,163 to Walker et al., and U.S. Patent Publication No. US20060046835A1 to Walker et al., each of which is incorporated herein by reference in its entirety for all purposes.

It will be appreciated that there are a number of differences between game play at electronic gaming machines and game play at live table games. Once such difference relates to the fact that, typically, only one player at a time can engage in game play conducted at an electronic gaming machine, whereas multiple players may engage in simultaneous game play at a live table game. In at least one embodiment, a live table game may be characterized as a wager-based game which is conducted at a physical gaming table (e.g., typically located on the casino floor). In at least one embodiment, a live table game may be further characterized in that multiple different players may be concurrent active participants of the table game at any given time. In at least one embodiment, a live table game may be further characterized in that the game outcome for any given active player of the table game may be affected by the game play decisions/actions of the other active players of the table game. In various embodiments of live card-based table games, the table game may be further characterized in that the hand/cards dealt to any given active player of the table game may be affected by the game play decisions/actions of the other active players of the table game.

These differences, as well as others, have conventionally made it difficult to implement or provide flat rate play functionality at live table games.

However, according to a specific embodiments, various intelligent multi-player electronic gaming systems described herein may include functionality for allowing one or more players to engage in a flat rate play session at the gaming table. For example, in one embodiment, intelligent multi-player electronic gaming system may include functionality for allowing a player to engage in a flat rate play session at the gaming table.

In one embodiment, a player may enter player identifying information and/or selected flat rate price parameters directly at the gaming table (e.g., via their player station display terminal and/or other input mechanisms). In one embodiment, the price parameters may define the parameters of the flat rate play session, describing, for example one or more of the following (or combinations thereof): duration of play, minimum/maximum wager amounts, insurance options, paytables, etc. In one embodiment, the gaming table may communicate with one or more local and/or remote systems for storing the player selected price parameters, and/or for retrieving flat rate price information and/or other information relating to a flat rate play session conducted at the gaming table.

In one embodiment, the player selected price parameters, in combination with operator price parameters and/or other criteria, may be used to determine the flat rate price. In one embodiment, if the player elects to pay the flat rate price, the player may simply deposit (e.g., provide to the dealer) the flat rate amount at the intelligent multi-player electronic gaming system (e.g., by way of gaming chips, cash and/or credits), and/or may make a credit account available for the intelligent multi-player electronic gaming system to automatically debit, as needed. For example, in one embodiment, the player may elect to pay $25 for a half hour flat rate blackjack table game session. According to specific embodiments the flat rate play session criteria may also specify a minimum wager amount to be placed on behalf of the player at the start of each new hand. Once the player initiates play, the intelligent multi-player electronic gaming system may be operable to track the flat rate play session and stop the play when the end of the flat rate play session has been determined to have occurred.

According to different embodiments, various criteria relating to the flat rate play session may be based, at least in part, upon the game theme and/or game type of table game to be played.

For example, a player at a blackjack table might elect to pay $50 to play a flat rate play session for 30 minutes and a guaranteed minimum wager amount of $2 for each new hand of blackjack played. Once the player initiates play of the flat rate play session, the intelligent multi-player electronic gaming system 200 tracks the flat rate play session, and stops the game play for that player when the session is completed, such as, for example, when a time limit has expired (e.g., after 30 minutes of game play have elapsed). In this particular example, during the flat rate play session, the intelligent multi-player electronic gaming system 200, dealer or other entity may automatically place an initial wager of the guaranteed minimum wager amount (e.g., $2) on behalf of the player at the start of each new hand of blackjack. In one embodiment, special gaming or wagering tokens may be used to represent wagers which have been placed (e.g., by the house) on behalf of a player who is participating in a flat rate play session.

In at least one embodiment, the player is not required to make any additional wagers during the flat rate play session. However, in at least some embodiments, the player may be permitted to increase the amount wagered using the player's own funds, and/or to place additional wagers as desired (e.g., to double down, to buy insurance, to call or raise in a game of poker, etc.). According to specific embodiments, payouts may be made either directly to the player in the form of gaming chips, and/or indirectly in the form vouchers or credits. It should be understood that the player balance could be stored in a number of mediums, such as smart cards, credit card accounts, debit cards, hotel credit accounts, etc.

According to other embodiments, special gaming tokens may be used to promote bonus or promotional game play, and/or may be used to entice players to engage in desired table game activities. For example, in one embodiment, a player may be offered a promotional gaming package whereby, for an initial buy-in amount (e.g., $50), the player will receive a predetermined amount or value (e.g., $100 value) of special gaming tokens which are valid for use in table game play (e.g., at one or more specified table games) for only a predetermined time value (e.g., up to 30 minutes of game play). In one embodiment, each of the special gaming tokens may have associated therewith a monetary value (e.g., $1, $5, $10, etc.). Additionally, each of the special gaming tokens may have embedded therein electronic components (such as, for example, RFID transponders and/or other circuitry) which may be used for electronically detecting and/or for reading information associated with that special gaming token. The special gaming tokens may also have a different visual or physical appearance so that a dealer and/or other casino employee may visually distinguish the special gaming tokens from other gaming chips used by the casino.

In accordance with a specific example, it may be assumed that a player has paid $50 for a promotional gaming package in which the player receives $100 worth of special gaming tokens for use in up to 30 minutes of continuous game play at a blackjack gaming table. In one implementation, each of the gaming tokens has a unique RFID identifier associated therewith. In one embodiment, each of the special gaming tokens which are provided to the player for use with the promotional gaming package have been registered at one or more systems of the casino gaming network, and associated with the promotional gaming package purchased by the player.

According to a specific embodiment, when the player desires to start the promotional game play at the blackjack gaming table, the player may occupy a player station at the blackjack table, and present information to the dealer (e.g., via the use of: a player tracking card, a promotional ticket, verbal instructions, etc.) that the player wishes to start the promotional game play session. In one embodiment, the player may initiate the promotional game play session simply by placing one of the special gaming tokens into the player's gaming chip placement zone at the blackjack table. In this example, once the promotional game play session has been initiated, the player may use the special gaming tokens to place wagers during one or more hands of blackjack. However, after the specified 30 minutes has elapsed, the special gaming tokens will be deemed to have automatically expired, and may no longer be used for wagering activity.

In at least one embodiment, the gaming table may be operable to automatically identify the presence of one or more special gaming tokens in the player's gaming chip placement zone, and may further be operable to authenticate, verify, and/or validate the use of the special gaming tokens by the player at the blackjack table. For example, if the player has exceeded the promotional game play time limit (and/or other criteria associated with the promotional game play), and the player tries to use one of the expired promotional gaming tokens to place a wager, the gaming table may automatically detect the improper use of the expired gaming tokens, and automatically generate a signal (e.g., audio signal and/or visual signal) in response to alert the dealer (and/or other systems of the casino network) of the detected improper activity.

In at least in one embodiment, intelligent electronic wagering tokens and/or other types of wireless portable electronic devices may be used for implementing for facilitating flat rate table game play at various types of live casino gaming tables. For example, in at least one embodiment, an intelligent electronic wagering token may include, a power source, a processor, memory, one or more status indicators, and a wireless interface, and may be operable to be configured by an external device for storing information relating to one or more flat rate table game sessions associated with one or more players. Similarly, a player's electronic player tracking card (or other UID) may include similar functionality.

For example, in one embodiment, a player may “prepay” a predetermined amount (e.g., $100) to participate in a flat rate blackjack table game session. In one embodiment, the player may provide funds directly to a casino employee (e.g., dealer, attendant, etc.). In other embodiments, the player may provide funds via one or more electronic transactions (such as, for example, via a kiosk, computer terminal, wireless device, etc.). In one embodiment, once the funds are verified, an electronic device (e.g., intelligent electronic wagering token, intelligent player tracking card, UID, etc.) may be configured with appropriate information to enable the player to participate in the selected flat rate table game session in accordance with the terms, restrictions, and/or other criteria associated with that flat rate table game session.

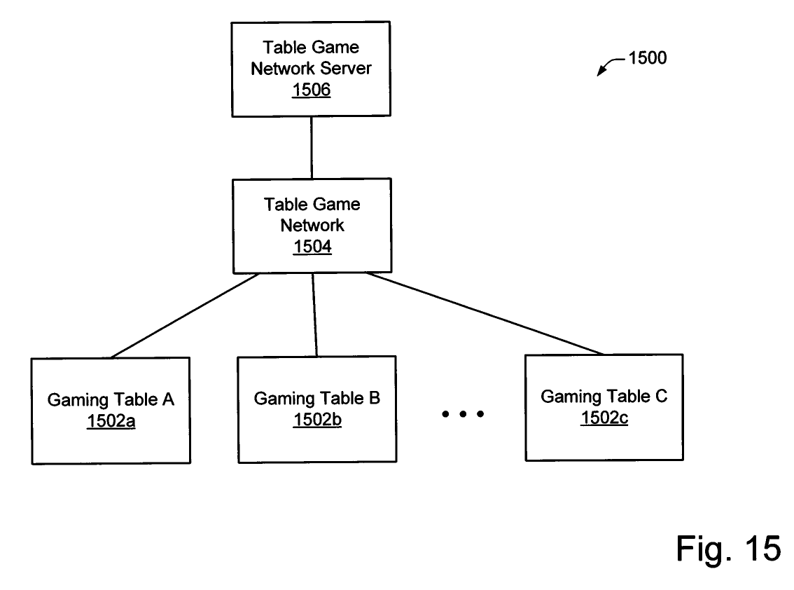

FIG. 15 shows an example of a gaming network portion 1500 in accordance with a specific embodiment. In at least one embodiment, gaming network portion 1500 may include a plurality of gaming tables (e.g., 1502a-c), a table game network 1504 and/or a table game network server 1506. In at least one embodiment, each gaming table 1502 may be uniquely identified by a unique identification (ID) number. In one embodiment, the table game network 1504 may be implemented as a local area network which may be managed and/or controlled by the table game network server 1506.

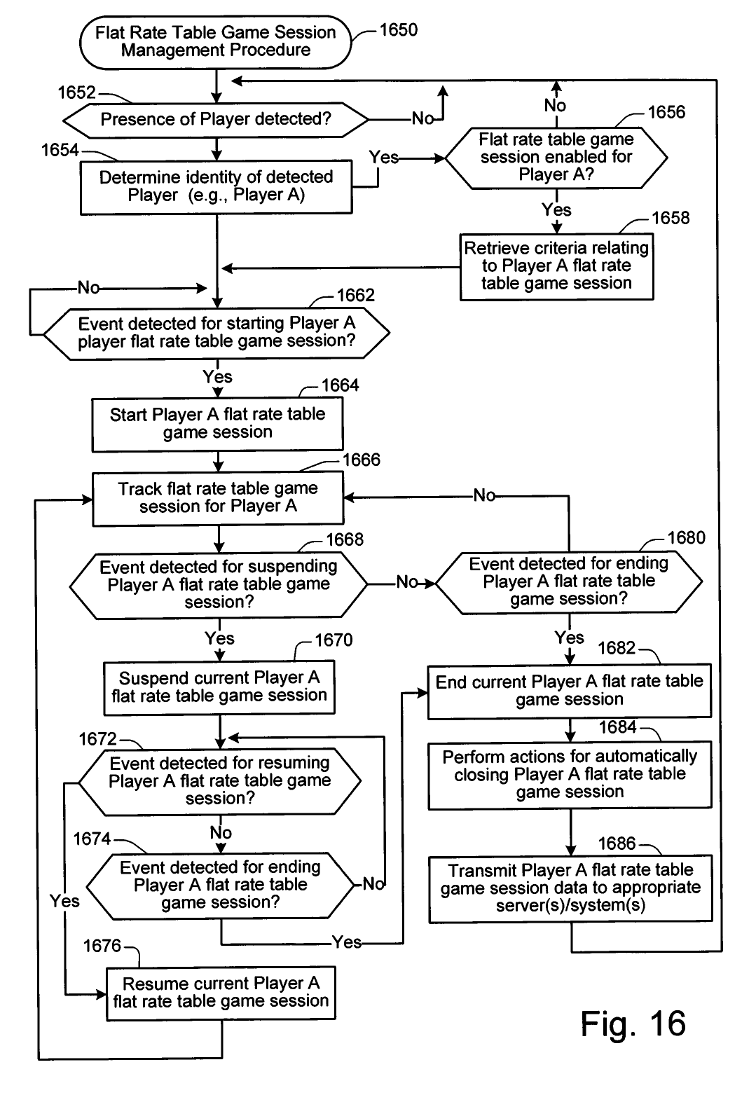

FIG. 16 shows a flow diagram of a Flat Rate Table Game Session Management Procedure in accordance with a specific embodiment. It will be appreciated that different embodiments of Flat Rate Table Game Session Management Procedures may be implemented at a variety of different gaming tables associated with different table game themes, table game types, paytables, denominations, etc., and may include at least some features other than or different from those described with respect to the specific embodiment of FIG. 16.

According to specific embodiments, multiple threads of the Flat Rate Table Game Session Management Procedure may be simultaneously running at a given gaming table. For example, in one embodiment, a separate instance or thread of the Flat Rate Table Game Session Management Procedure may be implemented for each player (or selected players) or who is currently engaged in an active flat rate table game session at the gaming table. Additionally, in at least one embodiment, a given gaming table may be operable to simultaneously or concurrently host both flat rate game play and non-flat rate game play for different players at the gaming table.

For purposes of illustration, an example of the Flat Rate Table Game Session Management Procedure 1650 will now be explained with reference to intelligent multi-player electronic gaming system 200. According to specific embodiments, one or more gaming tables may include functionality for detecting (1652) the presence of a player (e.g., Player A) at the gaming table and/or at one of the gaming table's player stations. Such functionality may be implemented using a variety of different types of technologies such as, for example: cameras, pressure sensors (e.g., embedded in a seat, bumper, table top, etc.), motion detectors, image sensors, signal detectors (e.g., RFID signal detectors), dealer and/or player input devices, etc.

For example, in a specific embodiment, Player A may be carrying his/her RFID-enabled player tracking card in his/her pocket, and chose to occupy a seat at player station position 25 of intelligent multi-player electronic gaming system 200. Intelligent multi-player electronic gaming system 200 may be operable to automatically and passively detect the presence of Player A, for example, by detecting an RFID signal transmitted from Player A's player tracking card. Thus, in at least one implementation, such player detection may be performed without requiring action on the part of a player or dealer.

In another embodiment, Player A may be provided with an flat rate gaming session object/token which has been configured with appropriate information to enable Player A to participate in a selected flat rate table game session at the gaming table in accordance with the terms, restrictions, and/or other criteria associated with that flat rate table game session. For example, in one embodiment, the object may be a simple non-electronic card or token displaying a machine readable code or pattern, which, when placed on the main gaming table display, may be identified and/or recognized by the intelligent multi-player electronic gaming system. In at least one embodiment, the gaming table may be operable to automatically and passively detect the presence, identity and/or relative locations of one or more flat rate gaming session object/tokens.

In at least one embodiment, the identity of Player A may be automatically determined (1654), for example, using information obtained from Player A's player tracking card, flat rate gaming session object/token, UID, and/or other player identification mechanisms. In at least some embodiments, the flat rate gaming session object/token may include a unique identifier to help identify the player's identity.

As shown at 1656, a determination may be made as to whether one or more flat rate table game sessions have been authorized or enabled for Player A. In at least one embodiment, such a determination may be performed, for example, using various types of information such as, for example, play identity information and/or other information obtained from the player's player tracking card, UID, flat rate gaming session object/token(s), etc. For example, in at least one embodiment, the intelligent multi-player electronic gaming system may be operable to read information from Player A's player tracking media and/or flat rate gaming session object/token, and may be further operable to provide at least a portion of this information and/or other types of information to a remote system (such as, for example, table game network server 1506, FIG. 15) in order to determine whether one or more flat rate table game sessions have been enabled or authorized for Player A. In at least one embodiment, such other types of information may include, but are not limited to, one or more of the following (or combinations thereof):
game rule criteria (e.g., game rules corresponding to one or more games which may be played at the gaming table);
game type criteria (e.g., type of game currently being played at the gaming table);
game theme criteria (e.g., theme of game currently being played at the gaming table)
min/max wager limit criteria (e.g., associated with the game and/or gaming table);
paytable criteria (e.g., paytable information relating to current game being played at gaming table);
etc.

In at least one embodiment, at least a portion of the above-described criteria may be stored in local memory at the intelligent multi-player electronic gaming system. In some embodiments, other information relating to the gaming table criteria may be stored in memory of one or more remote systems.

In response to receiving the information provided by the intelligent multi-player electronic gaming system, the table game network server (and/or other systems/devices of the gaming network) may provide the intelligent multi-player electronic gaming system with flat rate table game criteria and/or other information relating to flat rate table game session(s) which have been enabled or authorized for play by Player A at the gaming table. In at least one embodiment, such criteria/information may include, but are not limited to, one or more of the following (and/or combinations thereof):
authentication information (e.g., relating to authentication of Player A's electronic device);
flat rate table game session ID information;
criteria relating to the starting of a flat rate table game session;
criteria relating to the suspension of a flat rate table game session;
criteria relating to the resumption of a flat rate table game session;
criteria relating to the ending of a flat rate table game session;
criteria relating to the duration of a flat rate table game session;
criteria relating to wager restrictions associated with a flat rate table game session;
criteria relating to game theme restrictions associated with a flat rate table game session;
criteria relating to game type restrictions associated with a flat rate table game session;
criteria relating to paytable restrictions associated with a flat rate table game session;
criteria relating to denomination restrictions associated with a flat rate table game session;
criteria relating to player restrictions associated with a flat rate table game session;
criteria relating to purchase amounts or deposit amounts associated with a flat rate table game session;
criteria relating to time restrictions associated with a flat rate table game session; and/or
other criteria which may affect play of a flat rate table game session at the gaming table.

In some embodiments, the intelligent multi-player electronic gaming system may be operable to automatically determine a current position of Player A at the gaming table. Thus, for example, in the present example, intelligent multi-player electronic gaming system 200 may be operable to determine that Player A is occupying player station 25. Such information may be subsequently used, for example, when performing flat rate table game session activities associated with Player A at the gaming table.

According to different embodiments, the intelligent multi-player electronic gaming system may be operable to automatically initiate or start a new flat rate table game session for a given player (e.g., Player A) based on the detection (1662) of one or more conditions and/or events. For example, in one embodiment involving a flat rate blackjack table game, Player A may chose to place his flat rate gaming session object/token within Player A's designated playing zone and/or wagering zone at the gaming table in order to start (or resume) a flat rate table game session at the gaming table. The intelligent multi-player electronic gaming system may detect the presence (and/or location) of the flat rate gaming session object/token, and in response, may automatically perform one or more validation and/or authentication procedures in order to verify that the flat rate gaming session object/token may be used for flat rate table game play (e.g., by Player A) for the current game being played at the gaming table.

In one embodiment, if the intelligent multi-player electronic gaming system determines that the flat rate gaming session object/token may be used for flat rate table game play (e.g., by Player A) for the current game being played at the gaming table, the intelligent multi-player electronic gaming system may cause a first status indicator (e.g., candle, light pipe, etc.) of the player's player station system to be displayed (e.g., light pipe of player's player station system turns green). If, however, the intelligent multi-player electronic gaming system determines that the flat rate gaming session object/token may not be used for flat rate table game play (e.g., by Player A) for the current game being played at the gaming table, the intelligent multi-player electronic gaming system may cause a first status indicator (e.g., candle, light pipe, etc.) of the player's player station system to be displayed (e.g., light pipe of player's player station system turns yellow or red). In at least one embodiment, the intelligent multi-player electronic gaming system may display various content on the main gaming table display in response to determining whether or not the flat rate gaming session object/token may be used for flat rate table game play (e.g., by Player A) for the current game being played at the gaming table.

In at least one embodiment, the status indicators of the flat rate gaming session object/token may be visible or observable by Player A, a dealer, and/or other persons, and may be used to alert such persons of important events, conditions, and/or issues.

According to specific embodiments, a variety of different conditions, events and/or some combination thereof may be used to trigger the start of a flat rate table game session for a given player. Such events may include, for example, but are not limited to, one or more of the following:
physical proximity of player, player tracking media, and/or flat rate gaming session object/token detected as satisfying predetermined criteria;
player tracking media, and/or player wagering media detected within specified zone of player station area;
player tracking media, and/or player wagering media shown or handed to dealer and/or other casino employee;
appropriate player input detected (e.g., player pushes button);
appropriate dealer input detected;
specified time constraints detected as being satisfied (e.g., begin flat rate table game session at next round of play);
gaming chip(s) placed detected within player's assigned wagering region;
player flat rate gaming session object/token detected as being within player's assigned wagering region, or player station region on main gaming table display;
presence of player detected at player station;
detection of player's first wager being placed;
player location or position detected as satisfying predefined criteria;
appropriate floor supervisor input detected;
player identity determined;
detection of continuous presence of player tracking media and/or flat rate gaming session object/token for a predetermined amount of time;
etc.

For example, in one embodiment where Player A is carrying a portable electronic device such as, for example, an RFID-enabled player tracking card (or RFID-enabled flat rate gaming session object/token), the flat rate table game system may automatically start a flat rate table game for Player A using the time, position and/or identifier information associated with the RFID-enabled portable electronic device.

In another embodiment, Player A may be provided with an flat rate gaming session object/token which has been configured with appropriate information to enable Player A to participate in a selected flat rate table game session at the gaming table in accordance with the terms, restrictions, and/or other criteria associated with that flat rate table game session. For example, in one embodiment, the object may be a simple non-electronic card or token displaying a machine readable code or pattern, which, when placed on the main gaming table display, may be identified and/or recognized by the intelligent multi-player electronic gaming system. In at least one embodiment, the gaming table may be operable to automatically and passively detect the presence, identity and/or relative locations of one or more flat rate gaming session object/tokens.

In one embodiment, the player's identity may be determined using identifier information associated with Player A's portable electronic device and/or flat rate gaming session object/token(s). In another embodiment, the player's identity may be determined by requesting desired information from a player tracking system and/or other systems of the gaming network. In one embodiment, once the flat rate table game session has been started, any (or selected) wager activities performed by Player A may be automatically tracked.

Assuming that the appropriate event or events have been detected (1662) for starting a flat rate table game session for Player A, a flat rate table game session for Player A may then be started or initiated (1664). During the active flat rate table game session, game play information and/or wager information relating to Player A may be automatically tracked and/or generated by one or more components of the gaming table system. According to a specific embodiment, once the flat rate table game session has been started, all or selected wager and/or game play activities detected as being associated with Player A may be associated with the current flat rate table game session for Player A. According to specific embodiments, such flat rate table game information may include, but is not limited to, one or more of the following types of information (and/or some combination thereof):
wager data;
timestamp information;
player station position;
player buy-in data;
side wager data;
session start time;
session end time;
information relating to gaming chips (e.g., types, amount, value, etc.) detected as being within the player's personal player space (e.g., within personal player space region 250, FIG. 2);
player movement information (e.g., a player moving from player station at a gaming table to another player station at the gaming table);
rating information (e.g., one or more types of ratings) for a player;
player skill information;
game speed information;
various types of player-tracking related information;
amounts wagered;
time played;
game speed (e.g., wagers/hour);
house advantage;
walk amount;
actual wins/losses;
theoretical wins/losses;
net session win/loss;
winnings;
buy-in activity (e.g., using chips, cash, marker, vouchers, credits, etc.);
marker in activity;
time spent at gaming table;
active gaming time spent at gaming table;
chips out activity;
redemption activity (e.g., pay offs using credits and/or markers, buying back of credits/markers);
comp. value information (e.g., a value or rating for a player which may be used by the casino for awarding various complimentary products, services, etc. for a given player and/or for given time period);
player ranking information (e.g., bronze, silver, gold);
etc.

According to specific embodiments, the gaming table system may be operable to detect (1668) one or more events relating to the suspension and/or ending of an active flat rate table game session. For example, in one embodiment, the gaming table system may periodically check for events relating to the suspension and/or ending of an active flat rate table game session. Alternatively, a separate or asynchronous process (e.g., an event detection manager/component) may be utilized for detecting various events such as, for example, those relating to the starting, suspending, resuming, and/or ending of one or more flat rate table game sessions at the gaming table.

In at least one embodiment, if an event is detected for suspending Player A's active flat rate table game session, the current or active flat rate table game session for Player A may be suspended (1670) (e.g., temporarily suspended). In one embodiment, during a suspended flat rate table game session, no additional flat rate table game information is logged or tracked for that player. In some embodiments, the time interval relating to the suspended flat rate table game session may be tracked. Further, in at least some embodiments, other types of player tracking information associated with Player A (such as, for example, game play activities, wagering activities, player location, etc.) may be tracked during the suspension of the flat rate table game session.

According to specific embodiments, a variety of different events may be used to trigger the suspension of a flat rate table game session for a given player. Such events may include, for example, but are not limited to, one or more of the following (and/or some combination thereof):
no detection of player at assigned player station;
no detection of player's player tracking media, and/or player wagering media within predetermined range;
player input;
dealer input;
other casino employee input (e.g., pit boss, etc.)
time based events;
player detected as not being within predetermined range;
no player activity with specified time period;
change of dealer event;
deck reshuffle event;
etc.

For example, if a player inadvertently removes his/her player tracking media, and/or player wagering media from a designated location of the gaming table for a brief period of time, and/or for a predetermined number of rounds, and the player tracking media, and/or player wagering media is subsequently returned to its former location, the gaming table system may be operable to merge consecutive periods of activity into the same flat rate table game session, including any rounds tracked while the player's player tracking media, and/or player wagering media was detected as being absent. In one embodiment, if a player moves to a different player station at the gaming table, the gaming table system may respond by switching or modifying the player station identity associated with that player's flat rate table game session in order to begin tracking information associated with the player's flat rate table game session at the new player station.

In at least one embodiment, during a suspended flat rate table game session, the player's flat rate gaming session object/token (and/or other portable electronic devices) may not be used for flat rate table game play at the gaming table.

In at least one embodiment, a suspended flat rate table game session may be resumed or ended, depending upon the detection of one or more appropriate events. For example if an event is detected (1672) for resuming the suspended Player A flat rate table game session, the flat rate table game session for Player A may be resumed (1676) and/or re-activated, whereupon information relating to the resumed flat rate table game session for Player A may be automatically tracked and/or generated by one or more components of the gaming table system.

According to specific embodiments, a variety of different events may be used to trigger the resuming of a flat rate table game session for a given player. Such events may include, for example, but are not limited to, one or more of the following (and/or some combination thereof):
re-detection of player at assigned player station;
re-detection of player's player tracking media, and/or player wagering media within predetermined range;
player input;
dealer input;
other casino employee input (e.g., pit boss, etc.)
time based events;
player detected as being within predetermined range;
player game play activity detected;
player wager activity detected;
change of dealer end event;
deck reshuffle end event;
etc.

Alternatively, if an event is detected for ending (1680) the Player A flat rate table game session, the flat rate table game session for Player A may be ended (1682) and/or automatically closed (1684). At that point the gaming table system may be operable to automatically determine and/or compute any information which may be desired for ending or closing the flat rate table game session and/or for reporting to other devices/systems of the gaming network.

According to specific embodiments, a variety of different events may be used to trigger the ending and/or closing of a flat rate table game session for a given player. Such events may include, for example, but are not limited to, one or more of the following (and/or some combination thereof):
time limit(s) meet or exceed predetermined criteria;
total wager limit(s) meet or exceed predetermined criteria;
total number of games/rounds/hands played meet or exceed predetermined criteria;
total number of cards dealt meet or exceed predetermined criteria;
total number of wins meet or exceed predetermined criteria;
total number of game outcomes meet or exceed predetermined criteria;
total number of game losses meet or exceed predetermined criteria;
violation of flat rate table game session rule(s) detected;
player input;
dealer input;
other casino employee input (e.g., pit boss, etc.); and/or other criteria (e.g., terms, events, conditions, etc.) relating to ending of flat rate table game session detected as being satisfied.

In at least one embodiment where multiple players at a given intelligent multi-player electronic gaming system are engaged in the flat-rate table game play, a separate flat rate table game session may be established for each of the players to thereby allow each player to engage in flat rate table game play at the same electronic gaming table asynchronously from one another.

For example, in one example embodiment, an intelligent multi-player electronic gaming system may be configured as an electronic poker gaming table which includes functionality for enabling each of the following example scenarios to concurrently take place at the electronic poker gaming table: a first player at the table is engaged in game play in a standard (e.g., non-flat-rate play) mode; a second player at the table is engaged in a flat rate table game play session which is halfway through the session; a third player at the table (who has not yet initiated game play) is provided with the opportunity to engage in game play in standard (e.g., non-flat-rate play) mode, or to initiate a flat-rate table game play session. Further, in at least one embodiment each poker hand played by the players at the electronic poker gaming table may be played in a manner which is similar to that of a traditional table poker game, regardless of each player's mode of game play (e.g., standard mode or flat-rate mode).

Gesture Detection

Various embodiments of intelligent multi-player electronic gaming systems described or reference herein may be adapted for use in various types of gaming environments relating to the play of live multi-player games. For example, some embodiments of intelligent multi-player electronic gaming systems described or reference herein may be adapted for use in live casino gaming environments where multiple players may concurrently engage in wager-based gaming activities (and/or other activities) at an intelligent multi-player electronic gaming system which includes a multi-touch, multi-player interactive display surface having at least one multipoint or multi-touch input interface.

For example, casino table games are popular with players, and represent an important revenue stream to casino operators. However, gaming table manufacturers have so far been unsuccessful in employing the use of large touch screen displays to recreate the feel and play associated with most conventional (e.g., non-electronic and/or felt-top) casino table games. As a result, presently existing electronic casino gaming tables which employ the use of electronic touch systems (such as touchscreens) are typically not able to uniquely determine the individual identities of multiple individuals (e.g., players) who might touch a particular touchscreen at the same time. Additionally, such intelligent multi-player electronic gaming systems typically cannot resolve which transactions are being carried out by each of the individual players accessing the multi-touch display system. This limits the usefulness of touch-type interfaces in multi-player applications such as table games.

Accordingly, one aspect of at least some embodiments disclosed herein is directed to various techniques for processing inputs in intelligent multi-player electronic gaming systems having multi-touch, multi-player display surfaces, particularly live multi-player casino gaming table systems (e.g., in which live players are physically present at a physical gaming table, and engage in wager-based gaming activities at the gaming table).

For example, in at least one embodiment, a multi-player wager-based game may be played on an intelligent multi-player electronic gaming system having a table with a multi-touch, multi-player display surface and chairs and/or standing pads arranged around the table. Images associated with a wager-based game are projected and/or displayed on the display surface and the players physically interact with the display surface to play the wager-based game.

In at least one embodiment, an intelligent multi-player electronic gaming system may include one or more different input systems and/or input processing mechanisms for use serving multiple concurrent users (e.g., players, hosts, etc.) via a common input surface (input area) and/or one or more input device(s).

For example, in at least one embodiment, an intelligent multi-player electronic gaming system may include a multi-touch, multi-player interactive display surface having a multipoint or multi-touch input interface which is operable to receive multiple different gesture-based inputs from multiple different concurrent users (e.g., who are concurrently interacting with the multi-touch, multi-player interactive display surface). Additionally, the intelligent multi-player electronic gaming system may include at least one user input identification/origination system (e.g., 499, FIG. 7A) which is operable to determine and/or identify an appropriate origination entity (e.g., a particular player, dealer, and/or other user at the gaming system) to be associated with each (or selected ones of) the various contacts, movements, and/or gestures detected at or near the multi-touch, multi-player interactive display surface.

In at least one embodiment, the user input identification/origination system may be configured to communicate with an input processing system, and may provide the input processing system with origination information which, for example, may include information relating to the identity of the respective origination entity (e.g., user) associated with each detected contact, movement, and/or gesture detected at or near the multi-touch, multi-player interactive display surface. In at least one embodiment, input entered by a non-authorized user or person at the intelligent multi-player electronic gaming system may be effectively ignored.

In one embodiment, the user input identification/origination system(s) may be operable to function in a multi-player environment, and may include, for example, functionality for initiating and/or performing one or more of the following (or combinations thereof):
concurrently detecting multiple different input data from different players at the gaming table;
determining a unique identifier for each active player at the gaming table;
automatically determining, for each input detected, the identity of the player (or other person) who provided that input;
automatically associating each detected input with an identifier representing the player (or other person) who provided that input;
etc.

In some embodiments, the user input identification/origination system may include one or more cameras which may be may be used to identify the particular user who is responsible for performing one or more of the touches, contacts and/or gestures detected at or near the multi-touch, multi-player interactive display surface.

In at least one embodiment, a multi-player table gaming system may include multi-player touch input interface system which is operable to identify or determine where, who, and what transactions are taking place at the gaming table. Additionally, in at least one embodiment, an electronic intelligent multi-player electronic gaming system may be provided which mimics the look, feel, and game play aspects of traditional gaming tables.

As disclosed herein, the phrase “intelligent gaming table” may be used to represent or characterize one or more embodiments of intelligent multi-player electronic gaming systems described or referenced herein.

In at least one embodiment, the intelligent multi-player electronic gaming system may be operable to uniquely identify precisely where different players touch the multi-touch, multi-player interactive display surface even, if multiple players touch the surface simultaneously. Additionally, in at least one embodiment, the intelligent multi-player electronic gaming system may be operable to automatically and independently recognize and process different gestures which are concurrently performed by different users interacting with the multi-touch, multi-player interactive display surface of the intelligent multi-player electronic gaming system.

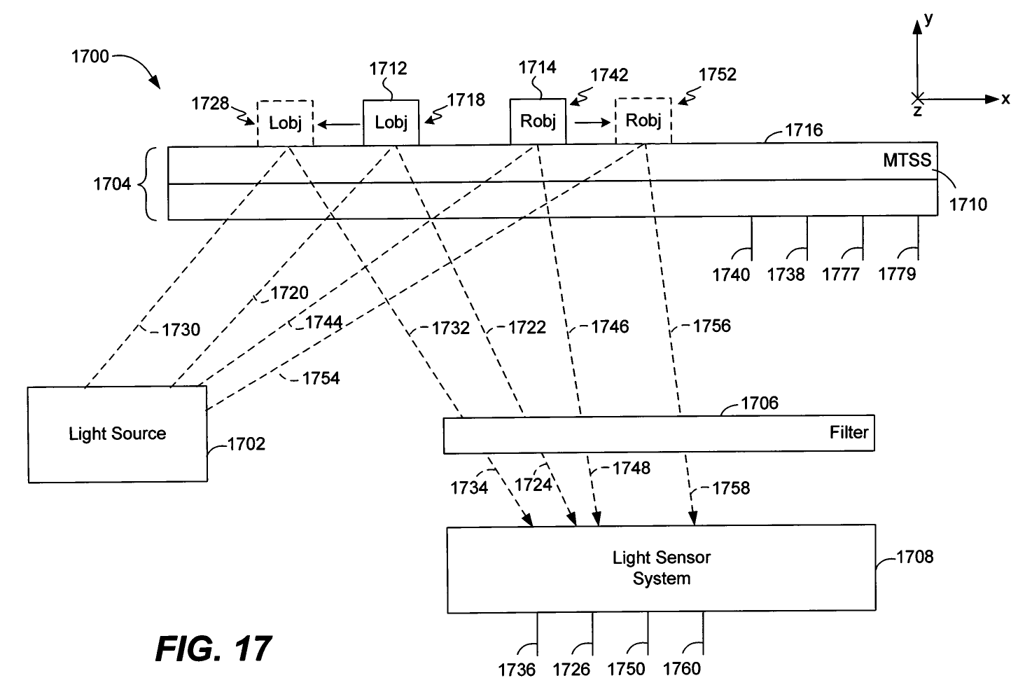

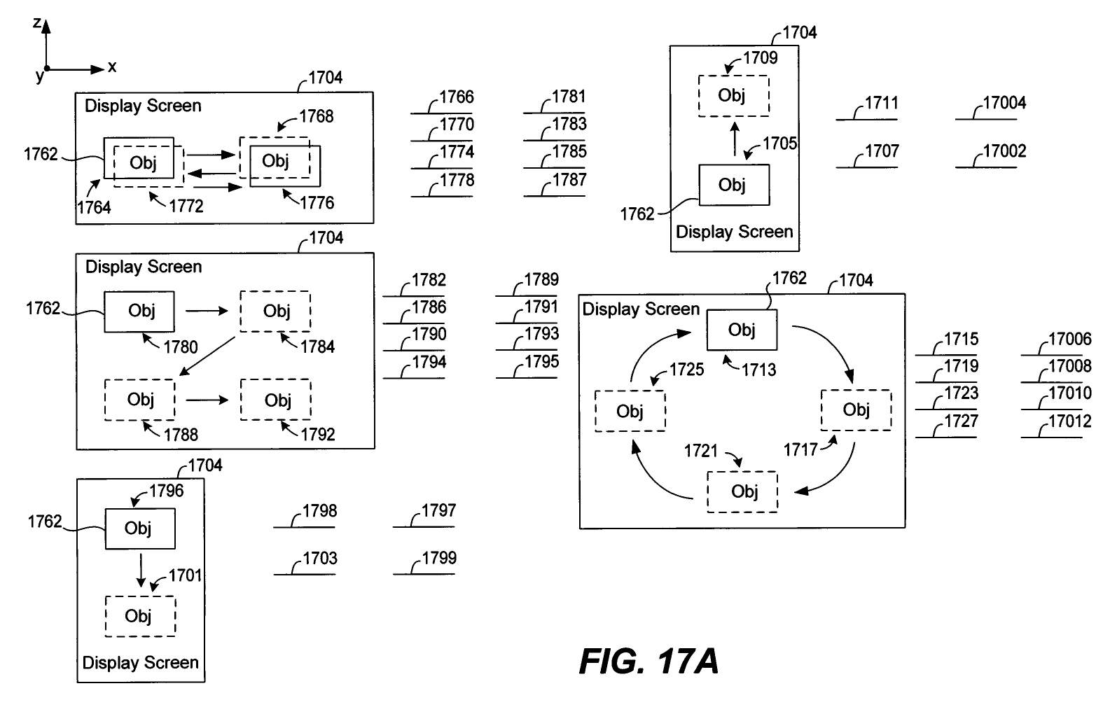

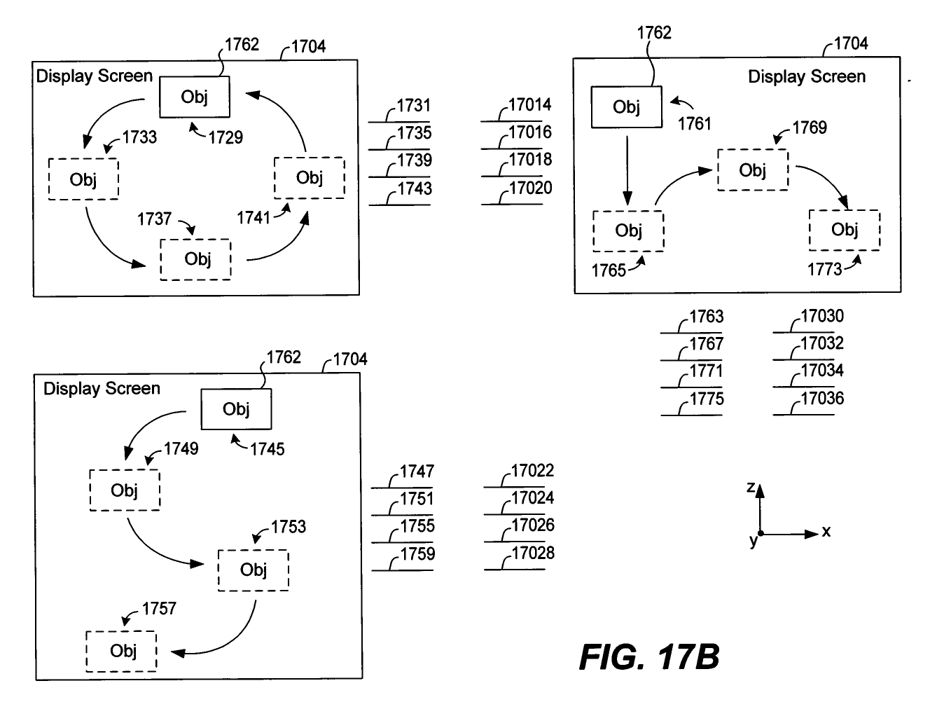

FIG. 17 is a block diagram of an exemplary system 1700 for determining a gesture, FIG. 17A shows an example embodiment of a map between a first set of movements of an object and a set of light sensor and touch sensor signals generated by the first set of movements, and FIG. 17B shows an example embodiment of a map between a second set of movements of the object and a set of light sensor and touch sensor signals generates by the second set of movements. System 1700 includes a light source 1702, a display screen 1704, a filter 1706, a light sensor system 1708, a multi-touch sensor system (MTSS) 1710, a left object (LObj) 1712, and a right object (RObj) 1714.

Light source 1702 may be an infrared light source that generates infrared light or an ambient light source, such as an incandescent light bulb or an incandescent light tube that generates ambient light, or a combination of the infrared light source and the ambient light source. An example of filter 1706 includes an infrared-pass filter than filters light that is not infrared light.

Display screen 1704 is a screen of a gaming table located within a facility, such as a casino, a restaurant, an airport, or a store. Display screen 1704 has a top surface 1716 and displays a video game, which may be a game of chance or a game of skill or a combination of the game of chance and the game of skill. Video game may or may not be a wagering game. Examples of the video game include slots, Blackjack, Poker, Rummy, and Roulette. Poker may be three card Poker, four card Poker, Texas Hold'em™, or Pai Gow Poker.

Multi-touch sensor system 1710 is implemented within display screen 1704. For example, multi-touch sensor system 1710 is located below and is in contact with display screen 1704. An example of multi-touch sensor system 1710 includes one or more touch sensors (not shown) made from either capacitors or resistors.

Light sensor system 1708 includes one or more sensors, such as optical sensors. For example, light sensor system 1708 may be a charge coupled device (CCD) included within a digital video camera (not shown). As another example, light sensor system 1708 includes photodiodes.

Examples of left object 1712 include any finger or a group of fingers of the left hand of a user, such as a game player, a dealer, or an administrator. Examples of right object 1714 include any finger or a group of fingers of the right hand of the user. Another example of left object 1712 includes any portion of the left hand of the user. Another example of right object 1714 includes any portion of the right hand of the user. As another example, left object 1712 is a finger of a hand of the user and right object 1714 is another finger of the same hand of the user. In this example, left object 1712 may be a thumb of the right hand of the user and right object 1714 may be a forefinger of the right hand of the user. As yet another example, left object 1712 is a group of fingers of a hand of the user and right object 1714 may be another group of fingers of the same hand. In this example, left object 1712 may be thumb and forefinger of the left hand of the user and right object 1714 may be the remaining fingers of the left hand.

When left object 1712 is at a first left-object position 1718 on top surface 1716, light source 1702 generates and emits light 1720 that is incident on at least a portion of left object 1712. Left object 1712 may or may not be in contact with top surface 1716 at the first left-object position 1718. At least a portion of left object 1712 reflects light 1720 to output light 1722 and light 1722 passes through display screen 1704 towards filter 1706. Filter 1706 receives light 1722 reflected from left object 1712 and filters the light to output filtered light 1724. If filter 1706 includes an infrared-pass filter 1706, filter 1706 filters a portion of any light passing through filter 1706 other than infrared light such that only the infrared light passes through filter 1706. Light sensor system 1708 senses filtered light 1724 output from filter 1706 and converts the light into a left-object-first-position-light-sensor-output signal 1726, which is an electrical signal. Light sensor system 1708 converts an optical signal, such as light, into an electrical signal.

During game play, the user may move left object 1712 across upper top surface 1716 from first left-object position 1718 to a second left-object position 1728. Left object 1712 may not or may not be in contact with top surface 1716 at the second left-object position 1728. When left object 1712 is moved across top surface 1716, from one position to another, the left object 1712 may or may not contact top surface 1716 for at least some time as the left object 1712 is moved. Moreover, when left object 1712 is placed at the second left-object position 1728, light source 1702 generates and emits light 1730 that is incident on left object 1712. At least a portion of left object 1712 reflects light 1730 to output light 1732 and light 1732 passes through display screen 1704 towards filter 1706. Filter 1706 filters a portion of light 1732 and outputs filtered light 1734. Light sensor system 1708 senses the filtered light 1734 output by filter 1706 and outputs a left-object-second-position-light-sensor-output signal 1736, which is an electrical signal.

Left object 1712 may be moved on top surface 1716 in any of an x-direction parallel to the x axis, a y-direction parallel to the y axis, a z-direction parallel to the z axis, and a combination of the x, y, and z directions. For example, in another embodiment, second left-object position 1728 is displaced in the y-direction with respect to the first left-object position 1718. As another example, second left-object position 1728 is displaced in a combination of the y and z directions with respect to the first left-object position 1718.

Multi-touch sensor system 1710 senses contact, such as a touch, of left object 1712 with top surface 1716 at first left-object position 1718 to output a left-object-first-position-touch-sensor-output signal 1738. Moreover, multi-touch sensor system 1710 senses contact, such as a touch, of left object 1712 with top surface 1716 at second left-object position 1728 to output a left-object-second-position-touch-sensor-output signal 1740.

When right object 1714 is at a first right-object position 1742 on top surface 1716, light source 1702 generates and emits light 1744 that is incident on at least a portion of right object 1714. Right object 1714 may or may not be in contact with top surface 1716 at the first right-object position 1742. At least a portion of right object 1714 reflects light 1744 to output light 1746 and light 1746 passes through display screen 1704 towards filter 1706. Filter 1706 receives light 1746 reflected from right object 1714 and filters the light to output filtered light 1748. Light sensor system 1708 senses filtered light 1748 output from filter 1706 and converts the light into a right-object-first-position-light-sensor-output signal 1750, which is an electrical signal.

During game play, the user may move right object 1714 across upper top surface 1716 from first right-object position 1742 to a second right-object position 1752. Right object 1714 may not or may not be in contact with top surface 1716 at the second right-object position 1752. When right object 1714 is moved across top surface 1716, from one position to another, the right object 1714 may or may not contact top surface 1716 for at least some time as the right object 1714 is moved. Moreover, when right object 1714 is placed at the second right-object position 1752, light source 1702 generates and emits light 1754 that is incident on right object 1714. At least a portion of right object 1714 reflects light 1754 to output light 1756 and light 1756 passes through display screen 1704 towards filter 1706. Filter 1706 filters a portion of light 1756 and outputs filtered light 1758. Light sensor system 1708 senses the filtered light 1758 output by filter 1706 and outputs a right-object-second-position-light-sensor-output signal 1760.

Similarly, as shown in FIG. 17A, when an object 1762 is placed at a first left position 1764 on display screen 1704, light sensor system 1708 (shown in FIG. 17) outputs a signal 1766. Object 1762 may be left object 1712 (shown in FIG. 17) or right object 1714 (shown in FIG. 17). Object 1762 moves from first left position 1764 to a first right position 1768 on display screen 1704. When object 1762 is placed at first right position 1768 on display screen 1704, light sensor system 1708 (shown in FIG. 17) outputs a signal 1770. Object 1762 further moves from first right position 1768 to a second left position 1772 on display screen 1704. When object 1762 is placed at second left position 1772 on display screen 1704, light sensor system 1708 (shown in FIG. 17) outputs a signal 1774. Object 1762 further moves from second left position 1772 to a second right position 1776 on display screen 1704. When object 1762 is placed at second right position 1776 on display screen 1704, light sensor system 1708 (shown in FIG. 17) outputs a signal 1778. Positions 1764, 1768, 1772, and 1776 lie within the same plane.

Moreover, when object 1762 is placed at a top left position 1780 on display screen 1704, light sensor system 1708 (shown in FIG. 17) outputs a signal 1782. Object 1762 moves from top left position 1780 to a top right position 1784 on display screen 1704. When object 1762 is placed at top right position 1784 on display screen 1704, light sensor system 1708 (shown in FIG. 17) outputs a signal 1786. Object 1762 further moves from top right position 1784 to a bottom left position 1788 on display screen 1704. When object 1762 is placed at bottom left position 1788 on display screen 1704, light sensor system 1708 (shown in FIG. 17) outputs a signal 1790. Object 1762 further moves from bottom left position 1788 to a bottom right position 1792 on display screen 1704. When object 1762 is placed at bottom right position 1792 on display screen 1704, light sensor system 1708 (shown in FIG. 17) outputs a signal 1794.

Additionally, when object 1762 is placed at a top position 1796 on display screen 1704, light sensor system 1708 (shown in FIG. 17) outputs a signal 1798. Object 1762 moves from top position 1796 to a bottom position 1701 on display screen 1704. When object 1762 is placed at bottom position 1701 on display screen 1704, light sensor system 1708 (shown in FIG. 17) outputs a signal 1703.

Furthermore, when object 1762 is placed at a bottom position 1705 on display screen 1704, light sensor system 1708 (shown in FIG. 17) outputs a signal 1707. Object 1762 moves from bottom position 1705 to a top position 1709 on display screen 1704. When object 1762 is placed at top position 1709 on display screen 1704, light sensor system 1708 (shown in FIG. 17) outputs a signal 1711.

Moreover, when object 1762 is placed at a top position 1713 on display screen 1704, light sensor system 1708 (shown in FIG. 17) outputs a signal 1715. Object 1762 moves from top position 1713 to a right position 1717 on display screen 1704. When object 1762 is placed at right position 1717 on display screen 1704, light sensor system 1708 outputs a signal 1719. Object 1762 further moves from right position 1717 to a bottom position 1721 on display screen 1704. When object 1762 is placed at bottom position 1721 on display screen 1704, light sensor system 1708 (shown in FIG. 17) outputs a signal 1723. Object 1762 further moves from bottom position 1721 to a left position 1725 on display screen 1704. When object 1762 is placed at left position 1725 on display screen 1704, light sensor system 1708 (shown in FIG. 17) outputs a signal 1727. Object 1762 further moves from left position back to top position 1713 on display screen 1704 and signal 1715 is generated again.

Similarly, as shown in FIG. 17B, when object 1762 is placed at a top position 1729 on display screen 1704, light sensor system 1708 (shown in FIG. 17) outputs a signal 1731. Object 1762 moves from top position 1729 to a left position 1733 on display screen 1704. When object 1762 is placed at left position 1733 on display screen 1704, light sensor system 1708 (shown in FIG. 17) outputs a signal 1735. Object 1762 further moves from left position 1733 to a bottom position 1737 on display screen 1704. When object 1762 is placed at bottom position 1737 on display screen 1704, light sensor system 1708 (shown in FIG. 17) outputs a signal 1739. Object 1762 further moves from bottom position 1737 to a right position 1741 on display screen 1704. When object 1762 is placed at right position 1741 on display screen 1704, light sensor system 1708 (shown in FIG. 17) outputs a signal 1743. Object 1762 further moves from right position 1743 back to top position 1729 on display screen 1704 and signal 1731 is generated again.

Moreover, when object 1762 is placed at a top position 1745 on display screen 1704, light sensor system 1708 (shown in FIG. 17) outputs a signal 1747. Object 1762 moves from top position 1745 to a first lower position 1749 on display screen 1704. When object 1762 is placed at first lower position 1749 on display screen 1704, light sensor system 1708 (shown in FIG. 17) outputs a signal 1751. Object 1762 further moves from first lower position 1749 to a second lower position 1753 on display screen 1704. When object 1762 is placed at second lower position 1753 on display screen 1704, light sensor system 1708 (shown in FIG. 17) outputs a signal 1755. Object 1762 further moves from second lower position 1755 to a bottom position 1757 on display screen 1704. When object 1762 is placed at bottom position 1757 on display screen 1704, light sensor system 1708 (shown in FIG. 17) outputs a signal 1759.

Furthermore, when object 1762 is placed at a top position 1761 on display screen 1704, light sensor system 1708 (shown in FIG. 17) outputs a signal 1763. Object 1762 moves from top position 1761 to a bottom left position 1765 on display screen 1704. When object 1762 is placed at bottom left position 1765 on display screen 1704, light sensor system 1708 (shown in FIG. 17) outputs a signal 1767. Object 1762 further moves from bottom left position 1765 to a middle position 1769 on display screen 1704. When object 1762 is placed at middle position 1769 on display screen 1704, light sensor system 1708 (shown in FIG. 17) outputs a signal 1771. Object 1762 further moves from middle position 1769 to a bottom right position 1771 on display screen 1704. When object 1762 is placed at bottom right position 1771 on display screen 1704, light sensor system 1708 (shown in FIG. 17) outputs a signal 1773.

Referring back to FIG. 17, right object 1714 can move on top surface 1716 in any of the x direction, the y direction, the z direction, and a combination of the x, y, and z directions. For example, in another embodiment, second right-object position 1752 is displaced in the z-direction with respect to first right-object position 1742. As another example, second right-object position 1752 is displaced in a combination of the y and z directions with respect to the first right-object position 1742.

Multi-touch sensor system 1710 senses contact, such as a touch, of right object 1714 with top surface 1716 at first right-object position 1742 to output a right-object-first-position-touch-sensor-output signal 1777. Moreover, multi-touch sensor system 1710 senses contact, such as a touch, of right object 1714 with top surface 1716 at second right-object position 1752 to output a right-object-second-position-touch-sensor-output signal 1779.

Similarly, as shown in FIG. 17A, when object 1762 is placed at first left position 1764 on display screen 1704, multi-touch sensor system 1710 (shown in FIG. 17) outputs a signal 1781. Object 1762 moves from first left position 1764 to a first right position 1768 on display screen 1704. When object 1762 is placed at first right position 1768 on display screen 1704, multi-touch sensor system 1710 (shown in FIG. 17) outputs a signal 1783. Object 1762 further moves from first right position 1768 to a second left position 1772 on display screen 1704. When object 1762 is placed at second left position 1772 on display screen 1704, multi-touch sensor system 1710 (shown in FIG. 17) outputs a signal 17852. Object 1762 further moves from second left position 1772 to a second right position 1776 on display screen 1704. When object 1762 is placed at second right position 1776 on display screen 1704, multi-touch sensor system 1710 (shown in FIG. 17) outputs a signal 1787.

Moreover, when object 1762 is placed at a first top left position 1780 on display screen 1704, multi-touch sensor system 1710 (shown in FIG. 17) outputs a signal 1789. Object 1762 moves from first top left position 1780 to a first top right position 1784 on display screen 1704. When object 1762 is placed at first top right position 1784 on display screen 1704, multi-touch sensor system 1710 (shown in FIG. 17) outputs a signal 1791. Object 1762 further moves from first top right position 1784 to a first bottom left position 1788 on display screen 1704. When object 1762 is placed at first bottom left position 1788 on display screen 1704, multi-touch sensor system 1710 (shown in FIG. 17) outputs a signal 1793. Object 1762 further moves from first bottom left position 1788 to a second bottom right position 1792 on display screen 1704. When object 1762 is placed at second bottom right position 1792 on display screen 1704, multi-touch sensor system 1710 (shown in FIG. 17) outputs a signal 1795.

Additionally, when object 1762 is placed at top position 1796 on display screen 1704, multi-touch sensor system 1710 (shown in FIG. 17) outputs a signal 1797. Object 1762 moves from top position 1796 to bottom position 1701 on display screen 1704. When object 1762 is placed at bottom position 1701 on display screen 1704, multi-touch sensor system 1710 (shown in FIG. 17) outputs a signal 1799.

Furthermore, when object 1762 is placed at a bottom position 1705 on display screen 1704, multi-touch sensor system 1710 (shown in FIG. 17) outputs a signal 17002. Object 1762 moves from bottom position 1705 to top position 1709 on display screen 1704. When object 1762 is placed at top position 1709 on display screen 1704, multi-touch sensor system 1710 (shown in FIG. 17) outputs a signal 17004.

Moreover, when object 1762 is placed at top position 1713 on display screen 1704, multi-touch sensor system 1710 (shown in FIG. 17) outputs a signal 17006. Object 1762 moves from top position 1713 to right position 1717 on display screen 1704. When object 1762 is placed at right position 1717 on display screen 1704, multi-touch sensor system 1710 (shown in FIG. 17) outputs a signal 17008. Object 1762 further moves from right position 1717 to bottom position 1721 on display screen 1704. When object 1762 is placed at bottom position 1721 on display screen 1704, multi-touch sensor system 1710 (shown in FIG. 17) outputs a signal 17010. Object 1762 further moves from bottom position 17010 to left position 1725 on display screen 1704. When object 1762 is placed at left position 1725 on display screen 1704, multi-touch sensor system 1710 (shown in FIG. 17) outputs a signal 17012. Object 1762 further moves from left position 1725 back to top position 1762 on display screen 1704 to again generate signal 17006.

Similarly, as shown in FIG. 17B, when object 1762 is placed at top position 1729 on display screen 1704, multi-touch sensor system 1710 (shown in FIG. 17) outputs a signal 17014. Object 1762 moves from top position 1729 to middle left position 1733 on display screen 1704. When object 1762 is placed at left position 1733 on display screen 1704, multi-touch sensor system 1710 (shown in FIG. 17) outputs a signal 17016. Object 1762 further moves from left position 1733 to a bottom position 1737 on display screen 1704. When object 1762 is placed at bottom position 1737 on display screen 1704, multi-touch sensor system 1710 (shown in FIG. 17) outputs a signal 17018. Object 1762 further moves from bottom position 1737 to right position 1741 on display screen 1704. When object 1762 is placed at right position 1741 on display screen 1704, multi-touch sensor system 1710 (shown in FIG. 17) outputs a signal 17020. Object 1762 further moves from right position 1741 back to top position 1762 on display screen 1704 to again generate signal 17014.

Moreover, when object 1762 is placed at top position 1745 on display screen 1704, multi-touch sensor system 1710 (shown in FIG. 17) outputs a signal 17022. Object 1762 moves from top position 1745 to first lower position 1749 on display screen 1704. When object 1762 is placed at first lower position 1749 on display screen 1704, multi-touch sensor system 1710 (shown in FIG. 17) outputs a signal 17024. Object 1762 further moves from first lower position 1749 to a second lower position 1753 on display screen 1704. When object 1762 is placed at second lower position 1753 on display screen 1704, multi-touch sensor system 1710 (shown in FIG. 17) outputs a signal 17026. Object 1762 further moves from second lower position 1753 to a bottom position 1757 on display screen 1704. When object 1762 is placed at bottom position 1757 on display screen 1704, multi-touch sensor system 1710 (shown in FIG. 17) outputs a signal 17028.

Furthermore, when object 1762 is placed at top position 1762 on display screen 1704, multi-touch sensor system 1710 (shown in FIG. 17) outputs a signal 17030. Object 1762 moves from top position 1762 to bottom left position 1765 on display screen 1704. When object 1762 is placed at bottom left position 1765 on display screen 1704, multi-touch sensor system 1710 (shown in FIG. 17) outputs a signal 17032. Object 1762 further moves from bottom left position 1765 to middle position 1769 on display screen 1704. When object 1762 is placed at middle position 1769 on display screen 1704, multi-touch sensor system 1710 (shown in FIG. 17) outputs a signal 17034. Object 1762 further moves from middle position 1769 to bottom right position 1773 on display screen 1704. When object 1762 is placed at bottom right position 1773 on display screen 1704, multi-touch sensor system 1710 (shown in FIG. 17) outputs a signal 17036.

Referring back to FIG. 17, a position of any of left and right objects 1712 and 1714 is determined with respect to an origin of an xyz coordinate system formed by the x, y, and z axes. The origin may be located at a vertex of display screen 1704 or at a point within display screen 1704, such as the centroid of display screen 1704.

In another embodiment, system 1700 does not include at least one of filter 1706 and multi-touch sensor system 1710. In still another embodiment, multi-touch sensor system 1710 is located outside and on top surface 1716. For example, multi-touch sensor system 1710 is coated on top surface 1716. In still another embodiment, light source 1702 is located at another position relative to display screen 1704. For example, light source 1702 is located above top surface 1716. In another embodiment, filter 1706 and light sensor system 1708 are located at another position relative to display screen 1704. For example, filter 1706 and light sensor system 1708 are located above display screen 1704. In another embodiment, system 1700 includes more or less than two object positions for each object 1712 and 1714. For example, the user moves left object 1712 from second left-object 1728 position to a third left-object position. As another example, the user retains left object 1712 at first left-object 1718 position and does not move left object 1712 from the first-left position to second-left position.

In yet another embodiment, left object 1712 includes any finger, a group of fingers, or a portion of a hand of a first user and the right object 1714 includes any finger, a group of fingers, or a portion of a hand of a second user. As an example, left object 1712 is a forefinger of the right hand of the first user and right object 1714 is a forefinger of the right hand of the second user.

In another embodiment, signals 1726, 1736, 1750, and 1760, and signals 1766, 1770, 1774, 1778, 1782, 1786, 1794, 1798, 1703, 1711, 1707, 1715, 1719, 1723, and 1727 (shown in FIG. 17A), and signals 1731, 1735, 1739, 1743, 1747, 1751, 1755, 1759, 1763, 1767, 1771, and 1775 (shown in FIG. 17B) are generated when object 1762 moves on top of an upper surface, described below, of a physical device, described below, from and to the same positions described in FIGS. 17, 17A, and 17B. For example, signal 1766 (shown in FIG. 17A) is generated when object 1762 is at first left position 1764 (shown in FIG. 17A) on top of the upper surface of the physical device. As another example, signal 1770 is generated when object 1762 is at first right position 1768 (shown in FIG. 17A) on top of the upper surface of the physical device. In another embodiment, system does not include left object 1712 or right object 1714.

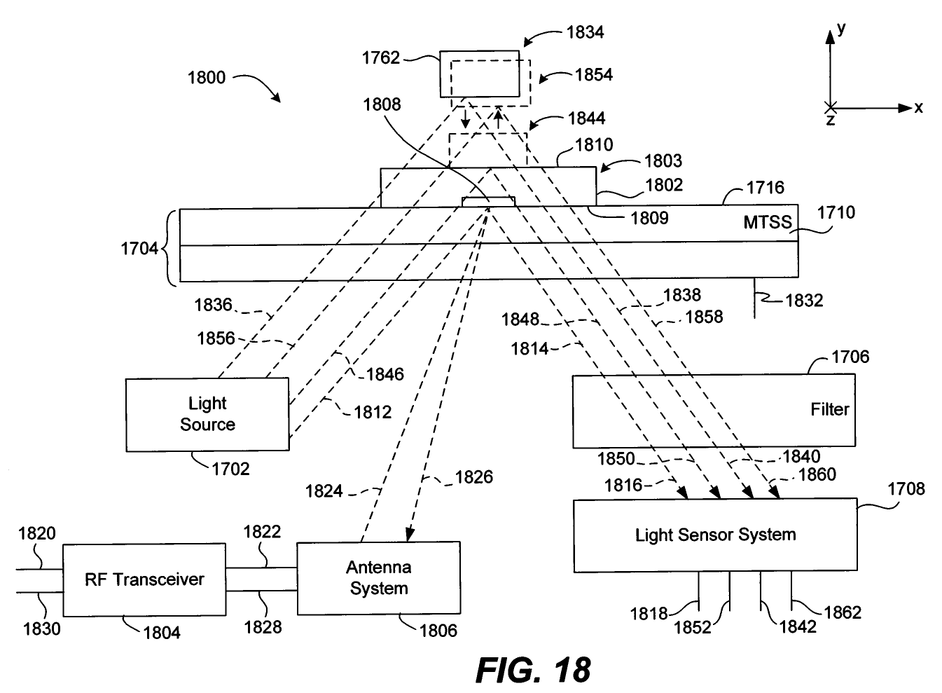

FIG. 18 is a block diagram of another embodiment of a system 1800 for determining a gesture. System 1800 includes a physical device (PD) 1802 at a physical device position 1803 with reference to the origin. System 1800 further includes multi-touch sensor system 1710, light source 1702, a radio frequency (RF) transceiver 1804, an antenna system 1806, filter 1706, and light sensor system 1708. System 1800 also includes identification indicia 1808. Physical device 1802 is in contact with top surface 1716. Physical device 1802 has an upper surface 1810. An example of physical device 1802 includes a game token that provides a credit to the user towards playing the video game. Another example of physical device 1802 includes a card, such as a transparent, translucent, or opaque card. The card may be a player tracking card, a credit card, or a debit card.

Antenna system 1806 includes a set of antennas, such as an x-antenna that is parallel to the x axis, a y-antenna parallel to the y axis, and a z-antenna parallel to the z axis. RF transceiver 1804 includes an RF transmitter (not shown) and an RF receiver (not shown).

Identification indicia 1808 may be a barcode, a radio frequency identification (RFID) mark, a matrix code, or a radial code. Identification indicia 1808 uniquely identifies physical device 1802, which is attached to identification indicia 1808. For example, identification indicia 1808 includes encoded bits that have an identification value that is different than an identification value of identification indicia attached to another physical device (not shown). Moreover, identification indicia 1808 is attached to and extends over at least a portion of a bottom surface 1809 of physical device 1802. For example, in one embodiment, identification indicia 1808 is embedded within a laminate and the laminate is glued to bottom surface 1809. As another example, identification indicia 1808 is embedded within bottom surface 1809. Identification indicia 1808 reflects light that is incident on identification indicia 1808.

When physical device 1802 is at physical device position 1803, light source 1702 generates and emits light 1812 that is incident on at least a portion of physical device 1802 and/or on identification indicia 1808. At least a portion of physical device 1802 and/or identification indicia 1808 reflects light 1814 towards filter 1706 to output reflected light 1814. Filter 1706 receives reflected light 1814 from identification indicia 1808 and/or at least a portion of physical device 1802 via display screen 1704 and filters the light to output filtered light 1816. Light sensor system 1708 senses, such as detects, filtered light 1816 output from filter 1706 and converts the light into a physical-device-light-sensor-output signal 1818.

Further, when physical device 1802 is at physical device position 1803, the RF transmitter of RF transceiver 1804 receives an RF-transmitter-input signal 1820 and modulates the RF-transmitter-input signal into an RF-transmitter-output signal 1822, which is an RF signal. Antenna system 1806 receives RF-transmitter-output signal 1822 from the RF transmitter, converts the RF-transmitter-output signal 1822 into a wireless RF signal and outputs the wireless RF signal as a wireless output signal 1824. Identification indicia 1808 receives wireless output signal 1824 and responds to the signal with an output signal 1826, which is an RF signal. Antenna system 1806 receives output signal 1826 from identification indicia 1808 and converts the signal into a wired RF signal that is output as a wired output signal 1828 to the RF receiver of RF transceiver 1804. The RF receiver receives wired output signal 1828 and demodulates the signal to output a set 1830 of RF-receiver-output signals. Moreover, multi-touch sensor system 1710 senses contact, such as a touch, of physical device 1802 with top surface 1716 at physical device position 1803 to output a physical-device-touch-sensor-output signal 1832.

When object 1762 is at a first object top position 1834 on upper surface 1810, light source 1702 generates and emits light 1836 that is incident on at least a portion of object 1762. Object 1762 is not in contact with upper surface 1810 at the first object top position 1834. At least a portion of object 1762 reflects light 1836 that passes through display screen 1704 towards filter 1706 to output light 1838. Filter 1706 receives light 1838 reflected from object 1762 and filters the light to output filtered light 1840. Light sensor system 1708 senses filtered light 1840 output from filter 1706 and converts the light into an object-first-top-position-light-sensor-output signal 1842, i.e., an electrical signal.

During game play, the user may move object 1762 on upper surface 1810 from first object top position 1834 to an object bottom position 1844. Object 1762 may or may not be in contact with upper surface 1810 at bottom position 1844. Moreover, when object 1762 is placed at object bottom position 1844, light source 1702 generates and emits light 1846 that is incident on object 1762. At least a portion of object 1762 reflects light 1846 that passes through display screen 1704 towards filter 1706 to output light 1848. Filter 1706 filters a portion of light 1848 and outputs filtered light 1850. Light sensor system 1708 senses the filtered light 1850 output by filter 1706 and outputs an object-bottom-position-light-sensor-output signal 1852.

Further, during game play, the user may further move object 1762 on upper surface 1810 from object bottom position 1844 to a second object top position 1854. Object 1762 is not in contact with upper surface 1810 at the second object top position 1854. When object 1762 is placed at the second object top position 1854, light source 1702 generates and emits light 1856 that is incident on object 1762. At least a portion of object 1762 reflects light 1856 that passes through display screen 1704 towards filter 1706 to output light 1858. Filter 1706 filters a portion of light 1858 and outputs filtered light 1860. Light sensor system 1708 senses the filtered light 1860 output by filter 1706 and outputs an object-second-top-position-light-sensor-output signal 1862.

In another embodiment object 1762 may be moved on upper surface 1810 in any of the x-direction, the y-direction, the z-direction, and a combination of the x, y, and z directions. For example, first object top position 1834 is displaced in the x-direction with respect to the object bottom position 1844 and object 1762 may or may not be in contact with upper surface 1810 at the first object top position 1834. As another example, first object top position 1834 is displaced in a combination of the y and z directions with respect to the object bottom position 1844.

In another embodiment, system 1800 includes more or less than three object positions for each object 1762. For example, the user moves object 1762 from the second object top position 1854 to a third object top position. As another example, the user does not move object 1762 from object bottom position 1844 to second object top position 1854. In yet another embodiment, system 1800 does not include RF transceiver 1804 and antenna system 1806. In still another embodiment of system 1800 that does not include physical device 1802, signals 1842, 1852, and 1862 are generated as object 1762 moves directly on top surface 1716 instead of on upper surface 1810. For example, signal 1842 is generated when object 1762 is at a first top position directly on top surface 1716. As another example, signal 1852 is generated when object 1762 is at a bottom position directly on top surface 1716. In another embodiment, system 1800 does not include identification indicia 1808.

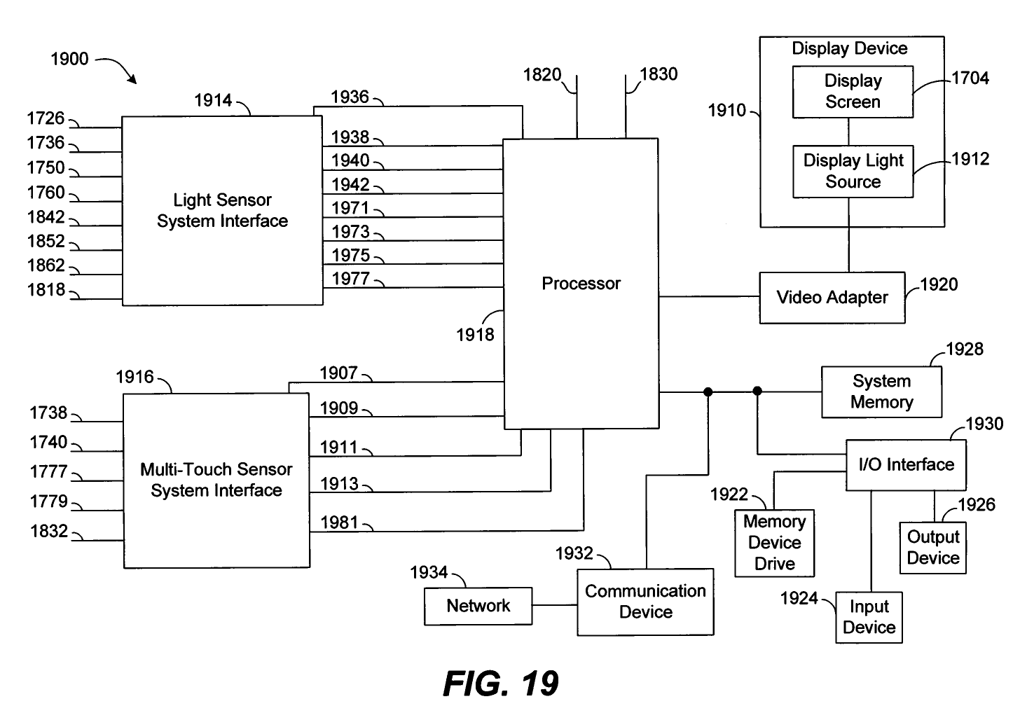

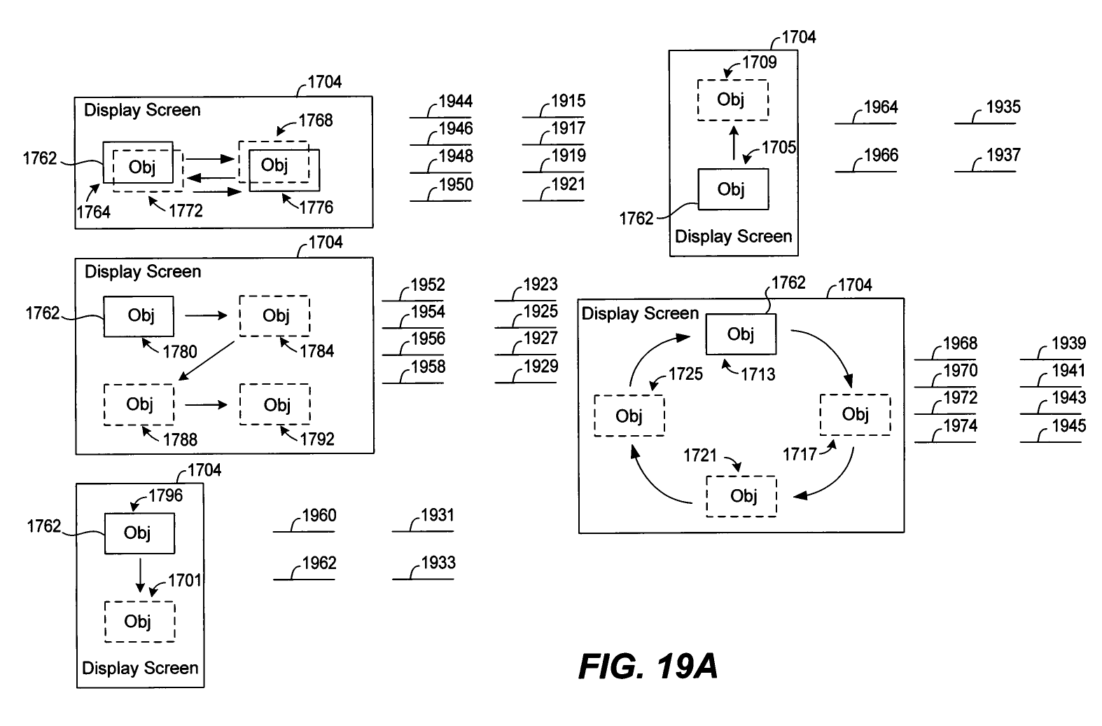

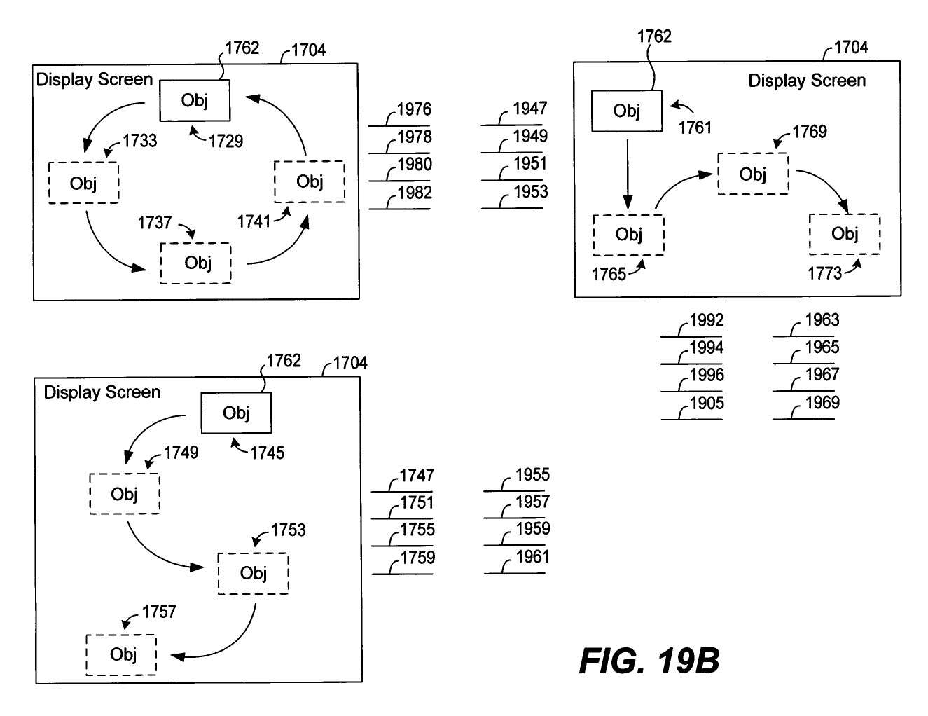

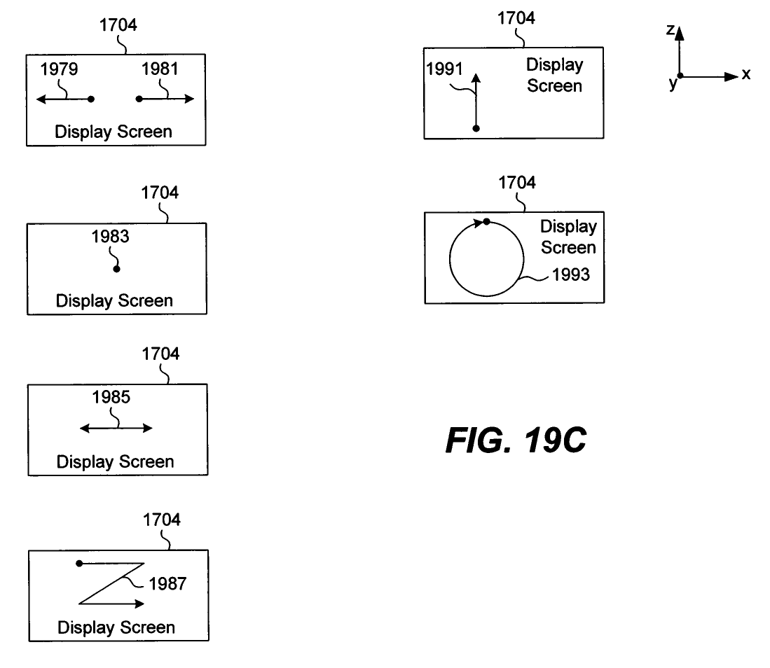

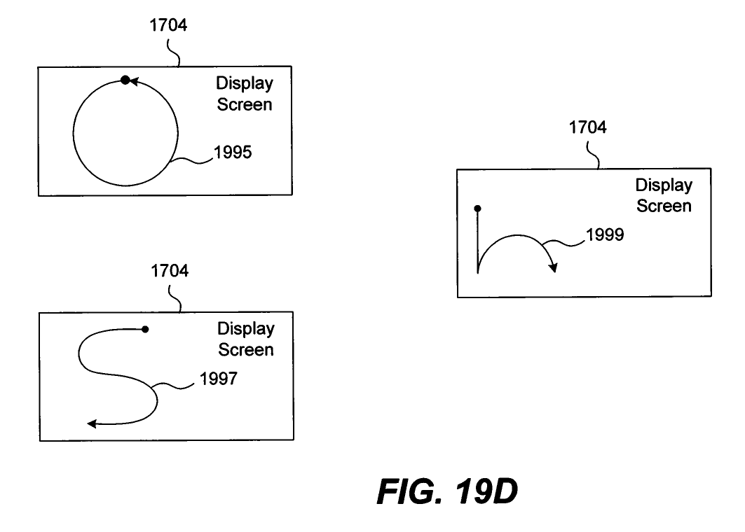

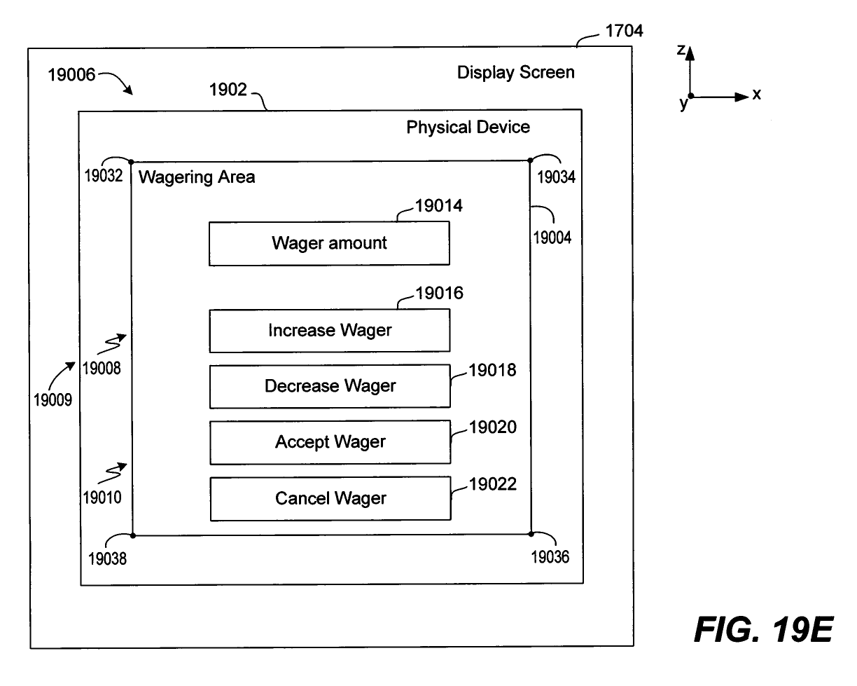

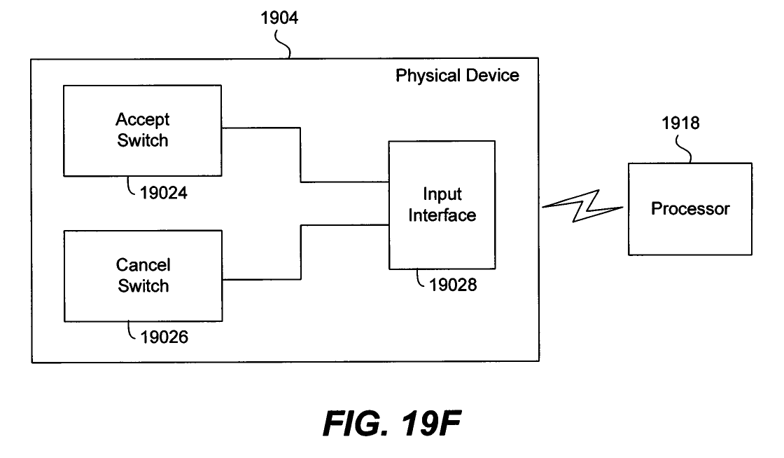

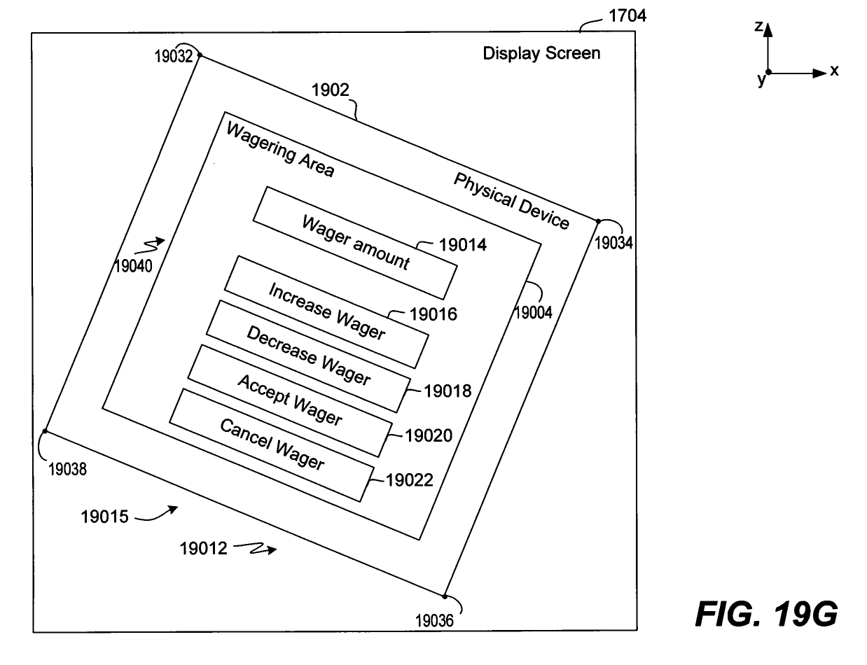

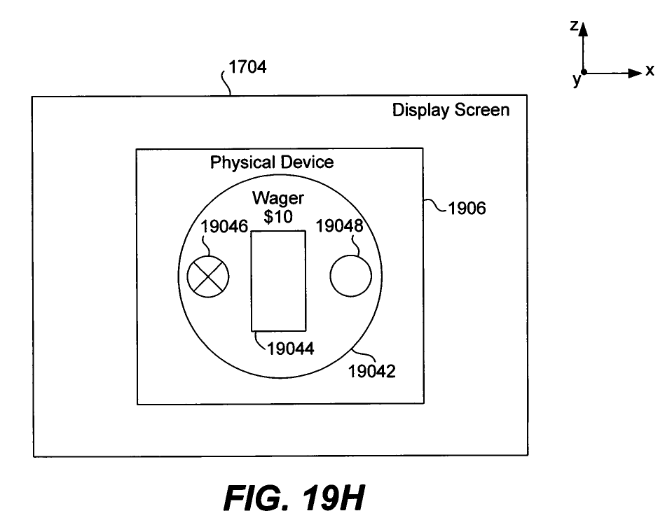

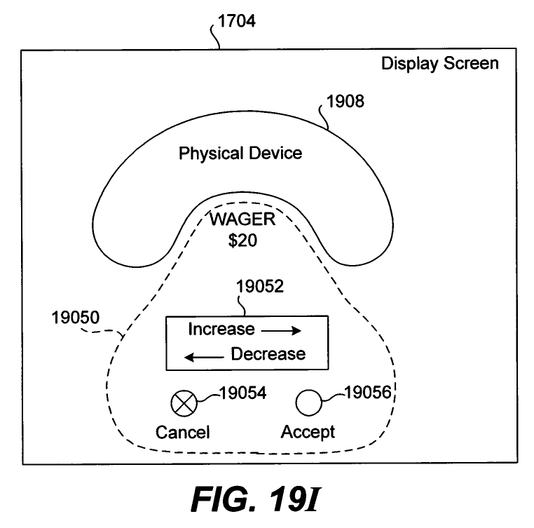

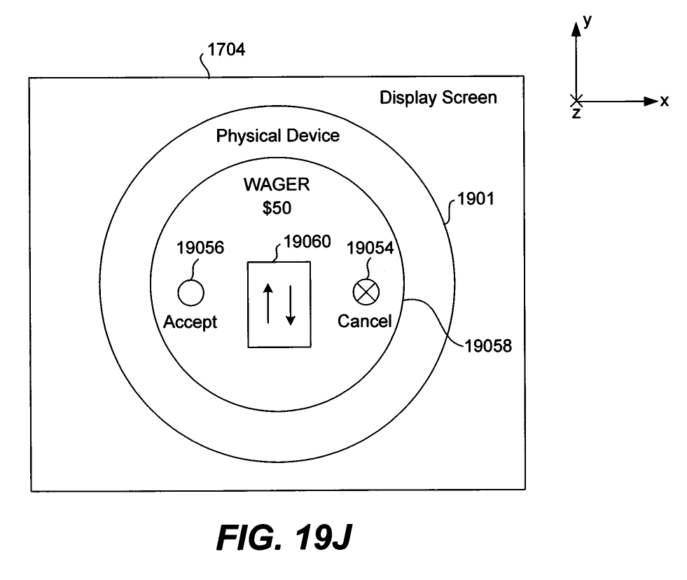

FIG. 19 is a block diagram of an example embodiment of a system 1900 for determining a gesture. FIG. 19A shows an example embodiment of a map between the first set of movements of object 1762 and a set of light sensor interface signals and touch sensor interface signals generated by the first set of movements, and FIG. 19B shows an example embodiment of a map between the second set of movements of object 1762 and a set of light sensor interface signals and touch sensor interface signals generates by the second set of movements. FIG. 19C shows an example embodiment of a plurality of images displayed on display screen 1704 based on various movements of object 1762 and FIG. 19D shows an example embodiment of a plurality of images displayed on display screen 1704 based on another variety of movements of object 1762. FIG. 19E shows an example embodiment of a physical device 1902 placed on display screen 1704 and FIG. 19F shows another embodiment of a physical device 1904. FIG. 19G shows physical device 1902 shown in FIG. 19E with a different orientation than that shown in FIG. 19E. FIG. 19H shows another embodiment of a physical device 1906, FIG. 19I shows yet another embodiment of a physical device 1908, and FIG. 19J shows yet another embodiment of a physical device 1901. System 1900 includes a display device 1910, which further includes a display light source 1912 and display screen 1704. System 1900 further includes a light sensor system interface 1914, a multi-touch sensor system interface 1916, a processor 1918, a video adapter 1920, a memory device drive 1922, an input device 1924, an output device 1926, a system memory 1928, an input/output (I/O) interface 1930, a communication device 1932, and a network 1934.

As used herein, the term processor is not limited to just those integrated circuits referred to in the art as a processor, but broadly refers to a microcontroller, a microcomputer, a programmable logic controller, an application specific integrated circuit, and any other programmable circuit. Video adapter 1920 is a video graphics array. System memory 1928 includes a random access memory (RAM) and a read-only memory (ROM). System memory 1928 includes a basic input/output (BIOS) system, which is a routine that enables transfer of information between processor 1918, video adapter 1920, input/output interface 1930, memory device drive 1922, and communication device 1932 during start up of the processor 1918. System memory 1928 further includes an operating system, an application program, such as the video game, a word processor program, or a graphics program, and other data.

Input device 1924 may be a game pedal, a mouse, a joystick, a keyboard, a scanner, or a stylus. Examples of output device 1926 include a display device, such as a cathode ray tube (CRT) display device, a liquid crystal display (LCD) device, an organic light emitting diode (OLED) display device, a light emitting diode (LED) display device, and a plasma display device. Input/output interface 1930 may be a serial port, a parallel port, a video adapter, or a universal serial bus (USB). Communication device 1932 may be a modem or a network interface card (NIC) that allows processor 1918 to communicate with network 1934. Examples of network 1934 include a wide area network 1934 (WAN), such as the Internet, or a local area network 1934 (LAN), such as an Intranet.

Memory device drive 1922 may be a magnetic disk drive or an optical disk drive. Memory device drive 1922 includes a memory device, such as an optical disk, which may be a compact disc (CD) or a digital video disc (DVD). Other examples of the memory device include a magnetic disk. The application program may be stored in the memory device. Each of the memory device and system memory 1928 is a computer-readable medium that is readable by processor 1918.

Display device 1910 may be a CRT display device, an LCD device, an OLED display device, an LED display device, a plasma display device, or a projector system including a projector. Examples of display light source 1912 include a set of LEDs, a set of OLEDs, an incandescent light bulb, and an incandescent light tube. Display screen 1704 may be a projector screen, a plasma screen, an LCD screen, an acrylic screen, or a cloth screen.

Light sensor system interface 1914 includes a digital camera interface, a filter, an amplifier, and/or an analog-to-digital (A/D) converter. Multi-touch sensor system interface 1916 includes a comparator having a comparator input terminal that is connected to a threshold voltage. Multi-touch sensor system interface 1916 may include a filter, an amplifier, and/or an analog-to-digital (A/D) converter.

Light sensor system interface 1914 receives left-object-first-position-light-sensor-output signal 1726 (shown in FIG. 17) from light sensor system 1708 (shown in FIG. 17), may amplify the signal, may filter the signal, and may convert the signal from an analog format to a digital format to output a left-object-first-position-light-sensor-interface-output signal 1936. Light sensor system interface 1914 performs a similar operation on left-object-second-position-light-sensor-output signal 1736 (shown in FIG. 17) as that performed on left-object-first-position-light-sensor-output signal 1726. For example, light sensor system interface 1914 receives left-object-second-position-light-sensor-output signal 1736 from light sensor system 1708 (shown in FIG. 17), may amplify the signal, may filter the signal, and may convert the signal from an analog format to a digital format to output a left-object-second-position-light-sensor-interface-output signal 1938.

Light sensor system interface 1914 receives right-object-first-position-light-sensor-output signal 1750 from light sensor system 1708, may amplify the signal, may filter the signal, and may convert the signal from an analog format to a digital format to output a right-object-first-position-light-sensor-interface-output signal 1940. Light sensor system interface 1914 performs a similar operation on right-object-second-position-light-sensor-output signal 1760 as that performed on right-object-first-position-light-sensor-output signal 1750. For example, light sensor system interface 1914 receives right-object-second-position-light-sensor-output signal 1760 from light sensor system 1708, may amplify the signal, may filter the signal, and may convert the signal from an analog format to a digital format to output a right-object-second-position-light-sensor-interface-output signal 1942.

Referring to FIG. 19A, light sensor system interface 1914 (shown in FIG. 19) performs similar operations on signals 1766, 1770, 1774, 1778, 1782, 1786, 1790, 1794, 1798, 1703, 1711, 1707, 1715, 1719, 1723, and 1727 (shown in FIG. 17A) to output a plurality of respective signals 1944, 1946, 1948, 1950, 1952, 1954, 1956, 1958, 1960, 1962, 1964, 1966, 1968, 1970, 1972, and 1974. For example, light sensor system interface 1914 (shown in FIG. 19) receives signal 1766 (shown in FIG. 17A) from light sensor system 1708 (shown in FIG. 17), may amplify the signal, may filter the signal, and may convert the signal from an analog format to a digital format to output signal 1944. As another example, light sensor system interface 1914 (shown in FIG. 19) receives signal 1798 (shown in FIG. 17A) from light sensor system 1708 (shown in FIG. 17), may amplify the signal, may filter the signal, and may convert the signal from an analog format to a digital format to output signal 1960. Furthermore, referring to FIG. 19B, light sensor system interface 1914 performs similar operations on signals 1731, 1735, 1739, 1743, 1747, 1751, 1755, 1759, 1763, 1767, 1771, and 1775 (shown in FIG. 17B) to output a plurality of respective signals 1976, 1978, 1980, 1982, 1984, 1986, 1988, 1990, 1992, 1994, 1996, and 1905. For example, light sensor system interface 1914 receives signal 1731 (shown in FIG. 17A) from light sensor system 1708 (shown in FIG. 17), may amplify the signal, may filter the signal, and may convert the signal from an analog format to a digital format to output signal 1976. As another example, light sensor system interface 1914 receives signal 1743 from light sensor system 1708 (shown in FIG. 17), may amplify the signal, may filter the signal, and may convert the signal from an analog format to a digital format to output signal 1982.

Moreover, referring back to FIG. 19, multi-touch sensor system interface 1916 receives left-object-first-position-touch-sensor-output signal 1738 (shown in FIG. 17) from multi-touch sensor system 1710, may amplify the signal, may filter the signal, may convert the signal from an analog to a digital format, and compares a voltage of the signal with the threshold voltage to output or not output a left-object-first-position-touch-sensor-interface-output signal 1907. Upon determining that a voltage of left-object-first-position-touch-sensor-output signal 1738 is greater than the threshold voltage, the comparator outputs a left-object-first-position-touch-sensor-interface-output signal 1907 representing that the voltage of the left-object-first-position-touch-sensor-output signal 1738 is greater than the threshold voltage. On the other hand, upon determining that a voltage of left-object-first-position-touch-sensor-output signal 1738 is equal to or less than the threshold voltage, the comparator does not output left-object-first-position-touch-sensor-interface-output signal 1907 to represent that the voltage of the left-object-first-position-touch-sensor-output signal 1738 is less than or equal to the threshold voltage.

Multi-touch sensor system interface 1916 receives left-object-second-position-touch-sensor-output signal 1740 (shown in FIG. 17) from multi-touch sensor system 1710 (shown in FIG. 17) and performs a similar operation on the signal as that performed on left-object-first-position-touch-sensor-output signal 1738 to output a left-object-second-position-touch-sensor-interface-output signal 1909. For example, multi-touch sensor system interface 1916 receives left-object-second-position-touch-sensor-output signal 1740 from multi-touch sensor system 1710, may amplify the signal, may filter the signal, may convert the signal from an analog to a digital format, and compares a voltage of the signal with the threshold voltage to output or not output left-object-second-position-touch-sensor-interface-output signal 1909. Upon determining that a voltage of left-object-second-position-touch-sensor-output signal 1740 is greater than the threshold voltage, the comparator outputs left-object-second-position-touch-sensor-interface-output signal 1909 representing that the voltage of the left-object-second-position-touch-sensor-output signal 1740 is greater than the threshold voltage. On the other hand, upon determining that a voltage of left-object-second-position-touch-sensor-output signal 1740 is equal to or less than the threshold voltage, the comparator does not output left-object-second-position-touch-sensor-interface-output signal 1909 to represent that the voltage of the left-object-second-position-touch-sensor-output signal 1740 is less than or equal to the threshold voltage.

Furthermore, multi-touch sensor system interface 1916 receives right-object-first-position-touch-sensor-output signal 1777 (shown in FIG. 17) from multi-touch sensor system 1710 (shown in FIG. 17) and performs a similar operation on the signal as that performed on left-object-first-position-touch-sensor-output signal 1738 to output or not output a right-object-first-position-touch-sensor-interface-output signal 1911. Additionally, multi-touch sensor system interface 1916 receives right-object-second-position-touch-sensor-output signal 1779 (shown in FIG. 17) from multi-touch sensor system 1710 (shown in FIG. 17) and performs a similar operation on the signal as that performed on right-object-first-position-touch-sensor-output signal 1777 to output or not output a right-object-second-position-touch-sensor-interface-output signal 1913.

Referring to FIG. 19A, multi-touch sensor system interface 1916 performs similar operations on signals 1781, 1783, 1785, 1787, 1789, 1791, 1793, 1795, 1797, 1799, 17004, 17002, 17006, 17008, 17010, 17012 (shown in FIG. 17A) to output a plurality of respective signals 1915, 1917, 1919, 1921, 1923, 1925, 1927, 1929, 1931, 1933, 1935, 1937, 1939, 1941, 1943, and 1945. For example, multi-touch sensor system interface 1916 receives signal 1781 (shown in FIG. 17A) from multi-touch sensor system 1710, may amplify the signal, may filter the signal, may convert the signal from an analog to a digital format, and compares a voltage of the signal with the threshold voltage to output or not output signal 1915. Upon determining that a voltage of signal 1781 (shown in FIG. 17A) is greater than the threshold voltage, the comparator outputs signal 1915 representing that the voltage of the signal is greater than the threshold voltage. On the other hand, upon determining that a voltage of signal 1781 (shown in FIG. 17A) is equal to or less than the threshold voltage, the comparator does not output signal 1915 to represent that the voltage of the signal is less than or equal to the threshold voltage. Referring to FIG. 19B, multi-touch sensor system interface 1916 performs similar operations on signals 17014, 17016, 17018, 17020, 17022, 17024, 17026, 17028, 17030, 17032, 17034, and 17036 (shown in FIG. 17B) to output a plurality of respective signals 1947, 1949, 1951, 1953, 1955, 1957, 1959, 1961, 1963, 1965, 1967, and 1969. For example, multi-touch sensor system interface 1916 receives signal 17014 (shown in FIG. 17B) from multi-touch sensor system 1710, may amplify the signal, may filter the signal, may convert the signal from an analog to a digital format, and compares a voltage of the signal with the threshold voltage to output or not output signal 1947. Upon determining that a voltage of signal 17014 (shown in FIG. 17B) is greater than the threshold voltage, the comparator outputs signal 1947 representing that the voltage of the signal is greater than the threshold voltage. On the other hand, upon determining that a voltage of signal 17014 (shown in FIG. 17B) is equal to or less than the threshold voltage, the comparator does not output signal 1947 to represent that the voltage of the signal is less than or equal to the threshold voltage.

Referring back to FIG. 19, light sensor system interface 1914 receives object-first-top-position-light-sensor-output signal 1842 (shown in FIG. 18) from light sensor system 1708 (shown in FIG. 17), may amplify the signal, may filter the signal, and may convert the signal from an analog format to a digital format to output an object-first-top-position-light-sensor-interface-output signal 1971. Light sensor system interface 1914 performs a similar operation on object-bottom-position-light-sensor-output signal 1852 (shown in FIG. 18) as that performed on object-first-top-position-light-sensor-output signal 1842. For example, light sensor system interface 1914 receives object-bottom-position-light-sensor-output signal 1852 (shown in FIG. 18) from light sensor system 1708 (shown in FIG. 17), may amplify the signal, may filter the signal, and may convert the signal from an analog format to a digital format to output an object-first-bottom-position-light-sensor-interface-output signal 1973. Light sensor system interface 1914 performs a similar operation on object-second-top-position-light-sensor-output signal 1862 (shown in FIG. 18) as that performed on object-bottom-position-light-sensor-output signal 1852 (shown in FIG. 18). For example, light sensor system interface 1914 receives object-second-top-position-light-sensor-output signal 1862 (shown in FIG. 18) from light sensor system 1708 (shown in FIG. 17), may amplify the signal, may filter the signal, and may convert the signal from an analog format to a digital format to output an object-second-top-position-light-sensor-interface-output signal 1975.

Light sensor system interface 1914 receives physical-device-light-sensor-output signal 1818 (shown in FIG. 18) from light sensor system 1708, may amplify the signal, may filter the signal, and may convert the signal from an analog format to a digital format to output a physical-device-light-sensor-interface-output signal 1977.

Multi-touch sensor system interface 1916 receives physical-device-touch-sensor-output signal 1832 (shown in FIG. 18) from multi-touch sensor system 1710 (shown in FIG. 18) and performs a similar operation on the signal as that performed on right-object-second-position-touch-sensor-output signal 1779 (shown in FIG. 17) to output a physical-device-touch-sensor-interface-output signal 1981. For example, multi-touch sensor system interface 1916 receives physical-device-touch-sensor-output signal 1832 from multi-touch sensor system 1710, may amplify the signal, may filter the signal, may convert the signal from an analog to a digital format, and compares a voltage of the signal with the threshold voltage to output or not output physical-device-touch-sensor-interface-output signal 1981. Upon determining that a voltage of physical-device-touch-sensor-output signal 1832 is greater than the threshold voltage, the comparator outputs physical-device-touch-sensor-interface-output signal 1981 representing that the voltage of physical-device-touch-sensor-output signal 1832 is greater than the threshold voltage. On the other hand, upon determining that a voltage of physical-device-touch-sensor-output signal 1832 is equal to or less than the threshold voltage, the comparator does not output physical-device-touch-sensor-interface-output signal 1981 to represent that the voltage of the physical-device-touch-sensor-output signal 1832 is less than or equal to the threshold voltage.

Processor 1918 instructs the RF transmitter of RF transceiver 1804 to transmit RF-transmitter-output signal 1822 (shown in FIG. 18) by sending RF-transmitter-input signal 1820 (shown in FIG. 18) to the transmitter.

Processor 1918 receives physical-device-light-sensor-interface-output signal 1977 from light sensor system interface 1914 and determines an identification indicia value of identification indicia 1808 (shown in FIG. 18) from the signal. Upon determining an identification indicia value, such as a bit value, of identification indicia 1808 from physical-device-light-sensor-interface-output signal 1977, processor 1918 determines whether the value matches a stored identification indicia value of the indicia. An administrator stores an identification indicia value within the memory or within system memory 1928. Upon determining that an identification indicia value of identification indicia 1808 represented by physical-device-light-sensor-interface-output signal matches the stored identification indicia value, processor 1918 determines that physical device 1802 is valid and belongs within the facility in which display screen 1704 is placed. Upon determining that physical device 1802 is valid, processor 1918 may control video adapter 1920 to display a validity message on display device 1910, which may be managed by the administrator, or on another display device 1910 that is connected via communication device 1932 and network 1934 with processor 1918 and that is managed by the administrator. The validity message indicates to the administrator that physical device 1802 is valid and belongs within the facility.

On the other hand, upon determining that an identification indicia value of identification indicia 1808 represented by physical-device-light-sensor-interface-output signal 1977 does not match the stored identification indicia value, processor 1918 determines that physical device 1802 is invalid and does not belong within the facility. Upon determining that physical device 1802 is invalid, processor 1918 may control video adapter 1920 to display an invalidity message on display device 1910 or on another display device 1910 that is connected via communication device 1932 and network 1934 with processor 1918 and that is managed by the administrator. The invalidity message indicates to the administrator that physical device 1802 is invalid and does not belong within the facility.

Moreover, referring to FIG. 19C, processor 1918 receives left-object-first-position-light-sensor-interface-output signal 1936 (shown in FIG. 19) and left-object-second-position-light-sensor-interface-output signal 1938 (shown in FIG. 19) from light sensor system interface 1914 (shown in FIG. 19) and instructs video adapter 1920 (shown in FIG. 19) to control, such as drive, display light source 1912 (shown in FIG. 19) and display screen 1704 (shown in FIG. 19) to display an image 1979 representing the movement from first left-object position 1718 (shown in FIG. 17) to second left-object position 1728 (shown in FIG. 17). Video adapter 1920 receives the instruction from processor 1918, generates a plurality of red, green, and blue (RGB) values or grayscale values based on the instruction, generates a plurality of horizontal synchronization values based on the instruction, generates a plurality of vertical synchronization values based on the instruction, and drives display light source 1912 and display screen 1704 to display the movement of left object 1712 from first left-object position 1718 to second left-object position 1728.

Similarly, processor 1918 instructs video adapter 1920 to control display device 1910 to display the movement from the first right-object position 1742 (shown in FIG. 17) to the second right-object position 1752. For example, processor 1918 receives right-object-first-position-light-sensor-interface-output signal 1940 and right-object-second-position-light-sensor-interface-output signal 1942 from light sensor system interface 1914 and instructs video adapter 1920 to drive display light source 1912 and display screen 1704 to display an image 1981 representing the movement from first right-object position 1742 (shown in FIG. 17) to second right-object position 1752 (shown in FIG. 17). In this example, video adapter 1920 receives the instruction from processor 1918, generates a plurality of red, green, and blue (RGB) values or grayscale values based on the instruction, generates a plurality of horizontal synchronization values based on the instruction, generates a plurality of vertical synchronization values based on the instruction, and drives display light source 1912 and display screen 1704 to display the movement of left object 1712 from first right-object position 1742 to second right-object position 1752.

Similarly, processor 1918 instructs video adapter 1920 to control display device 1910 to display the movement from first object top position 1834 (shown in FIG. 18) to object bottom position 1844 (shown in FIG. 18) and further to second object top position 1854 (shown in FIG. 18) as an image 1983, the movement from first left position 1764 (shown in FIG. 17A) to first right position 1768 (shown in FIG. 17A) further to second left position 1772 (shown in FIG. 17A) and further to second right position 1776 (shown in FIG. 17A) as an image 1985, and the movement from top left position 1780 (shown in FIG. 17A) to top right position 1784 (shown in FIG. 17A) further to bottom left position 1788 (shown in FIG. 17A) and further to bottom right position 1792 (shown in FIG. 17A) as an image 1987.

Similarly, processor 1918 instructs video adapter 1920 to control display device 1910 to display the movement from the top position 1796 (shown in FIG. 17A) to the bottom position 1701 (shown in FIG. 17A) as an image 1989, the movement from bottom position 1762 (shown in FIG. 17A) to top position 1709 (shown in FIG. 17A) as an image 1991, and the movement from top position 1762 (shown in FIG. 17A) to right position 1717 (shown in FIG. 17A) further to bottom position 1721 (shown in FIG. 17A) further to left position 1725 (shown in FIG. 17A) and further to top position 1762 (shown in FIG. 17A) as an image 1993.

Referring to FIG. 19D, processor 1918 instructs video adapter 1920 to control display device 1910 to display the movement from top position 1729 (shown in FIG. 17B) to left position 1733 (shown in FIG. 17B) further to bottom position 1737 (shown in FIG. 17B) further to right position 1741 (shown in FIG. 17B) and further to top position 1762 (shown in FIG. 17B) as an image 1995, the movement from top position 1745 (shown in FIG. 17B) to first lower position 1749 (shown in FIG. 17B) further to second lower position 1753 (shown in FIG. 17B) further to bottom position 1757 (shown in FIG. 17B) as an image 1997, and the movement from top position 1762 (shown in FIG. 17B) to bottom left position 1765 (shown in FIG. 17B) further to middle position 1769 (shown in FIG. 17B) and further to bottom right position 1773 (shown in FIG. 17B) as an image 1999.

Referring to FIG. 19E, an example embodiment of a physical device 1902 placed on display screen 1704 is shown. Physical device 1902 is an example of physical device 1802 (shown in FIG. 18). Upon determining that physical device 1902 is placed on display screen 1704, processor 1918 instructs video adapter 1920 to control display device 1910 to generate a wagering area image 19004 that allows a player to make a wager on a game of chance or a game of skill. Processor 1918 determines a position 19008 of wagering area image 19004 with respect to the origin based on a physical device position 19006, which is an example of physical device position 1803 (shown in FIG. 18). For example, upon determining that physical device 1902 is at physical device position 19006 with respect to the origin, processor 1918 instructs video adapter 1920 to control display light source 1912 and display screen 1704 to display wagering area image 19004 at position 19008 on display screen 1704. As yet another example, upon determining that physical device 1902 is at physical device position 19006 with respect to the origin, processor 1918 instructs video adapter 1920 to control display light source 1912 and display screen 1704 to display wagering area image 19008 at an increment or a decrement of physical device position 19006. As still another example, upon determining that physical device 1902 is at physical device position 19006 with respect to the origin, processor 1918 instructs video adapter 1920 to control display light source 1912 and display screen 1704 to display wagering area image 19004 at the same position as physical device position 19006.

The administrator provides the position increment and decrement to processor 1918 via input device 1924. The position increment and the position decrement are measured along the same axis as physical device position 19006. For example, if physical device position 19006 is measured parallel to the y axis, position 19008 of wagering area image 19004 is incremented by the position increment parallel to the y axis. As another example, if physical device position 19006 is measured parallel to both the x and y axes, position 19008 of wagering area image 19004 is decremented incremented by the position increment parallel to both the x and y axes. Processor 1918 instructs video adapter 1920 to control display device 1910 to display wagering area image 19004 having the same orientation as that of physical device 1902. For example, upon determining that a physical device orientation 19009 has changed to a physical device orientation 19012 (shown in FIG. 19G), processor 1918 instructs video adapter 1920 to control display device 1910 to change wagering area image 19004 from orientation 19010 to an orientation 19040 (shown in FIG. 19G). Orientation 19040 is parallel in all of the x, y, and z directions to orientation 19012 and orientation 19010 is parallel in all the directions to orientation 19009. Wagering area image 19004 includes a wager amount image 19014, an increase wager image 19016, a decrease wager image 19018, an accept wager image 19020, and a cancel wager image 19022.

Referring to FIG. 19F, instead of accept wager image 19020, physical device 1904 includes an accept switch 19024 that is selected by the user to accept a wager made and a cancel switch 19026 that is selected by the user to cancel a wager made. Physical device 1904 is an example of physical device 1802 (FIG. 18). Each of accept switch 19024 and cancel switch 19026 may be a double pole, double throw switch. In this embodiment, the accept and cancel switches 19024 and 19026 are connected to processor 1918 via an input interface 19028, which includes an analog to digital converter and a wireless transmitter. When the accept switch 19024 is selected by a player, accept switch 19024 sends an electrical signal to input interface 19028 that converts the signal into a digital format and from a wired form into a wireless form to generate a wireless accept signal. Input interface 19028 sends the wireless accept signal to processor 1918. Upon receiving the wireless accept signal from the accept switch 19024, processor 1918 instructs video adapter 1920 to control display device 1910 to leave unchanged any wagered amount and use the wagered amount for playing a game of chance or skill. When the cancel switch 19026 is selected by a player, cancel switch 19026 sends an electrical signal to input interface 19028 that converts the signal into a digital format and from a wired form into a wireless form to generate a wireless cancel signal. Input interface 19028 sends the wireless cancel signal to processor 1918. Upon receiving the wireless cancel signal from the cancel switch 19026, processor 1918 instructs video adapter 1920 to control display device 1910 to change any wagered amount to zero.

Referring back to FIG. 19, processor 1918 receives physical-device-light-sensor-interface-output signal 1977 and determines position 19006 and an orientation 19009 (shown in FIG. 19E) of physical device 1902 (shown in FIG. 19E) from the signal. For example, processor 1918 generates image data representing an image of physical device 1902 (shown in FIG. 19E) from physical-device-light-sensor-interface-output signal 1977, and determines a distance, parallel to either the x, y, or z axis, from the origin to pixels representing the physical device 1902 (shown in FIG. 19E) within the image. As another example, processor 1918 generates image data representing an image of physical device 1902 (shown in FIG. 19E) from physical-device-light-sensor-interface-output signal 1977, and determines, with respect to the xyz co-ordinate system, a set of co-ordinates of all vertices of the image representing physical device 1902 (shown in FIG. 19E). The vertices of an image representing physical device 1902 with respect to the origin are the same as a plurality of vertices 19032, 19034, 19036, and 19038 (shown in FIG. 19E) of physical device 1902. The vertices 19032, 19034, 19036, and 19038 (shown in FIG. 19E) represent a position of physical device 1902 (shown in FIG. 19E) with respect to the origin. A number of co-ordinates of vertices 19032, 19034, 19036, and 19038 (shown in FIG. 19E) of the image representing physical device 1902 (shown in FIG. 18) within the xyz co-ordinate system represents a shape of physical device 1902. For example, if physical device is a cube, an image of physical device 1802 (shown in FIG. 18) has eight vertices and if physical device 1802 is a pyramid, an image of physical device 1802 has four vertices. Each vertex 19032, 19034, 19036, and 19038 (shown in FIG. 19E) has co-ordinates with respect to the origin. Processor 1918 determines any position and any orientation with reference to the origin.

Processor 1918 receives set 1830 of RF-receiver-output signals and determines position 19006 (shown in FIG. 19E) and orientation 19009 (shown in FIG. 19E) of physical device 1902 (shown in FIG. 19E) from the set. As an example, processor 1918 determines a plurality of amplitudes of x, y, and z signals of set 1830 of RF-receiver-output signals and determines position 19006 and orientation 19009 (shown in FIG. 19E) of physical device 1902 (shown in FIG. 19E) from the amplitudes. The x signal of set 1830 of RF-receiver-output signals is generated from a signal received by the x-antenna, the y signal of set 1830 of RF-receiver-output signals is generated from a signal received by the y-antenna, and the z signal of set 1830 of RF-receiver-output signals is generated from a signal received by the z-antenna. In this example, processor 1918 may determine an amplitude of the x signal of set 1830 of RF-receiver-output signals when amplitudes of the y and z signals within set 1830 of RF-receiver-output signals are zero and the amplitude of the x signal represents position 19006 (shown in FIG. 19E) of physical device 1902 (shown in FIG. 19E), parallel to the x axis, with respect to the origin. In this example, processor 1918 may determine amplitudes of the y and z signals within set 1830 of RF-receiver-output signals when an amplitude of the x signal is zero, may determine amplitudes of the x and z signals within set 1830 of RF-receiver-output signals when an amplitude of the y signal within set 1830 is zero, may determine amplitudes of the x and z signals within set 1830 of RF-receiver-output signals when an amplitude of the y signal is zero, and may determine orientation 19009 (shown in FIG. 19E) of physical device 1902 (shown in FIG. 19) as a function of the determined amplitudes. The function may include an inverse tangent of a ratio of amplitudes of y and z signals within set 1830 of RF-receiver-output signals when an amplitude of the x signal within set 1830 is zero, an inverse tangent of a ratio of amplitudes of x and z signals within set 1830 of RF-receiver-output signals when an amplitude of the y signal within set 1830 is zero, and an inverse tangent of a ratio of amplitudes of x and y signals within set 1830 of RF-receiver-output signals when an amplitude of the z signal within set 1830 is zero.

Referring to FIG. 19G, processor 1918 determines a position 19015 of physical device and orientation 19012 of physical device 1902 in a similar manner as that of determining position 19006 (shown in FIG. 19E) and orientation 19009 (shown in FIG. 19E) of physical device 1902. Upon determining that the user has changed orientation of physical device 1902 (shown in FIG. 19E) from orientation 19009 (shown in FIG. 19E) to orientation 19012 (shown in FIG. 19G), processor 1918 changes orientation (shown in FIG. 19E) of wagering area image 19004 (shown in FIG. 19E) from orientation 19010 (shown in FIG. 19E) to orientation 19040 (shown in FIG. 19G) to match orientation 19012 (shown in FIG. 19G) of physical device 1902 (shown in FIG. 19G) and instructs video adapter 1920 to control display device 1910 to display wagering area image 19004 (shown in FIG. 19E) with orientation 19040 (shown in FIG. 19G).

Referring to FIG. 19H, physical device 1906 is a card that has a polygonal shape, such as a square or a rectangular shape and that is transparent or translucent. Physical device 1906 is an example of physical device 1902 (shown in FIGS. 19E and 19G). A wagering area 19042 is displayed on display screen 1704. Wagering area 19042 is an example of wagering area 19004 (shown in FIGS. 19E and 19G). Wagering area 19042 includes a display of a wager of $10 and a bar 19044. When object 1762 is moved from bottom position 1705 (shown in FIG. 19A) to top position 1709 (shown in FIG. 19A), processor 1918 (shown in FIG. 19) receives signals 1966 and 1964 and/or signals 1937 and 1935 (shown in FIG. 19A) and based on the signals received, instructs video adapter 1920 (shown in FIG. 19) to control display device 1910 to display an increase in the wager from $10 to a higher wager. On the other hand, when object 1762 is moved from top position 1796 (shown in FIG. 19A) to bottom position 1701 (shown in FIG. 19A), processor 1918 (shown in FIG. 19) receives signals 1960 and 1962 and/or signals 1931 and 1933 (shown in FIG. 19A) and based on the signals received, instructs video adapter 1920 (shown in FIG. 19) to control display device 1910 to display a decrease in the wager from $10 to a lower amount.

Physical device 1906 includes a cancel button 19046, which is an example of an actuator for actuating cancel switch 19026 (shown in FIG. 19F). Moreover, physical device includes an accept button 19048, which is an example of an actuator for actuating accept switch 19024 (shown in FIG. 19F). The wager is accepted by actuating accept button 19048 and is canceled by actuating cancel button 19046.

Referring to FIG. 19I, physical device 1908 of a shape of a half-donut is shown. Upon placement of physical device 1908 on display screen 1704, a wagering area 19050 (shown in dotted lines) is displayed on display screen 1704. Wagering area 19050 is an example of wagering area 19004 (shown in FIGS. 19E and 19G). Wagering area 19050 includes a display of a wager of $20 and a bar 19052. When right object 1714 is moved from first right-object position 1742 (shown in FIG. 17) to second right-object position 1752 (shown in FIG. 17), processor 1918 (shown in FIG. 19) receives signals 1940 and 1942 and/or signals 1911 and 1913 (shown in FIG. 19) and based on the signals, instructs video adapter 1920 (shown in FIG. 19) to control display device 1910 to display an increase in the wager from $20 to a higher wager. On the other hand, when left object 1712 is moved from first left-object position 1718 (shown in FIG. 17) to second left-object position 1728 (shown in FIG. 17), processor 1918 (shown in FIG. 19) receives signals 1936 and 1938 and/or signals 1907 and 1909 (shown in FIG. 19) and based on the signals received, instructs video adapter 1920 (shown in FIG. 19) to control display device 1910 to display a decrease in the wager from $20 to a lower amount.

Wagering area 19050 further includes a cancel wager image 19054, which is an example of cancel wager image 19022 (shown in FIG. 19E). Wagering area includes an accept wager image 19056, which is an example of accept wager image 19020 (shown in FIG. 19E).

Referring to FIG. 19J, physical device 1901 of a shape of a ring or donut is shown. Upon placement of physical device 1901 on display screen 1704, a wagering area image 19058 is displayed on display screen 1704. Wagering area image 19058 is an example of wagering area image 19004 (shown in FIGS. 19E and 19G). Wagering area image includes a display of a wager of $50 and a bar 19060. Bar 19060 is an example of bar 19044 (shown in FIG. 19H). Wagering area image 19058 further includes a cancel wager image 19062, which is an example of cancel wager image 19022 (shown in FIG. 19E). Wagering area image 19058 includes an accept wager image 19064, which is an example of accept wager image 19020 (shown in FIG. 19E). In another embodiment, physical device 1901 is of any shape other than a ring.

Referring back to FIG. 19, processor 1918 determines a position of object 1762 as being the same as a position of a touch sensor that outputs a touch-sensor-output signal, such as left-object-first-position-touch-sensor-output signal 1738 (shown in FIG. 17), left-object-second-position-touch-sensor-output signal 1740 (shown in FIG. 17), right-object-first-position-touch-sensor-output signal 1777 (shown in FIG. 17), and right-object-second-position-touch-sensor-output signal 1779 (shown in FIG. 17). For example, upon determining that a touch sensor of multi-touch sensor system 1710 (shown in FIG. 17) at a distance, parallel to one of the x, y, and z axes, outputs an object-touch-sensor-output signal, processor 1918 determines that object 1762 has a position represented by the distance from the origin.

Processor 1918 determines a position of physical device 1802 (shown in FIG. 18) as being the same as a position of a touch sensor that outputs physical-device-touch-sensor-output signal 1832 (shown in FIG. 17). As another example, upon determining that a touch sensor of multi-touch sensor system 1710 (shown in FIG. 17) at a distance, parallel to one of the x, y, and z axes, outputs physical-device-touch-sensor-output signal 1832, processor 1918 determines that physical device 1802 (shown in FIG. 18) has a position represented by the distance from the origin.

Processor 1918 determines a change between physical device position 1803 (shown in FIG. 18) and another physical device position (not shown). The change between the physical device positions is an amount of movement of physical device 1802 (shown in FIG. 18) between the physical device positions. For example, processor 1918 subtracts a distance, parallel to the x axis, of the other physical device position from a distance, parallel to the x axis, of physical device position 1803 (shown in FIG. 18) to determine a change between the physical device positions.

Processor 1918 determines a change between one object position and another object position. The change between the object positions is an amount of movement of object 1762 between the object positions. For example, processor 1918 subtracts a distance, parallel to the x axis, of the first left-object position 1718 (shown in FIG. 17) from a distance, parallel to the x axis, of second left-object position 1728 (shown in FIG. 17) to determine a change between the first left-object position 1718 and second left-object position 1728. As another example, processor 1918 subtracts a distance, parallel to the y axis, of the first object top position 1834 (shown in FIG. 18) from a distance, parallel to the y axis, of object bottom position 1844 (shown in FIG. 18) to determine a change between the first object top position 1834 and object bottom position 1844.

In another embodiment that includes an OLED or an LED display screen 1704, display device 1910 does not use display light source 1912. In yet another embodiment, a comparator used to compare a voltage of a physical-device-touch-sensor-output signal 1832 with a pre-determined voltage is different than the comparator used to compare a voltage of an object-touch-sensor-output signal with the threshold voltage. Examples of the object-touch-sensor-output signal include left-object-first-position-touch-sensor-output signal 1738 (shown in FIG. 17), left-object-second-position-touch-sensor-output signal 1740 (shown in FIG. 17), right-object-first-position-touch-sensor-output signal 1777 (shown in FIG. 17), and right-object-second-position-touch-sensor-output signal 1779 (shown in FIG. 17).

In another embodiment, system 1900 does not include output device 1926, network 1934, and communication device 1932. In yet another embodiment, system 1900 does not include multi-touch sensor system interface 1916. In still another embodiment, system 1900 does not include light sensor system interface 1914 and directly receives a signal, such as a physical-device-light-sensor-output signal or an object-light-sensor-output signal, from light sensor system 1708 (shown in FIGS. 17 and 18). Examples of the object-light-sensor-output signal include left-object-first-position-light-sensor-output signal 1726 (shown in FIG. 17), left-object-second-position-light-sensor-output signal 1736 (shown in FIG. 17), right-object-first-position-light-sensor-output signal 1750 (shown in FIG. 17), right-object-second-position-light-sensor-output signal 1760 (shown in FIG. 17), object-first-top-position-light-sensor-output signal 1842 (shown in FIG. 18), object-bottom-position-light-sensor-output signal 1852 (shown in FIG. 18), object-second-top-position-light-sensor-output signal 1862 (shown in FIG. 18). In another embodiment, each of the validity and invalidity messages are output via a speaker connected via an output interface to processor 1918. The output interface converts electrical signal into audio signals.

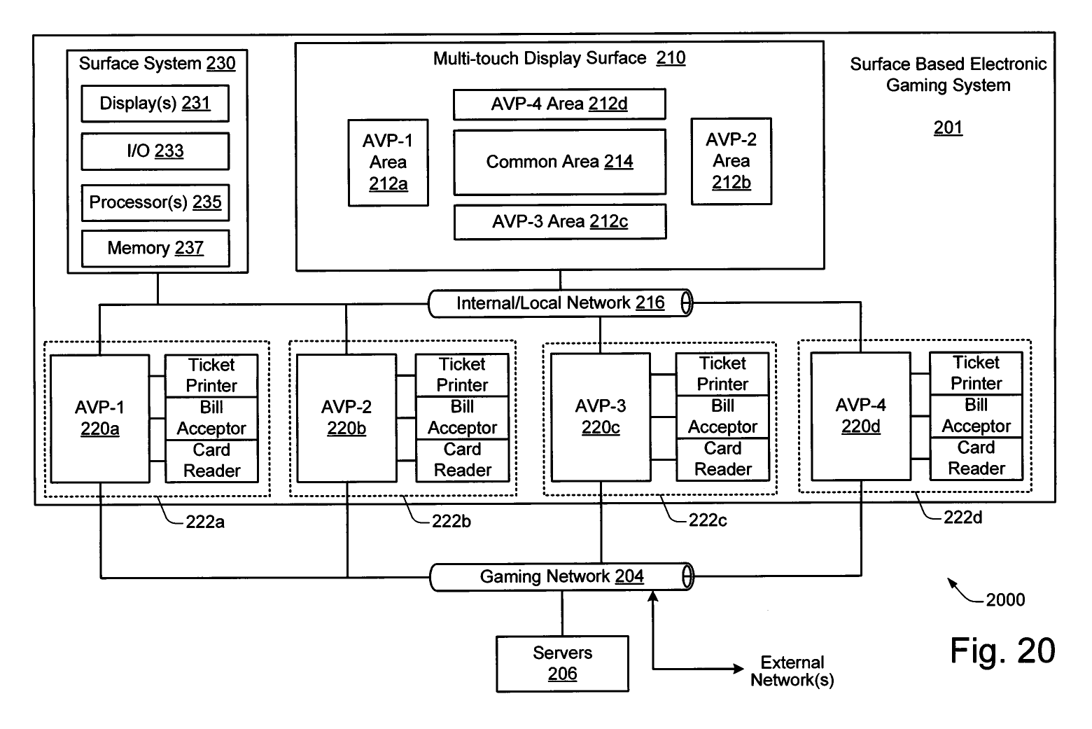

FIG. 20 shows a simplified block diagram of an alternate example embodiment of an intelligent multi-player electronic gaming system 2000.

As illustrated in the example embodiment of FIG. 20, intelligent multi-player electronic gaming system 2000 may include, for example:
a multi-touch, multi-player interactive display surface 210 which includes a multipoint or multi-touch input interface;
a surface system 230 which is configured or designed to control various functions relating to the multi-touch, multi-player interactive display surface 210 such as, for example: implementing display of content at one or more display screen(s) of the multi-touch, multi-player interactive display surface; detection and processing of user input provided via the multipoint or multi-touch input interface of the multi-touch, multi-player interactive display surface; etc.
a plurality of separate gaming controllers 222a-d;
internal interfaces 216;
external interfaces 204, which may be used for communicating with one or more remote servers 206 of the gaming network;
etc.

In at least one embodiment, one or more of the gaming controllers 222a-d may be implemented using IGT's Advanced Video Platform (AVP) gaming controller system manufactured by IGT of Reno, Nev.

In at least one embodiment, each player station at the intelligent multi-player electronic gaming system may assigned to a separate, respective Advanced Video Platform controller which is configured or designed to handle all gaming and wager related operations and/or transactions relating to it's assigned player station. In at least one embodiment, each AVP controller may also be configured or designed to control the peripheral devices (e.g. bill acceptor, card reader, ticket printer, etc.) associated with the AVP controller's assigned player station.

One or more interfaces may be defined between the AVP controllers and the multi-touch, multi-player interactive display surface. In at least one embodiment, surface 210 may be configured to function as the primary display and as the primary input device for gaming and/or wagering activities conducted at the intelligent multi-player electronic gaming system.

In at least one embodiment, one of the AVP controllers may be configured to function as a local server for coordinating the activities of the other the AVP controllers.

In at least one embodiment, the Surface 210 may be configured to function as a slave device to the AVP controllers, and may be treated as a peripheral device.

In at least one embodiment, when a player at a given player station initiates a gaming session at the intelligent multi-player electronic gaming system, the player may conduct his or her game play activities and/or wagering activities by interacting with the Surface 210 using different gestures. The AVP controller assigned to that player station may coordinate and/or process all (or selected) game play and/or wagering activities/transactions relating to the player's gaming session. The AVP controller may also determine game outcomes, and display appropriate results and/or other information via the Surface display.

In one embodiment, during a communal game, or during a communal bonus, the Surface 210 may interact with the players and feed information back to the appropriate AVP controllers. The AVP controllers may then produce an outcome which may be displayed at the Surface.

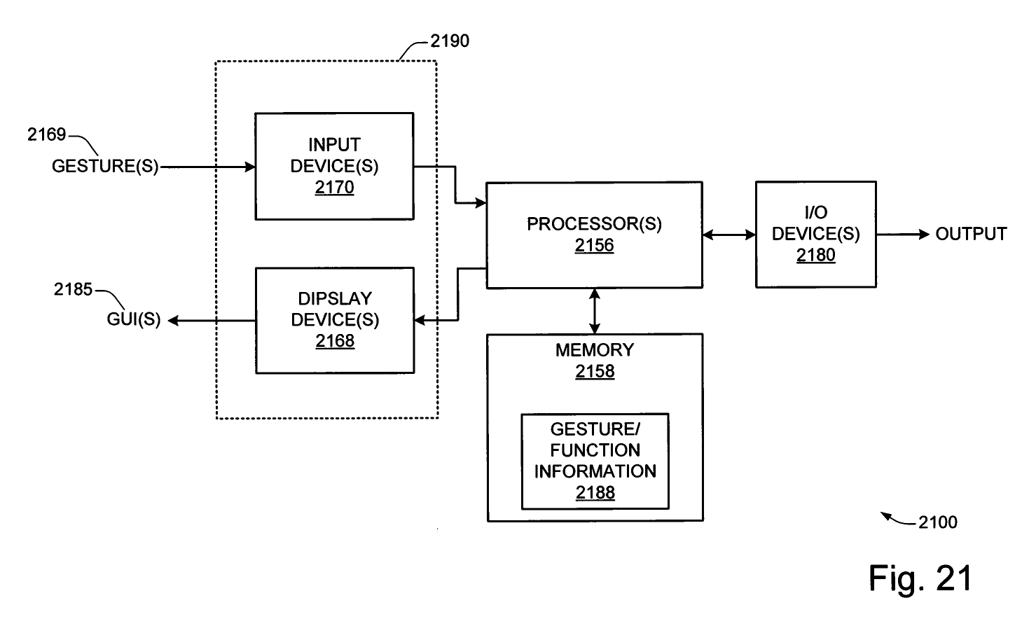

FIG. 21 shows a block diagram of an alternate example embodiment of a portion of an intelligent multi-player electronic gaming system 2100.

As illustrated in the example embodiment of FIG. 21 intelligent multi-player electronic gaming system 2100 may include at least one processor 2156 configured to execute instructions and to carry out operations associated with the intelligent multi-player electronic gaming system 2100. For example, using instructions retrieved for example from memory, the processor(s) 2156 may control the reception and manipulation of input and output data between components of the computing system 2100. The processor(s) 2156 may be implemented on a single-chip, multiple chips or multiple electrical components. For example, various architectures may be used for the processor(s) 2156, including dedicated or embedded processor(s), single purpose processor(s), controller, ASIC, and so forth.

In at least one embodiment, the processor(s) 2156 together with an operating system operates to execute code (such as, for example, game code) and produce and use data. A least a portion of the operating system, code and/or data may reside within a memory block 2158 that may be operatively coupled to the processor(s) 2156. Memory block 2158 may be configured or designed to store code, data, and/or other types of information that may be used by the intelligent multi-player electronic gaming system 2100.

The intelligent multi-player electronic gaming system 2100 may also include at least one display device 2168 that may be operatively coupled to the processor(s) 2156. In at least one embodiment, one or more display device(s) may include at least one flat display screen incorporating flat-panel display technology. This may include, for example, a liquid crystal display (LCD), a transparent light emitting diode (LED) display, an electroluminescent display (ELD), and a microelectromechanical device (MEM) display, such as a digital micromirror device (DMD) display or a grating light valve (GLV) display, etc. In some embodiments, one or more of the display screens may utilize organic display technologies such as, for example, an organic electroluminescent (OEL) display, an organic light emitting diode (OLED) display, a transparent organic light emitting diode (TOLED) display, a light emitting polymer display, etc. In addition, at least one display device(s) may include a multipoint touch-sensitive display that facilitates user input and interaction between a person and the intelligent multi-player electronic gaming system.

In at least some embodiments, display device(s) 2168 may incorporate emissive display technology in which the display screen, such as an electroluminescent display, is capable of emitting light and is self-illuminating. In other embodiments, display device(s) 2168, may incorporate emissive display technology, such as an LCD. Typically, a non-emissive display generally does not emit light or emits only low amounts of light, and is not self-illuminating. In the case of non-emissive displays for the front (or top) video display device(s), the display system may include at least one backlight to provide luminescence to video images displayed on the front video display device(s).

According to different embodiments, display screens for any of the display device(s) described herein may have any suitable shape, such as flat, relatively flat, concave, convex, and non-uniform shapes. In one embodiment, at least some of the display device(s) are all relatively flat display screens. LCD panels for example typically include a relatively flat display screen. OLED display device(s) may also include a relatively flat display surface. Alternatively, an OLED display device(s) may include a non-uniform and custom shape such as a curved surface, e.g., a convex or concave surface. Such a curved convex surface is particularly well suited to provide video information that resembles a mechanical reel. The OLED display device(s) differs from a traditional mechanical reel in that the OLED display device(s) permits the number of reels or symbols on each reel to be digitally changed and reconfigured, as desired, without mechanically disassembling a gaming machine.

One or more of the display device(s) 2168 may be generally configured to display a graphical user interface (GUI) 2169 that provides an easy to use interface between a user of the intelligent multi-player electronic gaming system and the operating system (and/or application(s) running thereon).

According to various embodiments, the GUI 2169 may represent programs, interface(s), files and/or operational options with graphical images, objects, and/or vector representations. The graphical images may include windows, fields, dialog boxes, menus, icons, buttons, cursors, scroll bars, etc. Such images may be arranged in predefined layouts, and/or may be created dynamically to serve the specific actions of one or more users interacting with the display(s).

During operation, a user may select and/or activate various graphical images in order to initiate functions and/or tasks associated therewith. In at least one embodiment, the GUI 2169 may additionally and/or alternatively display information, such as non interactive text and/or graphics.

The intelligent multi-player electronic gaming system 2100 may also include one or more input device(s) 2170 that may be operatively coupled to the processor(s) 2156. In at least one embodiment, the input device(s) 2170 may be configured to transfer data from the outside world into the intelligent multi-player electronic gaming system 2100. The input device(s) 2170 may for example be used to perform tracking and/or to make selections with respect to the GUI(s) 2169 on one or more of the display(s) 2168. The input device(s) 2170 may also be used to issue commands at the intelligent multi-player electronic gaming system 2100.

In at least some embodiments, the input device(s) 2170 may include at least one multi-person, multi-point touch sensing device configured to detect and receive input from one or more users who may be concurrently interacting with the multi-person, multi-point touch sensing device. For example, in one embodiment, the touch-sensing device may correspond to multipoint or multi-touch input touch screen which is operable to distinguish multiple touches (or multiple regions of contacts) which may occur at the same time. In at least one embodiment, the touch-sensing device may be configured or designed to detect an recognize multiple different concurrent touches (e.g., where each touch has associated therewith one or more contact regions), as well as other characteristics relating to each detected touch, such as, for example, the position or location of the touch, the magnitude of the touch, duration that contact is maintained with the touch-sensing device, movement(s) associated with a given touch, etc.

According to specific embodiments, the touch sensing device may be based on sensing technologies including but not limited to one or more of the following (or combinations thereof): capacitive sensing, resistive sensing, surface acoustic wave sensing, pressure sensing, optical sensing, and/or the like. In at least one embodiment, the input device(s) 2170 may include at least one multipoint sensing device (such as, for example, multipoint sensing device 492 of FIG. 7A) which, for example, may be positioned over or in front of one or more of the display(s) 2168, and/or may be integrated with one or more of the display device(s) 2168 (e.g., as represented by dashed region 2190).

The intelligent multi-player electronic gaming system 2100 may also preferably include capabilities for coupling to one and/or more I/O device(s) 2180. By way of example, the I/O device(s) 2180 may include various types of peripheral devices such as, for example, one or more of the peripheral device is described with respect to intelligent multi-player electronic gaming system 700 of FIG. 7A.

In at least one embodiment, the intelligent multi-player electronic gaming system 2100 may be configured or designed to recognize gestures 2185 applied to the input device(s) 2170 and/or to control aspects of the intelligent multi-player electronic gaming system 2100 based on the gestures 2185. According to different embodiments, various gestures 2185 may be performed through various hand and/or digit (e.g., finger) motions of a given user. Alternatively and/or additionally, the gestures may be made with a stylus and/or other suitable objects.

In at least one embodiment, the input device(s) 2170 receive the gestures 2185 and the processor(s) 2156 execute instructions to carry out operations associated with the received gestures 2185. In addition, the memory block 2158 may include gesture/function information 2188, which, for example, may include executable code and/or data (e.g., gesture data, gesture-function mapping data, etc.) for use in performing gesture detection, interpretation and/or mapping. For example, in at least one embodiment, the gesture/function information 2188 may include sets of instructions for recognizing the occurrences of different types of gestures 2185 and for informing one or more software agents of the gestures 2185 (and/or what action(s) to take in response to the gestures 2185).

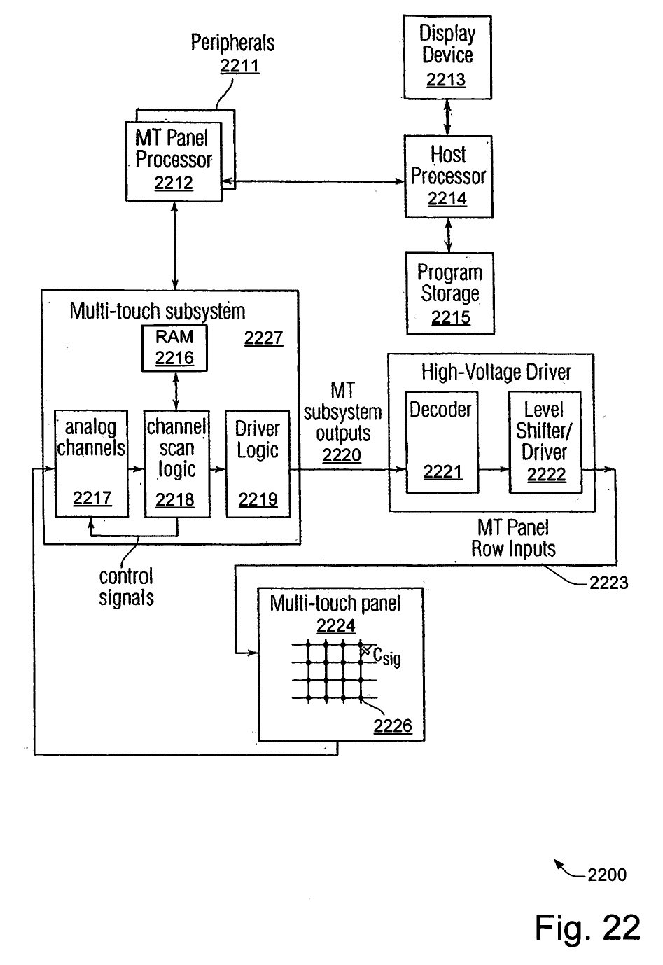

FIG. 22 illustrates an alternate example embodiment of a portion of an intelligent multi-player electronic gaming system 2200 which includes at least one multi-touch panel 2224 for use as a multipoint sensor input device for detecting and/or receiving gestures for one or more users of the intelligent multi-player electronic gaming system. In at least one embodiment, the multi-touch panel 2224 may at the same time function as a display panel.

The intelligent multi-player electronic gaming system 2200 may include one or more multi-touch panel processor(s) 2212 dedicated to the multi-touch subsystem 2227. Alternatively, the multi-touch panel processor(s) functionality may be implemented by dedicated logic, such as a state machine. Peripherals 2211 may include, but are not limited to, random access memory (RAM) and/or other types of memory and/or storage, watchdog timers and the like. Multi-touch subsystem 2227 may include, but is not limited to, one or more analog channels 2217, channel scan logic 2218, driver logic 2219, etc. In one embodiment, channel scan logic 2218 may access RAM 2216, autonomously read data from the analog channels and/or provide control for the analog channels. This control may include multiplexing columns of multi-touch panel 2224 to analog channels 2217. In addition, channel scan logic 2218 may control the driver logic and/or stimulation signals being selectively applied to rows of multi-touch panel 2224. In some embodiments, multi-touch subsystem 2227, multi-touch panel processor(s) 2212 and/or peripherals 2211 may be integrated into a single application specific integrated circuit (e.g., ASIC).

Driver logic 2219 may provide multiple multi-touch subsystem outputs 20 and/or may present a proprietary interface that drives high voltage driver, which preferably includes a decoder 2221 and/or subsequent level shifter and/or driver stage 2222. In some embodiments, level-shifting functions may be performed before decoder functions. Level shifter and/or driver 2222 may provide level shifting from a low voltage level (e.g. CMOS levels) to a higher voltage level, providing a better signal-to-noise (S/N) ratio for noise reduction purposes. Decoder 2221 may decode the drive interface signals to one out of N outputs, wherein N may correspond to the maximum number of rows in the panel. Decoder 2221 may be used to reduce the number of drive lines needed between the high voltage driver and/or multi-touch panel 2224. Each multi-touch panel row input 2223 may drive one or more rows in multi-touch panel 2224. It should be noted that driver 2222 and/or decoder 2221 may also be integrated into a single ASIC, be integrated into driver logic 2219, and/or in some instances be unnecessary.

The multi-touch panel 2224 may include a capacitive sensing medium having a plurality of row traces and/or driving lines and/or a plurality of column traces and/or sensing lines, although other sensing media may also be used. The row and/or column traces may be formed from a transparent conductive medium, such as, for example, Indium Tin Oxide (ITO) and/or Antimony Tin Oxide (ATO), although other transparent and/or non-transparent materials may also be used. In some embodiments, the row and/or column traces may be formed on opposite sides of a dielectric material, and/or may be perpendicular to each other, although in other embodiments other non-Cartesian orientations are possible. For example, in a polar coordinate system, the sensing lines may be concentric circles and/or the driving lines may be radially extending lines (or vice versa). It should be understood, therefore, that the terms “row” and “column,” “first dimension” and “second dimension,” and/or “first axis” and “second axis” as used herein are intended to encompass not only orthogonal grids, but the intersecting traces of other geometric configurations having first and second dimensions (e.g. the concentric and radial lines of a polar-coordinate arrangement). The rows and/or columns may be formed on a single side of a substrate, and/or may be formed on two separate substrates separated by a dielectric material. In some instances, an additional dielectric cover layer may be placed over the row and/or column traces to strengthen the structure and protect the entire assembly from damage.

At the “intersections” of the traces of the multi-touch panel 2224, where the traces pass or cross above and/or below each other (e.g., but do not make direct electrical contact with each other), the traces may essentially form two electrodes (although more than two traces could intersect as well). Each intersection of row and column traces may represent a capacitive sensing node and may be viewed as picture element (e.g., pixel) 2226, which may be particularly useful when multi-touch panel 2224 is viewed as capturing an “image” of touch.

For example, in at least one embodiment, after multi-touch subsystem 2227 has determined whether a touch event has been detected at each touch sensor in the multi-touch panel, the pattern of touch sensors in the multi-touch panel at which a touch event occurred may be viewed as an “image” of touch (e.g., a pattern of fingers touching the panel). The capacitance between row and column electrodes may appear as a stray capacitance on all columns when the given row is held at DC and/or as a mutual capacitance (e.g., Csig) when the given row is stimulated with an AC signal. The presence of a finger and/or other object near or on the multi-touch panel may be detected by measuring changes to Csig. The columns of multi-touch panel 2224 may drive one or more analog channels 2217 (also referred to herein as event detection and demodulation circuits) in multi-touch subsystem 2227. In some embodiments, each column may be coupled to a respective dedicated analog channel 2217. In other embodiments, the columns may be couplable via an analog switch to a different (e.g., fewer) number of analog channels 2217.

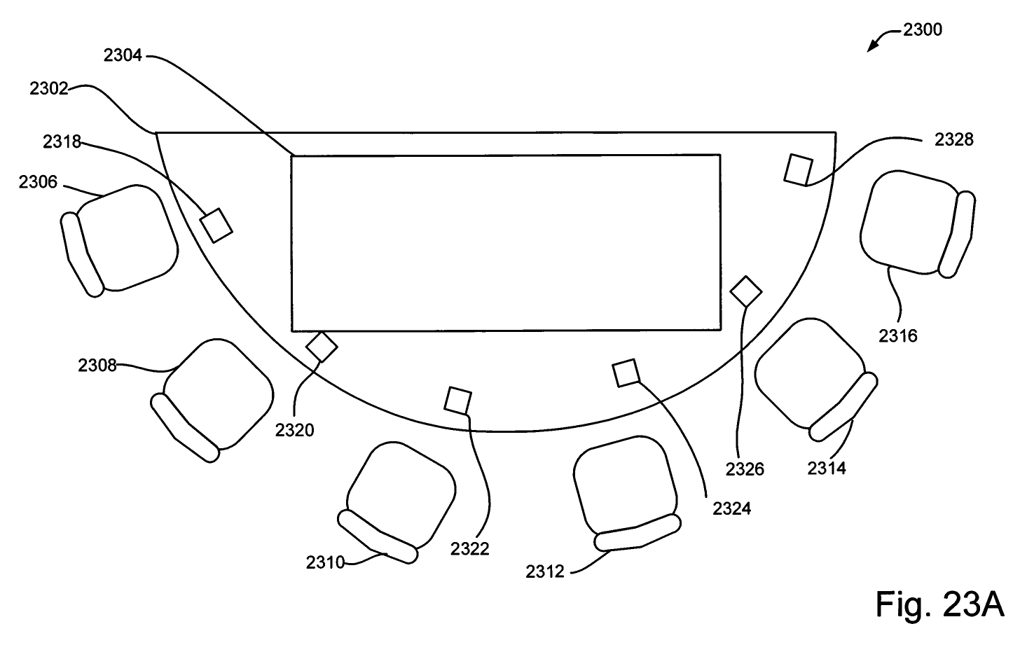

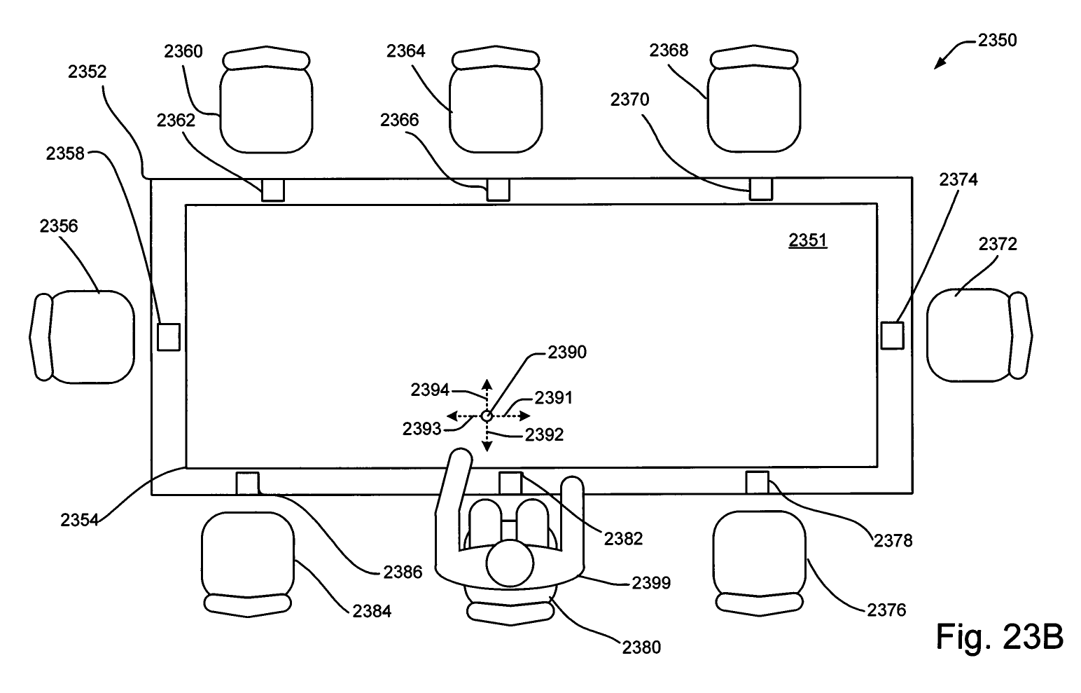

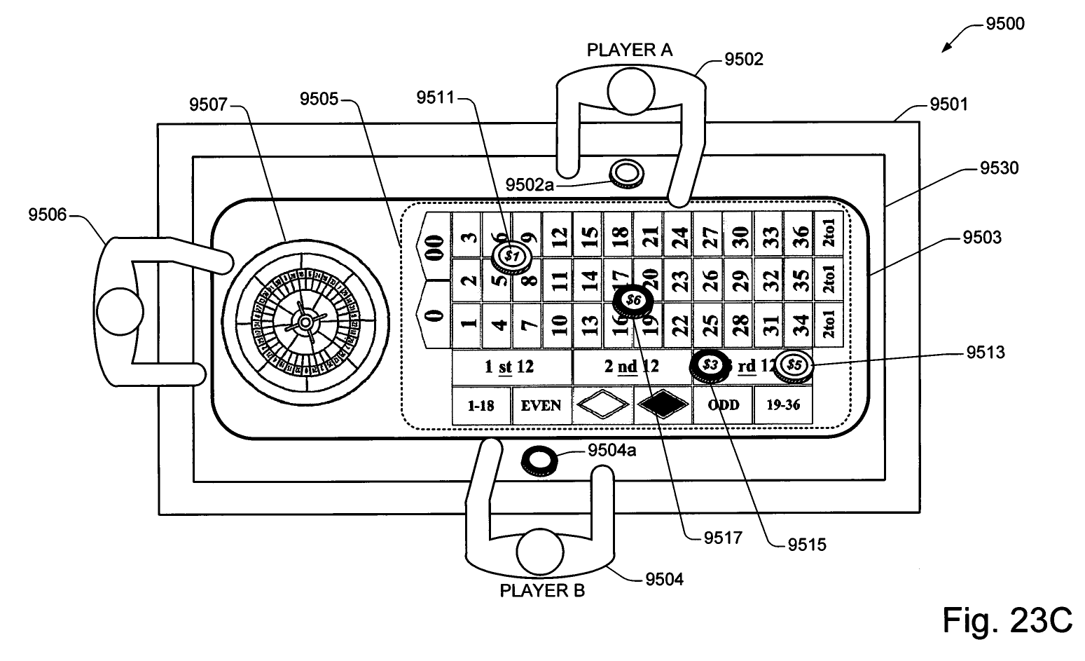

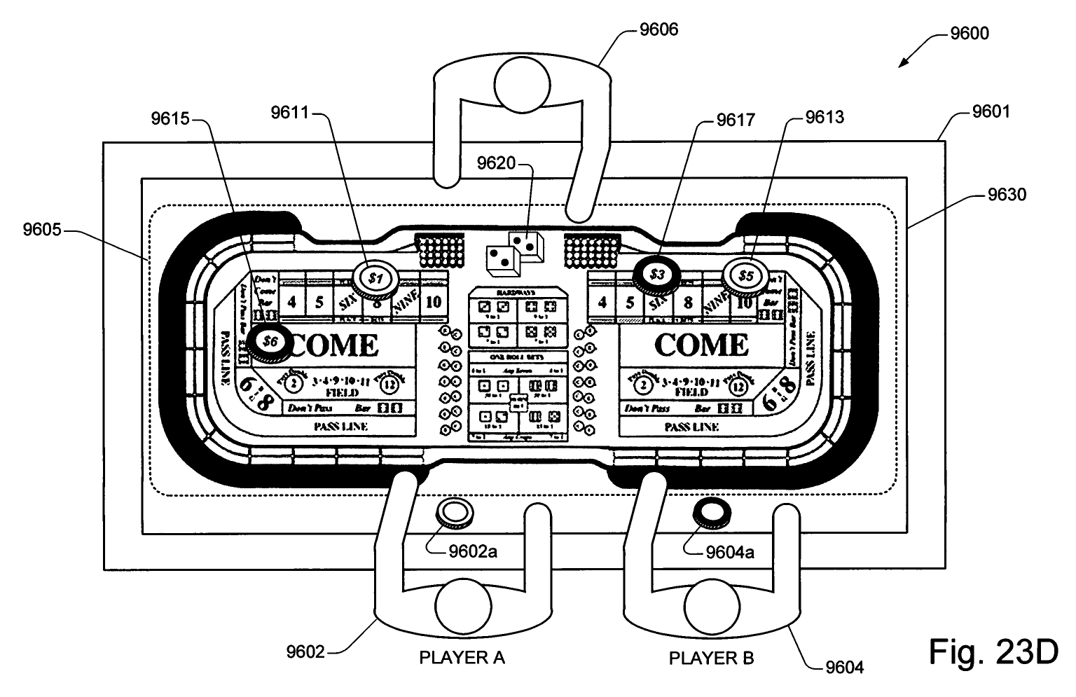

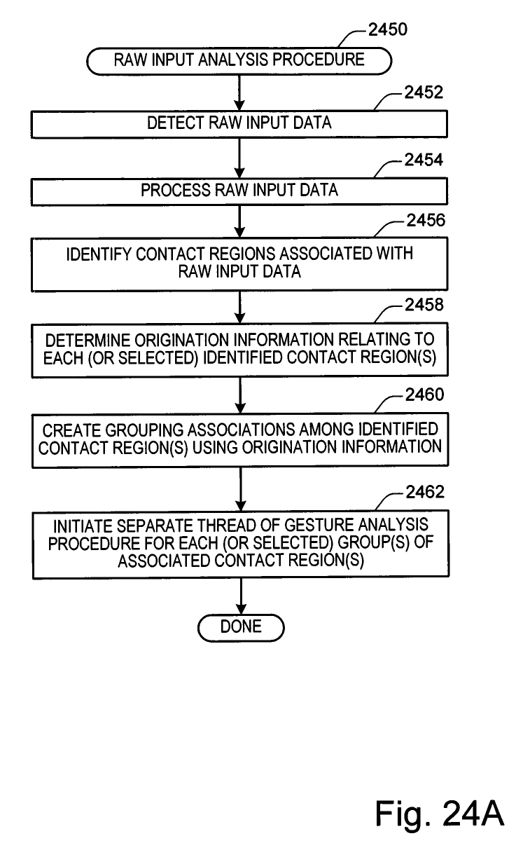

Intelligent multi-player electronic gaming system 2200 may also include host processor(s) 2214 for receiving outputs from multi-touch panel processor(s) 2212 and/or for performing actions based on the outputs. Further details of multi-touch sensor detection, including proximity detection by a touch panel, are described, for example, in the following patent applications: U.S. Patent Publication No. US2006/0097991, U.S. Patent Publication No. US2008/0168403 and U.S. Patent Publication No. US2006/0238522, each of which is incorporated herein by reference in its entirety for all purposes FIGS. 23A-D different example embodiments of intelligent multi-player electronic gaming system configurations having a multi-touch, multi-player interactive display surfaces.

FIG. 23A depicts a top view of a six-seat intelligent multi-player electronic gaming system 2300 having a multi-touch, multi-player interactive display surface 2304. As illustrated in the example embodiment of FIG. 23A, six (6) chairs 2306, 2308, 2310, 2312, 2314 and 2316 are arranged around a tabletop 2302. However, it will be appreciated that other embodiments (not illustrated) may include greater or fewer members of chairs/seats than that illustrated in the example embodiment of FIG. 23A. Additionally, in the illustrated embodiment, player tracking card readers/writers 2318, 2320, 2322, 2324 and 2328 may be provided for the players.

FIG. 23B depicts a top view of an eight-seat intelligent multi-player electronic gaming system 2350 having a multi-touch, multi-player interactive display surface 2351. As illustrated in the example embodiment of FIG. 23B, eight chairs 2356, 2360, 2364, 2368, 2372, 2376, 2380 and 2384 are arranged around the tabletop 2352. However, it will be appreciated that other embodiments (not illustrated) may include greater or fewer members of chairs/seats than that illustrated in the example embodiment of FIG. 23B. Additionally, in the illustrated embodiment, player tracking card readers/writers 2358, 2362, 2366, 2370, 2374, 2378, 2382, and 2386 may be provided for players.

FIGS. 23C and 23D illustrate different example embodiments of intelligent multi-player electronic gaming systems (e.g., 9501, 9601), each having a multi-touch, multi-player interactive display surface (e.g., 9530, 9630) for displaying and/or projecting wagering game images thereon in accordance with various aspects described herein. In at least one embodiment, such intelligent multi-player electronic gaming systems may form part of a server-based gaming network, wherein each intelligent multi-player electronic gaming system is operable to receive downloadable wagering games from a remote database according to various embodiments. In at least one embodiment, the wagering game network may include at least one wagering game server that is remotely communicatively linked via a communications network to a one or more intelligent multi-player electronic gaming systems. The wagering game server may store a plurality of wagering games playable on one or more of the intelligent multi-player electronic gaming systems via their respective display surfaces. For example, in one embodiment, an intelligent multi-player electronic gaming system may be initially configured or designed to function as a roulette-type gaming table (such as that illustrated, for example, in FIG. 23C), and may subsequently be configured or designed to function as a craps-type gaming table (such as that illustrated, for example, in FIG. 23D). In at least one embodiment, the wagering game playable on the intelligent multi-player electronic gaming system may be changed, for example, by downloading software and/or other information relating to a different wagering game theme and/or game type from the wagering game server to the intelligent multi-player electronic gaming system, whereupon the intelligent multi-player electronic gaming system may then reconfigure itself using the downloaded information.

According to one embodiment, the intelligent multi-player electronic gaming system 9501 of FIG. 23C illustrates an example embodiment of a multi-player roulette gaming table. In one embodiment, gaming system 9500 may include a virtual roulette wheel (e.g., 9507), while in other embodiments a gaming system 9501 may include a physical roulette wheel. As illustrated in the example embodiment of FIG. 23C, gaming system 9500 includes a multi-touch, multi-player interactive display 9530, which includes a common wagering areas 9505 that is accessible to the various player(s) (e.g., 9502, 9504) and casino staff (e.g., 9506) at the gaming system. For example, in at least one embodiment, players 9502 and 9504 may each concurrently place their respective bets at gaming system 9501 by interacting with (e.g., via contacts, gestures, etc) region 9505 of the multi-touch, multi-player interactive display 9530. In at least one embodiment, the individual wager(s) placed by each player at the gaming system 9501 may be graphically represented at the common wagering area 9505 of the multi-touch, multi-player interactive display. Further, in at least one embodiment, the wagers associated with each different player may be graphically represented in a manner which allows each player to visually distinguish his or her wagers from the wagers of other players at the gaming table.

For example, in the example embodiment of FIG. 23C, it is assumed that Player A 9502 has placed two wagers at the gaming system, which are graphically represented by wager token objects 9511 and 9513. Additionally, it is assumed that Player B 9504 has placed two wagers at the gaming system, which are graphically represented by wager token objects 9515 and 9517. As illustrated in the example of FIG. 23C, wager token objects 9511 and 9513 are displayed to have a visual appearance similar to the appearance of wagering token object 9502a, which, for example, represents the appearance of wagering token objects belonging to Player A 9502. Similarly, wager token objects 9515 and 9517 are displayed to have a visual appearance similar to the appearance of wagering token object 9504a, which, for example, represents the appearance of wagering token objects belonging to Player B 9504. As illustrated in the example of FIG. 23C, wager token objects 9511 and 9513 are displayed in a manner which has a different visual appearance than wager token objects 9515 and 9517, thereby allowing each player to visually distinguish his or her wagers from the wagers of other player(s) which are also displayed in the same common wagering area 9505.

In at least one embodiment, the intelligent multi-player electronic gaming system may be configured or designed to allow a player to select and/or modify only those placed wagers (e.g., displayed in common wagering area 9505) which belong to (or are associated with) that player. Thus, for example, in the example of FIG. 23C, Player B 9504 may be permitted to select, move, cancel, and/or otherwise modify wagering token objects 9515 and 9517 (e.g., belonging to Player B), but may not be permitted to select, move, cancel, and/or otherwise modify wagering token objects 9515 and 9517 (belonging to Player A). In some embodiments, the intelligent multi-player electronic gaming system may be configured or designed to permit an authorized casino employee 9506 (such as, for example, a dealer, croupier, pit boss, etc.) to select, move, cancel, and/or otherwise modify some or all of the wagering token objects which are displayed in common wagering area 9505.

According to one embodiment, the intelligent multi-player electronic gaming system 9601 of FIG. 23D illustrates an example embodiment of a multi-player craps gaming table. As illustrated in the example embodiment of FIG. 23D, gaming system 9600 includes a multi-touch, multi-player interactive display 9630, which includes a common wagering areas 9605 that is accessible to the various player(s) (e.g., 9602, 9604) and casino staff (e.g., croupier 9606) at the gaming system. For example, in at least one embodiment, players 9602 and 9604 may each concurrently place their respective bets at gaming system 9601 by interacting with (e.g., via contacts, gestures, etc) region 9605 of the multi-touch, multi-player interactive display 9630. In at least one embodiment, the individual wager(s) placed by each player at the gaming system 9601 may be graphically represented at the common wagering area 9605 of the multi-touch, multi-player interactive display. Further, in at least one embodiment, the wagers associated with each different player may be graphically represented in a manner which allows each player to visually distinguish his or her wagers from the wagers of other players at the gaming table.

In at least one embodiment, touches, contacts, movements and/or gestures by players (and/or other persons) interacting with the intelligent wager-based intelligent multi-player electronic gaming system may be distinguished among touches and/or gestures of other players. For example, various embodiments of the intelligent wager-based intelligent multi-player electronic gaming systems described herein may be configured or designed to automatically and dynamically determine the identity of each person who touches by different players are distinguishable without the player's having to enter any identification information and/or have such information detected by the intelligent multi-player electronic gaming system they are interacting with. Players' identities can remain anonymous, too, while playing multi-player games. In one aspect, the player may be identified by a sensor in a chair, and each sensor outputs a different signal that may be interpreted by the gaming system controller as a different player. If two players switch seats, for example, additional identification information could be inputted and/or detected, but not necessarily.

In one example embodiment, one or more player identification device(s) may be deployed at one or more chairs (e.g., 2380) associated with a given intelligent multi-player electronic gaming system. In at least one embodiment, a player identification device may include a receiver that may be capacitively coupled to the respective player. The receiver may be in communication with a gaming system controller located at the intelligent multi-player electronic gaming system. In one embodiment, the receiver receives signals transmitted from a transmitter array to an antenna in the antenna array under the display surface via a contact by the player sitting in the chair. When the player touches the display surface, a position signal may be sent from the antenna through the body of the player to the receiver. The receiver sends the signal to the gaming system controller indicating the player sitting in the chair has contacted the display surface and the position of the contact. In one embodiment, the receiver may communicate with the gaming system controller via a control cable. In other embodiments, a wireless connection may be used instead of the control cable by including a wireless interface on the receivers and gaming system controller. In at least some embodiments, the chairs (and associated receivers) may be replaced with a player-carried device such as a wrist strap, headset and/or waist pack in which case a player may stand on a conductive floor pad in proximity to the display surface.

Other types of gesture/contact origination identification techniques which may be used by and/or implemented at one or more intelligent multi-player electronic gaming system embodiments described herein are disclosed in one or more of the following references:

U.S. patent application Ser. No. 11/865,581 (Attorney Docket No. IGT1P424/P-1245) entitled “MULTI-USER INPUT SYSTEMS AND PROCESSING TECHNIQUES FOR SERVING MULTIPLE USERS” by Mattice et al., filed on Oct. 1, 2007, previously incorporated herein by reference for all purposes; and

U.S. Pat. No. 6,498,590, entitled “MULTI-USER TOUCH SURFACE” by Dietz et al., previously incorporated herein by reference for all purposes.

In at least one embodiment, the intelligent multi-player electronic gaming system may be configured or designed to associate a detected contact input (such as, for example, a gesture performed by a given player at the gaming system) with the chair or floor pad occupied by the player (or user) performing the contact/gesture. In some embodiments, the intelligent multi-player electronic gaming system may be configured or designed to associate a detected contact input with the player station associated with the player (or user) performing the contact/gesture. The intelligent multi-player electronic gaming system may also be configured or designed to determine an identity of the player performing the contact/gesture using information relating to the player's associated chair, player station, personalized object used in performing the gesture, etc.). In at least some embodiments, the identity of the player may be represented using an anonymous identifier (such as, for example, an identifier corresponding to the player's associated player station or chair) which does not convey any personal information about that particular player. In some embodiments, the intelligent multi-player electronic gaming system may be configured or designed to associate a detected contact input with the actual player (or user) who performed the contact/gesture.

In at least one embodiment, a detected input gesture from a player may be interpreted and mapped to an appropriate function. The gaming system controller may then execute the appropriate function in accordance with various criteria such as, for example, one or more of different types of criteria disclosed or referenced herein.

One advantageous feature of at least some intelligent multi-player electronic gaming system embodiments described herein relates to a players' ability to select wagering elements and/or objects (whether virtual and/or physical) from a common area and/or move objects to a common area. In at least one embodiment, the common area may be visible by all (or selected) players seated at the gaming table system, and the movement of objects in and out of the common area may be observed by all (or selected) players. In this way, the players at the gaming table system may observe the transfer of items into and out of the common area, and may also visually identify the live player(s) who is/are transferring items into and out of the common area.

In at least one embodiment, objects moved into and/or out of a common area may be selected simultaneously by multiple players without one player having to wait for another player to complete a transfer. This may help to reduce sequential processing of commands and associated real-time delays. For example, in one embodiment, multiple inputs may be processed substantially simultaneously (e.g., in real-time) without necessarily requiring particular sequences of events to occur in order to keep the game play moving. As a result, wagering throughput at the gaming table system may be increased since, for example, multiple wagers may be simultaneously received and concurrently processed at the gaming table system, thereby enabling multiple game actions to be performed concurrently (e.g., in real-time), and reducing occurrences of situations (and associated delays) involving a need to wait for other players and/or other wagering-game functions to be carried out. This may also help to facilitate a greater an awareness by players seated around the gaming table system of the various interactions presently occurring at the gaming table system. As such, this may help to foster a player's confidence and/or comfort level with the electronic gaming table system, particularly those players who may prefer mechanical-type gaming machines. Additionally, it allows players to observe each other and communicate with each other, and facilitates collective decision-making by the players as a group.

Further, as will readily be appreciated, by reducing or eliminating the need for events at the gaming table system to occur (and/or to be ordered) in a particular sequence, additional opportunities may be available to players to enter and leave the wagering environment at will. For example, in at least one embodiment, a player may join at any point and leave at any point without disrupting the other players and/or without requiring game play to be delayed, interrupted and/or restarted.

In at least one embodiment, sensors in the chairs may be configured or designed to detect when a player sits down and/or leaves the table, and to automatically trigger and/or initiate (e.g., in response to detecting that a given player is no longer actively participating at the gaming table system), any appropriate actions such as, for example, one or more actions relating to transfers of wagering assets and/or balances to the player's account (and/or to a portable data unit carried by the player). Additionally, in some embodiments, a least a portion of these actions may be performed without disrupting and/or interrupting game play and/or other events which may be occurring at that time at the gaming table system.

Another advantageous aspect of the various intelligent multi-player electronic gaming system embodiments described herein relates to the use of “personal” player areas or regions of the multi-touch, multi-player interactive display surface. For example, in at least one embodiment, a player at the intelligent multi-player electronic gaming system may be allocated at least one region or area of the multi-touch, multi-player interactive display surface which represents the player's “personal” area, and which may be allocated for exclusive use by that player.

For example, in at least one embodiment, an intelligent multi-player electronic gaming system may be configured or designed to automatically detect the presence and relative position of a player along the perimeter of the multi-touch, multi-player interactive display surface, and in response, may automatically and/or dynamically display a graphical user interface (GUI) at a region in front of the player which represents that player's personal use area/region. In at least one embodiment, the player may be permitted to dynamically modify the location, shape, appearance and/or other characteristics of the player's personal region. Such personal player regions may help to foster a sense of identity and/or “ownership” of that region of the display surface. Thus, for example, in at least one embodiment, a player may “stake out” his or her area of the table surface, which may then be allocated for personal and/or exclusive use by that player while actively participating in various activities at the gaming table system.

According to specific embodiments, the intelligent multi-player electronic gaming system may be configured or designed to allow a player to define a personal wagering area where wagering assets are to be physically placed and/or virtually represented. In at least one embodiment, the player may move selected wagering assets (e.g., via gestures) into the player's personal wagering area.

In particular embodiments, various types of user input (e.g., which may include, for example, player game play and/or wagering input/instructions) may be communicated in the form of one or more movements and/or gestures. According to one embodiment, recognition and/or interpretation of such gesture-based instructions/input may be based, at least in part, on one or more of the following characteristics (or combinations thereof):
characteristics relating to a beginning point and endpoint of a motion/gesture;
differences between such beginning points and endpoints;
length of time used in performing a given gesture;
the number of contact points used in performing a given gesture;
the shape of contact points used in performing a given gesture;
the relative positions of the contact points used in performing a given gesture;
characteristics relating to the displacement of a given gesture;
characteristics relating to the velocity of a given gesture;
characteristics relating to the acceleration of a given gesture;
etc.

For example, in one embodiment, a particular movement or gesture performed by a player (or other user) may comprise a series, sequence and/or pattern of discrete acts (herein collectively referred to as “raw movement(s)” or “raw motion”) such as, for example, a tap, a drag, a prolonged contact, etc., which occur within one or more specific time intervals. Further, according to different embodiments, the raw movement(s) associated with a given gesture may be performed using one or more different contact points or contact regions.

Various examples of different combinations of contact points (which, for example, may be used for performing one or more gestures with a single hand) may include, but are not limited to, one or more of the following (or combinations thereof): Any two fingers; Any three fingers; Any four fingers; Thumb+any finger; Thumb+any two fingers; Thumb+any three fingers; Thumb+four fingers; Two adjacent fingers; Two non adjacent fingers; Two adjacent fingers+one non adjacent finger; Thumb+two adjacent fingers; Thumb+two non adjacent fingers; Thumb+two adjacent fingers+one non adjacent finger; Any two adjacent fingers closed; Any two adjacent fingers spread; Any three adjacent fingers closed; Any three adjacent fingers spread; Four adjacent fingers closed; Four adjacent fingers spread; Thumb+two adjacent fingers closed; Thumb+two adjacent fingers spread; Thumb+three adjacent fingers closed; Thumb+three adjacent fingers spread; Thumb+four adjacent fingers closed; Thumb+four adjacent fingers spread; Index; Middle; Ring; Pinky; Index+Middle; Index+Ring; Index+Pinky; Middle+Ring; Middle+Pinky; Ring+Pinky; Thumb+Index; Thumb+Middle; Thumb+Ring; Thumb+Pinky; Thumb+Index+Middle; Thumb+Index+Ring; Thumb+Index—Pinky; Thumb+Middle+Ring; Thumb+Middle+Pinky; Thumb+Ring+Pinky; Index+Middle+Ring; Index+Middle+Pinky; Index+Ring+Pinky; Middle+Ring+Pinky; Thumb+Index+Middle+Ring; Thumb+Index+Middle+Pinky; Thumb+Index+Ring+Pinky; Thumb+Middle+Ring+Pinky; Index+Middle+Ring+Pinky; Thumb+Index+Middle+Ring+Pinky; Palm Face Down: Fingers closed fist or wrapped to palm; Index+remaining fingers closed fist or wrapped to palm; Index+Middle+remaining fingers closed fist or wrapped to palm; Index+Middle+Ring+Pinky closed fist or wrapped to palm; Thumb+remaining fingers closed fist or wrapped to palm; Thumb+Index+remaining fingers closed fist or wrapped to palm; Thumb+Index+Middle+remaining fingers closed fist or wrapped to palm; Thumb+Index+Middle+Ring+Pinky closed fist or wrapped to palm; Thumb+Index+remaining fingers closed fist or wrapped to palm; Thumb+Index+Middle+remaining fingers closed fist or wrapped to palm; Thumb+Index+Middle+Ring+Pinky closed fist or wrapped to palm; Right side of Hand; Left Side of Hand; Backside of hand; Front side of hand; Knuckles Face Down/Punch: Fingers closed fist or wrapped to palm; Index open+remaining fingers closed fist or wrapped to palm; Index open+Middle open+remaining fingers closed fist or wrapped to palm; Index open+Middle open+Ring open+Pinky closed fist or wrapped to palm; Thumb+Fingers closed fist or wrapped to palm; Thumb+Index open+remaining fingers closed fist or wrapped to palm; Thumb+Index open+Middle open+remaining fingers closed fist or wrapped to palm; Thumb+Index open+Middle open+Ring open+Pinky closed fist or wrapped to palm.

In some embodiments, at least some gestures may involve the use of two (or more) hands, wherein one or more digits from each hand is used to perform a given gesture. In some embodiments, one or more non-contact gestures may also be performed (e.g., wherein a gesture is performed without making physical contact with the multi-touch input device). In some embodiments, gestures may be conveyed using one or more appropriately configured handheld user input devices (UTDs) which, for example, may be capable of detecting motions and/or movements (e.g., velocity, displacement, acceleration/deceleration, rotation, orientation, etc). In at least one embodiment, tagged objects may be used to perform touches and/or gestures at or over the multi-touch, multi-player interactive display surface (e.g., with or without accompanying finger/hand contacts).

FIG. 24A shows a specific embodiment of a Raw Input Analysis Procedure 2450. FIG. 24B shows an example embodiment of a Gesture Analysis Procedure 2400. In at least one embodiment, at least a portion of the Raw Input Analysis Procedure 2450 and/or Gesture Analysis Procedure 2400 may be implemented by one or more systems, devices, and/or components of one or more intelligent multi-player electronic gaming system embodiments described herein.

As described in greater detail below, various operations and or information relating to the Raw Input Analysis Procedure and/or Gesture Analysis Procedure may be processed by, generated by, initiated by, and/or implemented by one or more systems, devices, and/or components of an intelligent multi-player electronic gaming system for the purpose of providing multi-touch, multi-player interactive display capabilities at the intelligent multi-player electronic gaming system.

For purposes of illustration, various aspects of the Raw Input Analysis Procedure 2450 and/or Gesture Analysis Procedure 2400 may now be described by way of example with reference to a specific example embodiment of an intelligent multi-player electronic gaming system which includes a multi-touch, multi-player interactive display surface having at least one multipoint or multi-touch input interface. In this particular example embodiment, it is assumed that the intelligent multi-player electronic gaming system has been configured to function as a multi-player electronic table gaming system in which multiple different players at the multi-player electronic table gaming system may concurrently interact with (e.g., by performing various gestures at or near the surface of) the gaming system's multi-touch, multi-player interactive display.

Referring first to FIG. 24A, as the various different players at the multi-player electronic table gaming system interact with the gaming system's multi-touch, multi-player interactive display surface, the gaming system may detect (2452) various types of raw input data (e.g., which may be received, for example, via one or more multipoint or multi-touch input interfaces of the multi-touch, multi-player interactive display device). For example, according to different embodiments, the raw input data may be represented by one or more images (e.g., captured using one or more different types of sensors) of the input surface which were recorded or captured by one or more multi-touch input sensing devices.

At 2454, the raw input data may be processed. In at least one embodiment, at least a portion of the raw input data may be processed by the gaming controller of the gaming system. In some embodiments, separate processors and/or processing systems may be provided at the gaming system for processing all or specific portions of the raw input data.

In at least one embodiment, the processing of the raw input data may include identifying (2456) the various contact region(s) and/or chords associated with the processed raw input data. Generally speaking, when objects are placed near or on a touch sensing surface, one or more regions of contact (sometimes referred to as “contact patches”) may be created and these contact regions form a pattern that can be identified. The pattern can be made with any assortment of objects and/or portions of one or more hands such as finger, thumb, palm, knuckles, etc.

At 2458, origination information relating to each (or at least some) of the identified contact regions may be determined and/or generated. For example, in some embodiments, each (or at least some) of the identified contact regions may be associated with a specific origination entity representing the entity (e.g., player, user, etc.) considered to be the “originator” of that contact region. Of course it is possible for several different identified contact regions to be associated with the same origination entity, such as, for example, in situations involving one or more users performing multi-contact gestures.

In at least one embodiment, one or more different types of user input identification/origination systems may be operable to perform one or more of the above-described functions relating to: the processing of raw input data, the identification of contact regions, and/or the determination/generation of contact region (or touch) origination information. Examples of at least some suitable user input identification/origination systems are illustrated and described with respect to the FIGS. 7A-D. In at least some embodiments, the intelligent multi-player electronic gaming system may utilize other types of multi-touch, multi-person sensing technology for performing one or more functions relating to raw input data processing, contact region (e.g., touch) identification, and/or touch origination. For example, one such suitable multi-touch, multi-person sensing technology is described in U.S. Pat. No. 6,498,590, entitled “MULTI-USER TOUCH SURFACE” by Dietz et al., previously incorporated herein by reference for all purposes.

At 2460, various associations may be created between or among the different identified contact regions to thereby enable the identified contact regions to be separated into different groupings in accordance with their respective associations. For example, in at least one embodiment, the origination information may be used to identify or create different groupings of contact regions based on contact region-origination entity associations. In this way, each of the resulting groups of contact region(s) which are identified/created may be associated with the same origination entity as the other contact regions in that group.

Thus, for example, in one embodiment, if two different users at the intelligent multi-player electronic gaming system were to each perform, at about the same time, a one hand multi-touch gesture at the multi-touch, multi-player interactive display surface, the intelligent multi-player electronic gaming system may be operable to process the raw input data relating to each gesture (e.g., using the Raw Input Analysis Procedure) and identify two groupings of contact regions, wherein one grouping is associated with the first user, and the other grouping is associate with the second user. Once this information has been obtained/generated, a gesture analysis procedure (e.g., 24B) may be performed for each grouping of contact regions, for example, in order to recognize the gesture(s) performed by each of the users, and to map each of the recognized gesture(s) to respective functions.

It is anticipated that, in at least some embodiments, a complex gesture may permit or require participation by two or more users at the intelligent multi-player electronic gaming system. For example, in one embodiment, a complex gesture for manipulating an object displayed at the multi-touch, multi-player interactive display surface may involve the participation of two or more different users at the intelligent multi-player electronic gaming system simultaneously or concurrently interacting with that displayed object (e.g., wherein each user's interaction is implemented via a gesture performed at or over a respective region of the display object). Accordingly, in at least some embodiments, the intelligent multi-player electronic gaming system may be operable to process the raw input data resulting from the multi-user combination gesture, and to identify and/or create associations between different identified groupings of contact regions. For example, in the above have been described example where two or more different users at the gaming system are simultaneously or concurrently interacting with the displayed object, the identified individual contact regions may be grouped together according to their common contact region-origination entity associations, and the identified groups of contact regions may be associated or group together based on their identified common associations (if any). In this particular example, and the identified groups of contact regions may be associated or group together based on their common associations of interacting with the same displayed object at about the same time.

As shown at 2462, one or more separate (and/or concurrent) threads of a gesture analysis procedure (e.g., Gesture Analysis Procedure 2400) may be initiated for each (or selected) group(s) of associated contact region(s).

In the example of FIG. 24B, it is assumed that a separate instance or thread of the Gesture Analysis Procedure 2400 has been initiated (e.g., by the Raw Input Analysis Procedure) for processing a gesture involving an identified grouping of one or more contact region(s) which has been performed by a user at the intelligent multi-player electronic gaming system.

As shown at 2401, it is assumed that various types of input parameters/data may be provided to the Gesture Analysis Procedure for processing. Examples of various types of input data which may be provided to the Gesture Analysis Procedure may include, but are not limited to, one or more of the following (or combinations thereof):
identified groupings of contact region(s);
origination information (e.g., contact region-origination entity associations, touch-ownership associations, etc.);
origination entity identifier information;
information useful for determining an identity of the player/person performing the gesture;
association(s) between different identified groups of contact regions;
number/quantity of contact regions;
shapes/sizes of regions;
coordination location(s) of contact region(s) (which, for example, may be expressed as a function of time and/or location);
arrangement of contact region(s)
raw movement data (e.g., data relating to movements or locations of one or more identified contact region(s), which, for example, may be expressed as a function of time and/or location);
movement characteristics of gesture (and/or portions thereof) such as, for example, velocity, displacement, acceleration, rotation, orientation, etc.;
timestamp information (e.g., gesture start time, gesture end time, overall duration, duration of discrete portions of gesture, etc.)
game state information;
gaming system state information;
starting point of gesture;
ending point of gesture;
number of discrete acts involved with gesture;
types of discrete acts involved with gesture;
order of sequence of the discrete acts;
contact/non-contact based gesture;
initial point of contact of gesture;
ending point of contact of gesture;
current state of game play (e.g., which existed at the time when gesture detected);
game type of game being played at gaming system (e.g., as of the time when the gesture was detected);
game theme of game being played at gaming system (e.g., as of the time when the gesture was detected);
current activity being performed by user (e.g., as of the time when the gesture was detected);
etc.

In at least some embodiments, at least some of the example input data described above may not yet be determined, and/or may be determined during processing of the input data at 2404.

At 2402, if desired, and identity of the origination entity (e.g., identity of the user who performed the gesture) may be determined. In at least one embodiment, such information may be subsequently used for performing user-specific gesture interpretation/analysis, for example, based on known characteristics relating to that specific user. In some embodiments, the determination of the user/originator identity may be performed at a subsequent stage of the Gesture Analysis Procedure.

At 2404, the received input data portions(s) may be processed, along with other contemporaneous information, to determine, for example, various properties and/or characteristics associated with the input data such as, for example, one or more of the following (or combinations thereof):
Determining and/or recognizing various contact region characteristics such as, for example, one or more of the following (or combinations thereof): number/quantity of contact regions; shapes/sizes of regions; coordination location(s) of contact region(s) (which, for example, may be expressed as a function of time and/or location); arrangement(s) of contact region(s);
Determining and/or recognizing association(s) between different identified groups of contact regions;
Determining and/or recognizing raw movement data such as, for example: data relating to movements or locations of one or more identified contact region(s), which, for example, may be expressed as a function of time and/or location;
Determining information useful for determining an identity of the player/person performing the gesture;
Determining and/or recognizing movement characteristics of the gesture (and/or portions thereof) such as, for example: velocity, displacement, acceleration, rotation, orientation, etc.;
Determining and/or recognizing various types of gesture specific characteristics such as, for example, one or more of the following (or combinations thereof): starting point of gesture; ending point of gesture; starting time of gesture; ending time of gesture; duration of gesture (and/or portions thereof); number of discrete acts involved with gesture; types of discrete acts involved with gesture; order of sequence of the discrete acts; contact/non-contact based gesture; initial point of contact of gesture; ending point of contact of gesture; etc.
Determining and/or accessing other types of information which may be contextually relevant for gesture interpretation and/or gesture-function mapping, such as, for example, one or more of the following (or combinations thereof): game state information; gaming system state information; current state of game play (e.g., which existed at the time when gesture detected); game type of game being played at gaming system (e.g., as of the time when the gesture was detected); game theme of game being played at gaming system (e.g., as of the time when the gesture was detected); number of persons present at the gaming system; number of persons concurrently interacting with the interacting with the multi-touch, multi-player interactive display surface (e.g., as of the time when the gesture was detected); current activity being performed by user (e.g., as of the time when the gesture was detected); number of active players participating in current game; amount or value of user's wagering assets;
Etc.

In at least one embodiment, the processing of the input data at 2040 may also include application of various filtering techniques and/or fusion of data from multiple detection or sensing components of the intelligent multi-player electronic gaming system.

At 2406, the processed raw movement data portion(s) may be mapped to a gesture. According to specific embodiments, the mapping of raw movement data to a gesture may include, for example, accessing (2408) a user settings database, which, for example, may include user data (e.g., 2409). According to specific embodiments, such user data may include, for example, one or more of the following (or combination thereof): user precision and/or noise characteristics/thresholds; user-created gestures; user identity data and/or other user-specific data or information. According to specific embodiments, the user data 2409 may be used to facilitate customization of various types of gestures according to different, customized user profiles.

In at least one embodiment, user settings database 2408 may also include environmental model information (e.g., 2410) which, for example, may be used in interpreting or determining the current gesture. For example, in at least one embodiment, through environmental modeling, the intelligent multi-player electronic gaming system may be operable to mathematically represent its environment and the effect that environment is likely to have on gesture recognition.

For example, in one embodiment, if it is determined that the intelligent multi-player electronic gaming system is located in a relatively noisy environment, then the intelligent multi-player electronic gaming system may automatically raise the noise threshold level for audio-based gestures.

Additionally, in at least some embodiments, mapping of the actual motion to a gesture may also include accessing a gesture database (e.g., 2412). For example, in one embodiment, the gesture database 2412 may include data which characterizes a plurality of different gestures recognizable by the intelligent multi-player electronic gaming system for mapping the raw movement data to a specific gesture (or specific gesture profile) of the gesture database. In at least one embodiment, at least some of the gestures of the gesture database may each be defined by a series, sequence and/or pattern of discrete acts. In one embodiment, the raw movement data may be matched to a pattern of discrete acts corresponding to of one of the gestures of the gesture database.

It will be appreciated that, it may be difficult for a user to precisely duplicate the same raw movements for one or more gestures each time those gestures are to be used as input. Accordingly, particular embodiments may be operable to allow for varying levels of precision in gesture input. Precision describes how accurately a gesture must be executed in order to constitute a match to a gesture recognized by the intelligent multi-player electronic gaming system, such as a gesture included in a gesture database accessed by the intelligent multi-player electronic gaming system. According to specific embodiments, the closer a user generated motion must match a gesture in a gesture database, the harder it will be to successfully execute such gesture motion. In particular embodiments movements may be matched to gestures of a gesture database by matching (or approximately matching) a detected series, sequence and/or pattern of raw movements to those of the gestures of the gesture database.

For example, as the precision of gestures required for recognition increases, one may have more gestures (at the same level of complexity) that may be distinctly recognized. In particular embodiments, the precision required by intelligent multi-player electronic gaming system for gesture input may be varied. Different levels of precision may be required based upon different conditions, events and/or other criteria such as, for example, different users, different regions of the “gesture space” (e.g., similar gestures may need more precise execution for recognition while gestures that are very unique may not need as much precision in execution), different individual gestures, such as signatures, and different functions mapped to certain gestures (e.g., more critical functions may require greater precision for their respective gesture inputs to be recognized), etc. In some embodiments users and/or casino operators may be able to set the level(s) of precision required for some or all gestures or gestures of one or more gesture spaces.

According to specific embodiments, gestures may be recognized by detecting a series, sequence and/or pattern of raw movements performed by a user according to an intended gesture. In at least one embodiment, recognition may occur when the series, sequence and/or pattern of raw movements is/are matched by the intelligent multi-player electronic gaming system (and/or other system or device) to a gesture of a gesture database.

At 2414, the gesture may be mapped to one or more operations, input instructions, and/or tasks (herein collectively referred to as “functions”). According to at least one embodiment, this may include accessing a function mapping database (e.g., 2416) which, for example, may include correlation information between gestures and functions.

In at least one embodiment, different types of external variables (e.g., context information 2418) may affect the mappings of gestures to the appropriate functions. Thus, for example, in at least one embodiment, function mapping database 2416 may include specific mapping instructions, characteristics, functions and/or any other input information which may be applicable for mapping a particular gesture to appropriate mapable features (e.g., functions, operations, input instructions, tasks, keystrokes, etc) using at least a portion of the external variable or context information associated with the gesture. Additionally, in at least some embodiments, different users may have different mappings of gestures to functions and different user-created functions.

For example, according to specific embodiments, various types of context information (and/or criteria) may be used in determining the mapping of a particular gesture to one or more mapable features or functions. Examples of such context information may include, but are not limited to, one or more of the following (or combinations thereof):
game state information (e.g., current state of game play at the time when gesture performed);
criteria relating to game play rules/regulations (e.g., relating to the game currently being played by the user);
criteria relating to wagering rules/regulations;
game type information (e.g., of game being played at intelligent multi-player electronic gaming system at the time when gesture performed);
game theme information (e.g., of game being played at intelligent multi-player electronic gaming system at the time when gesture performed);
wager-related paytable information (e.g., relating to the game currently being played by the user);
wager-related denomination information (e.g., relating to the game currently being played by the user);
user identity information (e.g., 2411), which, for example, may include information relating to an identity of the player/person performing the gesture;
time/date information;
location(s) of the region(s) of contact at (or over) the multi-touch, multi-player interactive display surface of the gesture;
content displayed at the multi-touch, multi-player interactive display (e.g., at the time when gesture performed);
user/player preferences;
environmental model information (e.g., 2419);
device state information (e.g., 2421)
application in focus information (e.g., 2420);
etc.

Thus, for example, in at least one embodiment, a first identified gesture may be mapped to a first set of functions (which, for example, may include one or more specific features or functions) if the gesture was performed during play of a first game type (e.g., Blackjack) at the intelligent multi-player electronic gaming system; whereas the first identified gesture may be mapped to a second set of functions if the gesture was performed during play of a second game type (e.g., Sic Bo) at the intelligent multi-player electronic gaming system.

At 2422 one or more associations may be created between the identified function(s) and the user who has been identified as the originator of the identified gesture. In at least one embodiment, such associations may be used, for example, for creating a causal association between the initiation of one or more functions at the gaming system and the input instructions provided by the user (via interpretation of the user's gesture).

As shown at 2424, the intelligent multi-player electronic gaming system may initiate the appropriate mapable set of features or functions which have been mapped to the identified gesture. For example, in at least one embodiment, an identified gesture may be mapped to a specific set of functions which are associated with a particular player input instruction (e.g., “STAND”) to be processed and executed during play of a blackjack gaming session conducted at the intelligent multi-player electronic gaming system.

Additional details relating to various aspects of gesture mapping technology are described in U.S. patent application Ser. No. 10/807,562 to Marvit et al., entitled “Motion Controlled Remote Controller”, filed Mar. 23, 2004, the entirety of which is incorporated herein by reference for all purposes.

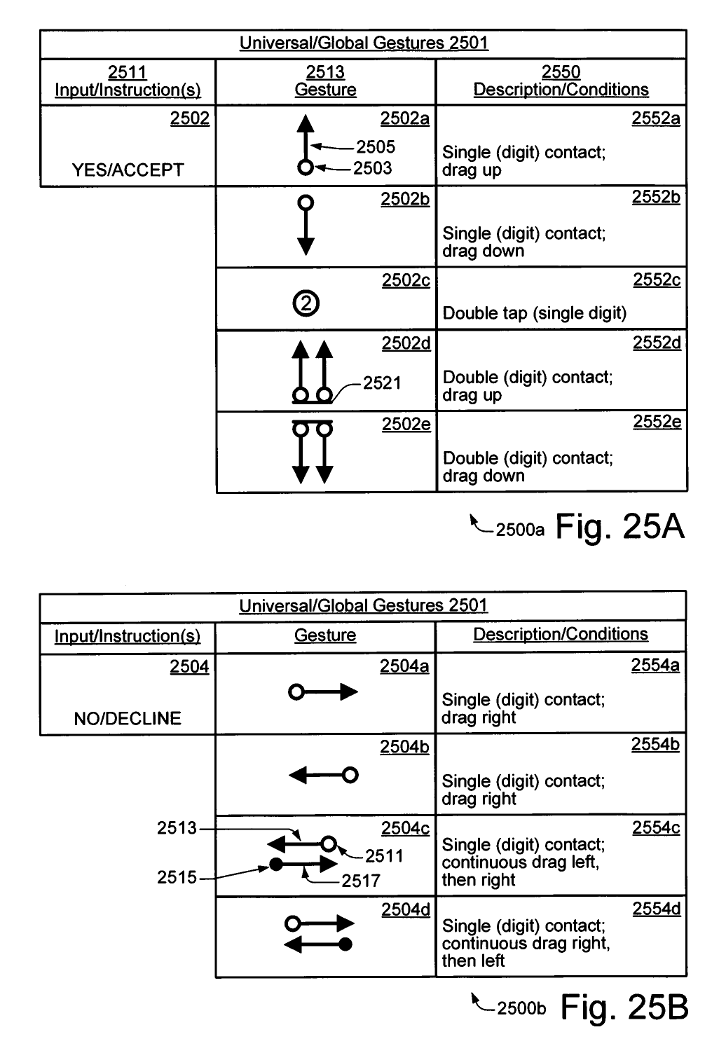

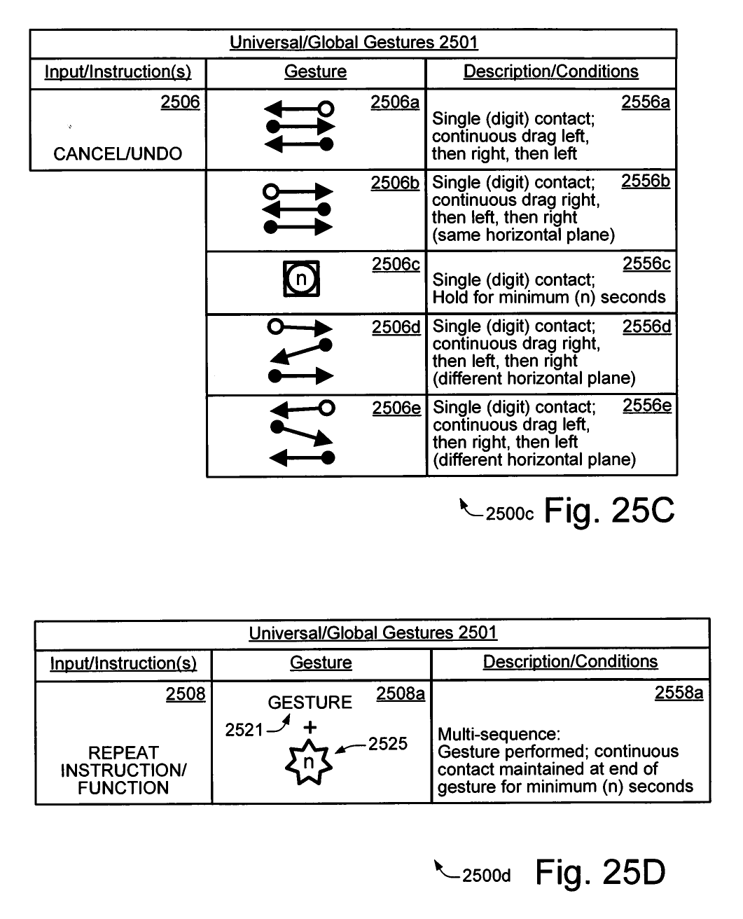

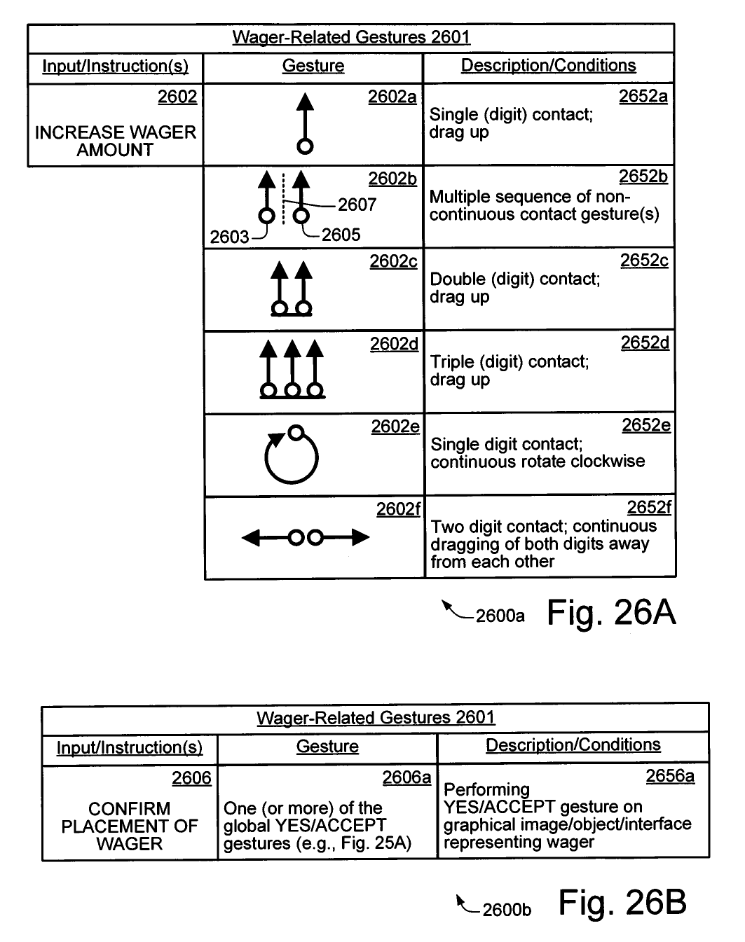

FIGS. 25-39 illustrate various example embodiments of different gestures and gesture-function mappings which may be utilized at one or more intelligent multi-player electronic gaming systems described herein. In at least one embodiment, an intelligent multi-player electronic gaming system may be configured or designed as an intelligent wager-based gaming system having a multi-touch, multi-player interactive display surface. In one embodiment, an intelligent multi-player electronic gaming system may be configured to function as a live, multi-player electronic wager-based casino gaming table. Example embodiments of such intelligent multi-player electronic gaming systems (and/or portions thereof) are illustrated, for example, in FIGS. 1, 5A, 5B, 23A, 23B, 23C, 23D, and 39A.

In at least one embodiment, gesture-function mapping information relating to the various gestures and gesture-function mappings of FIGS. 25-29 may be stored in one or more gesture databases (such as, for example, gesture database 2412 of FIG. 24B) and/or one or more function mapping databases (such as, for example, function mapping database 2416 of FIG. 24B). Further, in at least one embodiment, at least a portion of the gesture-function mapping information may be used, for example, for mapping detected raw input data (e.g., resulting from a user interacting with an intelligent multi-player electronic gaming system) to one or more specific gestures, for mapping one or more identified gestures to one or more operations, input instructions, and/or tasks (herein collectively referred to as “functions”), and/or for associating one or more gestures (and/or related functions) with one or more specific users (e.g., who have been identified as the originators of the identified gestures).

In at least one embodiment, the gesture-function mapping information may include data which characterizes a plurality of different gestures recognizable by the intelligent multi-player electronic gaming system for mapping the raw input data to a specific gesture (or specific gesture profile) of the gesture database. In at least one embodiment, at least some of the gestures of the gesture database may each be defined by a series, sequence and/or pattern of discrete acts. Further, in some embodiments, the raw movement(s) associated with a given gesture may be performed using one or more different contact points or contact regions.

In one embodiment, the raw input data may be matched to a particular series, sequence and/or pattern of discrete acts (and associated contact region(s)) corresponding to of one or more of the gestures of the gesture database.

According to specific embodiments, gestures may be recognized by detecting a series, sequence and/or pattern of raw movements (and their associated contact region(s)) performed by a user according to an intended gesture. In at least one embodiment, the gesture-function mapping information may be used to facilitate recognition, identification and/or determination of a selected function (e.g., corresponding to a predefined set of user input instructions) when the series, sequence and/or pattern of raw movements (and their associated contact region(s)) is/are matched (e.g., by the intelligent multi-player electronic gaming system and/or other system or device) to a specific gesture which, for example, has been selected using various types of contemporaneous contextual information.

For example, FIGS. 25A-D illustrate various example embodiments of different types of universal and/or global gesture-function mapping information which may be utilized at one or more intelligent multi-player electronic gaming systems described herein. In at least some embodiments, one or more of the various gesture-related techniques described herein may be implemented at one or more gaming system embodiments which include a single touch interactive display surface.

As illustrated in the example embodiment of FIG. 25A, an example plurality of different (e.g., alternative) gestures are graphically represented and described which, for example, may be mapped to function(s) (e.g., user input/instructions) corresponding to: “YES” and/or “ACCEPT”.

For example, in at least one embodiment, a user may convey the input/instruction(s) “YES” and/or “ACCEPT,” for example, by performing gesture 2502a at a multipoint or multi-touch input interface of an intelligent multi-player electronic gaming system. As illustrated in the example embodiment of FIG. 25A, gesture 2502a may be defined to include at least the following gesture-specific characteristics: one contact region, drag up movement. In at least one embodiment, this gesture may be interpreted as being characterized by an initial single point or single region of contact 2503 (herein referred to as a single “contact region”), followed by movement 2505 (e.g., dragging, sliding, pushing, pulling, etc.) of the contact region upward (e.g., relative to the initial location of contact, and/or relative to the location of the user performing the gesture), followed by a break of continuous contact.

For reference purposes, a ringed symbol (e.g., 2503) may be defined herein to represent an initial contact point of any gesture (or portion thereof) involving any sequence of movements in which contact with the multi-touch input interface is continuously maintained during that sequence of movements. Thus, for example, as illustrated by the representation of gesture 2502a of FIG. 25A, ring symbol 2503 represents an initial point of contact relating to a gesture (or portion thereof) involving continuous contact with the multi-touch input interface, and arrow segment 2505 represents the direction(s) of subsequent movements of continuous contact immediately following the initial point of contact.

Additionally, it may generally be assumed for reference purposes that the various example embodiments of gestures disclosed herein (such as, for example, those illustrated and described with respect to FIGS. 25-39) are being described with respect to a specific example perspective relative to user 2399 of FIG. 23B. Thus, for example, referring to FIG. 23B, if it is assumed that user 2399 performs a gesture on multi-touch display 2351 in which contact is first initiated at contact region 2390, the relative direction “up” (e.g., up, or away from the user) may be represented by directional arrow 2394, the relative direction “down” (e.g., down, or towards the user) may be represented by directional arrow 2392, the relative direction “left” (e.g., to the user's left) may be represented by directional arrow 2393, and the relative direction “right” (e.g., to the user's right) may be represented by directional arrow 2391.

Accordingly, based upon this particular perspective/orientation, the relative direction of a drag up movement may be represented by directional arrow 2394, the relative direction of a drag down movement may be represented by directional arrow 2392, the relative direction of a drag left movement may be represented by directional arrow 2393, and the relative direction of a drag right movement may be represented by directional arrow 2391.

However, it will be appreciated that any of the gestures illustrated described and/or referenced herein may be adapted and/or modified to be compatible with other embodiments involving different user perspectives and/or different orientations (e.g., vertical, horizontal, tilted, etc.) of the multi-touch input interface.

Returning to FIG. 25A, it is also to be noted that the example gesture 2502a represents a gesture involving a one contact region, such as, for example, a gesture which may be implemented using a single finger, digit, and/or other object which results in a single region of contact at the multi-touch input interface. For reference purposes, it is assumed that the various example embodiments of gestures disclosed herein (such as, for example, those illustrated and described with respect to FIGS. 25-39) are implemented using one or more digits (e.g., thumbs, fingers) of a user's hand(s). However, in at least some embodiments, at least a portion of the gestures described or referenced herein may be implemented and/or adapted to work with other portions of a user's body and/or other objects which may be used for creating one or more regions of contact with the multi-touch input interface. Further, unless otherwise stated, it will be assumed herein that any of the continuous contact gestures described herein (e.g., such as those which require that continuous contact with the surface be maintained throughout the gesture) may be completed or ended by breaking continuous contact with at least one of the contact region(s) used to perform that gesture.

Gesture 2502b represents an alternative example gesture which, in at least some embodiments, may be mapped to function(s) (e.g., user input/instructions) corresponding to: “YES” and/or “ACCEPT”. For example, in at least one embodiment, a user may convey the input/instruction(s) “YES” and/or “ACCEPT” for example, by performing gesture 2502b at a multipoint or multi-touch input interface of an intelligent multi-player electronic gaming system. As illustrated in the example embodiment of FIG. 25A, gesture 2502b may be defined to include at least the following gesture-specific characteristics: one contact region, drag down movement. In at least one embodiment, this gesture may be interpreted as being characterized by an initial single region of contact, followed by a drag down movement.

Gesture 2502c represents an alternative example gesture which, in at least some embodiments, may be mapped to function(s) (e.g., user input/instructions) corresponding to: “YES” and/or “ACCEPT”. For example, in at least one embodiment, a user may convey the input/instruction(s) “YES” and/or “ACCEPT” for example, by performing gesture 2502c at a multipoint or multi-touch input interface of an intelligent multi-player electronic gaming system. As illustrated in the example embodiment of FIG. 25A, gesture 2502c may be defined to include at least the following gesture-specific characteristics: double tap, one contact region. In at least one embodiment, gesture 2502c may be referred to as a “single digit” double tap gesture. In at least one embodiment, a “single digit” double tap gesture may be may be interpreted as being characterized by a sequence of two consecutive “tap” gestures on the multi-touch input interface in which continuous contact with the multi-touch input interface is broken in between each tap. Thus, for example, in at least one embodiment, the user may perform a “single digit” double tap gesture by initially contacting the multi-touch input interface with a single finger, lifting the finger up (e.g., to break contact with the multi-touch input interface, thereby completing the first “tap” gesture), contacting the multi-touch input interface again with the single finger, and then lifting the finger up again (e.g., to thereby complete the second “tap” gesture).

In at least some embodiments, a “single digit” double tap gesture (and/or other multiple sequence/multiple contact gestures) may be further defined or characterized to include at least one time-related characteristic or constraint. For example, in one embodiment, a “single digit” double tap operation may be defined to comprise a sequence of two consecutive “tap” gestures which occur within a specified time interval (e.g., both taps should occur within at most T mSec of each other, where T represents a time value such as, for example, T=500 mSec, T=about 1 second, T selected from the range 250-1500 mSec, etc.). It will be appreciated that the duration of the time interval may be varied, depending upon various criteria such as, for example, the user's ability to perform the gesture(s), the number of individual gestures or acts in the sequence, the complexity of each individual gesture or act, etc.

Gesture 2502d represents an alternative example gesture which, in at least some embodiments, may be mapped to function(s) (e.g., user input/instructions) corresponding to: “YES” and/or “ACCEPT”. For example, in at least one embodiment, a user may convey the input/instruction(s) “YES” and/or “ACCEPT” for example, by performing gesture 2502d at a multipoint or multi-touch input interface of an intelligent multi-player electronic gaming system. As illustrated in the example embodiment of FIG. 25A, gesture 2502d may be defined to include at least the following gesture-specific characteristics: two concurrent contact regions, drag up movement. In at least one embodiment, this gesture may be interpreted as being characterized by an initial two regions of contact, followed by concurrent drag up movements of both contact regions. For example, in at least one embodiment, a user may perform a “double digit” or two contact regions type gesture by concurrently or simultaneously using two fingers or digits to perform the gesture. Thus, for example, in at least one embodiment, a “double digit” type gesture may involve the use of two concurrent and separate contact regions (e.g., one for each finger) at a multi-touch input interface.

For reference purposes, a gesture which involves the use of a least two or more concurrent contact regions may be referred to as a multipoint gesture. Such gestures may be bimanual (e.g., performed via the use of two hands) and/or multi-digit (e.g., performed via the use of two or more digits of one hand). Some types of bimanual gestures may be performed using both the hands of a single player, while other types of bimanual gestures may be performed using different hands of different players.

As used herein, the use of terms such as “concurrent” and/or “simultaneous” with respect to multipoint or multi-contact region gestures (such as, for example, “two concurrent contact regions”) may be interpreted to include gestures in which, at some point during performance of the gesture, at least two regions of contact are detected at the multipoint or multi-touch input interface at the same point in time. Thus, for example, when performing a two digit (e.g., two contact region) multipoint gesture, it may not necessarily be required that both digits initially make contact with the multipoint or multi-touch input interface at precisely the same time. Rather, in at least one embodiment, it may be permissible for one of the user's digits to make contact with the multipoint or multi-touch input interface before the other, so long as the first digit remains in continuous contact with the multipoint or multi-touch input interface until the second digit makes contact with the multipoint or multi-touch input interface. In one embodiment, if continuous contact by the first finger is broken before the second finger has made contact with the multipoint or multi-touch input interface, the gesture may not be interpreted as a multipoint gesture.

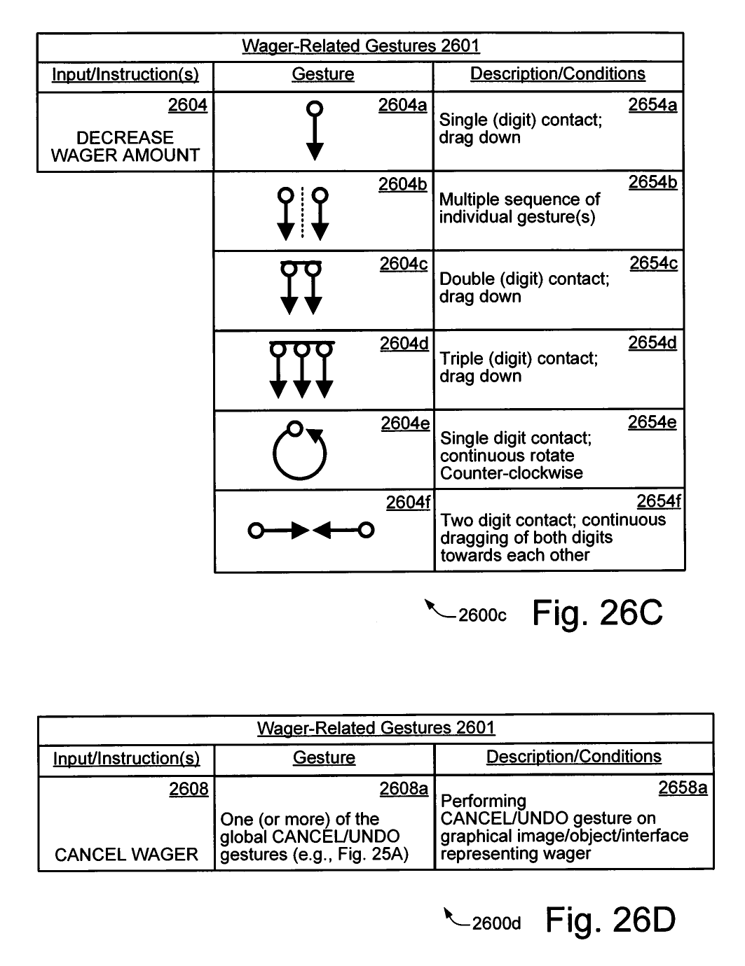

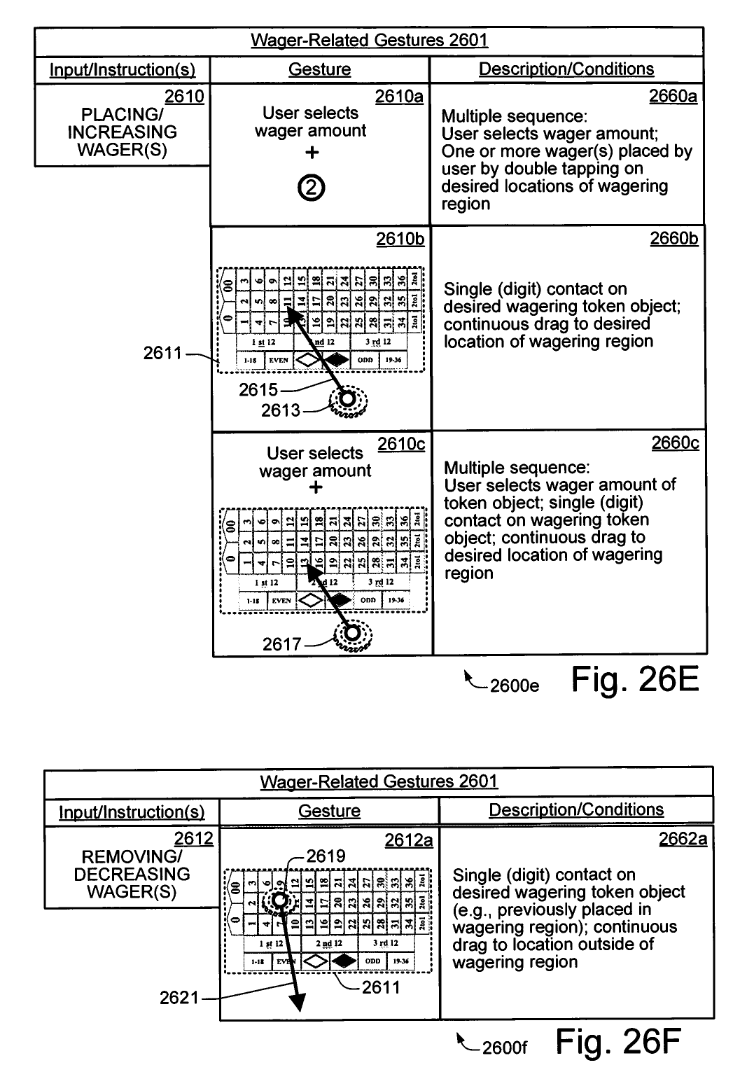

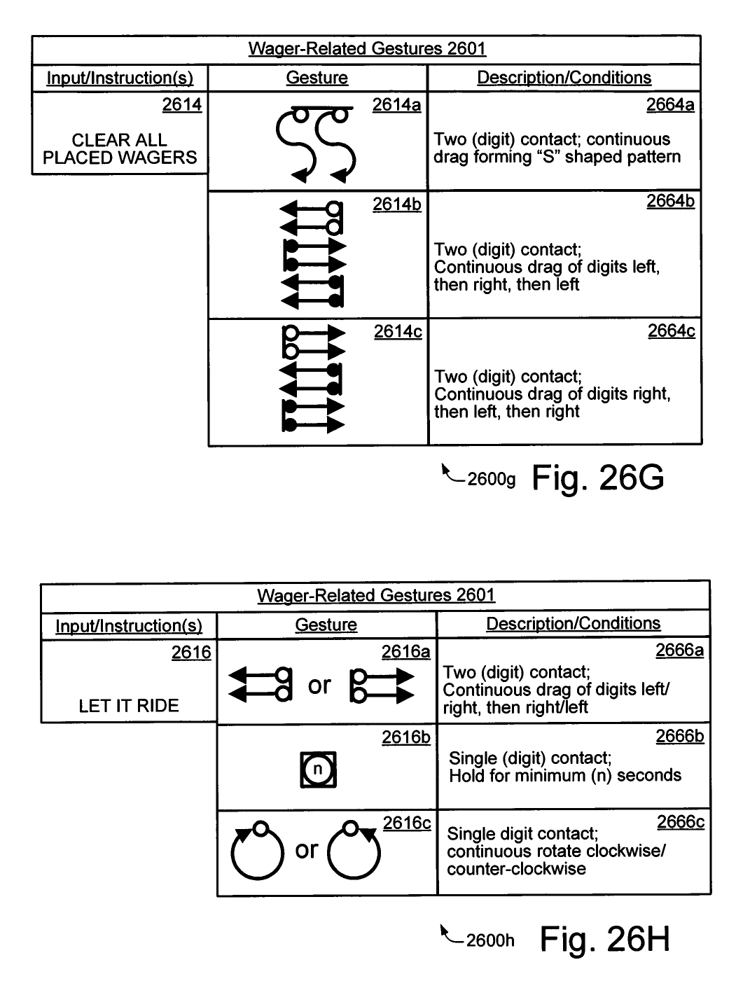

For reference purposes, a line segment symbol (e.g., 2521) is used herein to characterize multiple digit (or multiple contact region) gestures involving the concurrent or simultaneous use of multiple different contact regions. Thus, for example, line segment symbol 2521 of gesture 2502d signifies that this gesture represents a multiple contact region (or multipoint) type gesture. In addition, the use of line segment symbol 2521 helps to distinguish such multiple digit (or multiple contact) type gestures from other types gestures involving a multi-gesture sequence of individual gestures (e.g., where contact with the intelligent multi-player electronic gaming system is broken between each individual gesture in the sequence) an example of which is illustrated by gesture 2602d of FIG. 26A (described in greater detail below).

Gesture 2502e represents an alternative example gesture which, in at least some embodiments, may be mapped to function(s) (e.g., user input/instructions) corresponding to: “YES” and/or “ACCEPT”. For example, in at least one embodiment, a user may convey the input/instruction(s) “YES” and/or “ACCEPT” for example, by performing gesture 2502e at a multipoint or multi-touch input interface of an intelligent multi-player electronic gaming system. As illustrated in the example embodiment of FIG. 25A, gesture 2502e may be defined to include at least the following gesture-specific characteristics: two concurrent contact regions, drag down movement. In at least one embodiment, this gesture may be interpreted as being characterized by an initial two regions of contact, followed by concurrent drag down movements of both contact regions.

As illustrated in the example embodiment of FIG. 25B, an example plurality of different (e.g., alternative) gestures are graphically represented and described which, for example, may be mapped to function(s) (e.g., user input/instructions) corresponding to: “NO” and/or “DECLINE”.

For example, in at least one embodiment, a user may convey the input/instruction(s) “NO” and/or “DECLINE” for example, by performing gesture 2504a or gesture 2504b at a multipoint or multi-touch input interface of an intelligent multi-player electronic gaming system.

As illustrated in the example embodiment of FIG. 25B, gesture 2504a may be defined to include at least the following gesture-specific characteristics: one contact region, drag right movement. In at least one embodiment, this gesture may be interpreted as being characterized by an initial single region of contact, followed by a drag right movement.

As illustrated in the example embodiment of FIG. 25B, gesture 2504b may be defined to include at least the following gesture-specific characteristics: one contact region, drag left movement. In at least one embodiment, this gesture may be interpreted as being characterized by an initial single region of contact, followed by a drag left movement.

Gesture 2504c represents an alternative example gesture which, in at least some embodiments, may be mapped to function(s) (e.g., user input/instructions) corresponding to: “NO” and/or “DECLINE”. For example, in at least one embodiment, a user may convey the input/instruction(s) “NO” and/or “DECLINE” for example, by performing gesture 2504c at a multipoint or multi-touch input interface of an intelligent multi-player electronic gaming system. As illustrated in the example embodiment of FIG. 25B, gesture 2504c may be defined to include at least the following gesture-specific characteristics: one contact region, continuous drag left movement, continuous drag right movement. In at least one embodiment, this gesture may be interpreted as being characterized by an initial single region of contact (e.g., 2511), followed by a continuous sequence of the following specific movements (e.g., which are performed in order, while maintaining continuous contact with the multi-touch input interface): drag left movement (2513), then drag right movement (2515, 2517).

For reference purposes, a solid circle symbol (e.g., 2515) is used herein to convey that the start or beginning of the next (or additional) portion of the gesture (e.g., drag right movement 2517) occurs without breaking continuous contact with the multi-touch input interface. In addition, the use of the solid circle symbol (e.g., 2515) helps to distinguish such multiple sequence, continuous contact type gestures from other types gestures involving a multi-gesture sequence of individual gestures (e.g., where contact with the intelligent multi-player electronic gaming system is broken between each individual gesture in the sequence), an example of which is illustrated by gesture 2602d of FIG. 26A (described in greater detail below).

Gesture 2504d represents an alternative example gesture which, in at least some embodiments, may be mapped to function(s) (e.g., user input/instructions) corresponding to: “NO” and/or “DECLINE”. For example, in at least one embodiment, a user may convey the input/instruction(s) “NO” and/or “DECLINE” for example, by performing gesture 2504d at a multipoint or multi-touch input interface of an intelligent multi-player electronic gaming system. As illustrated in the example embodiment of FIG. 25B, gesture 2504d may be defined to include at least the following gesture-specific characteristics: one contact region, continuous drag right movement, continuous drag left movement. In at least one embodiment, this gesture may be interpreted as being characterized by an initial single region of contact, followed by a continuous sequence of the following specific movements (e.g., which are performed in order, while maintaining continuous contact with the multi-touch input interface): drag right movement, then drag left movement.

As illustrated in the example embodiment of FIG. 25C, an example plurality of different (e.g., alternative) gestures are graphically represented and described which, for example, may be mapped to function(s) (e.g., user input/instructions) corresponding to: “CANCEL” and/or “UNDO”.

For example, in at least one embodiment, a user may convey the input/instruction(s) “CANCEL” and/or “UNDO” for example, by performing gesture 2506a at a multipoint or multi-touch input interface of an intelligent multi-player electronic gaming system. As illustrated in the example embodiment of FIG. 25C, gesture 2506a may be defined to include at least the following gesture-specific characteristics: one contact region, continuous drag left movement, continuous drag right movement, continuous drag left movement. In at least one embodiment, this gesture may be interpreted as being characterized by an initial single region of contact, followed by a continuous sequence of the following specific movements (e.g., which are performed in order, while maintaining continuous contact with the multi-touch input interface): drag left movement, then drag right movement, then drag left movement.

Gesture 2506b represents an alternative example gesture which, in at least some embodiments, may be mapped to function(s) (e.g., user input/instructions) corresponding to: “CANCEL” and/or “UNDO”. For example, in at least one embodiment, a user may convey the input/instruction(s) “CANCEL” and/or “UNDO” for example, by performing gesture 2506b at a multipoint or multi-touch input interface of an intelligent multi-player electronic gaming system. As illustrated in the example embodiment of FIG. 25C, gesture 2506b may be defined to include at least the following gesture-specific characteristics: one contact region, continuous drag right movement, continuous drag left movement, continuous drag right movement. In at least one embodiment, this gesture may be interpreted as being characterized by an initial single region of contact, followed by a continuous sequence of the following specific movements (e.g., which are performed in order, while maintaining continuous contact with the multi-touch input interface): drag right movement, then drag left movement, then drag right movement.

Because it is contemplated that the same gesture may be performed quite differently by different users, at least some embodiments may include one or more mechanisms for allowing users different degrees of freedom in performing their movements relating to different types of gestures. For example, the CANCEL/UNDO gestures illustrated at 2506a and 2506b may be defined in a manner which allows users some degree of freedom in performing the drag right movements and/or drag left movements in different horizontal planes (e.g., of a 2-dimensional multi-touch input interface). Additionally, as illustrated in FIG. 25C, for example, additional gestures (e.g., 2506d and/or 2506e) may be provided and defined in a manner which allows users even more degrees of freedom in performing the drag right movements and/or drag left movements of a gesture which, for example, is intended to represent the CANCEL/UNDO instruction/function (2506). Thus, for example, in at least one embodiment, the gesture-function mapping functionality of the intelligent multi-player electronic gaming system may be operable to map gesture 2506b (which, for example, may be implemented by a user performing each of the drag right/drag left movements in substantially the same and/or substantially proximate horizontal planes), and/or may also be operable to map gesture 2506d (which, for example, may resemble more of a “Z”-shaped continuous gesture) to the CANCEL/UNDO instruction/function.

Gesture 2506c represents an alternative example gesture which, in at least some embodiments, may be mapped to function(s) (e.g., user input/instructions) corresponding to: “CANCEL” and/or “UNDO”. For example, in at least one embodiment, a user may convey the input/instruction(s) “CANCEL” and/or “UNDO” for example, by performing gesture 2506c at a multipoint or multi-touch input interface of an intelligent multi-player electronic gaming system. As illustrated in the example embodiment of FIG. 25C, gesture 2506c may be defined to include at least the following gesture-specific characteristics: one contact region, hold at least n seconds. In at least one embodiment, this gesture may be interpreted as being characterized by an initial single region of contact which is continuously maintained at about the same location or position (and/or in which the contact region is continuously maintained within a specified boundary) for a continuous time interval of at least n seconds (e.g., value of n selected from range of 1-8 seconds, n=about 5 seconds, n=3.75 seconds, etc.).

As illustrated in the example embodiment of FIG. 25D, an example embodiment of a multi-gesture sequence gesture is graphically represented and described which, for example, may be mapped to function(s) (e.g., user input/instructions) corresponding to: “REPEAT INSTRUCTION/FUNCTION.” For example, in at least one embodiment, the function mapped to a given gesture (e.g., which may be performed by a user at the display surface) may be caused to be periodically repeated one or more times by allowing the contact regions (associated with that gesture) to remain in continuous contact with the surface for different lengths of time at the end of the gesture (e.g., after all of the movements associated with the gesture have been performed). As illustrated in the example embodiment of FIG. 25D, multi-sequence gesture 2508a may be characterized as a combinational sequence of gestures which include: the user performing a first gesture (e.g., 2521), followed by a gesture (e.g., 2525) which may be characterized as the maintaining of continuous contact of the contact regions (e.g., associated with gesture 2521) for a continuous time interval of at least n seconds (e.g., value of n selected from range of 0.5-8 seconds, n about 2 seconds, n=1.75 seconds, etc.).

Additionally, in at least one embodiment, the periodic rate at which the function of the gesture may be repeated may depend upon the length of time in which continuous contact is maintained with the surface after the end of the gesture. For example, in one embodiment, the longer continuous contact is maintained after the end of the gesture, the greater the rate at which the function of the gesture may be periodically repeated. Thus, for example, in one embodiment, after about 1-2 seconds of maintaining continuous contact at the end of the INCREASE WAGER AMOUNT gesture (2602a), the gaming system may automatically begin periodically to increase the user's wager amount (e.g., by the predetermined wager increase value) at a rate of about once every 500-1000 mSec; after about 4-5 seconds of maintaining continuous contact at the end of the INCREASE WAGER AMOUNT gesture (2602a), the gaming system may automatically begin periodically to increase the user's wager amount (e.g., by the predetermined wager increase value) at a rate of about once every 250-500 mSec; and so forth.

FIGS. 26A-H illustrate various example embodiments of different types of wager-related gesture-function mapping information which may be utilized at one or more intelligent multi-player electronic gaming systems described herein.

In at least one embodiment, various types of wager-related gestures may be performed at or over one or more graphical image(s)/object(s)/interface(s) which may be used for representing one or more wager(s). Additionally, in some embodiments, various types of wager-related gestures may be performed at or over one or more specifically designated region(s) of the multi-touch input interface. In at least one embodiment, as a user performs his or her gesture(s), displayed content representing the user's wager amount value may be automatically and dynamically modified and/or updated (e.g., increased/decreased) to reflect the user's current wager amount value (e.g., which may have been updated based on the user's gesture(s)). In one embodiment, this may be visually illustrated by automatically and/or dynamically modifying one or more image(s) representing the virtual wager “chip pile” to increase/decrease the size of the virtual chip pile based on the user's various input gestures.

As illustrated in the example embodiment of FIG. 26A, an example plurality of different (e.g., alternative) gestures are graphically represented and described which, for example, may be mapped to function(s) (e.g., user input/instructions) corresponding to: INCREASE WAGER AMOUNT.

For example, in at least one embodiment, a user may convey the input/instruction(s) INCREASE WAGER AMOUNT for example, by performing gesture 2602a at a multipoint or multi-touch input interface of an intelligent multi-player electronic gaming system. As illustrated in the example embodiment of FIG. 26A, gesture 2602a may be defined to include at least the following gesture-specific characteristics: one contact region, drag up movement. In at least one embodiment, this gesture may be interpreted as being characterized by an initial single region of contact, followed by a drag up movement.

Gesture 2602b represents an alternative example gesture which, in at least some embodiments, may be mapped to function(s) (e.g., user input/instructions) corresponding to: INCREASE WAGER AMOUNT. For example, in at least one embodiment, a user may convey the input/instruction(s) INCREASE WAGER AMOUNT for example, by performing a multi-gesture sequence of non-continuous contact gestures (e.g., as illustrated at 2602b) at a multipoint or multi-touch input interface of an intelligent multi-player electronic gaming system. As illustrated in the example embodiment of FIG. 26A, gesture 2602b may be defined to include at least the following gesture-specific characteristics: multiple sequence of non-continuous contact gestures: one contact region, drag up; one contact region, drag up movement. In at least one embodiment, the combination gesture illustrated at 2602b may be interpreted as being characterized by a first “one contact region, drag up” gesture (e.g., 2603), followed by another “one contact region, drag up” gesture (e.g., 2605), wherein contact with the multi-touch input interface is broken between the end of the first gesture 2603 and the start of the second gesture 2605. For reference purposes, a dashed vertical line segment symbol (e.g., 2607) is used herein to convey a break contact with the multi-touch input interface.

For example, in one embodiment, if a given user (e.g., player) wishes to convey input instructions to an intelligent multi-player electronic gaming system for increasing the user's wager amount using the combination gesture illustrated at 2602b, the user may be required to perform both gesture portion 2603 and gesture portion 2605 within a predetermined or specified time interval (e.g., both gesture portions should occur within at most T seconds of each other, where T represents a time value such as, for example, T=about 2 seconds, T=1.5 seconds, T selected from the range 250-2500 mSec, etc.).

Gesture 2602c represents an alternative example gesture which, in at least some embodiments, may be mapped to function(s) (e.g., user input/instructions) corresponding to: INCREASE WAGER AMOUNT. For example, in at least one embodiment, a user may convey the input/instruction(s) INCREASE WAGER AMOUNT for example, by performing a gesture 2602c at a multipoint or multi-touch input interface of an intelligent multi-player electronic gaming system. As illustrated in the example embodiment of FIG. 26A, gesture 2602c may be defined to include at least the following gesture-specific characteristics: two concurrent contact regions, drag up movement. In at least one embodiment, this gesture may be interpreted as being characterized by an initial two regions of contact, followed by concurrent drag up movements of both contact regions.

Gesture 2602d represents an alternative example gesture which, in at least some embodiments, may be mapped to function(s) (e.g., user input/instructions) corresponding to: INCREASE WAGER AMOUNT. For example, in at least one embodiment, a user may convey the input/instruction(s) INCREASE WAGER AMOUNT for example, by performing a gesture 2602d at a multipoint or multi-touch input interface of an intelligent multi-player electronic gaming system. As illustrated in the example embodiment of FIG. 26A, gesture 2602d may be defined to include at least the following gesture-specific characteristics: three concurrent contact regions, drag up movement. In at least one embodiment, this gesture may be interpreted as being characterized by an initial three regions of contact (e.g., via the use of 3 digits), followed by concurrent drag up movements of all three contact regions.

Gesture 2602e represents an alternative example gesture which, in at least some embodiments, may be mapped to function(s) (e.g., user input/instructions) corresponding to: INCREASE WAGER AMOUNT. For example, in at least one embodiment, a user may convey the input/instruction(s) INCREASE WAGER AMOUNT for example, by performing a gesture 2602e at a multipoint or multi-touch input interface of an intelligent multi-player electronic gaming system. As illustrated in the example embodiment of FIG. 26A, gesture 2602e may be defined to include at least the following gesture-specific characteristics: one contact region, continuous “rotate clockwise” movement. In at least one embodiment, this gesture may be interpreted as being characterized by an initial single region of contact, followed by a continuous “rotate clockwise” movement. In at least one embodiment, a “rotate clockwise” movement may be characterized by movement of the contact region in an elliptical, circular, and/or substantially circular pattern in a clockwise direction (e.g., relative to the user's perspective).

Gesture 2602f represents an alternative example gesture which, in at least some embodiments, may be mapped to function(s) (e.g., user input/instructions) corresponding to: INCREASE WAGER AMOUNT. For example, in at least one embodiment, a user may convey the input/instruction(s) INCREASE WAGER AMOUNT for example, by performing a gesture 2602f at a multipoint or multi-touch input interface of an intelligent multi-player electronic gaming system. As illustrated in the example embodiment of FIG. 26A, gesture 2602f may be defined to include at least the following gesture-specific characteristics: two concurrent contact regions, “expand” movement. In at least one embodiment, this gesture may be interpreted as being characterized by an initial two regions of contact, followed by a “expand” movement, in which both contact regions are concurrently moved in respective directions away from the other.

In at least one embodiment, one or more of the various wager-related gestures described herein may be performed at or over one or more graphical image(s)/object(s)/interface(s) which may be used for representing one or more wager(s). For example, in one embodiment, a user may perform one or more INCREASE WAGER AMOUNT gesture(s) and/or DECREASE WAGER AMOUNT gesture(s) on an image of a stack of chips representing the user's wager. When the user performs a gesture (e.g., on, above, or over the image) for increasing the wager amount, the image may be automatically and dynamically modified in response to the user's gesture(s), such as, for example, by dynamically increasing (e.g., in real-time) the number of “wagering chip” objects represented in the image. Similarly, when the user performs a gesture (e.g., on, above, or over the image) for decreasing the wager amount, the image may be automatically and dynamically modified in response to the user's gesture(s), such as, for example, by dynamically decreasing (e.g., in real-time) the number of “wagering chip” objects represented in the image. In at least one embodiment, when desired wagering amount is reached, the user may perform an additional gesture to confirm or approve the placement of the wager on behalf of the user.

As illustrated in the example embodiment of FIG. 26B, one or more other gestures (2606a) may be mapped to function(s) (e.g., user input/instructions) corresponding to: CONFIRM PLACEMENT OF WAGER. For example, in at least one embodiment, a user may convey the input/instruction(s) CONFIRM PLACEMENT OF WAGER for example, by performing one or more different types of gestures at a multipoint or multi-touch input interface of an intelligent multi-player electronic gaming system. As illustrated in the example embodiment of FIG. 26B, examples of such gestures may include, but are not limited to, one or more of the global YES/ACCEPT gestures such as those described previously with respect to FIG. 25A.

Additionally, in at least some embodiments, other types of gestures may also be performed by a user for increasing and/or decreasing the user's current wager amount value. For example, in at least one embodiment, the user may perform an INCREASE WAGER AMOUNT gesture by selecting and dragging one or more “wagering chip” objects from the user's credit meter/player bank to the image representing the user's current wager. Similarly, the user may perform a DECREASE WAGER AMOUNT gesture by selecting and dragging one or more “wagering chip” objects away from the image representing the user's current wager.

In at least one embodiment, various characteristics of the gesture(s) may be used to influence or affect how the gestures are interpreted and/or how the mapped functions are implemented/executed. For example, in at least one embodiment, the relative magnitude of the change in wager amount (e.g., amount of increase/decrease) may be affected by and/or controlled by various types of gesture-related characteristics, such as, for example, one or more of the following (or combinations thereof):
velocity of the movement(s) of the gesture(s) (or portions thereof) (e.g., relatively faster drag up movement(s) of a gesture may result in greater increase of the wager amount, as compared to the same gesture being performed using relatively slower drag up movement(s); similarly a relatively faster rotational velocity of a “rotate clockwise” movement of a gesture may result in a greater rate of increase of the wager amount, as compared to the same gesture being performed using a relatively slower rotational velocity of a “rotate clockwise” movement);
acceleration of the movement(s) of the gesture(s) (or portions thereof);
displacement of the movement(s) of the gesture(s) (or portions thereof) (e.g., a relatively longer drag up movement of a gesture may result in greater increase of the wager amount, as compared to the same gesture being performed using a relatively shorter drag up movement);
number or quantity of digits (or contact regions) used in performing a gesture (or portions thereof);
amount of contact pressure used in performing a gesture (or portions thereof);
relative location of the initial point of contact on or over an image or object to be moved (e.g., a gesture involving the spinning of a virtual wheel which is performed at a contact point near the wheel's center may result in a faster rotation of the virtual wheel as compared to the same gesture being performed at a contact point near the wheel's outer perimeter);
amount of time used to perform the gesture;
amount of time a contact region remains in continuous contact at a given location;
etc.

For example, in one embodiment, a user may perform gesture 2602a (e.g., using a single finger) to dynamically increase the wager amount at a rate of 1×, may perform gesture 2602c (e.g., using a two fingers) to dynamically increase the wager amount at a rate of 2×, may perform gesture 2602d (e.g., using three fingers) to dynamically increase the wager amount at a rate of 10×, and/or may perform a four contact region drag up gesture (e.g., using four fingers) to dynamically increase the wager amount at a rate of 100×. This technique may be similarly applied to gestures which may be used for decreasing a wager amount, and/or may be applied to other types of gestures disclosed herein.

Additionally, as discussed previously with respect to FIG. 25D, for example, the function mapped to a given gesture (e.g., which may be performed by a user at the display surface) may be caused to be repeated one or more times by allowing the contact regions (associated with that gesture) to remain in continuous contact with the surface for different lengths of time after the gesture has been completed (e.g., after all of the movements associated with the gesture have been performed). Thus, for example, a user performing an INCREASE WAGER AMOUNT gesture may cause the wager amount to be periodically and continuously increased by allowing his finger(s) to remain in continuous contact with the surface at the end of performing the INCREASE WAGER AMOUNT gesture. Similarly, a user performing a DECREASE WAGER AMOUNT gesture may cause the wager amount to be periodically and continuously decreased by allowing his finger(s) to remain in continuous contact with the surface at the end of performing the DECREASE WAGER AMOUNT gesture. Additionally, in at least one embodiment, the periodic rate at which the function of the gesture may be repeated may depend upon the length of time in which continuous contact is maintained with the surface after the end of the gesture. In some embodiments, continuous contact at the end of the gesture may be required to be maintained for some minimal threshold amount of time until the wager amount value begins to be continuously increased.

It will be appreciated that similar techniques may also be applied to gestures relating to decreasing a wager amount. Further, in at least some embodiments, similar techniques may also be applied to other types of gestures and/or gesture-function mappings, for example, for enabling a user to dynamically modify and/or dynamically control the relative magnitude of the output function which is mapped to the specific gesture being performed by the user.

As illustrated in the example embodiment of FIG. 26C, an example plurality of different (e.g., alternative) gestures are graphically represented and described which, for example, may be mapped to function(s) (e.g., user input/instructions) corresponding to: DECREASE WAGER AMOUNT.

For example, in at least one embodiment, a user may convey the input/instruction(s) DECREASE WAGER AMOUNT for example, by performing gesture 2604a at a multipoint or multi-touch input interface of an intelligent multi-player electronic gaming system. As illustrated in the example embodiment of FIG. 26C, gesture 2604a may be defined to include at least the following gesture-specific characteristics: one contact region, drag down movement. In at least one embodiment, this gesture may be interpreted as being characterized by an initial single region of contact, followed by a drag down movement.

Gesture 2604b represents an alternative example multiple gesture sequence which, in at least some embodiments, may be mapped to function(s) (e.g., user input/instructions) corresponding to: DECREASE WAGER AMOUNT. For example, in at least one embodiment, a user may convey the input/instruction(s) DECREASE WAGER AMOUNT for example, by performing a multi-gesture sequence of non-continuous contact gestures (e.g., as illustrated at 2604b) at a multipoint or multi-touch input interface of an intelligent multi-player electronic gaming system. As illustrated in the example embodiment of FIG. 26C, combination gesture 2604b may be defined to include at least the following gesture-specific characteristics: multiple sequence of non-continuous contact gestures: one contact region, drag down; one contact region, drag down movement. In at least one embodiment, the combination gesture illustrated at 2604b may be interpreted as being characterized by a first “one contact region, drag down” gesture, followed by another “one contact region, drag down” gesture, wherein contact with the multi-touch input interface is broken between the end of the first gesture and the start of the second gesture.

For example, in one embodiment, if a given user (e.g., player) wishes to convey input instructions to an intelligent multi-player electronic gaming system for increasing the user's wager amount using the combination gesture illustrated at 2604b, the user may be required to perform both “one contact region, drag down” gestures within a predetermined or specified time interval (e.g., both gesture portions should occur within at most T seconds of each other, where T represents a time value such as, for example, T=about 2 seconds, T=1.5 seconds, T selected from the range 250-2500 mSec, etc.).

Gesture 2604c represents an alternative example gesture which, in at least some embodiments, may be mapped to function(s) (e.g., user input/instructions) corresponding to: DECREASE WAGER AMOUNT. For example, in at least one embodiment, a user may convey the input/instruction(s) DECREASE WAGER AMOUNT for example, by performing a gesture 2604c at a multipoint or multi-touch input interface of an intelligent multi-player electronic gaming system. As illustrated in the example embodiment of FIG. 26C, gesture 2604c may be defined to include at least the following gesture-specific characteristics: two concurrent contact regions, drag down movement. In at least one embodiment, this gesture may be interpreted as being characterized by an initial two regions of contact, followed by concurrent drag down movements of both contact regions.

Gesture 2604d represents an alternative example gesture which, in at least some embodiments, may be mapped to function(s) (e.g., user input/instructions) corresponding to: DECREASE WAGER AMOUNT. For example, in at least one embodiment, a user may convey the input/instruction(s) DECREASE WAGER AMOUNT for example, by performing a gesture 2604d at a multipoint or multi-touch input interface of an intelligent multi-player electronic gaming system. As illustrated in the example embodiment of FIG. 26C, gesture 2604d may be defined to include at least the following gesture-specific characteristics: three concurrent contact regions, drag down movement. In at least one embodiment, this gesture may be interpreted as being characterized by an initial three regions of contact (e.g., via the use of 3 digits), followed by concurrent drag down movements of all three contact regions.

Gesture 2604e represents an alternative example gesture which, in at least some embodiments, may be mapped to function(s) (e.g., user input/instructions) corresponding to: DECREASE WAGER AMOUNT. For example, in at least one embodiment, a user may convey the input/instruction(s) DECREASE WAGER AMOUNT for example, by performing a gesture 2604e at a multipoint or multi-touch input interface of an intelligent multi-player electronic gaming system. As illustrated in the example embodiment of FIG. 26C, gesture 2604e may be defined to include at least the following gesture-specific characteristics: one contact region, continuous “rotate counter-clockwise” movement. In at least one embodiment, this gesture may be interpreted as being characterized by an initial single region of contact, followed by a continuous “rotate counter-clockwise” movement. In at least one embodiment, a “rotate counter-clockwise” movement may be characterized by movement of the contact region in an elliptical, circular, and/or substantially circular pattern in a counter-clockwise direction (e.g., relative to the user's perspective).

Gesture 2604f represents an alternative example gesture which, in at least some embodiments, may be mapped to function(s) (e.g., user input/instructions) corresponding to: DECREASE WAGER AMOUNT. For example, in at least one embodiment, a user may convey the input/instruction(s) DECREASE WAGER AMOUNT for example, by performing a gesture 2604f at a multipoint or multi-touch input interface of an intelligent multi-player electronic gaming system. As illustrated in the example embodiment of FIG. 26C, gesture 2604f may be defined to include at least the following gesture-specific characteristics: two concurrent contact regions, “pinch” movement. In at least one embodiment, this gesture may be interpreted as being characterized by an initial two regions of contact, followed by a “pinch” movement, in which both contact regions are concurrently moved in respective directions towards each other.

As illustrated in the example embodiment of FIG. 26D, one or more other gestures (2608a) may be mapped to function(s) (e.g., user input/instructions) corresponding to: CANCEL WAGER. For example, in at least one embodiment, a user may convey the input/instruction(s) CANCEL WAGER for example, by performing one or more different types of gestures at a multipoint or multi-touch input interface of an intelligent multi-player electronic gaming system. As illustrated in the example embodiment of FIG. 26D, examples of such gestures may include, but are not limited to, one or more of the global CANCEL/UNDO gestures such as those described previously with respect to FIG. 25C.

In at least some embodiments it is contemplated that the various players' wagers may be graphically represented at one or more common areas of a multi-touch, multi-player interactive display, which forms part of an intelligent multi-player electronic gaming system. Various examples of such intelligent multi-player electronic gaming systems are illustrated and described, for example, with respect to FIGS. 23C and 23D.

For example, as illustrated in the example embodiment of FIG. 23C, gaming system 9500 includes a multi-touch, multi-player interactive display 9530, which includes a common wagering areas 9505 that is accessible to the various player(s) (e.g., 9502, 9504) and casino staff (e.g., 9506) at the gaming system. In at least one embodiment, players 9502 and 9504 may each concurrently place their respective bets at gaming system 9501 by interacting with (e.g., via contacts, gestures, etc) region 9505 of the multi-touch, multi-player interactive display 9530. In at least one embodiment, the individual wager(s) placed by each player at the gaming system 9501 may be graphically represented at the common wagering area 9505 of the multi-touch, multi-player interactive display.

As illustrated in the example embodiment of FIG. 26E, an example plurality of different (e.g., alternative) gestures are graphically represented and described which, for example, may be mapped to one or more function(s) (e.g., user input/instructions) for PLACING and/or INCREASING WAGER AMOUNTS. In at least one embodiment, such gestures may be practiced, for example, at one or more intelligent multi-player electronic gaming systems where various players' wagers are graphically represented at one or more common areas of a multi-touch, multi-player interactive display.

For example, in one embodiment, a given user (e.g., player) may convey input instructions to an intelligent multi-player electronic gaming system for placing a wager and/or for increasing a wager amount for example, by performing a multi-gesture sequence of gestures (e.g., as illustrated at 2610a) at a multipoint or multi-touch input interface of an intelligent multi-player electronic gaming system. As illustrated in the example embodiment of FIG. 26E, combination gesture 2610a may be defined to include at least the following gesture-specific characteristics: multiple sequence of gestures: user selects wager amount (e.g., by performing one or more wager increase/wager decrease gestures described herein); user performs “single digit” double tap gesture. In at least one embodiment, once the user has selected his desired wager amount, the user may place one or more wagers (e.g., in the common wagering area of the multi-touch, multi-player interactive display), for example, by performing a “single digit” double tap gesture on each desired location(s) of the common wagering area where the user wishes to place a wager for the selected wager amount. In at least one embodiment, if the user performs “single digit” double tap gesture at a location of the common wagering area corresponding to a different one of the user's placed wagers, the value of the wager amount at that location may be increased by the selected wager amount each time the user performs a “single digit” double tap gesture at that location.

Gesture 2610b represents an alternative example gesture which, in at least some embodiments, may enable a user (e.g., player) to convey input instructions to an intelligent multi-player electronic gaming system for placing a wager and/or for increasing a wager amount. For example, in at least one embodiment, a user may convey the input/instruction(s) PLACE WAGER and/or INCREASE WAGER AMOUNT for example, by performing gesture 2610b at a multipoint or multi-touch input interface of an intelligent multi-player electronic gaming system. As illustrated in the example embodiment of FIG. 26E, gesture 2610b may be defined to include at least the following gesture-specific characteristics: one contact region over desired wager token object; continuous “drag” movement to desired location of wagering region; release. For example, in at least one embodiment, the user may select a desired wager token object of predetermined value, for example, by touching the location of the multi-touch, multi-player interactive display where the selected wager token object is displayed. The user may then drag (e.g., 2615) the selected wager token object (e.g., 2613) (e.g., with the user's finger) to a desired location of the common wagering area (e.g., 2611) where the user wishes to place a wager. In one embodiment, the user may then remove his or her finger to complete the placement of the wager. In at least one embodiment, if the user drags the selected wager token object to a location of the common wagering area where the user has already placed a wager, the value of the wager amount at that location may be increased by the value of the selected wager token object which has been dragged to that location.

In an alternate embodiment, a user (e.g., player) may convey input instructions to an intelligent multi-player electronic gaming system for placing a wager and/or for increasing a wager amount for example, by performing a multi-gesture sequence of gestures (e.g., as illustrated at 2610c) at a multipoint or multi-touch input interface of an intelligent multi-player electronic gaming system. As illustrated in the example embodiment of FIG. 26E, combination gesture 2610c may be defined to include at least the following gesture-specific characteristics: multiple sequence of gestures: user selects value of wager token object (e.g., 2617) (e.g., by performing one or more wager increase/wager decrease gestures described herein); continuous “drag” movement to desired location of wagering region; release. For example, in at least one embodiment, the user may select a wager token object to be placed in the common wagering area, and may adjust the value of the selected wager token object to a desired value (e.g., by performing one or more wager increase/wager decrease gestures described herein). The user may then drag the selected wager token object to a desired location of the common wagering area where the user wishes to place a wager. In one embodiment, the user may then remove his or her finger to complete the placement of the wager. In at least one embodiment, if the user drags the selected wager token object to a location of the common wagering area where the user has already placed a wager, the value of the wager amount at that location may be increased by the value of the selected wager token object which has been dragged to that location.

As illustrated in the example embodiment of FIG. 26F, an example gesture (e.g., 2612a) is graphically represented and described which, for example, may be mapped to one or more function(s) (e.g., user input/instructions) for REMOVING A PLACED WAGER and/or DECREASING WAGER AMOUNTS. In at least one embodiment, such gestures may be practiced, for example, at one or more intelligent multi-player electronic gaming systems where various players' wagers are graphically represented at one or more common areas of a multi-touch, multi-player interactive display.

For example, in one embodiment, a given user (e.g., player) may convey input instructions to an intelligent multi-player electronic gaming system for removing a placed wager and/or for decreasing a wager amount for example, by performing gesture 2612a at a multipoint or multi-touch input interface of an intelligent multi-player electronic gaming system. As illustrated in the example embodiment of FIG. 26F, gesture 2612a may be defined to include at least the following gesture-specific characteristics: one contact region over desired wager token object(s) representing a placed wager belonging to user; continuous “drag” movement to location outside of common wagering area; release. For example, in at least one embodiment, the user may select a desired wager token object (e.g., 2619) located in common wagering area (e.g., 2611) which represents a placed wager belonging to that user. The user may then drag (e.g., 2621) the selected wager token object to a location outside of the common wagering area 2611. In one embodiment, the user may then remove his or her finger to complete the gesture. In at least one embodiment, if the user's placed wager (in the common wagering area) is graphically represented by multiple wager tokens, the user may decrease the placed wager amount by selecting one (or more) of the multiple wager tokens, and dragging the selected wager token(s) to a location outside of the common wagering area.

As illustrated in the example embodiment of FIG. 26G, an example plurality of different (e.g., alternative) gestures are graphically represented and described which, for example, may be mapped to function(s) (e.g., user input/instructions) corresponding to: CLEAR ALL PLACED WAGERS.

For example, in at least one embodiment, a user may convey the input/instruction(s) CLEAR ALL PLACED WAGERS (e.g., belonging to that particular user) for example, by performing gesture 2614a at a multipoint or multi-touch input interface of an intelligent multi-player electronic gaming system. As illustrated in the example embodiment of FIG. 26G, gesture 2614a may be defined to include at least the following gesture-specific characteristics: two contact regions; continuous “S”-shaped pattern drag down movements. In at least one embodiment, this gesture may be interpreted as being characterized by an initial two regions of contact (e.g., in the common wagering area), followed by concurrent, continuous drag down movements of both contact regions forming an “S”-shaped pattern. According to different embodiments, a user may perform this gesture within the common wagering area, and/or within the user's “personal” area of the multi-touch, multi-player interactive display.

Gesture 2614b represents an alternative example gesture which, in at least some embodiments, may be mapped to function(s) (e.g., user input/instructions) corresponding to: CLEAR ALL PLACED WAGERS. For example, in at least one embodiment, a user may convey the input/instruction(s) CLEAR ALL PLACED WAGERS for example, by performing gesture 2614b at a multipoint or multi-touch input interface of an intelligent multi-player electronic gaming system. As illustrated in the example embodiment of FIG. 26G, gesture 2614b may be defined to include at least the following gesture-specific characteristics: two concurrent contact regions, continuous drag left movement, continuous drag right movement, continuous drag left movement. In at least one embodiment, this gesture may be interpreted as being characterized by an initial two regions of contact, followed by a continuous sequence of the following specific movements (e.g., which are performed in order, while maintaining continuous contact with the multi-touch input interface): two contact regions drag left movement, two contact regions drag right movement, two contact regions drag left movement.

Gesture 2614c represents an alternative example gesture which, in at least some embodiments, may be mapped to function(s) (e.g., user input/instructions) corresponding to: CLEAR ALL PLACED WAGERS. For example, in at least one embodiment, a user may convey the input/instruction(s) CLEAR ALL PLACED WAGERS for example, by performing gesture 2614c at a multipoint or multi-touch input interface of an intelligent multi-player electronic gaming system. As illustrated in the example embodiment of FIG. 26G, gesture 2614c may be defined to include at least the following gesture-specific characteristics: two concurrent contact regions, continuous drag right movement, continuous drag left movement, continuous drag right movement. In at least one embodiment, this gesture may be interpreted as being characterized by an initial two regions of contact, followed by a continuous sequence of the following specific movements (e.g., which are performed in order, while maintaining continuous contact with the multi-touch input interface): two contact regions drag right movement, two contact regions drag left movement, two contact regions drag right movement.

As illustrated in the example embodiment of FIG. 26H, an example plurality of different (e.g., alternative) gestures are graphically represented and described which, for example, may be mapped to function(s) (e.g., user input/instructions) corresponding to: LET IT RIDE.

For example, in at least one embodiment, a user may convey the input/instruction(s) LET IT RIDE (e.g., relating to that particular user) for example, by performing one of the gestures illustrated at 2616a at a multipoint or multi-touch input interface of an intelligent multi-player electronic gaming system. As illustrated in the example embodiment of FIG. 26H, the gesture(s) of 2616a may be defined to include at least some of the following gesture-specific characteristics: two concurrent contact regions, drag left; or two concurrent contact regions, drag right. According to different embodiments, a user may perform either of these gestures within the common wagering area, and/or within the user's “personal” area of the multi-touch, multi-player interactive display.

Gesture 2616b represents an alternative example gesture which, in at least some embodiments, may be mapped to function(s) (e.g., user input/instructions) corresponding to: LET IT RIDE. For example, in at least one embodiment, a user may convey the input/instruction(s) LET IT RIDE for example, by performing gesture 2616b at a multipoint or multi-touch input interface of an intelligent multi-player electronic gaming system. As illustrated in the example embodiment of FIG. 26H, gesture 2616b may be defined to include at least the following gesture-specific characteristics: one contact region, hold at least n seconds. In at least one embodiment, this gesture may be interpreted as being characterized by an initial single region of contact which is continuously maintained at about the same location or position (and/or in which the contact region is continuously maintained within a specified boundary) for a continuous time interval of at least n seconds (e.g., value of n selected from range of 1-8 seconds, n=about 5 seconds, n=3.75 seconds, etc.). According to different embodiments, a user may perform this gesture within the common wagering area, and/or within the user's “personal” area of the multi-touch, multi-player interactive display.

For example, in at least one embodiment, a user may convey the input/instruction(s) LET IT RIDE (e.g., relating to that particular user) for example, by performing one of the gestures illustrated at 2616c at a multipoint or multi-touch input interface of an intelligent multi-player electronic gaming system. As illustrated in the example embodiment of FIG. 26H, the gesture(s) of 2616c may be defined to include at least some of the following gesture-specific characteristics: one contact region, continuous “rotate clockwise” movement; or one contact region, continuous “rotate counter-clockwise” movement. According to different embodiments, a user may perform either of these gestures within the common wagering area, and/or within the user's “personal” area of the multi-touch, multi-player interactive display.

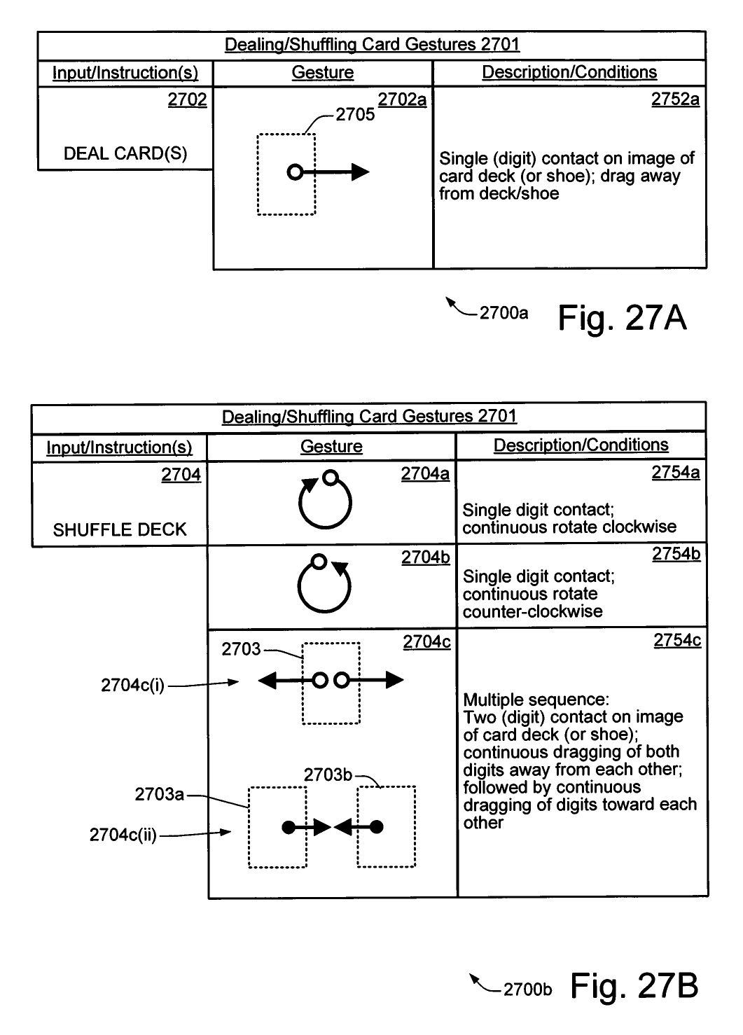

FIGS. 27A-B illustrate various example embodiments of different types of dealing/shuffling related gesture-function mapping information which may be utilized at one or more intelligent multi-player electronic gaming systems described herein.

As illustrated in the example embodiment of FIG. 27A, an example gesture is graphically represented and described which, for example, may be mapped to function(s) (e.g., user input/instructions) corresponding to: DEAL virtual card(S). For example, in at least one embodiment, a user may convey the input/instruction(s) DEAL CARD(S) for example, by performing gesture 2702a at a multipoint or multi-touch input interface of an intelligent multi-player electronic gaming system. As illustrated in the example embodiment of FIG. 27A, gesture 2702a may be defined to include at least the following gesture-specific characteristics: one contact region (e.g., on or over an image of card deck or shoe), drag away from deck/shoe. In at least one embodiment, this gesture may be interpreted as being characterized by an initial single region of contact on, over, or above an image (or graphical object) representing a card deck or card shoe (or other types of card(s) to be dealt), followed by a continuous drag movement away from the card deck/shoe image. In at least one embodiment, the direction of the drag movement may be used to determine the recipient of the dealt card.

As illustrated in the example embodiment of FIG. 27B, an example plurality of different (e.g., alternative) gestures are graphically represented and described which, for example, may be mapped to function(s) (e.g., user input/instructions) corresponding to: SHUFFLE DECK(S).

For example, in at least one embodiment, a user may convey the input/instruction(s) SHUFFLE DECK(S) for example, by performing a gesture 2704a at a multipoint or multi-touch input interface of an intelligent multi-player electronic gaming system. As illustrated in the example embodiment of FIG. 27B, gesture 2704a may be defined to include at least the following gesture-specific characteristics: one contact region, continuous “rotate clockwise” movement. In at least one embodiment, this gesture may be interpreted as being characterized by an initial single region of contact (e.g., on, over or above an image (e.g., 2703) representing the deck(s) or shoe(s) to be shuffled), followed by a continuous “rotate clockwise” movement.

Gesture 2704b represents an alternative example gesture which, in at least some embodiments, may be mapped to function(s) (e.g., user input/instructions) corresponding to: SHUFFLE DECK(S). For example, in at least one embodiment, a user may convey the input/instruction(s) SHUFFLE DECK(S) for example, by performing a gesture 2704b at a multipoint or multi-touch input interface of an intelligent multi-player electronic gaming system. As illustrated in the example embodiment of FIG. 27B, gesture 2704b may be defined to include at least the following gesture-specific characteristics: one contact region, continuous “rotate counter-clockwise” movement. In at least one embodiment, this gesture may be interpreted as being characterized by an initial single region of contact (e.g., on, over or above an image (e.g., 2705) representing the deck(s) or shoe(s) to be shuffled), followed by a continuous “rotate counter-clockwise” movement.

Gesture 2704c represents an alternative example gesture sequence which, in at least some embodiments, may be mapped to function(s) (e.g., user input/instructions) corresponding to: SHUFFLE DECK(S). For example, in at least one embodiment, a user may convey the input/instruction(s) SHUFFLE DECK(S) for example, by performing a sequence of movements and/or gestures (e.g., as illustrated at 2704c) at a multipoint or multi-touch input interface of an intelligent multi-player electronic gaming system. As illustrated in the example embodiment of FIG. 27B combination gesture 2704c may be defined to include at least the following gesture-specific characteristics: two concurrent contact regions, “expand” movement; then “pinch” movement. In at least one embodiment, this gesture may be interpreted as being characterized by a sequence of continuous movements which, for example, may begin with an initial two regions of contact (e.g., on, over or above an image (e.g., 2703) representing the deck(s) or shoe(s) to be shuffled), followed by a “expand” movement (e.g., 2704c(i)), in which both contact regions are concurrently moved in respective directions away from the other; followed by a “pinch” movement (e.g., 2704c(ii)), in which both contact regions are concurrently moved in respective directions towards each other. In some embodiments, the entire sequence of gestures may be performed while maintaining continuous contact (e.g., of both contact regions) with the multi-touch input interface. In other embodiments, contact with the multi-touch input interface may be permitted to be broken, for example, between the “expand” movement and the “pinch” movement.

As illustrated in the example embodiment of FIG. 27B, the intelligent multi-player electronic gaming system may be configured or designed to graphically portray, while the gesture is being performed, animated images of the target deck (e.g., 2703) being split in to two separate piles (e.g., 2703a, 2703b) while the “expand” movement(s) of the gesture are being performed, and then being shuffled and recombined into a single pile (e.g., while the “pinch” movement(s) of the gesture are being performed).

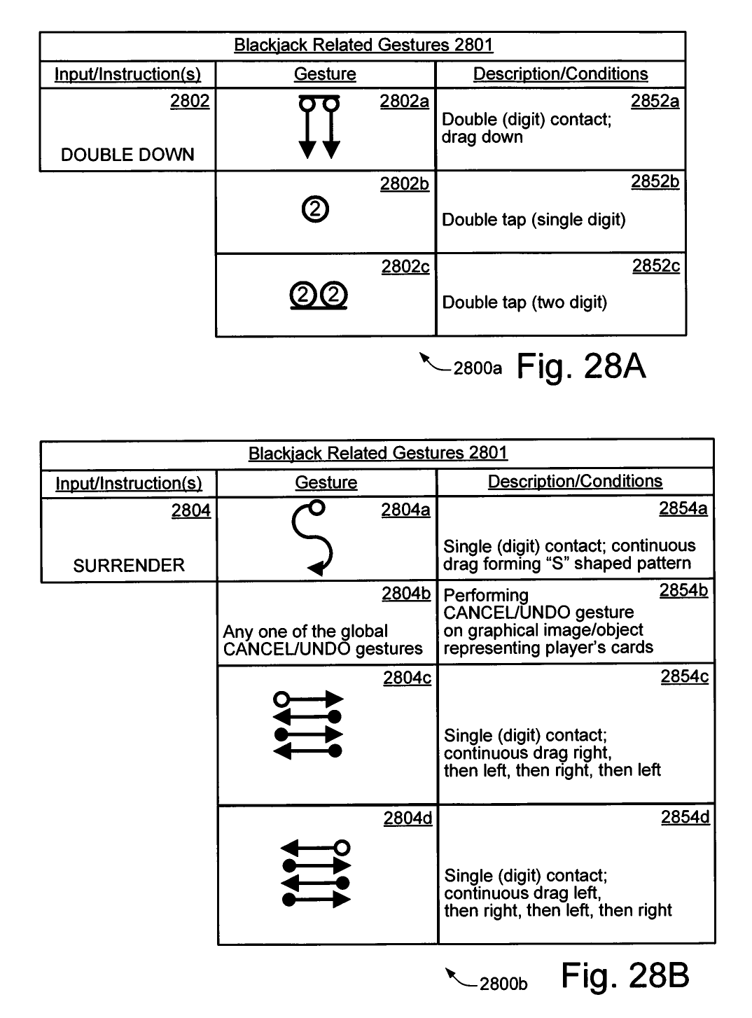

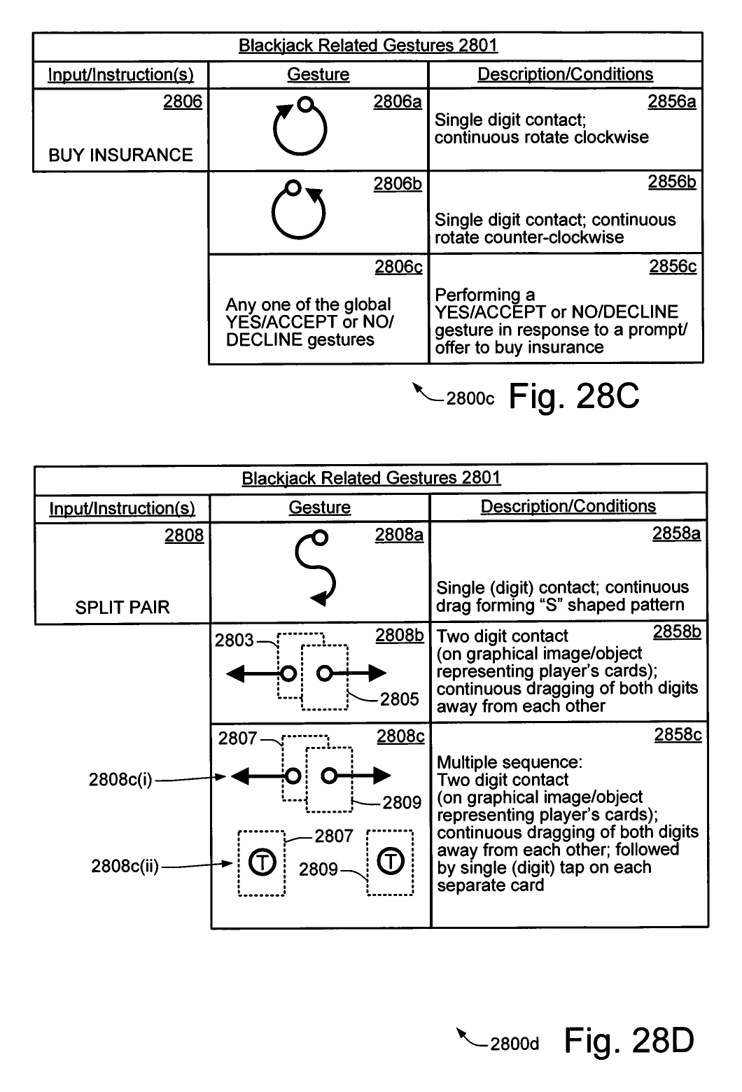

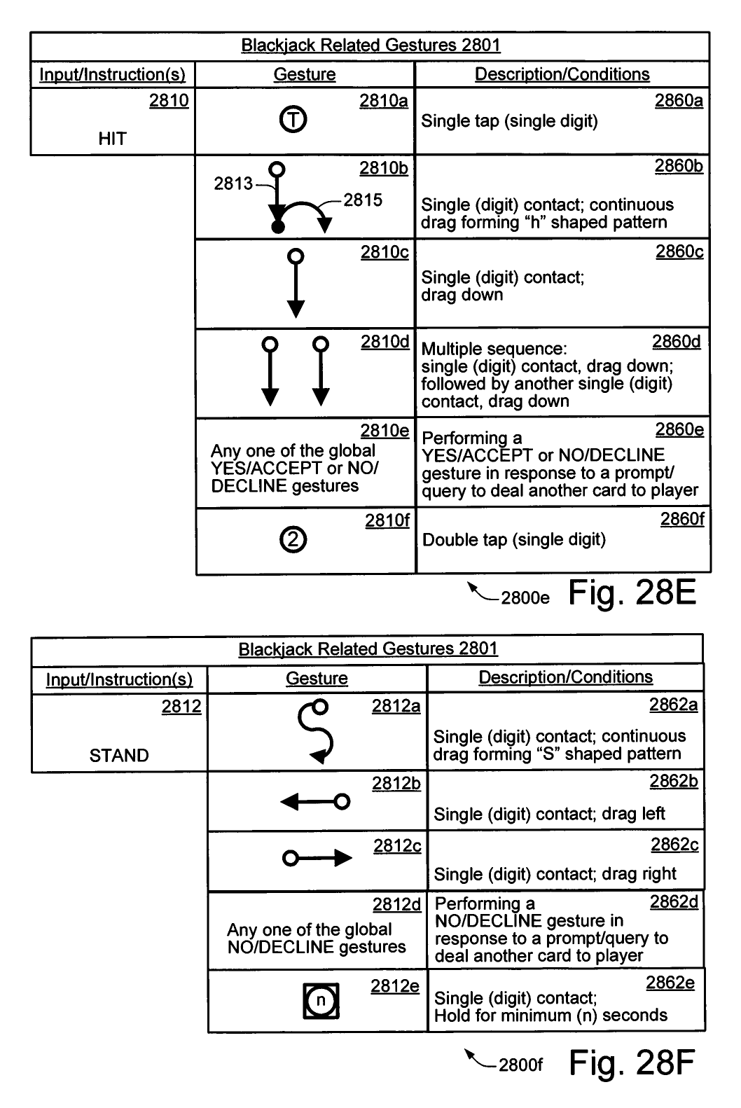

FIGS. 28A-F illustrate various example embodiments of different types of blackjack game related gesture-function mapping information which may be utilized at one or more intelligent multi-player electronic gaming systems described herein. In at least one embodiment, the user may perform one or more of the blackjack-related gesture(s) described herein on, at, or over a graphical image representing the card(s) of the user (e.g., player) performing the gesture(s).

As illustrated in the example embodiment of FIG. 28A, an example plurality of different (e.g., alternative) gestures are graphically represented and described which, for example, may be mapped to function(s) (e.g., user input/instructions) corresponding to: DOUBLE DOWN. In at least one embodiment, the user may perform one or more of the DOUBLE DOWN gesture(s) on or over a displayed graphical image representing the user's cards.

For example, in at least one embodiment, a user may convey the input/instruction(s) DOUBLE DOWN for example, by performing gesture 2802a at a multipoint or multi-touch input interface of an intelligent multi-player electronic gaming system. As illustrated in the example embodiment of FIG. 28A, gesture 2802a may be defined to include at least the following gesture-specific characteristics: two concurrent contact regions, drag down movement. In at least one embodiment, this gesture may be interpreted as being characterized by an initial two regions of contact, followed by concurrent drag down movements of both contact regions.

Gesture 2802b represents an alternative example gesture which, in at least some embodiments, may be mapped to function(s) (e.g., user input/instructions) corresponding to: DOUBLE DOWN. For example, in at least one embodiment, a user may convey the input/instruction(s) DOUBLE DOWN for example, by performing gesture 2802b at a multipoint or multi-touch input interface of an intelligent multi-player electronic gaming system. As illustrated in the example embodiment of FIG. 28A, gesture 2802b may be defined to include at least the following gesture-specific characteristics: double tap, one contact region. In at least one embodiment, this gesture may be interpreted as being characterized by a sequence of two consecutive one contact region “tap” gestures on the multi-touch input interface in which continuous contact with the multi-touch input interface is broken in between each tap.

Gesture 2802c represents an alternative example gesture which, in at least some embodiments, may be mapped to function(s) (e.g., user input/instructions) corresponding to: DOUBLE DOWN. For example, in at least one embodiment, a user may convey the input/instruction(s) DOUBLE DOWN for example, by performing gesture 2802c at a multipoint or multi-touch input interface of an intelligent multi-player electronic gaming system. As illustrated in the example embodiment of FIG. 28A, gesture 2802c may be defined to include at least the following gesture-specific characteristics: double tap, two contact regions. In at least one embodiment, this gesture may be interpreted as being characterized by a sequence of two consecutive two contact regions “tap” gestures (e.g., using two digits) on the multi-touch input interface in which continuous contact with the multi-touch input interface is broken in between each tap.

As illustrated in the example embodiment of FIG. 28B, an example plurality of different (e.g., alternative) gestures are graphically represented and described which, for example, may be mapped to function(s) (e.g., user input/instructions) corresponding to: SURRENDER. In at least one embodiment, the user may perform one or more of the SURRENDER gesture(s) on or over a displayed graphical image representing the user's cards.

For example, in at least one embodiment, a user may convey the input/instruction(s) SURRENDER for example, by performing gesture 2804a at a multipoint or multi-touch input interface of an intelligent multi-player electronic gaming system. As illustrated in the example embodiment of FIG. 28B, gesture 2804a may be defined to include at least the following gesture-specific characteristics: one contact region; continuous “S”-shaped pattern drag down movements. In at least one embodiment, this gesture may be interpreted as being characterized by an initial single region of contact, followed by continuous drag movements forming an “S”-shaped” pattern.

As illustrated in the example embodiment of FIG. 28B, one or more alternative gestures (2804b) may be mapped to function(s) (e.g., user input/instructions) corresponding to: SURRENDER. For example, in at least one embodiment, a user may convey the input/instruction(s) SURRENDER for example, by performing one or more different types of gestures at a multipoint or multi-touch input interface of an intelligent multi-player electronic gaming system. As illustrated in the example embodiment of FIG. 28B, examples of such gestures may include, but are not limited to, one or more of the global CANCEL/UNDO gestures such as those described previously with respect to FIG. 25C.

Gesture 2804c represents an alternative example gesture which, in at least some embodiments, may be mapped to function(s) (e.g., user input/instructions) corresponding to: SURRENDER. For example, in at least one embodiment, a user may convey the input/instruction(s) SURRENDER for example, by performing gesture 2804c at a multipoint or multi-touch input interface of an intelligent multi-player electronic gaming system. As illustrated in the example embodiment of FIG. 28B, gesture 2804c may be defined to include at least the following gesture-specific characteristics: one contact region, continuous drag right movement, continuous drag left movement, continuous drag right movement, continuous drag left movement. In at least one embodiment, this gesture may be interpreted as being characterized by an initial single region of contact, followed by a continuous sequence of the following specific movements (e.g., which are performed in order, while maintaining continuous contact with the multi-touch input interface): drag right movement, then drag left movement, then drag right movement, then drag left movement.

Gesture 2804d represents an alternative example gesture which, in at least some embodiments, may be mapped to function(s) (e.g., user input/instructions) corresponding to: SURRENDER. For example, in at least one embodiment, a user may convey the input/instruction(s) SURRENDER for example, by performing gesture 2804d at a multipoint or multi-touch input interface of an intelligent multi-player electronic gaming system. As illustrated in the example embodiment of FIG. 28B, gesture 2804d may be defined to include at least the following gesture-specific characteristics: one contact region, continuous drag left movement, continuous drag right movement, continuous drag left movement, continuous drag right movement. In at least one embodiment, this gesture may be interpreted as being characterized by an initial single region of contact, followed by a continuous sequence of the following specific movements (e.g., which are performed in order, while maintaining continuous contact with the multi-touch input interface): drag left movement, then drag right movement, then drag left movement, then drag right movement.

As illustrated in the example embodiment of FIG. 28C, an example plurality of different (e.g., alternative) gestures are graphically represented and described which, for example, may be mapped to function(s) (e.g., user input/instructions) corresponding to: BUY INSURANCE.

For example, in at least one embodiment, a user may convey the input/instruction(s) BUY INSURANCE for example, by performing gesture 2806a at a multipoint or multi-touch input interface of an intelligent multi-player electronic gaming system. As illustrated in the example embodiment of FIG. 28C, gesture 2806a may be defined to include at least the following gesture-specific characteristics: one contact region, continuous “rotate clockwise” movement. In at least one embodiment, this gesture may be interpreted as being characterized by an initial single region of contact, followed by a continuous “rotate clockwise” movement.

Gesture 2806b represents an alternative example gesture which, in at least some embodiments, may be mapped to function(s) (e.g., user input/instructions) corresponding to: BUY INSURANCE. For example, in at least one embodiment, a user may convey the input/instruction(s) BUY INSURANCE for example, by performing gesture 2806b at a multipoint or multi-touch input interface of an intelligent multi-player electronic gaming system. As illustrated in the example embodiment of FIG. 28C, gesture 2806b may be defined to include at least the following gesture-specific characteristics: one contact region, continuous “rotate counter-clockwise” movement. In at least one embodiment, this gesture may be interpreted as being characterized by an initial single region of contact, followed by a continuous “rotate counter-clockwise” movement.

As illustrated in the example embodiment of FIG. 28C, one or more alternative gestures (2806c) may be mapped to function(s) (e.g., user input/instructions) corresponding to: BUY INSURANCE. For example, in at least one embodiment, a user may convey the input/instruction(s) BUY INSURANCE for example, by performing one or more different types of gestures at a multipoint or multi-touch input interface of an intelligent multi-player electronic gaming system in response to an offer to the user to buy insurance. As illustrated in the example embodiment of FIG. 28C, examples of such gestures may include, but are not limited to, one or more of the global YES/ACCEPT gestures (e.g., to accept a “Buy Insurance?” offer), and/or more of the global NO/DECLINE gestures (e.g., to decline a “Buy Insurance?” offer) described herein.

As illustrated in the example embodiment of FIG. 28D, an example plurality of different (e.g., alternative) gestures are graphically represented and described which, for example, may be mapped to function(s) (e.g., user input/instructions) corresponding to: SPLIT PAIR. In at least one embodiment, the user may perform one or more of the SPLIT PAIR gesture(s) on or over a displayed graphical image representing the user's cards.

For example, in at least one embodiment, a user may convey the input/instruction(s) SPLIT PAIR for example, by performing gesture 2808a at a multipoint or multi-touch input interface of an intelligent multi-player electronic gaming system. As illustrated in the example embodiment of FIG. 28D, gesture 2808a may be defined to include at least the following gesture-specific characteristics: one contact region; continuous “S”-shaped pattern drag down movements. In at least one embodiment, this gesture may be interpreted as being characterized by an initial single region of contact, followed by continuous drag movements forming an “S”-shaped” pattern.

Gesture 2808b represents an alternative example gesture which, in at least some embodiments, may be mapped to function(s) (e.g., user input/instructions) corresponding to: SPLIT PAIR. For example, in at least one embodiment, a user may convey the input/instruction(s) SPLIT PAIR for example, by performing gesture 2808b at a multipoint or multi-touch input interface of an intelligent multi-player electronic gaming system. As illustrated in the example embodiment of FIG. 28D, gesture 2808b may be defined to include at least the following gesture-specific characteristics: two concurrent contact regions, “expand” movement. In at least one embodiment, this gesture may be interpreted as being characterized by an initial two regions of contact (e.g., where each contact region is located on or over a respective card a respective card image (e.g., 2803, 2805)), followed by an “expand” movement, in which both contact regions are concurrently moved in respective directions away from the other.

Gesture 2808c represents an alternative example multiple gesture sequence which, in at least some embodiments, may be mapped to function(s) (e.g., user input/instructions) corresponding to: SPLIT PAIR. For example, in at least one embodiment, a user may convey the input/instruction(s) SPLIT PAIR for example, by performing a sequence of movements and/or gestures (e.g., as illustrated at 2808c) at a multipoint or multi-touch input interface of an intelligent multi-player electronic gaming system. As illustrated in the example embodiment of FIG. 28D, combination gesture 2808c may be defined to include at least the following gesture-specific characteristics: multiple sequence of gestures: two concurrent contact regions, “expand” movement; then two one contact region tap gestures. In at least one embodiment, this gesture may be interpreted as being characterized by an initial two regions of contact (e.g., where each contact region is located on or over a respective card image (e.g., 2807, 2809)); followed by a “expand” movement, in which both contact regions are concurrently moved in respective directions away from the other; followed by a respective one contact region single “tap” gesture on (or over) each of the separate card images.

In at least one embodiment, as illustrated in the example embodiments of FIG. 28D, the intelligent multi-player electronic gaming system may be configured or designed to graphically portray, while each gesture is being performed, animated images of the target cards being moved apart (e.g., while the “expand” movement(s) of the gesture are being performed).

As illustrated in the example embodiment of FIG. 28E, an example plurality of different (e.g., alternative) gestures are graphically represented and described which, for example, may be mapped to function(s) (e.g., user input/instructions) corresponding to: HIT (or, in some embodiments, DEAL ONE CARD). In at least one embodiment, the user may perform one or more of the HIT gesture(s) on or over a displayed graphical image representing the user's cards.

For example, in at least one embodiment, a user may convey the input/instruction(s) HIT for example, by performing gesture 2810a at a multipoint or multi-touch input interface of an intelligent multi-player electronic gaming system. As illustrated in the example embodiment of FIG. 28E, gesture 2810a may be defined to include at least the following gesture-specific characteristics: single tap, one contact region. In at least one embodiment, this gesture may be interpreted as being characterized by a one contact region “tap” gesture on the multi-touch input interface.

Gesture 2810b represents an alternative example gesture which, in at least some embodiments, may be mapped to function(s) (e.g., user input/instructions) corresponding to: HIT. For example, in at least one embodiment, a user may convey the input/instruction(s) HIT for example, by performing gesture 2810b at a multipoint or multi-touch input interface of an intelligent multi-player electronic gaming system. As illustrated in the example embodiment of FIG. 28E, gesture 28 10b may be defined to include at least the following gesture-specific characteristics: one contact region; continuous drag forming “h”-shaped pattern drag movements. In at least one embodiment, this gesture may be interpreted as being characterized by an initial single region of contact, followed by continuous sequence of movements forming an “h”-shaped” pattern. As illustrated in the example embodiment of FIG. 28E, the sequence of continuous “h”-shaped” pattern movements may include, for example, a drag down movement (2813), followed by an “arch right” drag movement (2815).

Gesture 2810c represents an alternative example gesture which, in at least some embodiments, may be mapped to function(s) (e.g., user input/instructions) corresponding to: HIT. For example, in at least one embodiment, a user may convey the input/instruction(s) HIT for example, by performing gesture 2810c at a multipoint or multi-touch input interface of an intelligent multi-player electronic gaming system. As illustrated in the example embodiment of FIG. 28E, gesture 2810c may be defined to include at least the following gesture-specific characteristics: one contact region, drag down movement.

Gesture 2810d represents an alternative example gesture which, in at least some embodiments, may be mapped to function(s) (e.g., user input/instructions) corresponding to: HIT. For example, in at least one embodiment, a user may convey the input/instruction(s) HIT for example, by performing a multi-gesture sequence of non-continuous contact gestures (e.g., as illustrated at 2810d) at a multipoint or multi-touch input interface of an intelligent multi-player electronic gaming system. As illustrated in the example embodiment of FIG. 28E, gesture 2810d may be defined to include at least the following gesture-specific characteristics: multiple sequence of non-continuous contact gestures: one contact region, drag down; one contact region, drag down movement. In at least one embodiment, the combination gesture illustrated at 2810d may be interpreted as being characterized by a first “one contact region, drag down gesture, followed by another “one contact region, drag down gesture, wherein contact with the multi-touch input interface is broken between the end of the first gesture and the start of the second gesture. In one embodiment, the user may be required to perform both drag down gesture within a predetermined or specified time interval (e.g., both gesture portions should occur within at most T seconds of each other, where T represents a time value such as, for example, T=about 2 seconds, T 1.5 seconds, T selected from the range 250-2500 mSec, etc.).

As illustrated in the example embodiment of FIG. 28E, one or more other gestures may be mapped to function(s) (e.g., user input/instructions) corresponding to: HIT. For example, in at least one embodiment, a user may convey the input/instruction(s) HIT for example, by performing one or more different types of gestures represented at 2810e, which, for example, may include, but is not limited to, one or more of the global YES/ACCEPT gestures such as those described herein.

Gesture 2810f represents an alternative example gesture which, in at least some embodiments, may be mapped to function(s) (e.g., user input/instructions) corresponding to: HIT. For example, in at least one embodiment, a user may convey the input/instruction(s) HIT for example, by performing gesture 2810f at a multipoint or multi-touch input interface of an intelligent multi-player electronic gaming system. As illustrated in the example embodiment of FIG. 28E, gesture 2810f may be defined to include at least the following gesture-specific characteristics: double tap, one contact region.

In at least some embodiments, one or more of the various gestures which may be used to convey the input/instruction(s) HIT (such as, for example, those described with respect to FIG. 28E, may be mapped to the input instruction/function: DEAL ONE CARD, such as, for example, during play of one or more card games at the intelligent multi-player electronic gaming system in which a player may instruct the dealer to deal another card to the player.

As illustrated in the example embodiment of FIG. 28F, an example plurality of different (e.g., alternative) gestures are graphically represented and described which, for example, may be mapped to function(s) (e.g., user input/instructions) corresponding to: STAND. In at least one embodiment, the user may perform one or more of the STAND gesture(s) on or over a displayed graphical image representing the user's cards.

For example, in at least one embodiment, a user may convey the input/instruction(s) STAND for example, by performing gesture 2812a at a multipoint or multi-touch input interface of an intelligent multi-player electronic gaming system. As illustrated in the example embodiment of FIG. 28F, gesture 2812a may be defined to include at least the following gesture-specific characteristics: one contact region; continuous “S”-shaped pattern drag down movements. In at least one embodiment, this gesture may be interpreted as being characterized by an initial single region of contact, followed by continuous drag movements forming an “S”-shaped” pattern.

Gesture 2812b represents an alternative example gesture which, in at least some embodiments, may be mapped to function(s) (e.g., user input/instructions) corresponding to: STAND. For example, in at least one embodiment, a user may convey the input/instruction(s) STAND for example, by performing gesture 2812b at a multipoint or multi-touch input interface of an intelligent multi-player electronic gaming system. As illustrated in the example embodiment of FIG. 28F, gesture 2812b may be defined to include at least the following gesture-specific characteristics: one contact region, drag left movement. In at least one embodiment, this gesture may be interpreted as being characterized by an initial single region of contact, followed by a drag left movement.

Gesture 2812c represents an alternative example gesture which, in at least some embodiments, may be mapped to function(s) (e.g., user input/instructions) corresponding to: STAND. For example, in at least one embodiment, a user may convey the input/instruction(s) STAND for example, by performing gesture 2812c at a multipoint or multi-touch input interface of an intelligent multi-player electronic gaming system. As illustrated in the example embodiment of FIG. 28F, gesture 2812c may be defined to include at least the following gesture-specific characteristics: one contact region, drag right movement. In at least one embodiment, this gesture may be interpreted as being characterized by an initial single region of contact, followed by a drag right movement.

As illustrated in the example embodiment of FIG. 28F, one or more other gestures may be mapped to function(s) (e.g., user input/instructions) corresponding to: STAND. For example, in at least one embodiment, a user may convey the input/instruction(s) STAND for example, by performing one or more different types of gestures (e.g., as represented at 2812d) at a multipoint or multi-touch input interface of an intelligent multi-player electronic gaming system. In at least one embodiment, examples of such gestures may include, but are not limited to, one or more of the global YES/ACCEPT gestures such as those described herein.

Gesture 2812e represents an alternative example gesture which, in at least some embodiments, may be mapped to function(s) (e.g., user input/instructions) corresponding to: STAND. For example, in at least one embodiment, a user may convey the input/instruction(s) STAND for example, by performing gesture 2812e at a multipoint or multi-touch input interface of an intelligent multi-player electronic gaming system. As illustrated in the example embodiment of FIG. 28F, gesture 2812e may be defined to include at least the following gesture-specific characteristics: one contact region, hold at least n seconds. In at least one embodiment, this gesture may be interpreted as being characterized by an initial single region of contact which is continuously maintained at about the same location or position (and/or in which the contact region is continuously maintained within a specified boundary) for a continuous time interval of at least n seconds (e.g., value of n selected from range of 1-8 seconds, n about 5 seconds, n=3.75 seconds, etc.).

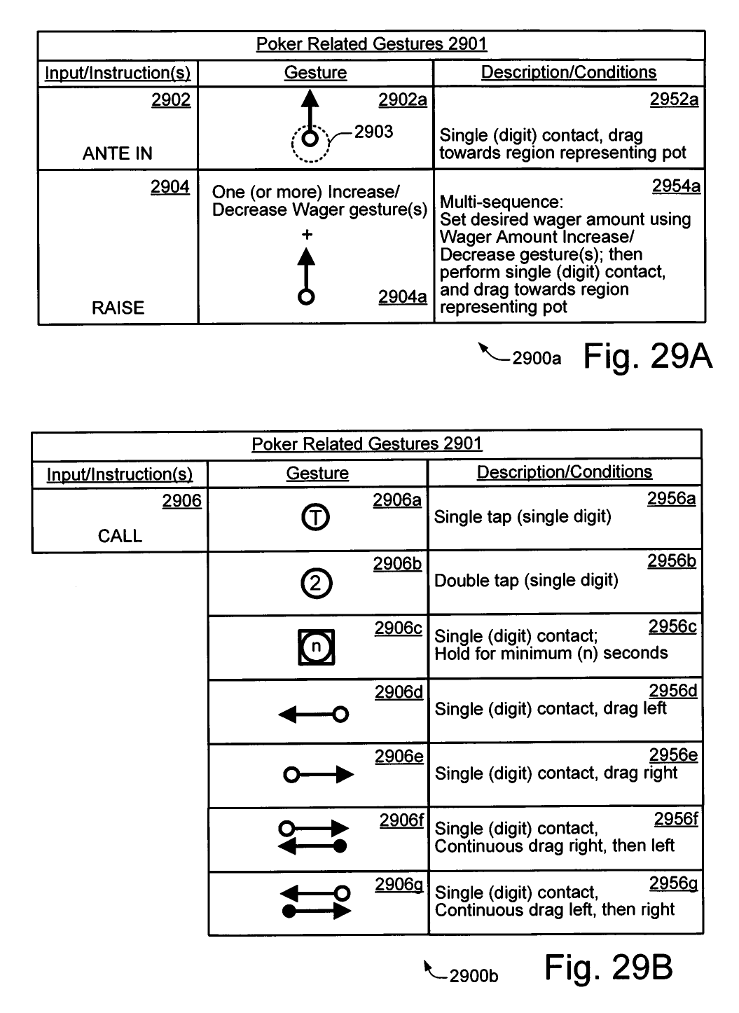

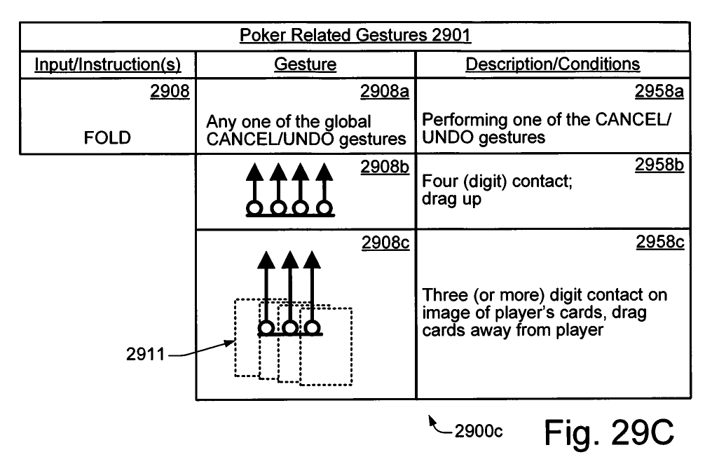

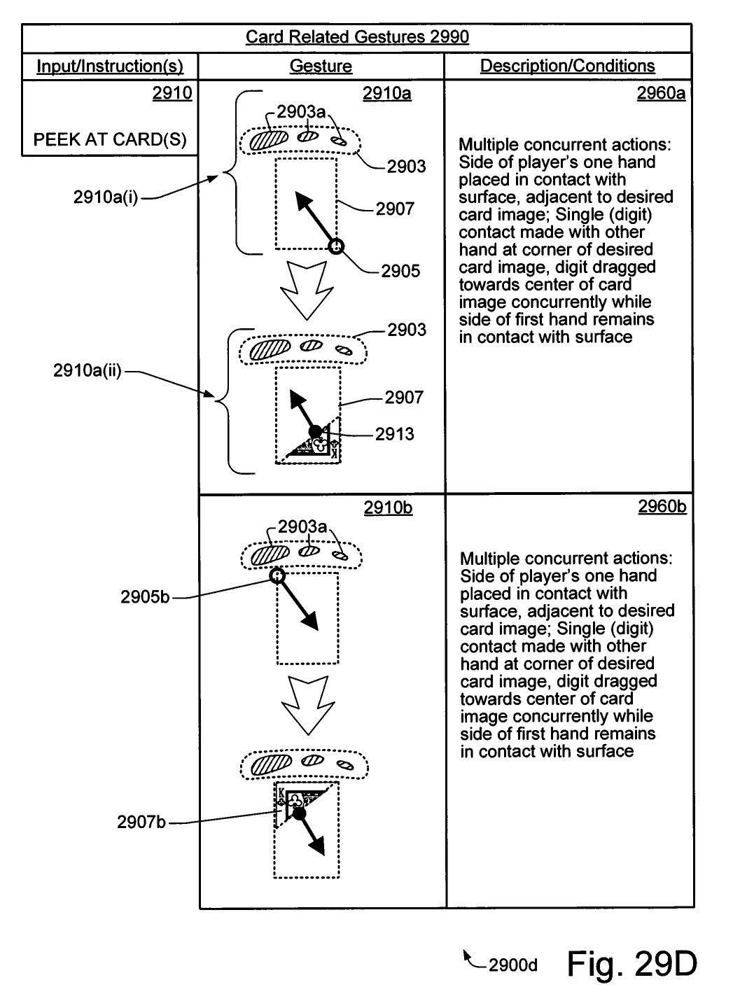

FIGS. 29A-C illustrate various example embodiments of different types of poker game related gesture-function mapping information which may be utilized at one or more intelligent multi-player electronic gaming systems described herein.

For example, as illustrated in the example embodiment of FIG. 29A, a user may convey the input/instruction(s) ANTE IN for example, by performing gesture 2902a at a multipoint or multi-touch input interface of an intelligent multi-player electronic gaming system. As illustrated in the example embodiment of FIG. 29A, gesture 2902a may be defined to include at least the following gesture-specific characteristics: one contact region, continuous drag towards region representing pot. In at least one embodiment, this gesture may be interpreted as being characterized by an initial single region of contact (e.g., on or over an image representing one or more wager token(s), on or over an image or object representing the ante amount, etc.) followed by a drag movement. In at least one embodiment, the direction of the drag movement may preferably be toward an image representing the pot and/or towards the region (e.g., of the multi-touch, multi-player interactive display surface) representing the pot.

Gesture 2904a represents an example multiple gesture sequence which, in at least some embodiments, may be mapped to function(s) (e.g., user input/instructions) corresponding to: RAISE. For example, in at least one embodiment, a user may convey the input/instruction(s) RAISE for example, by performing a sequence of movements and/or gestures (e.g., as illustrated at 2904a) at a multipoint or multi-touch input interface of an intelligent multi-player electronic gaming system. As illustrated in the example embodiment of FIG. 29A, combination gesture 2904a may be defined to include at least the following gesture-specific characteristics: multiple sequence of gestures: user selects wager amount; one contact region, continuous drag towards region representing pot. In at least one embodiment, this gesture may be interpreted as being characterized by a sequence of continuous contact and/or non-continuous contact movements/gestures which, for example, may begin with the user performing one or more wager increase/wager decrease gestures described herein in order to establish a desired wager value; followed by a single region of contact (e.g., on or over an image or virtual object representing the desired wager value; followed by a drag movement. In at least one embodiment, the direction of the drag movement may preferably be toward an image representing the pot and/or towards the region (e.g., of the multi-touch, multi-player interactive display surface) representing the pot.

As illustrated in the example embodiment of FIG. 29B, an example plurality of different (e.g., alternative) gestures are graphically represented and described which, for example, may be mapped to function(s) (e.g., user input/instructions) corresponding to: CALL. For example, in at least one embodiment, a user may convey the input/instruction(s) CALL for example, by performing one or more different types of gestures represented at FIG. 29B. According to specific embodiments, examples of such gestures may include, but are not limited to, one or more of the following (or combinations thereof): a gesture (e.g., 2906a) characterized by a one contact region, single tap; a gesture (e.g., 2906b) characterized by a one contact region, double tap; a gesture (e.g., 2906c) characterized by a one contact region, hold at least n seconds; a gesture (e.g., 2906d) characterized by a one contact region, drag left movement; a gesture (e.g., 2906e) characterized by a one contact region, drag right movement; a gesture (e.g., 2906f) characterized by a one contact region, continuous drag left movement, continuous drag right movement; a gesture (e.g., 2906g) characterized by a one contact region, continuous drag right movement, continuous drag left movement; etc.

As illustrated in the example embodiment of FIG. 29C, an example plurality of different (e.g., alternative) gestures are graphically represented and described which, for example, may be mapped to function(s) (e.g., user input/instructions) corresponding to: FOLD.

For example, in at least one embodiment, as shown, for example, at 2908a, a user may convey the input/instruction(s) FOLD for example, by performing one or more different types of gestures at a multipoint or multi-touch input interface of an intelligent multi-player electronic gaming system in response to an offer to the user to FOLD. Examples of such gestures may include, but are not limited to, one or more of the global CANCEL/UNDO gestures described herein.

Gesture 2908b represents an alternative example gesture which, in at least some embodiments, may be mapped to function(s) (e.g., user input/instructions) corresponding to: FOLD. For example, in at least one embodiment, a user may convey the input/instruction(s) FOLD for example, by performing gesture 2908b at a multipoint or multi-touch input interface of an intelligent multi-player electronic gaming system. As illustrated in the example embodiment of FIG. 29C, gesture 2908b may be defined to include at least the following gesture-specific characteristics: four contact regions, concurrent drag up movements. In at least one embodiment, this gesture may be interpreted as being characterized by an initial four regions of contact, followed by concurrent drag up movements of all four contact regions.

Gesture 2908c represents an alternative example gesture which, in at least some embodiments, may be mapped to function(s) (e.g., user input/instructions) corresponding to: FOLD. For example, in at least one embodiment, a user may convey the input/instruction(s) FOLD for example, by performing gesture 2908c at a multipoint or multi-touch input interface of an intelligent multi-player electronic gaming system. As illustrated in the example embodiment of FIG. 29C, gesture 2908c may be defined to include at least the following gesture-specific characteristics: three concurrent contact regions, concurrent drag up movements. In at least one embodiment, this gesture may be interpreted as being characterized by an initial three regions of contact (e.g., on or over an image (e.g., 2911) representing the user's card(s)), followed by concurrent drag up movements of all three contact regions.

FIG. 29D illustrates various example embodiments of different types of card game related gesture-function mapping information which may be utilized at one or more intelligent multi-player electronic gaming systems described herein.

As illustrated in the example embodiment of FIG. 29D, an example gesture graphically represented (e.g., at 2910a) and described which, for example, may be mapped to function(s) (e.g., user input/instructions) corresponding to: PEEK AT CARD(S). For example, in at least one embodiment, a user may convey the input/instruction(s) PEEK AT CARD(S) for example, by concurrently performing multiple different movements and/or gestures (e.g., as illustrated at 2910a) at a multipoint or multi-touch input interface of an intelligent multi-player electronic gaming system. As illustrated in the example embodiment of FIG. 29D, combination gesture 2910a may be defined to include at least the following gesture-specific characteristics: multiple concurrent gestures: side of one hand (e.g., 2903) placed in contact with surface adjacent to desired card(s) image (e.g., 2907); single region of contact (e.g., 2905) on or above corner of card(s), continuous drag towards center of card(s) image concurrently while side of one hand remains in contact with surface. In at least one embodiment, a user may be required to use both hands to perform this combination gesture.

As illustrated in the example embodiment of FIG. 29D, as the user performs this gesture and continues to slide or drag his finger over the card(s) image (e.g., as represented at 2913), the image of the card(s) 2907 may automatically and dynamically be updated to reveal a portion (e.g., 2907a) of one or more of the card face(s) to the user. In at least one embodiment, use of the covering hand (e.g., 2903) may be required to help obscure visibility of the displayed portion (2907a) of card face(s) by other players at the gaming table.

In at least one embodiment, the image of the card(s) 2907 may automatically and dynamically be updated to remove the displayed portion (2907a) of the card face(s), for example, in response to detecting a non-compliant condition of the gesture, such as, for example, the removal of the covering hand 2903 and/or sliding digit.

As illustrated in the example embodiment of FIG. 29D, the intelligent multi-player electronic gaming system may be configured or designed to recognize and/or identify one or more different patterns and/or arrangements of concurrent contact regions (e.g., 2903a) as being representative of (and/or as corresponding to) a side of a human hand (e.g., in one or more configurations) being placed in contact with the multi-touch input interface.

Gesture 2910b represents an alternative example gesture combination which, for example, may be mapped to function(s) (e.g., user input/instructions) corresponding to: PEEK AT CARD(S). In at least one embodiment, this combination gesture may be performed in a manner similar to that of gesture 2910a, except that, as shown at 2910b, the user may initiate the gesture at a different corner (e.g., 2905b) of the card(s) to cause a different portion or region (e.g., 2907b) of the card(s) to be revealed.

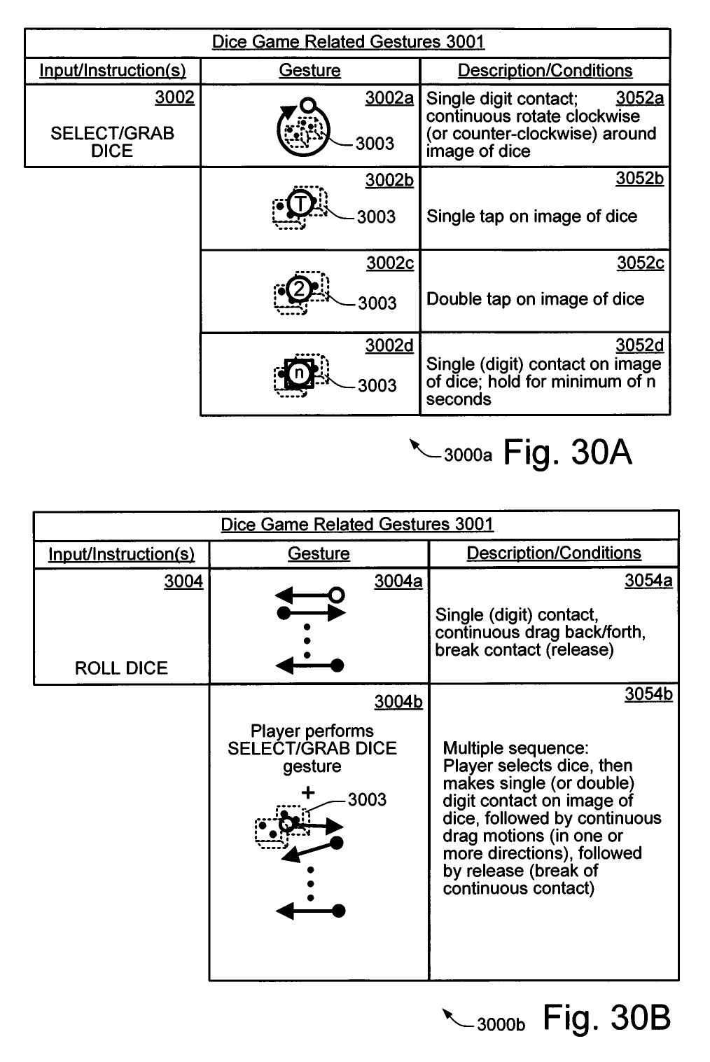

FIGS. 30A-B illustrate various example embodiments of different types of dice game related gesture-function mapping information which may be utilized at one or more intelligent multi-player electronic gaming systems described herein.

As illustrated in the example embodiment of FIG. 30A, an example plurality of different (e.g., alternative) gestures are graphically represented and described which, for example, may be mapped to function(s) (e.g., user input/instructions) corresponding to: SELECT/GRAB DICE. For example, in at least one embodiment, a user may convey the input/instruction(s) SELECT/GRAB DICE for example, by performing one or more different types of gestures represented at FIG. 30A. According to specific embodiments, examples of such gestures may include, but are not limited to, one or more of the following (or combinations thereof): a gesture (e.g., 3002a) characterized by a one contact region, continuous “rotate clockwise” (or counter-clockwise) movement (e.g., around an image of the dice to be selected); a gesture (e.g., 3002b) characterized by a one contact region, single tap; a gesture (e.g., 3002c) characterized by a one contact region, double tap; a gesture (e.g., 3002d) characterized by a one contact region, hold at least n seconds. In at least one embodiment, one or more of the gestures may be performed at, on, and/or above an image (e.g., 3003) representing the dice to be selected/grabbed.

As illustrated in the example embodiment of FIG. 30B, an example plurality of different (e.g., alternative) gestures are graphically represented and described which, for example, may be mapped to function(s) (e.g., user input/instructions) corresponding to: ROLL DICE.

For example, gesture 3004a represents an example gesture which, in at least some embodiments, may be mapped to function(s) (e.g., user input/instructions) corresponding to: ROLL DICE. For example, in at least one embodiment, a user may convey the input/instruction(s) ROLL DICE for example, by performing gesture 3004a at a multipoint or multi-touch input interface of an intelligent multi-player electronic gaming system. As illustrated in the example embodiment of FIG. 30B, gesture 3004a may be defined to include at least the following gesture-specific characteristics: one contact region, continuous repetition of one or more drag left/drag right movements (or continuous repetition of one or more drag right/drag left movements), release. Thus, for example, in one embodiment, the shooter at an intelligent wager-based gaming craps gaming table system may use this gesture to convey the input/instruction(s) ROLL DICE by performing a continuous contact sequence of one or more drag left/drag right movements (or drag right/drag left movements) on the multi-touch, multi-player interactive display surface, as desired by the shooter, and may complete the gesture by breaking contact with the surface.

Gesture 3004b represents an alternative example multiple gesture sequence which, in at least some embodiments, may be mapped to function(s) (e.g., user input/instructions) corresponding to: ROLL DICE. For example, in at least one embodiment, a user may convey the input/instruction(s) ROLL DICE for example, by performing a sequence of movements and/or gestures (e.g., as illustrated at 3004b) at a multipoint or multi-touch input interface of an intelligent multi-player electronic gaming system. As illustrated in the example embodiment of FIG. 30B, combination gesture 3004b may be defined to include at least the following gesture-specific characteristics: multiple sequence of gestures: user performs SELECT/GRAB DICE gesture (e.g., to select desired dice for game play); single (or double) contact region (e.g., on or over image of selected dice), continuous contact movements in any direction, release. For example, in one embodiment, the shooter at an intelligent wager-based gaming craps gaming table system may first select a the desired pair of dice to be used for game play (e.g., by performing one of the SELECT/GRAB DICE gestures referenced in FIG. 30A). Thereafter, the shooter may place one or two fingers on (or over) the image of the selected dice, and may perform any series of continuous movements in any direction (e.g., while maintaining continuous contact with the multi-touch, multi-player interactive display surface), and may complete the ROLL DICE gesture by breaking contact with the display surface.

In at least one embodiment, the initial trajectory and/or an initial velocity of the rolled dice may be determined, at least in part, based upon one or more of the characteristics (e.g., displacement, velocity, trajectory, etc.) associated with the user's (e.g., shooter's) final movement(s) before breaking contact with the display surface. Additionally, in at least one embodiment, while the movements of the ROLL DICE gesture are being performed by the user, the intelligent multi-player electronic gaming system may be configured or designed to display (e.g., in real-time) animated images of the dice image moving in accordance with the user's various movements.

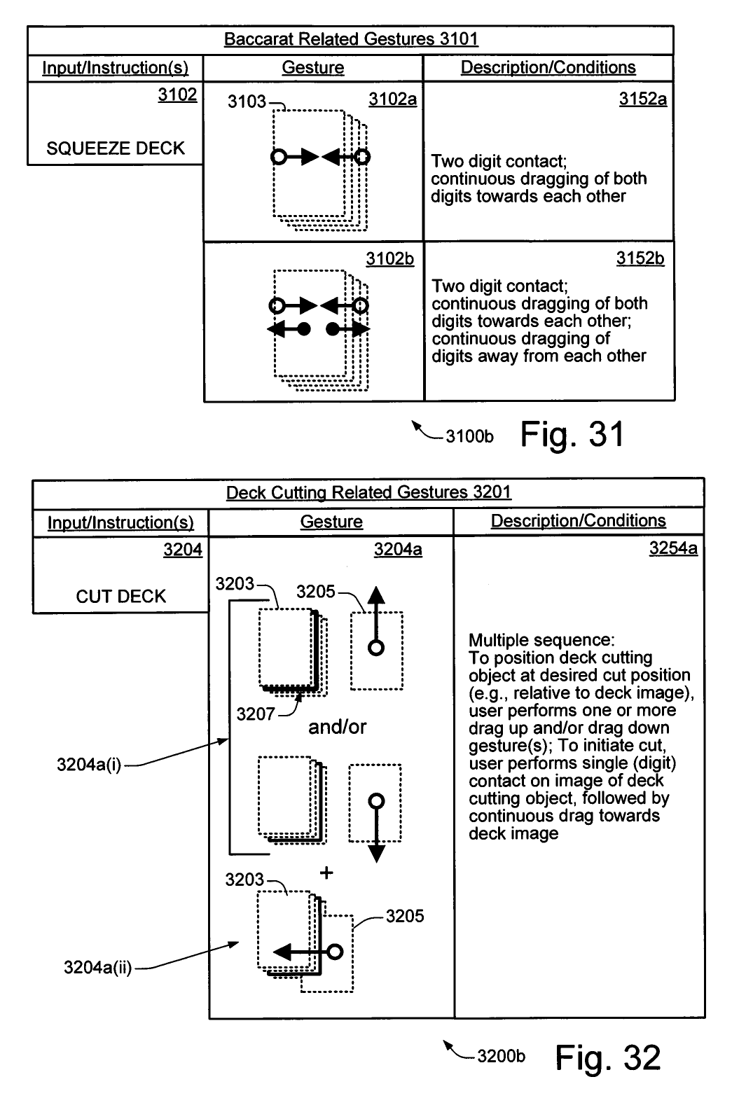

FIG. 31 illustrated an example embodiment of baccarat game related gesture-function mapping information which may be utilized at one or more intelligent multi-player electronic gaming systems described herein.

For example, as illustrated in the example embodiment of FIG. 31, an example gesture is graphically represented and described which, for example, may be mapped to function(s) (e.g., user input/instructions) corresponding to: SQUEEZE DECK. In at least one embodiment, a user may convey the input/instruction(s) SQUEEZE DECK for example, by performing gesture 3102a at a multipoint or multi-touch input interface of an intelligent multi-player electronic gaming system. As illustrated in the example embodiment of FIG. 31, gesture 3102a may be defined to include at least the following gesture-specific characteristics: two contact regions (e.g., on, above or adjacent to image 3103 representing deck), “pinch” movement (e.g., in which both contact regions are concurrently moved in respective directions towards each other.

Gesture 3102b represents an alternative example gesture which, in at least some embodiments, may be mapped to function(s) (e.g., user input/instructions) corresponding to: SQUEEZE DECK. For example, in at least one embodiment, a user may convey the input/instruction(s) SQUEEZE DECK for example, by performing gesture 3102b at a multipoint or multi-touch input interface of an intelligent multi-player electronic gaming system. As illustrated in the example embodiment of FIG. 31, gesture 3102b may be defined to include at least the following gesture-specific characteristics: two contact regions (e.g., on, above or adjacent to image 3103 representing deck), “pinch” movement (e.g., in which both contact regions are concurrently moved in respective directions towards each other, followed by continuous contact “expand” movement (e.g., in which both contact regions are concurrently moved in respective directions away from the other).

In at least one embodiment, other gesture-function mappings relating to other baccarat game related activities (e.g., such as, for example, those relating to dealing cards, wagering, etc.) may be similar to other gesture-function mapping(s) described herein which relate to those respective activities.

FIG. 32 illustrates an example embodiment of card deck cutting related gesture-function mapping information which may be utilized at one or more intelligent multi-player electronic gaming systems described herein. For example, combination gesture 3204a represents an example multiple gesture sequence which, in at least some embodiments, may be mapped to function(s) (e.g., user input/instructions) corresponding to: CUT DECK. For example, in at least one embodiment, a user may convey the input/instruction(s) CUT DECK for example, by performing a sequence of movements and/or gestures (e.g., as illustrated at 3204a) at a multipoint or multi-touch input interface of an intelligent multi-player electronic gaming system. As illustrated in the example embodiment of FIG. 32, combination gesture 3204a may be defined to include at least the following gesture-specific characteristics: multiple sequence of gestures: user performs desired combination of drag up/drag down gestures (e.g., on or over image of deck cutting object 3205) to achieve desired cut position (e.g., relative to deck image); one contact region (e.g., on deck cutting object 3205), drag toward deck image (e.g., to initiate/execute cut operation).

For example, as illustrated in the example embodiment of FIG. 32, a user (e.g., a player selected to cut the deck) may be presented with an image of the deck (e.g., 3203) and an image of a deck cutting object (e.g., 3205) (which, for example, may be a representation of a card, paddle, etc.). In at least one embodiment, the deck image 3203 may be presented in isomorphic projection, thereby providing the user with a perspective view of the virtual deck. In one embodiment, the user may perform any desired combination of drag up and/or drag down gestures (e.g., on or over image of deck cutting object 3205) to achieve desired cut position (e.g., relative to the deck image 3203).

For example, in at least one embodiment, each time the user performs a separate drag up gesture (e.g., using a one contact region, drag up movement) on or over the deck cutting object 3205, the relative position of the projected deck cut location (which, for example, may be represented by highlighted region 3207) may be dynamically and/or incrementally moved (e.g., raised) towards the top of the virtual deck. Similarly, each time the user performs a separate drag down gesture (e.g., using a one contact region, drag down movement) on or over the deck cutting object 3205, the relative position of the projected deck cut location 3207 may be dynamically and/or incrementally moved (e.g., lowered) towards the bottom of the virtual deck. In other embodiments, a drag up gesture may result in the relative position of the projected deck cut location being lowered toward the bottom of the virtual deck, and a drag down gesture may result in the relative position of the projected deck cut location being raised toward the top of the virtual deck. In yet other embodiments, other gestures (e.g., described herein) may be used for allowing the user to dynamically raise and/or lower the relative position of the desired location of the cut. In at least one embodiment, while the drag up/drag down gestures are being performed by the user, the intelligent multi-player electronic gaming system may be configured or designed to display (e.g., in real-time) animated images of the highlighted deck cut position (e.g., 3207) dynamically moving up/down in accordance with the user's actions/gestures.

In at least one embodiment, assuming that the user is content with the currently selected deck cut location, the user may initiate and/or execute the CUT DECK operation (as illustrated at 3204(ii) for example) by dragging the deck cutting object 3205 toward the deck image 3203 (e.g., via use of a one contact region, drag left (or drag right) gesture).

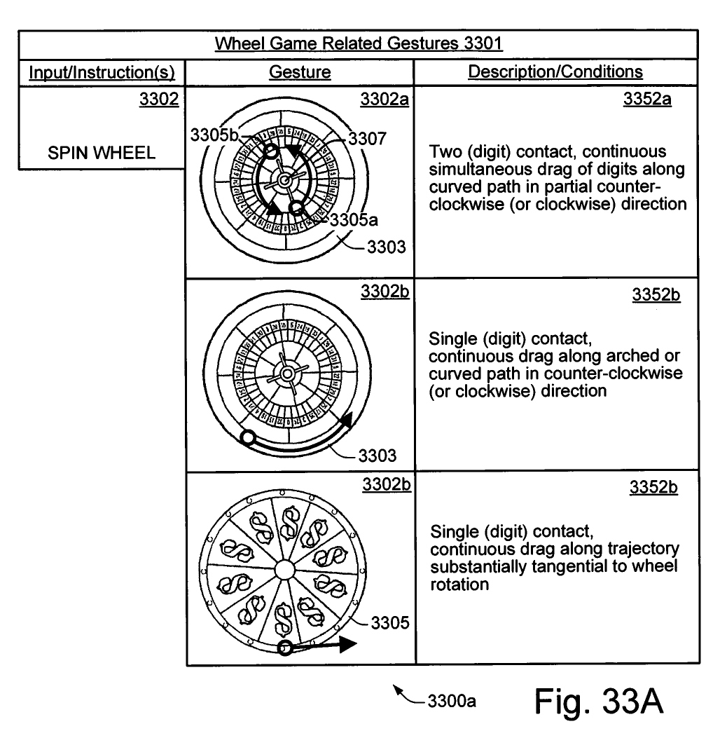

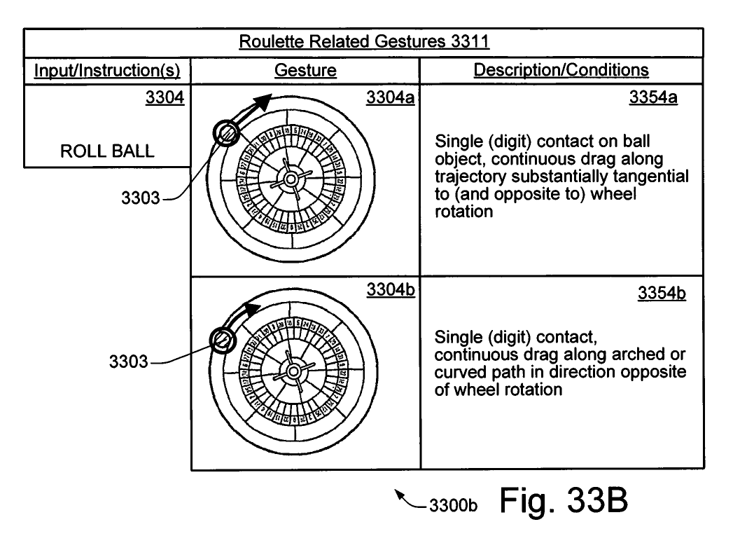

FIG. 33A illustrates various example embodiments of different types of wheel game related gesture-function mapping information which may be utilized at one or more intelligent multi-player electronic gaming systems described herein.

As illustrated in the example embodiment of FIG. 33A, an example plurality of different (e.g., alternative) gestures are graphically represented and described which, for example, may be mapped to function(s) (e.g., user input/instructions) corresponding to: SPIN WHEEL. In at least one embodiment, the user may perform one or more of the SPIN WHEEL gesture(s) at, on, or over a portion of a graphical image or object representing a virtual wheel such as, for example, a roulette wheel, a bonus wheel (e.g., Wheel of Fortune bonus wheel), a carousel, etc.

For example, in at least one embodiment, a user may convey the input/instruction(s) SPIN WHEEL for example, by performing gesture 3302a at a multipoint or multi-touch input interface of an intelligent multi-player electronic gaming system. As illustrated in the example embodiment of FIG. 33A, gesture 3302a may be defined to include at least the following gesture-specific characteristics: two concurrent contact regions (e.g., 3305a, 3305b) defining a central region therebetween (e.g., 3307), continuous, concurrent partial-rotate counter-clockwise (or clockwise) movements of each contact region about the central region. In at least one embodiment, a partial-rotate counter-clockwise (or clockwise) movement of a contact region (about the central region) may be characterized by an arched or curved movement of the contact region (e.g., along an elliptical, circular, and/or substantially circular path) around or about the central region in a counter-clockwise (or clockwise) direction (e.g., relative to the user's perspective).

Gesture 3302b represents an alternative example gesture which, in at least some embodiments, may be mapped to function(s) (e.g., user input/instructions) corresponding to: SPIN WHEEL. For example, in at least one embodiment, a user may convey the input/instruction(s) SPIN WHEEL for example, by performing gesture 3302b at a multipoint or multi-touch input interface of an intelligent multi-player electronic gaming system. As illustrated in the example embodiment of FIG. 33A, gesture 3302b may be defined to include at least the following gesture-specific characteristics: one contact region (e.g., at, on, or over a region of a virtual wheel represented by graphical image of the wheel), continuous arched or curved movement(s) in a counter-clockwise (or clockwise) direction.

Gesture 3302c represents an alternative example gesture which, in at least some embodiments, may be mapped to function(s) (e.g., user input/instructions) corresponding to: SPIN WHEEL. For example, in at least one embodiment, a user may convey the input/instruction(s) SPIN WHEEL for example, by performing gesture 3302c at a multipoint or multi-touch input interface of an intelligent multi-player electronic gaming system. As illustrated in the example embodiment of FIG. 33A, gesture 3302c may be defined to include at least the following gesture-specific characteristics: one contact region (e.g., at, on, or over a region of a virtual wheel represented by graphical image of the wheel), continuous movement(s) along trajectory substantially tangential to the wheel's rotation.

In at least one embodiment, the initial rotational velocity of the virtual wheel may be determined, at least in part, based upon one or more of the characteristics (e.g., displacement, acceleration, velocity, trajectory, etc.) associated with the user's gesture(s). Additionally, in at least one embodiment, the relative location of the initial point(s) of contact at, on, or over the virtual wheel may also affect the wheel's initial rotational velocity resulting from the user's SPIN WHEEL gesture. For example, a gesture involving the spinning of a virtual wheel which is performed at a contact point near the wheel's center may result in a faster rotation of the virtual wheel as compared to the same gesture being performed at a contact point near the wheel's outer perimeter. Additionally, in at least one embodiment, while the movement(s) of the SPIN WHEEL gesture are being performed by the user, the intelligent multi-player electronic gaming system may be configured or designed to display (e.g., in real-time) animated images of the wheel moving/rotating in accordance with the user's various movements.

FIG. 33B illustrates various example embodiments of different types of roulette game related gesture-function mapping information which may be utilized at one or more intelligent multi-player electronic gaming systems described herein.

As illustrated in the example embodiment of FIG. 33B, an example plurality of different (e.g., alternative) gestures are graphically represented and described which, for example, may be mapped to function(s) (e.g., user input/instructions) corresponding to: ROLL BALL. In at least one embodiment, the user may perform one or more of the ROLL BALL gesture(s) at, on, or over a portion of a graphical image or object representing a virtual wheel such as, for example, a roulette wheel, a bonus wheel (e.g., Wheel of Fortune bonus wheel), a carousel, etc.

For example, gesture 3304a represents an example gesture which, in at least some embodiments, may be mapped to function(s) (e.g., user input/instructions) corresponding to: ROLL BALL. For example, in at least one embodiment, a user may convey the input/instruction(s) ROLL BALL for example, by performing gesture 3304a at a multipoint or multi-touch input interface of an intelligent multi-player electronic gaming system. As illustrated in the example embodiment of FIG. 33B, gesture 3304a may be defined to include at least the following gesture-specific characteristics: one contact region (e.g., at, on, or over an image of a ball object 3303), continuous movement(s) along trajectory substantially tangential to (e.g., and in some embodiments, opposite to) the wheel's rotation.

Gesture 3304b represents an alternative example gesture which, in at least some embodiments, may be mapped to function(s) (e.g., user input/instructions) corresponding to: ROLL BALL. For example, in at least one embodiment, a user may convey the input/instruction(s) ROLL BALL for example, by performing gesture 3304b at a multipoint or multi-touch input interface of an intelligent multi-player electronic gaming system. As illustrated in the example embodiment of FIG. 33B, gesture 3304b may be defined to include at least the following gesture-specific characteristics: one contact region (e.g., at, on, or over an image of a ball object 3303), continuous arched or curved movement(s). In some embodiments, the continuous arched or curved movement(s) should preferably be in a direction opposite to the wheel's rotation.

In at least one embodiment, the initial velocity of the virtual ball may be determined, at least in part, based upon one or more of the characteristics (e.g., displacement, acceleration, velocity, trajectory, etc.) associated with the user's ROLL BALL gesture(s).

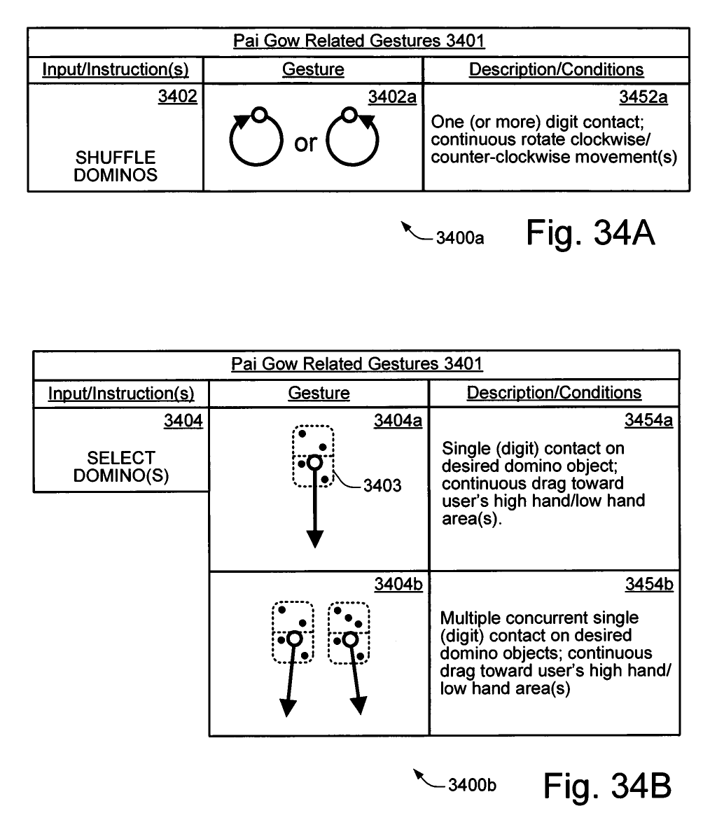

FIGS. 34A-B illustrate various example embodiments of different types of pai gow game related gesture-function mapping information which may be utilized at one or more intelligent multi-player electronic gaming systems described herein.

As illustrated in the example embodiment of FIG. 34A, an example gesture graphically represented (e.g., at 3402a) and described which, for example, may be mapped to function(s) (e.g., user input/instructions) corresponding to: SHUFFLE DOMINOS. For example, in at least one embodiment, a user may convey the input/instruction(s) SHUFFLE DOMINOS for example, by performing gesture 3402a at a multipoint or multi-touch input interface of an intelligent multi-player electronic gaming system. As illustrated in the example embodiment of FIG. 34A, gesture 3402a may be defined to include at least the following gesture-specific characteristics: one (or more) contact region(s), continuous “rotate clockwise” movement(s) and/or “rotate counter-clockwise” movement. For example, in at least one embodiment, a user may initiate a shuffling of a virtual pile of dominoes, for example, by placing one or more of the user's digits, palms, hands, etc. on or over the image representing the virtual pile of dominoes, and continuously performing circular movements (e.g., of the digits, palms, hands, etc.) in clockwise and/or counter-clockwise direction(s).

In at least one embodiment, while the movements of the SHUFFLE DOMINOS gesture are being performed by the user, the intelligent multi-player electronic gaming system may be configured or designed to display (e.g., in real-time) animated images of the virtual dominos moving in accordance with the user's various movements.

It will be appreciated that, in other embodiments other types of gestures may also be performed by a user which may be mapped to function(s) (e.g., user input/instructions) corresponding to: SHUFFLE DOMINOS. For example, in at least one embodiment (not shown) a user may perform a gesture which may be characterized by an initial contact of one or more contact regions (e.g., using one or more of the user's digits, palms, hands, etc.) at or over the virtual pile of dominoes, followed by continuous and substantially random movements of the various contact regions over the image region representing the virtual pile of dominoes. In at least one embodiment, the intelligent multi-player electronic gaming system may be operable to interpret and map such as gesture to the SHUFFLE DOMINOS function.

As illustrated in the example embodiment of FIG. 34B, an example plurality of different (e.g., alternative) gestures are graphically represented and described which, for example, may be mapped to function(s) (e.g., user input/instructions) corresponding to: SELECT DOMINO(S). In at least one embodiment, the user may perform one or more of the SELECT DOMINO(S) gesture(s) at, on, or over one or more graphical image(s) or object(s) representing one or more virtual dominos.

For example, gesture 3404a represents an example gesture which, in at least some embodiments, may be mapped to function(s) (e.g., user input/instructions) corresponding to: SELECT DOMINO(S). For example, in at least one embodiment, a user may convey the input/instruction(s) SELECT DOMINO(S) for example, by performing gesture 3404a at a multipoint or multi-touch input interface of an intelligent multi-player electronic gaming system. As illustrated in the example embodiment of FIG. 34B, gesture 3404a may be defined to include at least the following gesture-specific characteristics: one contact region (e.g., at, on, or over an image or object (e.g., 3403) representing a virtual domino), continuous drag movement toward user's high hand/low hand area(s). In at least one embodiment, the domino selected by the user may initially be located in a common game play region of the multi-touch, multi-player interactive display.

Gesture 3404b represents an alternative example gesture which, in at least some embodiments, may be mapped to function(s) (e.g., user input/instructions) corresponding to: SELECT DOMINO(S). For example, in at least one embodiment, a user may convey the input/instruction(s) SELECT DOMINO(S) for example, by performing gesture 3404b at a multipoint or multi-touch input interface of an intelligent multi-player electronic gaming system. As illustrated in the example embodiment of FIG. 34B, gesture 3404b may be defined to include at least the following gesture-specific characteristics: multiple concurrent contact region(s) (e.g., at, on, or over two or more images or objects representing virtual dominos), continuous drag movements of both contact regions toward user's high hand/low hand area(s). In at least one embodiment, each contact region may initially be placed on or over a respective domino located in a common game play region of the multi-touch, multi-player interactive display. Thus, for example, in one embodiment, this gesture allows a user to select (and drag) multiple dominos using a single gesture.

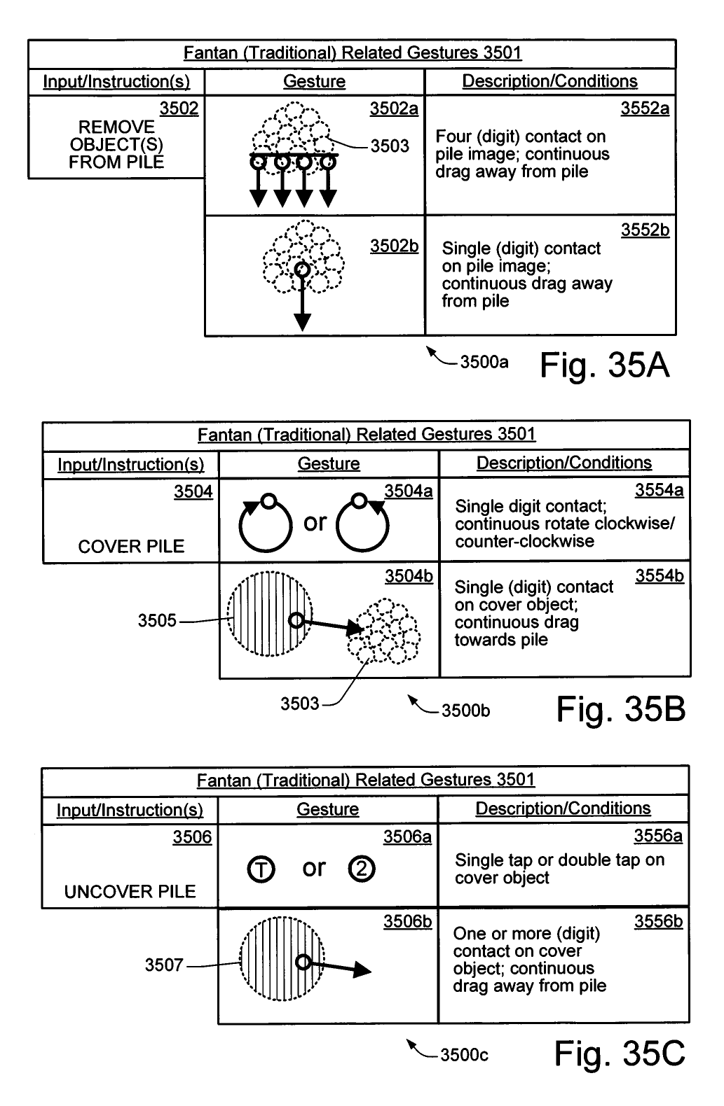

FIGS. 35A-C illustrate various example embodiments of different types of traditional fantan game related gesture-function mapping information which may be utilized at one or more intelligent multi-player electronic gaming systems described herein.

As illustrated in the example embodiment of FIG. 35A, an example plurality of different (e.g., alternative) gestures are graphically represented and described which, for example, may be mapped to function(s) (e.g., user input/instructions) corresponding to: REMOVE OBJECT(S) FROM PILE. In at least one embodiment, the user may perform one or more of the REMOVE OBJECT(S) FROM PILE gesture(s) at, on, or over one or more graphical image(s) or object(s) representing one or more piles of Fantan-related beans, coins, tokens, and/or other objects which may be used for playing traditional Fantan.

For example, gesture 3502a represents an example gesture which, in at least some embodiments, may be mapped to function(s) (e.g., user input/instructions) corresponding to: REMOVE OBJECT(S) FROM PILE. For example, in at least one embodiment, a user may convey the input/instruction(s) REMOVE OBJECT(S) FROM PILE for example, by performing gesture 3502a at a multipoint or multi-touch input interface of an intelligent multi-player electronic gaming system. As illustrated in the example embodiment of FIG. 35A, gesture 3502a may be defined to include at least the following gesture-specific characteristics: four contact region (e.g., at, on, or over an image (e.g., 3503) representing a virtual pile of objects), continuous drag movement away from pile. In at least one embodiment, the virtual pile image may be located in a common game play region of the multi-touch, multi-player interactive display.

Gesture 3502b represents an alternative example gesture which, in at least some embodiments, may be performed by a user to convey the input/instruction(s) REMOVE OBJECT(S) FROM PILE. For example, in at least one embodiment, gesture 3502b may be defined to include at least the following gesture-specific characteristics: single contact region (e.g., at, on, or over an image representing a virtual pile of objects), continuous drag movement away from virtual pile. In other embodiments (not illustrated), gesture 3502b may be performed using two, or three contact regions.

In at least one embodiment, each time a REMOVE OBJECT(S) FROM PILE gesture is performed by a user (e.g., by a casino attendant), a predetermined quantity of virtual objects may be removed from the virtual pile. For example, in one embodiment where the virtual object pile includes a plurality of images representing individual tokens, a predetermined quantity of 4 tokens may be removed from the virtual object pile each time a REMOVE OBJECT(S) FROM PILE gesture is performed by the user. In at least one embodiment, the intelligent multi-player electronic gaming system may be configured or designed to display (e.g., in real-time) animated images of the virtual objects being removed from and/or dragged away from the virtual pile (e.g., as the user performs the “drag away from pile” movement(s)). Additionally, in at least one embodiment, as the user performs one or more REMOVE OBJECT(S) FROM PILE gesture(s), the intelligent multi-player electronic gaming system may be configured or designed to update (e.g., in real-time) the displayed quantity of remaining objects in the virtual pile in accordance with the user's actions/gestures.

As illustrated in the example embodiment of FIG. 35B, an example plurality of different (e.g., alternative) gestures are graphically represented and described which, for example, may be mapped to function(s) (e.g., user input/instructions) corresponding to: COVER PILE. For example, gesture 3504a represents different example gestures which, in at least some embodiments, may be mapped to function(s) (e.g., user input/instructions) corresponding to: COVER PILE. In at least one embodiment, a user may convey the input/instruction(s) COVER PILE for example, by performing, for example, either of the gestures represented at 3504a at a multipoint or multi-touch input interface of an intelligent multi-player electronic gaming system. As illustrated in the example embodiment of FIG. 35B, gesture 3504a may be defined to include at least the following gesture-specific characteristics: one contact region, continuous “rotate clockwise” movement; or one contact region, continuous “rotate counter-clockwise” movement. For example, in one embodiment, a user may cause the virtual pile to be covered by performing a COVER PILE gesture in which the user drags his finger in a clockwise (or counter-clockwise) movement around the image representing the virtual pile.

Gesture 3504b represents an alternative example gesture which, in at least some embodiments, may be performed by a user to convey the input/instruction(s) COVER PILE. For example, in at least one embodiment, gesture 3504b may be defined to include at least the following gesture-specific characteristics: single contact region (e.g., at, on, or over an image or virtual object (e.g., 3505) representing a cover pile of objects), continuous drag movement toward virtual pile (e.g., 3503). In other embodiments (not illustrated), gesture 3504b may be performed using multiple different contact regions.

In at least one embodiment, the intelligent multi-player electronic gaming system may be configured or designed to display (e.g., in real-time) animated images of the virtual cover moving toward and/or covering the virtual pile (and/or portions thereof), for example, as the user performs gesture 3504b.

As illustrated in the example embodiment of FIG. 35C, an example plurality of different (e.g., alternative) gestures are graphically represented and described which, for example, may be mapped to function(s) (e.g., user input/instructions) corresponding to: UNCOVER PILE. For example, gesture 3506a represents different example gestures which, in at least some embodiments, may be mapped to function(s) (e.g., user input/instructions) corresponding to: UNCOVER PILE. In at least one embodiment, a user may convey the input/instruction(s) UNCOVER PILE for example, by performing, for example, either of the gestures represented at 3506a at a multipoint or multi-touch input interface of an intelligent multi-player electronic gaming system. As illustrated in the example embodiment of FIG. 35C, gesture 3506a may be defined to include at least the following gesture-specific characteristics: double tap, one contact region; or single tap, one contact region. For example, in one embodiment, a user may cause the virtual pile to be uncovered by performing an UNCOVER PILE gesture in which the user either taps or double taps his finger on or above the image representing the covered virtual pile.

Gesture 3506b represents an alternative example gesture which, in at least some embodiments, may be performed by a user to convey the input/instruction(s) UNCOVER PILE. For example, in at least one embodiment, gesture 3506b may be defined to include at least the following gesture-specific characteristics: single contact region (e.g., at, on, or over an image (e.g., 3507) representing a covered pile of objects), continuous drag movement in any direction (or, alternatively, in one or more specified directions). In other embodiments (not illustrated), gesture 3506b may be performed using multiple different contact regions.

In at least one embodiment, the intelligent multi-player electronic gaming system may be configured or designed to display (e.g., in real-time) animated images of the virtual cover moving away from and/or uncovering the virtual pile (and/or portions thereof), for example, as the user performs gesture 3506b.

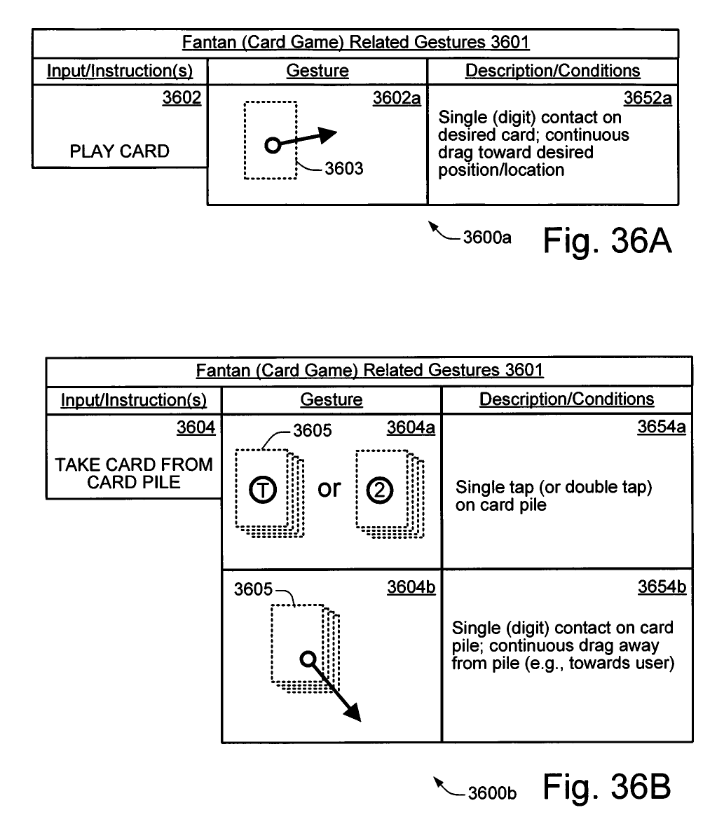

FIGS. 36A-B illustrate various example embodiments of different types of card-based fantan game related gesture-function mapping information which may be utilized at one or more intelligent multi-player electronic gaming systems described herein.

As illustrated in the example embodiment of FIG. 36A, gesture 3602a represents an example gesture which, in at least some embodiments, may be mapped to function(s) (e.g., user input/instructions) corresponding to: PLAY CARD. In at least one embodiment, a user may convey the input/instruction(s) PLAY CARD for example, by performing, for example, either of the gestures represented at 3602a at a multipoint or multi-touch input interface of an intelligent multi-player electronic gaming system. As illustrated in the example embodiment of FIG. 36A, gesture 3602a may be defined to include at least the following gesture-specific characteristics: one contact region (e.g., at, on, or over an image (e.g., 3603) representing a virtual card (e.g., from the user's hand)), continuous drag movement towards card play region (or, alternatively, in one or more specified directions). In at least one embodiment, the card selected by the user may initially be located in one of the user's personal region(s) (such as, for example, region 554a, FIG. 5B) of the multi-touch, multi-player interactive display, and may be dragged by the user to a common game play region (such as, for example, region 560, FIG. 5B) of the multi-touch, multi-player interactive display. In other embodiments (not illustrated), gesture 3602a may be performed using multiple different contact regions.

In at least one embodiment, the intelligent multi-player electronic gaming system may be configured or designed to display (e.g., in real-time) animated images of the virtual card being moved in accordance with the user's actions/gestures.

As illustrated in the example embodiment of FIG. 36B, an example plurality of different (e.g., alternative) gestures are graphically represented and described which, for example, may be mapped to function(s) (e.g., user input/instructions) corresponding to: TAKE CARD FROM PILE. For example, gesture 3604a represents different example gestures which, in at least some embodiments, may be mapped to function(s) (e.g., user input/instructions) corresponding to: TAKE CARD FROM PILE. In at least one embodiment, a user may convey the input/instruction(s) TAKE CARD FROM PILE for example, by performing, for example, either of the gestures represented at 3604a at a multipoint or multi-touch input interface of an intelligent multi-player electronic gaming system. As illustrated in the example embodiment of FIG. 36B, gesture 3604a may be defined to include at least the following gesture-specific characteristics: double tap, one contact region; or single tap, one contact region. In at least one embodiment, the contact region may be located at, on, or over an image (e.g., 3605) representing the virtual pile. Additionally, in at least one embodiment, the virtual pile image may be located in a common game play region of the multi-touch, multi-player interactive display.

Gesture 3606b represents an alternative example gesture which, in at least some embodiments, may be performed by a user to convey the input/instruction(s) TAKE CARD FROM PILE. For example, in at least one embodiment, gesture 3606b may be defined to include at least the following gesture-specific characteristics: single contact region (e.g., at, on, or over an image (e.g., 3605) representing the virtual pile), continuous drag movement away from virtual pile (or, alternatively, toward one or the user's personal region(s)). In other embodiments (not illustrated), gesture 3604b may be performed using multiple different contact regions. In at least one embodiment, the intelligent multi-player electronic gaming system may be configured or designed to display (e.g., in real-time) animated images of the selected virtual card being moved in accordance with the user's actions/gestures. Additionally, in at least one embodiment, as each user performs one or more TAKE CARD FROM PILE gesture(s), the intelligent multi-player electronic gaming system may be configured or designed to update (e.g., in real-time) the displayed quantity of remaining cards in the virtual pile (e.g., based on the number of virtual cards which have been removed from the virtual pile by the various user(s)).

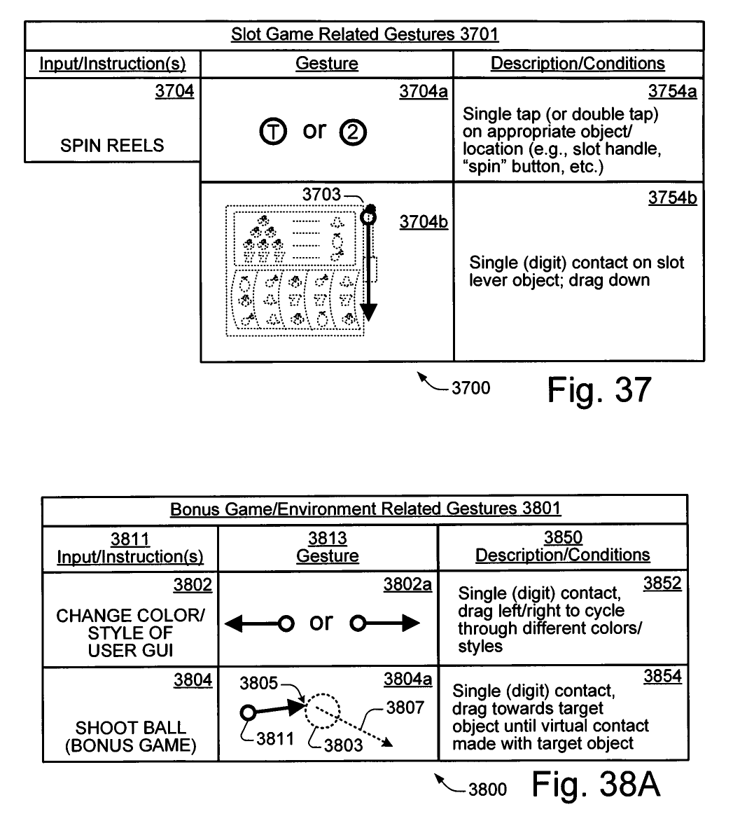

FIG. 37 illustrates various example embodiments of different types of slot game related gesture-function mapping information which may be utilized at one or more intelligent multi-player electronic gaming systems described herein.

As illustrated in the example embodiment of FIG. 37, an example plurality of different (e.g., alternative) gestures are graphically represented and described which, for example, may be mapped to function(s) (e.g., user input/instructions) corresponding to: SPIN REELS. For example, gesture 3704a represents different example gestures which, in at least some embodiments, may be mapped to function(s) (e.g., user input/instructions) corresponding to: SPIN REELS. In at least one embodiment, a user may convey the input/instruction(s) SPIN REELS for example, by performing, for example, either of the gestures represented at 3704a at a multipoint or multi-touch input interface of an intelligent multi-player electronic gaming system. As illustrated in the example embodiment of FIG. 37, gesture 3704a may be defined to include at least the following gesture-specific characteristics: double tap, one contact region; or single tap, one contact region. In at least one embodiment, the contact region may be located at, on, or over a portion of an image representing a virtual slot machine. For example, in one embodiment, the user may tap (or double tap) on a virtual “spin” button located at the virtual slot machine. In another embodiment, the user may tap (or double tap) on a virtual “handle” portion of the virtual slot machine. In other embodiments (not illustrated), gesture 3704a may be performed using multiple different contact regions.

Gesture 3704b represents an alternative example gesture which, in at least some embodiments, may be performed by a user to convey the input/instruction(s) SPIN REELS. For example, in at least one embodiment, gesture 3704b may be defined to include at least the following gesture-specific characteristics: single contact region (e.g., at, on, or over an image (e.g., 3703) representing the handle of the virtual slot machine), continuous drag down movement). In other embodiments (not illustrated), gesture 3704b may be performed using multiple different contact regions.

In at least one embodiment, the intelligent multi-player electronic gaming system may be configured or designed to display (e.g., in real-time) animated images of the virtual handle being moved (and/or animated images of the virtual reels spinning) in accordance with the user's actions/gestures.

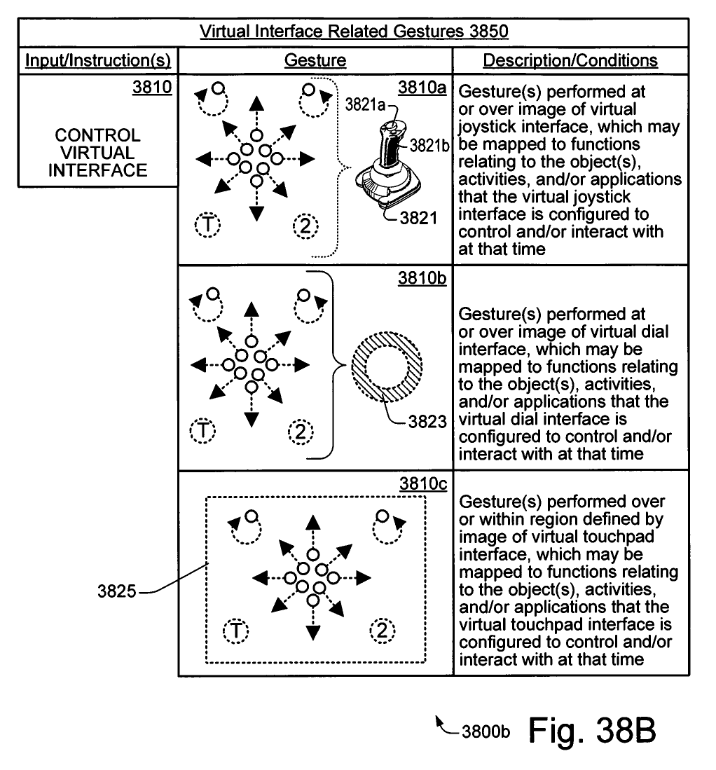

FIG. 38A illustrates various example embodiments of different types of environmental and/or bonus game related gesture-function mapping information which may be utilized at one or more intelligent multi-player electronic gaming systems described herein.

As illustrated in the example embodiment of FIG. 38A, an example plurality of different gestures are graphically represented and described which, for example, may be mapped to various different function(s) (e.g., user input/instructions). For example, the gestures represented at 3802a relate to different example gestures which, in at least some embodiments, may be mapped to function(s) (e.g., user input/instructions) corresponding to: CHANGE COLOR/STYLE OF USER GUI. For example, in at least one embodiment, a user's graphical user interface (GUI) may correspond to one or more of the user's personal regions of the multi-touch, multi-player interactive display. In at least one embodiment, a user may convey the input/instruction(s) CHANGE COLOR/STYLE OF USER GUI for example, by performing, for example, either of the gestures represented at 3802a at a multipoint or multi-touch input interface of an intelligent multi-player electronic gaming system. As illustrated in the example embodiment of FIG. 38A, gesture 3802a may be defined to include at least the following gesture-specific characteristics: one contact region, drag right movement, or one contact region, drag left movement. In at least one embodiment, when a user performs one of the CHANGE COLOR/STYLE OF USER GUI gestures at, over, or within one of the user's personal regions of the display, the intelligent multi-player electronic gaming system may respond by automatically and dynamically changing the color scheme, format, and/or style of the GUI used to represent one or more of the user's personal region(s).

Gesture 3804a represents an example gesture which, in at least some embodiments, may be performed by a user to convey the input/instruction(s) SHOOT BALL. In at least one embodiment, the SHOOT BALL gesture 3804a may be implemented during game play, such as, for example, during one or more bonus games. In at least one embodiment, gesture 3804b may be defined to include at least the following gesture-specific characteristics: one contact region, continuous drag towards target virtual object (e.g., 3803) until virtual contact made with target virtual object (e.g., 3803). In at least one embodiment, implementation of this gesture upon a particular target virtual object may have an effect on the target virtual object which is analogous to that of a ball being struck by a billiards cue stick. For example, as illustrated in the example embodiment of FIG. 38A, a user may initiate a SHOOT BALL gesture as shown at 3811, which makes virtual contact with virtual ball object 3803 at virtual contact point 3805. In response to this virtual contact event, the virtual ball object 3803 may begin moving in a direction indicated by directional arrow 3807 (which, for example, may be similar to the direction a billiards ball may move if the SHOOT BALL gesture 3811a were a billiards cue stick.

FIG. 38B illustrates various example embodiments of different types of virtual interface related gesture-function mapping information which may be utilized at one or more intelligent multi-player electronic gaming systems described herein.

According to various embodiments, the multi-touch, multi-player interactive display surface may be configured to display one or more graphical objects representing different types of virtual control interfaces which may be dynamically configured to control and/or interact with various object(s), activities, and/or actions at the intelligent multi-player electronic gaming system.

For example, in one embodiment, the intelligent multi-player electronic gaming system may display a graphical image of a virtual joystick interface (e.g., 3821) on a region of the display surface located in front of a particular user. In at least one embodiment, the user may perform gestures at, on, around, within, and/or over various regions of the display virtual joystick interface in order to perform various different types of activities at the intelligent multi-player electronic gaming system such as, for example, one or more of the following (or combinations thereof): wagering activities, game play activities, bonus play activities, etc.

Three different example embodiments of virtual interfaces are represented in FIG. 38B, namely, virtual joystick interface 3821, virtual dial interface 3823, and virtual touchpad interface 3825. It will be appreciated that other types of virtual interfaces (which, for example, may be represented using various different images of virtual objects) may also be used at one or more intelligent multi-player electronic gaming system embodiments described herein.

According to different embodiments, each type of virtual interface may be configured to have its own set of characteristics which may be different from the characteristics of other virtual interfaces. Accordingly, in at least one embodiment, some types of virtual interfaces may be more appropriate for use with certain types of activities and/or applications than others. For example, a virtual joystick interface may be more appropriate for use in controlling movements of one or more virtual objects displayed at the multi-touch, multi-player interactive display surface, whereas a virtual dial interface may be more appropriate for use in controlling the rotation of one or more virtual bonus wheel objects displayed at the multi-touch, multi-player interactive display surface.

In at least one embodiment, user gesture(s) performed at or over a given virtual interface (and/or specific portions thereof) may be mapped to functions relating to the object(s), activities, and/or applications that the virtual interface is currently configured to control and/or interact with (e.g., as of the time when the gesture(s) were performed).

Thus, for example, in one embodiment, gesture(s) performed by a first user at or over image of virtual joystick interface may be mapped to functions relating to the object(s), activities, and/or actions that the virtual joystick interface is configured to control and/or interact with; gesture(s) performed by a second user at or over image of virtual dial interface may be mapped to functions relating to the object(s), activities, and/or actions that the virtual dial interface is configured to control and/or interact with; and/or gesture(s) performed by a third user over or within region defined by image of virtual touchpad interface may be mapped to functions relating to the object(s), activities, and/or actions that the virtual touchpad interface is configured to control and/or interact with.

As an illustrative example, it may be assumed in one embodiment that the intelligent multi-player electronic gaming system has displayed a graphical image of a virtual joystick interface (e.g., 3821) on a region of the display surface located in front of a first player to be used by the first user to control aspects of the player's wagering activities such as, for example, increasing or decreasing the amount of a wager. In this particular example, gestures which are performed by the player at or over the virtual joystick interface may be mapped to various types of wager-related functions, such as, for example, INCREASE WAGER AMOUNT, DECREASE WAGER AMOUNT, CONFIRM PLACEMENT OF WAGER, CANCEL WAGER, etc. In at least one embodiment, at least a portion of these gesture-function mappings may correspond to one or more of the various different types of gesture function mappings illustrated and described, for example, with respect to FIGS. 25-38.

For example, in one embodiment, the player may perform a single contact region, drag “up” gesture (e.g., similar to gesture 2602a) at the virtual joystick lever portion 3821b of the virtual joystick interface to cause the player's wager amount to be increased. Similarly, the player may perform a single contact region, drag “down” gesture (e.g., similar to gesture 2604a) at the virtual joystick lever portion 3821b of the virtual joystick interface to cause the player's wager amount to be decreased. In at least one embodiment, while the gesture is being performed by the user (e.g., at the virtual joystick lever 3821b), the intelligent multi-player electronic gaming system may be configured or designed to display (e.g., in real-time) animated images of the virtual joystick lever moving in accordance with the user's various movements.

Additionally, in at least one embodiment, the rate of increase/decrease of the wager amount may be controlled by the relative displacement of the virtual joystick lever. For example, in one embodiment, the farther up the player moves or displaces the virtual joystick lever, the more rapid the rate of increase of the players wager amount. Similarly, the farther down the player moves or displaces the virtual joystick lever, the more rabid the rate of decrease of the players wager amount. Further, in at least one embodiment, if the user performs one or more gestures to cause the virtual joystick lever to remain in one position (e.g., and up position or down position) for a given period of time, the player's wager amount may continue to be increased or decreased, as appropriate (e.g., depending upon the relative position of the virtual joystick lever), while the virtual joystick lever is caused to remain in that position.

Examples of some of the different types of gestures which may be performed by a user at, over, in, or on a given virtual interface (and/or specific portions thereof) are illustrated in FIG. 38B. It will be appreciated, however, that other types of gestures (not illustrated) may also be performed. Additionally, it will be appreciated that different types of gestures involving the use of different numbers of contact regions may also be performed.

In at least one embodiment, the intelligent multi-player electronic gaming system may be configured or designed to display (e.g., in real-time) animated images of the movement(s) of the target virtual object in accordance with the user's actions/gestures on or at that virtual object. Further, in at least one embodiment, the initial velocity of the target virtual object may be determined, at least in part, based upon one or more of the characteristics (e.g., displacement, acceleration, velocity, trajectory, etc.) associated with the user's gesture(s).

In other embodiments (not illustrated), various permutations and/or combinations of at least a portion of the gestures described in reference to FIGS. 25-38 may be used to create other specific gesture-function mappings relating to any of the various different types of game related and/or wager related activities which may be conducted at the intelligent multi-player electronic gaming system. In at least one embodiment, one or more functions described herein which have been mapped to one or more gestures involving the use of an “S”-shaped movement may also (or alternatively) be mapped to a respectively similar type of gesture involving the use of a reverse “S”-shaped movement.

It will be appreciated by one having ordinary skill in the art that the various gestures and/or gesture-function mappings described herein have been purposefully selected and/or created to provide various advantages/benefits. For example, various factors and/or considerations were taken into account in selecting and defining at least some of the various gestures and/or gesture-function mappings described herein. Examples of such factors and/or considerations may include, but are not limited to, one or more of the following (or combinations thereof):
Use of contextually intuitive gesture-function mappings relating to specific types of game-related and/or wager-related activities;
Selection of specific gestures which may be easily performed by persons of different ages, genders, and physical abilities;
Selection of gestures which are specifically intended not to hinder speed of play;
Avoidance of gestures which may result in false positives (e.g., false detection of gestures);
Avoidance of gestures which may result in improper gesture recognition/interpretation;
Etc.

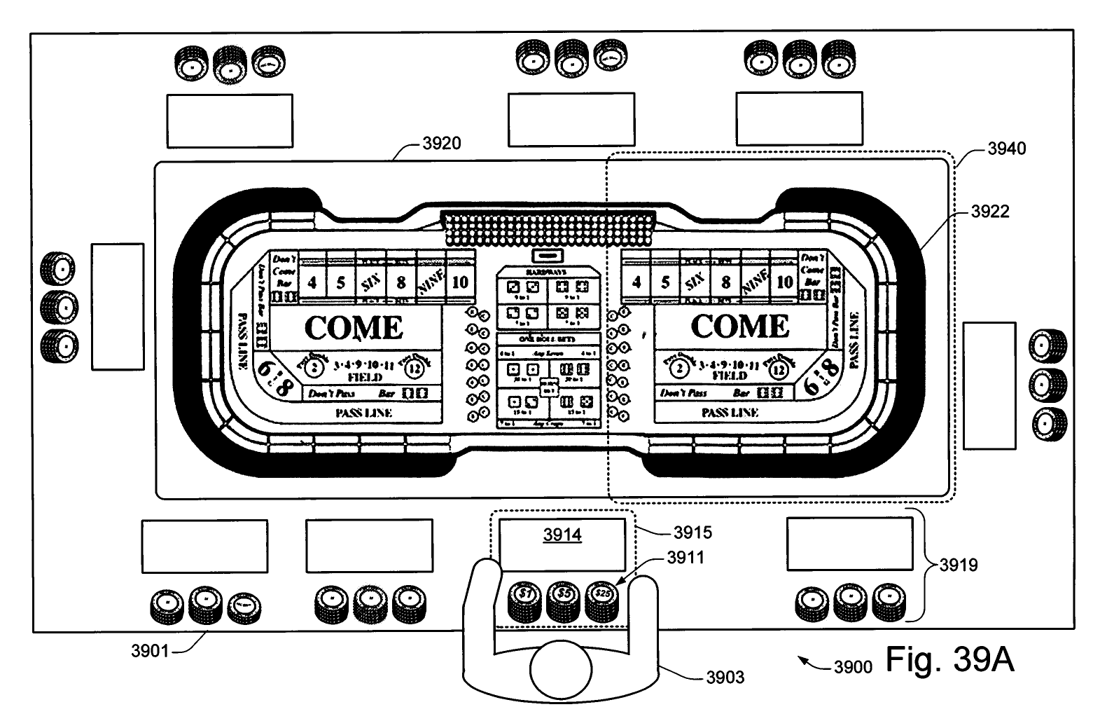

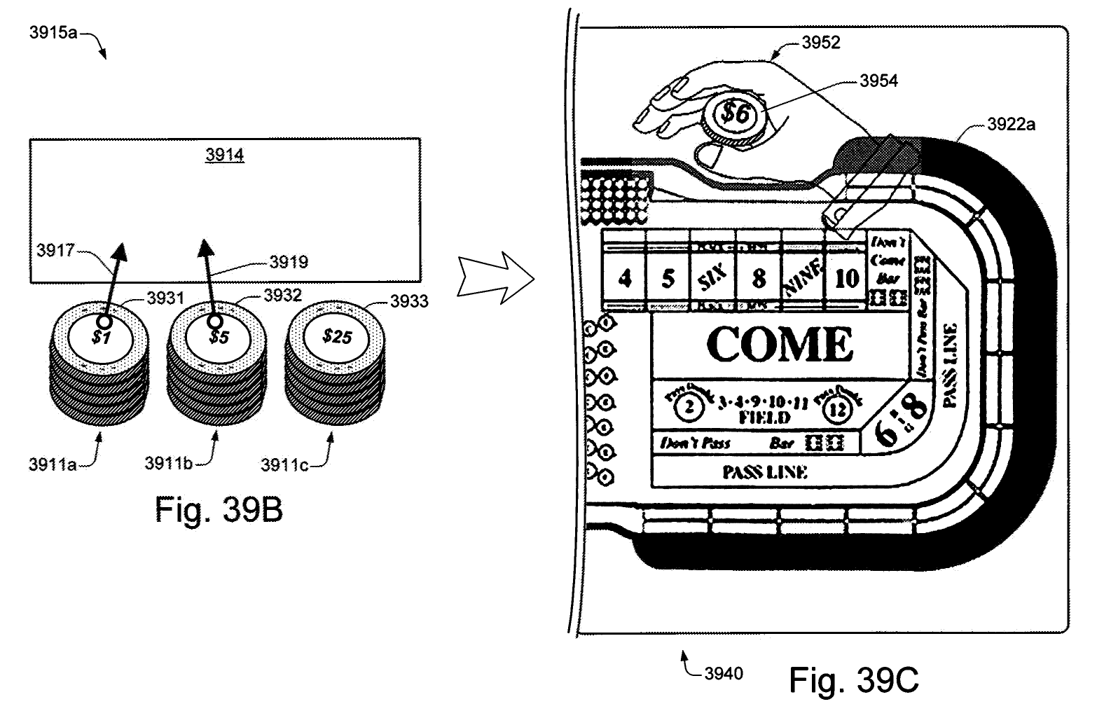

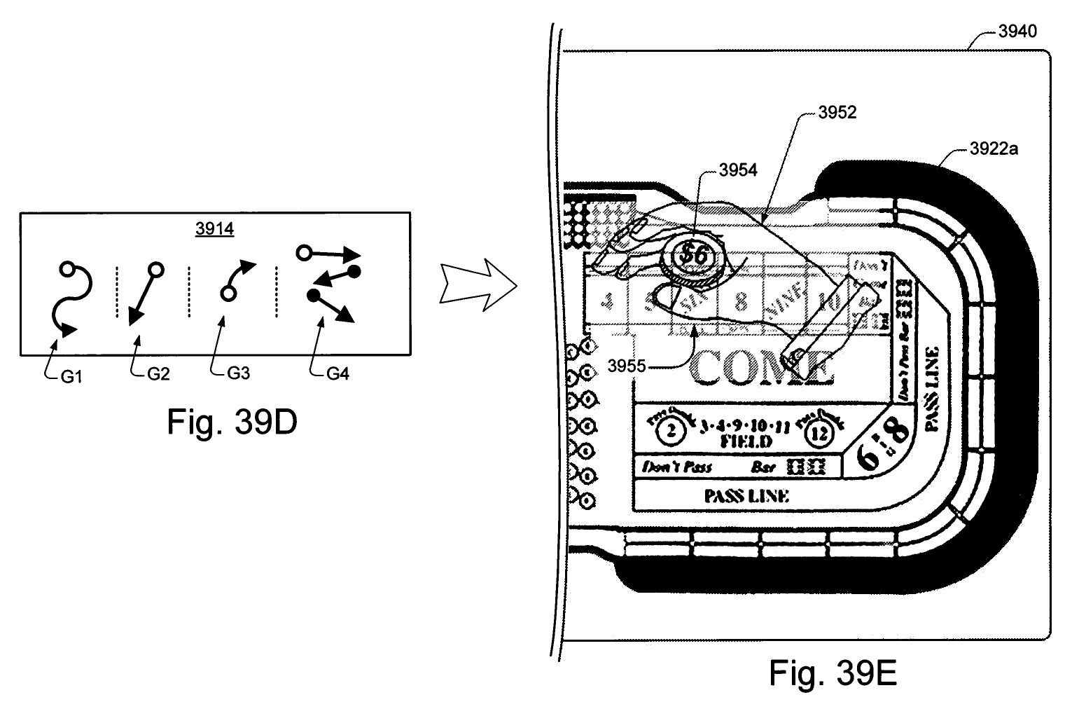

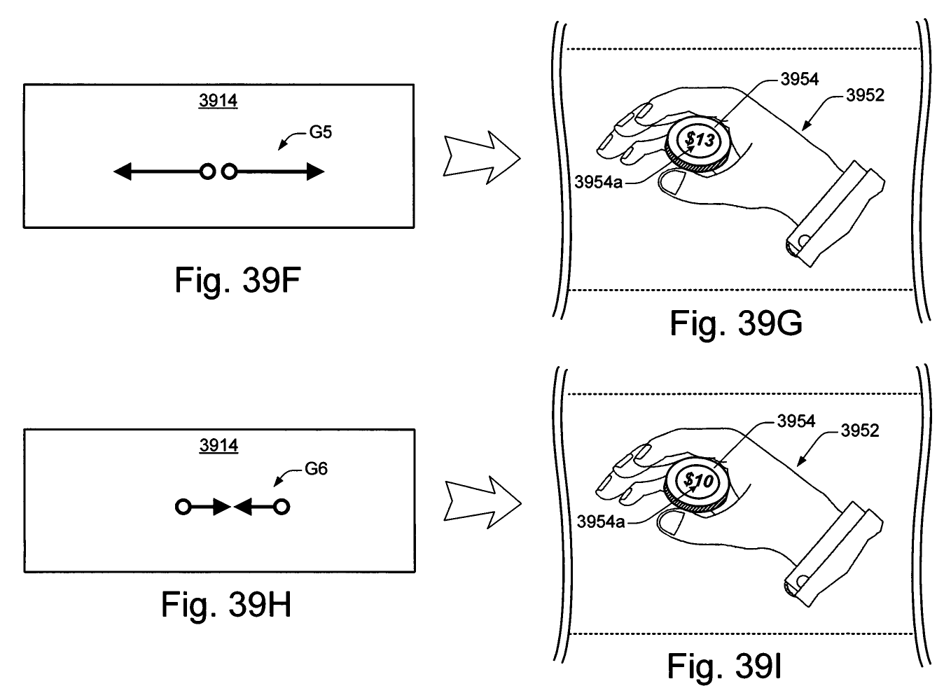

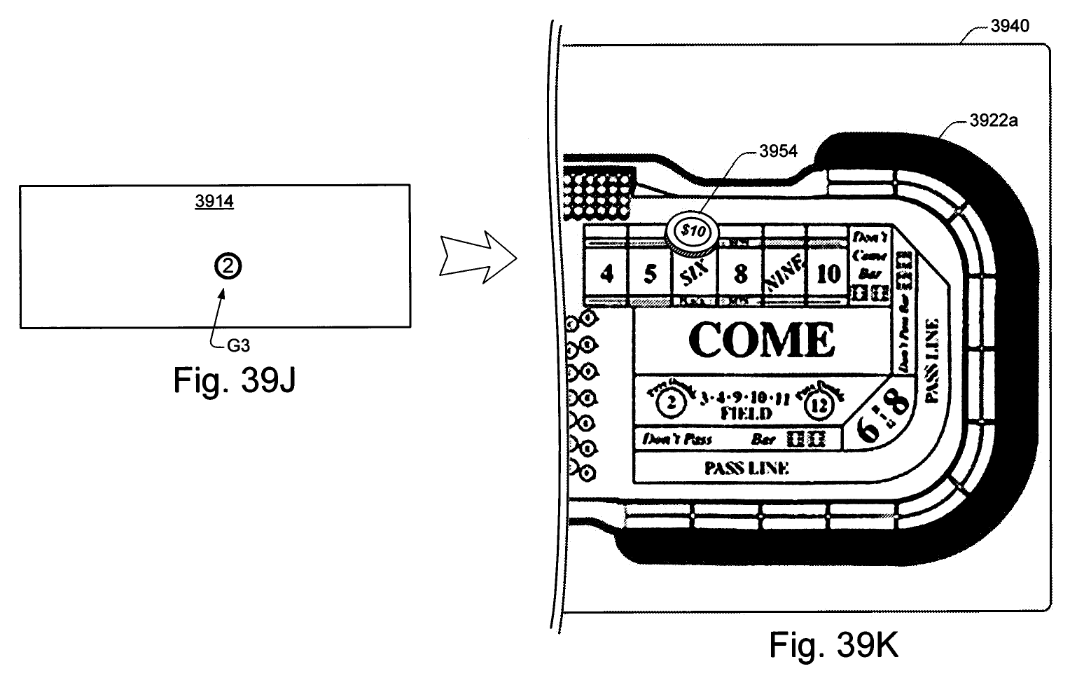

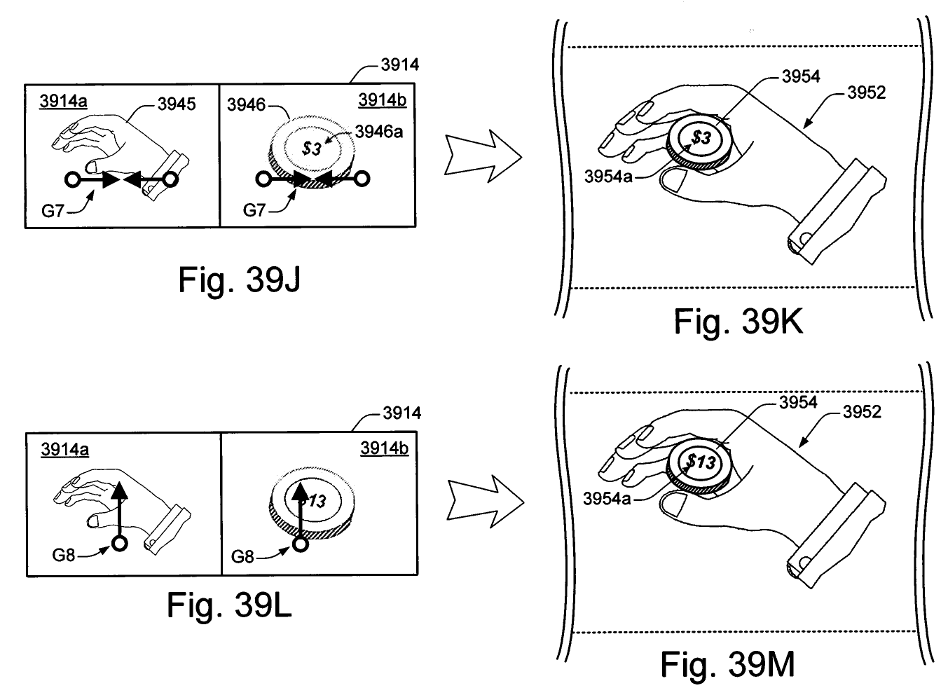

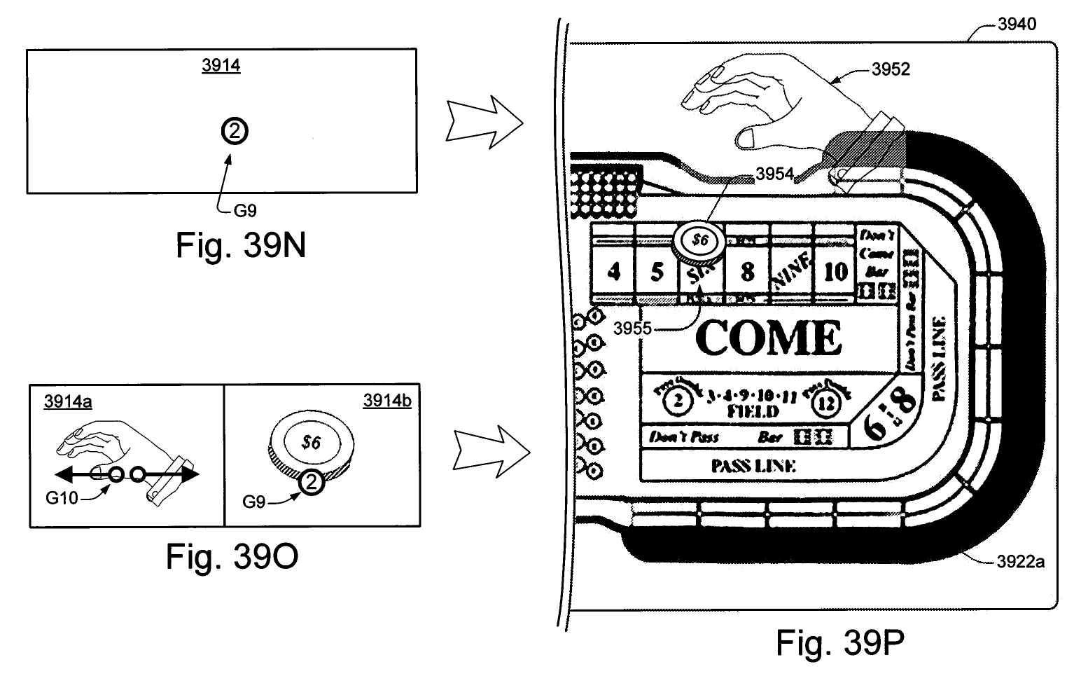

FIGS. 39A-P illustrate various example embodiments of different types of virtualized user interface techniques which may be implemented or utilized at one or more intelligent multi-player electronic gaming systems described herein.

In at least one embodiment, the virtualized user interface techniques illustrated in the example of FIGS. 39A-P enable a user (e.g., player and/or other person) at an intelligent multi-player electronic gaming system to virtually interact with one or more regions of the multi-touch, multi-player interactive display surface which, for example, may not be physically accessible to the user. For example, in at least some situations, the relative size of the multi-touch, multi-player interactive display may lead to situations, for example, where one or more regions of the multi-touch, multi-player interactive display surface are not within physical reach of a player at a given position at the intelligent multi-player electronic gaming system.

In other situations, the gaming establishment may prohibit or discourage player access to specific regions of the multi-touch, multi-player interactive display surface of an intelligent multi-player electronic gaming system. For example, a player participating at a conventional (e.g., felt-top) craps table game is typically unable to physically access all of the different wagering regions displayed on the gaming table surface, and therefore typically relies on the assistance of croupiers to physically place (at least a portion of) the player's wager(s) at different locations of the craps table wagering area, as designated by the player. Similarly, in at least some embodiments, a player participating in a craps game being conducted at a multi-player, electronic wager-based craps gaming table may be unable to physically access all of the different wagering regions displayed on the gaming table surface.

Further, as noted previously, at least some of the various intelligent multi-player electronic gaming system embodiments described herein may be configured to graphically represent various wagers from different players at one or more common areas of a multi-touch, multi-player interactive display which may be physically inaccessible to one or more players at the intelligent multi-player electronic gaming system.

Accordingly, in at least one embodiment, the virtualized user interface techniques illustrated in the example of FIGS. 39A-P provide at least one mechanism for enabling a user (e.g., player and/or other person) at an intelligent multi-player electronic gaming system to virtually interact with one or more regions of a multi-touch, multi-player interactive display surface which are not physically accessible (and/or which are not conveniently physically accessible) to the user. Additionally, in at least one embodiment, at least some of the virtualized user interface techniques described herein may permit multiple different users (e.g., players) to simultaneously and/or concurrently interact with the same multi-player shared-access region of a multi-touch, multi-player interactive display surface in a manner which allows each user to independently perform his or her own activities (e.g., game play, wagering, bonus play, etc.) within the shared-access region without interfering with the activities of other players who are also simultaneously and/or concurrently interacting with the same shared-access region.

FIG. 39A illustrates an example embodiment of an intelligent multi-player electronic gaming system 3900 which, for example, has been configured as a multi-player, electronic wager-based craps gaming table. As illustrated in the example embodiment of FIG. 39A, the multi-player, electronic wager-based craps gaming table includes a multi-touch, multi-player interactive display surface 3901.

As illustrated in the example embodiment of FIG. 39A, gaming system 3900 includes a multi-touch, multi-player interactive electronic display surface 3901. In at least one embodiment, the multi-touch, multi-player interactive display surface may be implemented using an electronic display having a continuous electronic display region (e.g., wherein the boundaries of the continuous electronic display region are approximately represented by the boundary 3901 of the electronic display surface), and one or more multipoint or multi-touch input interface(s) deployed over the entire display surface (or deployed over selected portions of the display surface). In at least one embodiment, a plurality of multipoint or multi-touch input interfaces may be deployed over different regions of the electronic display surface and communicatively coupled together to thereby form a continuous multipoint or multi-touch input interface covering the entirety of the display surface (or a continuous portion thereof)

In at least one embodiment, the multi-touch, multi-player interactive display surface includes a common wagering area 3920 that may be accessible to the various player(s) and/or casino staff at the gaming table system. Displayed within the common wagering area 3920 is an image 3922 representing a virtual craps table surface. For purposes of illustration, it will be assumed that the common wagering area 3920 is not physically accessible to any of the players at the gaming table system.

In at least some embodiments where an intelligent multi-player electronic gaming system includes one (or more) multi-player shared access area(s) of the multi-touch, multi-player interactive display surface that is/are not intended to be physically accessed or physically contacted by users, it may be desirable to omit multipoint or multi-touch input interfaces over such common/shared-access regions of the multi-touch, multi-player interactive display surface.

As illustrated in the example embodiment of FIG. 39A, a first player 3903 is illustrated at a first position along the perimeter of the multi-touch, multi-player interactive display surface 3901. Region 3915 of the display surface represents the player's “personal” area, which, for example, may be allocated for exclusive use by player 3903.

In at least one embodiment, when player 3903 first approaches the intelligent multi-player electronic gaming system and takes his position along the perimeter of the multi-touch, multi-player interactive display surface, the intelligent multi-player electronic gaming system may be configured or designed to automatically detect the presence and relative position of player 3903, and in response, may automatically and/or dynamically display a graphical user interface (GUI) at a region (e.g., 3915) in front of the player for use by the player in performing game play activities, wagering activities, and/or other types of activities relating to one or more different types of services accessible via the gaming table system (such as, for example, a hotel/room services, concierge services, entertainment services, transportation services, side wagering services, restaurant services, bar services, etc.).

In some embodiments, the user may place an object on the multi-touch, multi-player interactive display surface, such as, for example, a transparent card with machine readable markings and/or other types of identifiable objects. In response, the intelligent multi-player electronic gaming system may automatically identify the object (and/or user associated with object), and/or may automatically and/or dynamically display a graphical user interface (GUI) under the region of the object (e.g., if the object is transparent) and/or adjacent to the object, wherein the displayed GUI region is configured for use by the player in performing game play activities, wagering activities, and/or other types of activities relating to one or more different types of services accessible via the gaming table system. While the object remains on the table, the player may continue to use the GUI for performing game play activities, wagering activities, and/or other types of activities relating to one or more different types of services accessible via the gaming table system.

For purposes of illustration, as shown in the example embodiment of FIG. 39A, the GUI of personal player region 3915 is depicted as displaying different stacks of virtual wagering tokens 3911 (e.g., of different denominations), and a region (e.g., 3914) defining a virtual interactive control interface.

In at least one embodiment, additional players may also be positioned at various locations around the perimeter of the multi-touch, multi-player interactive display surface. For purposes of simplification and explanation, the images of these other players is not represented in the example embodiment of FIG. 39A. However, the presence of at least some additional players at the gaming table system is intended to be represented by the presence of additional personal player regions/GUIs (e.g., 3919) positioned at various other locations around the perimeter of the multi-touch, multi-player interactive display surface.

As will be explained in greater detail below, in at least one embodiment, the virtual interactive control interface 3914 may be used by player 3903 to engage in virtual interactions with common wagering area 3902, for example, in order to perform various different types of activities within common wagering area 3920 such as, for example, one or more of the following (or combinations thereof): wagering activities, game play activities, bonus play activities, etc. Moreover, in at least one embodiment, player 3903 is able to independently perform these activities within common wagering area 3920 without the need to make and/or perform any physical contact with any portion of the common wagering area.

FIG. 39B illustrates a portion (3915a) of the personal player region 3915 GUI illustrated in FIG. 39A. More specifically, FIG. 39B shows an example embodiment illustrating how player 3903 (FIG. 39A) may place one or more wagers at the intelligent multi-player electronic gaming system 3900 using at least a portion of the GUI associated with personal player region 3915.

In at least one embodiment, as illustrated, for example, in the example embodiment of FIG. 39B, personal player region portion 3915a may include a GUI which includes, for example, a graphical representation of one or more virtual stacks (e.g., 3911a-c) of virtual wagering tokens (e.g., 3931, 3932, 3933) of different denominations (e.g., $1, $5, $25).

Additionally, as illustrated in the example embodiment of FIG. 39B, the GUI of personal player region portion 3915a also includes a virtual interactive control interface region 3914. In at least one embodiment, the virtual interactive control interface region 3914 may function as a virtual interface or portal for enabling a player or other user to access and interact with the common wagering area 3920 (and/or other shared or common areas of the display surface). According to specific embodiments, the virtual interactive control interface may be configured or designed to interact with various component(s)/device(s)/system(s) of the intelligent multi-player electronic gaming system (and/or other component(s)/device(s)/system(s) of the gaming network) to enable and/or provide one or more of the following types of features and/or functionalities (or combinations thereof):
allow various different types of virtual objects to be placed (e.g., by a user/player) into the virtual interactive control interface region;
detect the presence of a virtual object which has been placed into the virtual interactive control interface region;
identity various different types of virtual objects which have been placed into the virtual interactive control interface region;
identify different characteristics of a virtual object which has been placed into the virtual interactive control interface region;
authenticate and/or validate various different types of virtual objects which have been placed into the virtual interactive control interface region;
determine and/or authenticate an identity of a user/player attempting to access and/or interact with the virtual interactive control interface region;
cause a representation of a virtual object which has been placed into the virtual interactive control interface region to be instantiated at a selected (or designated) multi-player shared access region (e.g., common wagering area 3920) of the multi-touch, multi-player interactive display surface;
recognize various different types of gestures performed (e.g., by a user/player) at, on, in, or over the virtual interactive control interface region;
enable a user/player to initiate and/or complete one or more actions and/or activities in a given multi-player shared access region by performing one or more gestures and/or movements at, on, in, or over the virtual interactive control interface region;
enable a user/player to manipulate virtual object(s) located at a given multi-player shared access region by performing one or more gestures and/or movements at, on, in, or over the virtual interactive control interface region;
enable a user/player to modify one or more characteristics associated with one or more virtual object(s) located at a given multi-player shared access region by performing one or more gestures and/or movements at, on, in, or over the virtual interactive control interface region;
enable a user/player to remove selected virtual object(s) from a given multi-player shared access region by performing one or more gestures and/or movements at, on, in, or over the virtual interactive control interface region;
determine whether a given user/player is authorized to use the virtual interactive control interface region to engage in one or more actions and/or activities in a given multi-player shared access region
determine whether a given user/player is authorized to interact with the virtual interactive control interface region;
determine whether a given user/player is authorized to use the virtual interactive control interface region to interact with one or more virtual object(s) located a given multi-player shared access region
determine whether a given user/player is authorized to use the virtual interactive control interface region to access and/or interact with the virtual interactive control interface region;
determine whether a given user/player is authorized to use the virtual interactive control interface region to access and/or interact with one or more different types of features and/or functionalities accessible via the virtual interactive control interface region;
determine an identity of a particular user/player who is authorized to interact with the virtual interactive control interface region;
determine an identity of a particular user/player who has placed a given virtual object into the virtual interactive control interface region;
determine an identifier relating to (or associated with) a particular user/player who is authorized to interact with the virtual interactive control interface region;
determine an identity of a particular user/player associated with a virtual object which has been placed into the virtual interactive control interface region;
determine an identifier relating to a particular user/player having an ownership association with a virtual object which has been placed into the virtual interactive control interface region;
prevent a given user/player from using the virtual interactive control interface region to access and/or interact with a selected virtual object located a given multi-player shared access region in response to a determination that the user/player is not authorized to use the virtual interactive control interface region to access and/or interact with the virtual interactive control interface region;
ignore gestures, movements, and/or other interactions performed by a given user/player at, on, in or over the virtual interactive control interface region in response to a determination that the user/player is not authorized to interact with the virtual interactive control interface region;
ignore gestures, movements, and/or other interactions performed by a given user/player at, on, in or over the virtual interactive control interface region in response to a determination that the identity of the user/player does not match an identity of the authorized user/player who is authorized to interact with the virtual interactive control interface region;
prevent a virtual object from being placed into the virtual interactive control interface region in response to a determination that the virtual object is not allowed or authorized to be placed into the virtual interactive control interface region;
prevent a virtual object from being placed into the virtual interactive control interface region in response to a determination that the identity of the user/player having an ownership association with a virtual object does not match the identity of the authorized user/player who is authorized to interact with the virtual interactive control interface region.
reject a virtual object placed into the virtual interactive control interface region in response to a determination that the identity of the user/player having an ownership association with a virtual object does not match the identity of the authorized user/player who is authorized to interact with the virtual interactive control interface region.
reject a virtual object placed into the virtual interactive control interface region in response to a determination that the identity of the user/player who placed the virtual object into the virtual interactive control interface region does not match the identity of the authorized user/player who is authorized to interact with the virtual interactive control interface region.
etc.

For example, in at least one embodiment, a player may perform one or more gestures at, on, or over the multi-touch, multi-player interactive display surface to cause various different types of virtual objects to be moved, dragged, dropped, and/or placed into the player's virtual interactive control interface region 3914. Examples of different types of virtual objects which may be moved, dragged, dropped or otherwise placed in the virtual interactive control interface region may include, but are not limited to, one or more of the following (or combinations thereof):
virtual wagering token(s);
virtual card(s);
virtual dice;
virtual domino(s);
virtual markers;
virtual vouchers;
virtual coupons;
virtual cash;
virtual indicia of credit;
virtual bonus object(s);
etc.

For purposes of illustration and explanation, various aspects of the virtualized user interface techniques illustrated in FIG. 39B are described herein by way of a specific example in which it is assumed (in the example of FIG. 39B), that player 3903 initially wishes to place a wager for $6 at a desired location of the virtual craps table surface displayed within the common wagering area 3920.

In at least one embodiment, player 3903 may place one or more different wagers at selected locations of common wagering area (e.g., 3920) by performing one or more gestures at, on, or over the multi-touch, multi-player interactive display surface to cause one or more different virtual wagering tokens to be moved, dragged, dropped, and/or placed into the player's virtual interactive control interface region 3914. In at least one embodiment, at least a portion of the player's gestures may be performed at, on, in, or over a portion of the player's personal player region 3915.

For example, as illustrated in the example embodiment of FIG. 39B, it is assumed that player 3903 performs a first gesture (e.g., 3917) to cause a first virtual wagering token 3931 (e.g., having an associated token value of $1) to be “dragged and dropped” into virtual interactive control interface region 3914. As illustrated in the example embodiment of FIG. 39B, gesture 3917 may be defined to include at least the following gesture-specific characteristics: one contact region, drag movement into virtual interactive control interface region 3914. In at least one embodiment, this gesture may be interpreted as being characterized by an initial single region of contact on or over the image of virtual wagering token 3931, followed by a continuous contact drag movement into virtual interactive control interface region 3914.

Similarly, as illustrated in the example embodiment of FIG. 39B, it is also assumed that player 3903 performs a first gesture (e.g., 3919) to cause a second virtual wagering token 3932 (e.g., having an associated token value of $5) to be “dragged and dropped” into virtual interactive control interface region 3914. In at least one embodiment, gesture 3919 may be interpreted as being characterized by an initial single region of contact on or over the image of virtual wagering token 3932, followed by a continuous contact drag movement into virtual interactive control interface region 3914.

In at least one embodiment, player 3903 may serially perform each of the gestures 3917 and 3919 (e.g., at different points in time). In some embodiments, player 3903 may concurrently perform both of the gestures 3917 and 3919 at about the same time (e.g., via the use of two fingers, where one finger is placed in contact with the display surface over virtual wagering token 3931 concurrently while the other finger is placed in contact with the display surface over virtual wagering token 3932).

In at least one embodiment, the intelligent multi-player electronic gaming system may be configured or designed to display (e.g., in real-time) animated images of each of the virtual wagering tokens 3917 and 3919 of the target virtual object in accordance with the user's actions/gestures

In other embodiments (not illustrated), other types of gestures involving one or more different contact regions may be used to cause virtual wagering tokens 3917 and 3919 to be moved, dragged, dropped, and/or placed into the virtual interactive control interface region 3914.

In at least one embodiment, the intelligent multi-player electronic gaming system may be operable to automatically detect the presence of the virtual objects which have been placed into the virtual interactive control interface region 3914, and to identify different characteristics associated with each virtual object which has been placed into the virtual interactive control interface region.

Accordingly, in the present example of FIG. 39B, it is assumed that the intelligent multi-player electronic gaming system is operable to automatically detect that player 3903 has placed two virtual wagering tokens into virtual interactive control interface region 3914, and is further operable to identify and/or determine the respective token value (e.g., $1, $5) associated with each token.

In the present example, using this information, the intelligent multi-player electronic gaming system may be operable to interpret the gestures/actions performed by player 3903 as relating to a desire by the player to place at least one $6 wager (e.g., $5+$1=$6) at a desired location of the virtual craps table surface displayed within the common wagering area 3920.

Accordingly, in response to the player's gestures as illustrated in the example of FIG. 39B, the intelligent multi-player electronic gaming system may automatically cause a representation of a $6 virtual wagering token to be instantiated at the common wagering area 3920 of the multi-touch, multi-player interactive display surface. An example of this is illustrated in FIG. 39C.

FIG. 39C illustrates an example embodiment of portion 3940 of the common wagering area 3920 of the multi-touch, multi-player interactive display surface illustrated in FIG. 39A. More specifically, display surface portion 3940 of FIG. 39C represents an example embodiment of content which may be displayed within common wagering area 3920 in response to the player's various gestures (and associated processing and/or interpretation of such gestures by the intelligent multi-player electronic gaming system) which are assumed to have been performed by player 3903 at the player's personal player region 3915/3915a in accordance with the specific example illustrated and described with respect to FIG. 39B.

As illustrated in the example embodiment of FIG. 39C, a representation of a $6 virtual wagering token 3954 may be dynamically and/or automatically instantiated at the common wagering area 3920 in response to the player's gestures performed in the example of FIG. 39B. Additionally, as shown, for example, in the example embodiment of FIG. 39C, a representation of a virtual object manipulator 3952 may also be displayed at the common wagering area 3920 (e.g., in response to the player's gestures performed in the example of FIG. 39B).

In at least one embodiment, the virtual object manipulator 3952 may be configured or designed to function as a “virtual hand” of player 3903 for enabling a player (e.g., 3903) to perform various actions and/or activities at or within the physically inaccessible common wagering area 3920 and/or for enabling the player to interact with (e.g., select, manipulate, modify, move, remove, etc.) various types of virtual objects (e.g., virtual wagering token(s), virtual card(s), etc.) located at or within common wagering area 3920.

In at least one embodiment, each player at the intelligent multi-player electronic gaming system may be provided with a different respective virtual object manipulator (as needed) which, for example, may be configured or designed for exclusive use by that player. For example, the virtual object manipulator 3952 may be configured or designed for exclusive use by player 3903.

In at least one embodiment, the various different virtual object manipulators represented at or within the common wagering area 3920 may each be visually represented (e.g., via the use of colors, shapes, patterns, shading, visual strobing techniques, markings, symbols, graphics, and/or other various types of visual display techniques) in a manner which allows each player to visually distinguish his or her virtual object manipulator from other virtual object manipulators associated with other players at the gaming system.

According to different embodiments, virtual object manipulator 3952 may be used to perform a variety of different types of actions and/or activities at or within the physically inaccessible common wagering area, such as, for example, one or more of the following (or combinations thereof):
select and/or grab one or more virtual objects located at or within common wagering area 3920;
deselect and/or release one or more virtual objects currently being held (or selected) by the virtual object manipulator;
manipulate one or more virtual objects located at or within common wagering area 3920;
remove one or more virtual objects located at or within common wagering area 3920;
modify characteristics associated with one or more virtual objects located at or within common wagering area 3920;
place one or more wagers on behalf of player 3903 at desired positions at or within common wagering area 3920;
modify one or more wagers previously placed by player 3903 (e.g., which may be represented at or within common wagering area 3920);
cancel one or more wagers previously placed by player 3903 (e.g., which may be represented at or within common wagering area 3920);
select and/or draw one or more virtual cards which may be represented at or within common wagering area 3920;
etc.

In at least one embodiment, player 3903 may control the movements and/or actions performed by virtual object manipulator 3952 via use of the virtual interactive control interface region 3914 located with the player's personal player region 3915.

For example, as illustrated in FIGS. 39D and 39E, player 3903 may perform a variety of different types of gestures (e.g., G1, G2, G3, G4, etc.) at, in, or over virtual interactive control interface region 3914 to control the virtual movements, location, and/or actions of the virtual object manipulator 3952. In at least one embodiment, such gestures may include, for example, sequences of gestures, combinations of gestures, multiple concurrent gestures, etc.

In at least one embodiment, the intelligent multi-player electronic gaming system may be configured or designed to display (e.g., in real-time) animated images of the various movements/actions of the virtual object manipulator 3952 in accordance with the corresponding gestures performed by player 3903 at, in, or over virtual interactive control interface region 3914.

For example, as illustrated in the example embodiment of FIGS. 39D and 39E, it is assumed that player 3903 wishes to place a $6 wager at a desired location of the virtual craps table wagering area corresponding to wager region 3955 (which, for example, may correspond to a “place the 6” bet at a traditional craps table).

In at least one embodiment, such a wager may be placed at the intelligent multi-player electronic gaming system 3900 by moving the virtual object manipulator 3952 about the common wagering area 3920 until the $6 virtual wagering token 3954 is substantially positioned over the desired wagering region (e.g., 3955) of the virtual craps table wagering area. For example, as illustrated in the example embodiment of FIG. 39D, player 3903 may perform one or more gestures (e.g., G1, G2, G3, G4, etc.) at virtual interactive control interface region 3914 to move the virtual object manipulator 3952 about the common wagering area 3920 until the $6 virtual wagering token 3954 is substantially positioned over the desired wagering region (e.g., 3955) of the virtual craps table wagering area.

In at least one embodiment, assuming that the virtual wagering token 3954 has been properly positioned over the desired wagering region, the player 3903 may perform one or more additional gestures (e.g., at the virtual interactive control interface region 3914) to confirm placement of the virtual wagering token 3954 at the selected wagering region 3955 of the virtual craps table wagering area.

As illustrated in the example embodiment of FIGS. 39F-I, a player may also perform one or more gestures (e.g., G5, G6, etc.) at virtual interactive control interface region 3914 to dynamically adjust the amount of the wager, which, for example, may be represented by the displayed token value 3954a of the virtual wagering token 3954 displayed in the common wagering area (e.g., 3920).

For example, as illustrated in the example embodiment of FIG. 39F, a player may perform an “expand” gesture (G5) (e.g., using two concurrent contact regions) to dynamically increase the token value 3954a represented at virtual wagering token 3954 (e.g., as shown at FIG. 39G). Thus, for example, as illustrated in the example embodiments of FIGS. 39F-G, player 3903 may dynamically increase the token value (or wager amount) represented at virtual wagering token 3954 (FIG. 39G) by performing “expand” gesture (G5) at virtual interactive control interface region 3914 (e.g., as shown at FIG. 39F). In response, as illustrated, for example, in FIG. 39G, the intelligent multi-player electronic gaming system may be configured or designed to dynamically increase the token amount value associated with virtual wagering token 3954 (e.g., from $6 to $13), and may further be configured or designed to dynamically update the current token amount value (3954a) of the virtual wagering token 3954 displayed at the common wagering area 3920).

Similarly, in at least one embodiment, a player may perform a “pinch” gesture (G6) (e.g., using two concurrent contact regions) to dynamically decrease the token value 3954a represented at virtual wagering token 3954 (e.g., as shown at FIG. 39I). Thus, for example, as illustrated in the example embodiments of FIGS. 39H-G, player 3903 may dynamically decrease the token value (or wager amount) represented at virtual wagering token 3954 (FIG. 39I) by performing “pinch” gesture (G6) at virtual interactive control interface region 3914 (e.g., as shown at FIG. 39H). In response, as illustrated, for example, in FIG. 39I, the intelligent multi-player electronic gaming system may be configured or designed to dynamically decrease the token amount value associated with virtual wagering token 3954 (e.g., from $13 to $10), and may further be configured or designed to dynamically update the current token amount value (3954a) of the virtual wagering token 3954 displayed at the common wagering area 3920).

As noted previously, various characteristics of the gesture(s) may be used to influence or affect how the gestures are interpreted and/or how the mapped functions are implemented/executed. For example, according to different embodiments, the relative amount by which the token value 3954a is increased/decreased may be influenced by, affected by and/or controlled by different types of gesture-related characteristics, such as, for example, one or more of the following (or combinations thereof):
velocity of the movement(s) of the gesture(s) (or portions thereof);
displacement of the movement(s) of the gesture(s) (or portions thereof) (e.g., a relatively longer gesture movement (as illustrated, for example, at G5) may result in greater increase of the wager amount, as compared to a relatively shorter gesture movement (as illustrated, for example, at G6));
number or quantity of digits (or contact regions) used in performing a gesture (or portions thereof);
etc.

FIGS. 39J-M illustrate an alternate example embodiment of the virtual interactive control interface region 3914, which may be used for implementing various aspects described herein. For example, as illustrated in the example embodiment of FIGS. 39J and 39L, the GUI representing virtual interactive control interface region 3914 may be configured or designed to include multiple different sub-regions (e.g., 3914a, 3914b, etc.). In at least one embodiment, each sub-region (e.g., 3914a, 3914b) may be configured or designed to control different aspects, functions, objects and/or other characteristics associated with the common wagering area 3920.

For example, in the example embodiment of FIGS. 39J and 39L, sub-region 3914a may be dynamically mapped to various aspects, functions, and/or other characteristics relating to virtual object manipulator 3952, and sub-region 3914b may be dynamically mapped to various aspects, functions, and/or other characteristics relating to one or more virtual object(s) (such as, for example, virtual wagering token 3954) which is/are currently selected for manipulation (e.g., being held or grasped) via the player's virtual object manipulator.

In at least one embodiment, as illustrated in the example embodiment of FIGS. 39J and 39L, each sub-region each sub-region (e.g., 3914a, 3914b) may be configured to display a respective image and/or object (e.g., 3945, 3946) which, for example, may be used to assist the user/player in identifying the associated aspects, functions, objects, characteristics, etc. which that particular region is currently configured to control. For example, as illustrated in the example embodiment of FIGS. 39J and 39L, the displayed hand image 3945 of sub-region 3914a may convey to player 3903 that sub-region 3914a is currently configured to control movements and/or other functions relating to the player's virtual object manipulator 3952. Similarly, the displayed token image 3946 of sub-region 3914b may convey to player 3903 that: (1) virtual wagering token 3954 (e.g., located at the common wagering area 3920) is currently selected for manipulation by the player's virtual object manipulator 3952 and/or (2) sub-region 3914b is currently configured to control various characteristics relating to virtual wagering token 3954 (such as, for example, its token value, its current location or position within the common wagering area 3920, etc.).

In at least one embodiment, a user/player may perform various types of different gestures at, on, or over each sub-region of the virtual interactive control interface region 3914 to implement and/or interact with one or more of the various aspects, functions, characteristics, etc. which that particular region is currently configured to control. For example, in the example embodiment of FIGS. 39J and 39L, player 3903 may perform one or more gestures at, on, or over sub-region 3914a to control movements and/or other functions relating to the player's virtual object manipulator 3952. Similarly, player 3903 may perform one or more gestures at, on, or over sub-region 3914b to control movements, characteristics and/or other aspects relating virtual wagering token 3954.

However, in at least some embodiments, a gesture performed in sub-region 3914a may be mapped to a first function, while the same gesture performed in sub-region 3914b may be mapped to a different function. For example, in at least one embodiment, as illustrated, for example, in FIG. 39J, a “pinch” gesture (G7) performed in sub-region 3914a may be mapped to a function for controlling a movement of the player's virtual object manipulator 3952 (such as, for example, “GRASP/SELECT”), whereas the same gesture (G7) performed in sub-region 3914b may be mapped to a function for adjusting the token value of virtual wagering token 3954 (such as, for example, “DECREASE WAGER/TOKEN VALUE”).

In at least one embodiment, as illustrated, for example, in FIG. 39K, the intelligent multi-player electronic gaming system may be configured or designed to dynamically decrease the token amount value associated with virtual wagering token 3954 (e.g., from $6 to $3), and may further be configured or designed to dynamically update the current token amount value (3954a) of the virtual wagering token 3954 displayed at the common wagering area 3920).

In a similar manner, an “expand” gesture performed in sub-region 3914a may be mapped to a function for controlling a movement of the player's virtual object manipulator 3952 (such as, for example, “UNGRASP/DESELECT”), whereas the same “expand” gesture performed in sub-region 3914b may be mapped to a function for adjusting the token value of virtual wagering token 3954 (such as, for example, “INCREASE WAGER/TOKEN VALUE”).

In another example, as illustrated, for example, in FIG. 39L, a “drag up” gesture (G8) performed in sub-region 3914a may be mapped to a function for controlling a movement of the player's virtual object manipulator 3952 (such as, for example, “MOVE UP”), whereas the same gesture (G8) performed in sub-region 3914b may be mapped to a function for adjusting the token value of virtual wagering token 3954 (such as, for example, “INCREASE WAGER/TOKEN VALUE”).

In a similar manner, an “drag down” gesture performed in sub-region 3914a may be mapped to a function for controlling a movement of the player's virtual object manipulator 3952 (such as, for example, “MOVE DOWN”), whereas the same “drag down” gesture performed in sub-region 3914b may be mapped to a function for adjusting the token value of virtual wagering token 3954 (such as, for example, “DECREASE WAGER/TOKEN VALUE”).

FIGS. 39N, 39O and 39P illustrate different example embodiments relating to the conformation and/or placement of wager(s) (and/or associated virtual wagering token(s)) at one or more locations of the common wagering area 3920.

For example, as illustrated in the example embodiment of FIGS. 39N-P, player 3903 may perform one or more gestures (e.g., at the virtual interactive control interface region 3914) to confirm placement of the wager, which for example, may be graphically represented at the common wagering area 3920 by placement of the virtual wagering token 3954 at the desired wagering region (e.g., 3955) of the virtual craps table wagering area.

In at least one embodiment, before confirmation/placement of the wager, the player may preferably select and/or confirm a desired wager amount (e.g., by adjusting the token value of the virtual wagering token 3954), and/or may preferably position the virtual wagering token 3954 (e.g., via use of virtual interactive control interface region 3914 and/or virtual object manipulator 3952) over a desired region of the virtual craps table represented in the common wagering area 3920.

For example, as illustrated in the example embodiment of FIG. 39N, player 3903 may perform a gesture (e.g., “double tap” gesture (G9)) at, on, or over the virtual interactive control interface region 3914 to confirm placement of a $6 wager at region (e.g., 3955) of the virtual craps table wagering area.

In a different embodiment, as illustrated in the example embodiment of FIG. 39O, player 3903 may perform a gesture (e.g., “double tap” gesture (G9)) at, on, or over sub-region 3914b of the virtual interactive control interface region 3914 to confirm placement of the $6 wager at region (e.g., 3955) of the virtual craps table wagering area. Alternatively, in at least some embodiments, the player may perform a gesture (e.g., an “expand” gesture (G10)) at, on, or over sub-region 3914a of the virtual interactive control interface region 3914 to confirm placement of the $6 wager at region (e.g., 3955) of the virtual craps table wagering area.

As illustrated in the example embodiment of FIG. 39P, confirmation/placement of the $6 wager may be graphically represented in the common wagering area 3920 by the placement of virtual wagering token 3954 at the specified wagering region (e.g., 3955) of the virtual craps table wagering area.

In at least one embodiment, the intelligent multi-player electronic gaming system 3900 may be configured or designed to utilize one or more of the various different types of gesture-function mappings described herein. For example, in some embodiments, intelligent multi-player electronic gaming system 3900 may be configured or designed to recognize one or more of the different types of universal/global gestures (e.g., 2501), wager-related gestures (2601), and/or other gestures described herein which may be performed by one or more users/players at, on, or over one or more virtual interactive control interface regions of the multi-touch, multi-player interactive display surface. Additionally, the intelligent multi-player electronic gaming system may be further configured or designed to utilize one or more of the gesture-function mappings described herein to map such recognized gestures to appropriate functions. For example, in at least one embodiment, a user/player may perform one or more of the global CANCEL/UNDO (e.g., at, on, or over the user's associated virtual interactive control interface region) to cancel and/or undo one or more mistakenly placed wagers.

According to various embodiments, each of the players at the intelligent multi-player electronic gaming system may concurrently place, modify and/or cancel their respective wagers within the common wagering area 3920 via interaction with that player's respective virtual interactive control interface region displayed on the multi-touch, multi-player interactive display surface 3901. In at least one embodiment, the individual wager(s) placed by each player at the gaming table system may be graphically represented with the common wagering area 3920 of the multi-touch, multi-player interactive display surface. Further, in at least one embodiment, the wagers associated with each different player may be visually represented (e.g., via the use of colors, shapes, patterns, shading, visual strobing techniques, markings, symbols, graphics, and/or other various types of visual display techniques) in a manner which allows each player to visually distinguish his or her wagers (and/or associated virtual wagering tokens/objects) from other wagers (and/or associated virtual wagering tokens/objects) belonging to other players at the gaming table system.

It will be appreciated that the various gestures and gesture-function mappings described or referenced herein (e.g., including at least a portion of those illustrated, for example, in FIGS. 25-39) are representative of only an example portion of possible gestures and gesture-function mappings which may be used in conjunction with gaming, wagering, and/or other activities performed by users (e.g., players, dealers, etc.) at one or more intelligent multi-player electronic gaming systems described herein. In other embodiments (not illustrated), various other permutations and/or combinations of at least a portion of the gestures and/or gesture-function mappings described herein (and/or commonly known to one having ordinary skill in the art) may be utilized at one or more intelligent multi-player electronic gaming systems such as those described herein.

Additionally, it is specifically contemplated that at least a portion of the various gestures described or referenced herein may be utilized for creating other types of gesture-function mappings which may relate to other types of activities that may be conducted at the intelligent multi-player electronic gaming system. Various examples of such other types of activities may include, but are not limited to, one or more of the following (or combinations thereof):
object interaction activities such as, for example, one or more activities which may be performed for selecting/modifying/deselecting various types of virtual objects displayed at the multi-touch, multi-player interactive display;
content modification activities such as, for example, one or more activities which may be performed for modifying the visual appearances of various types of images, virtual objects and/or other content displayed at the multi-touch, multi-player interactive display;
payline interaction activities such as, for example, one or more activities which may be performed for selecting/modifying/deselecting virtual payline(s) represented at a virtual slot machine;
system configuration activities such as, for example, one or more activities which may be performed for accessing/selecting/modifying/deselecting configuration features relating to configuration and/or maintenance of the intelligent multi-player electronic gaming system;
authentication related activities such as, for example, one or more activities which may be performed during various types of authentication procedures which may be performed at the intelligent multi-player electronic gaming system;
verification/validation related activities such as, for example, one or more activities which may be performed during various types of verification/validation procedures which may be performed at the intelligent multi-player electronic gaming system;
menu navigation activities such as, for example, one or more activities which may be performed for navigating menus displayed on the multi-touch, multi-player interactive display;
security-related activities such as, for example, one or more activities which may be performed for accessing and/or modifying various types of security features and/or security configurations of the intelligent multi-player electronic gaming system
side wagering activities such as, for example, one or more activities which may be performed for placing side wagers via interaction with the multi-touch, multi-player interactive display surface;
cash-out related activities such as, for example, one or more activities which may be performed for initiating and/or completing a cash-out transaction;
bonus related activities such as, for example, one or more activities which may be performed for selecting and/or modifying bonus awards (or potential bonus awards);
entertainment related activities such as, for example, one or more activities which may be performed during interaction with one or more different types of entertainment services offered via interaction with the multi-touch, multi-player interactive display surface;
reservation related activities such as, for example, one or more activities which may be performed during interaction with one or more different types of reservation services offered via interaction with the multi-touch, multi-player interactive display surface;
room/lodging related activities such as, for example, one or more activities which may be performed during interaction with one or more different types of room/lodging services (e.g., view bill, check-out, book room, etc.) offered via interaction with the multi-touch, multi-player interactive display surface;
transportation related activities such as, for example, one or more activities which may be performed during interaction with one or more different types of transportation services offered via interaction with the multi-touch, multi-player interactive display surface;
restaurant related activities such as, for example, one or more activities which may be performed during interaction with one or more different types of restaurant/food services offered via interaction with the multi-touch, multi-player interactive display surface;
bar related activities such as, for example, one or more activities which may be performed during interaction with one or more different types of bar/drink services offered via interaction with the multi-touch, multi-player interactive display surface;
concierge related activities such as, for example, one or more activities which may be performed during interaction with one or more different types of concierge services offered via interaction with the multi-touch, multi-player interactive display surface;
messaging related activities such as, for example, one or more activities which may be performed during interaction with one or more different types of messaging services (e.g., text chat, e-mail, video chat, telephone, etc.) offered via interaction with the multi-touch, multi-player interactive display surface;
etc.

Other aspects of gesture recognition, gesture interpretation and/or gesture mapping techniques (e.g., which may be used by and/or implemented at one or more intelligent multi-player electronic gaming system embodiments described herein) are disclosed in PCT Publication No. WO2008/094791A2 entitled “GESTURING WITH A MULTIPOINT SENSING DEVICE” by WESTERMAN et al., the entirety of which is incorporated herein by reference for all purposes.

It is to be understood that the scope of the present disclosure is not intended to be limited only to the specific example gestures and gesture-function mappings described and/or illustrated herein. Rather, it is intended that the scope of the present disclosure be inclusive of the specific example gestures and gesture-function mappings described and/or illustrated herein, as well as any other adaptations, derivations, variations, combinations and/or permutations of the various gestures and/or gesture-function mappings described or referenced herein (and/or commonly known to one having ordinary skill in the art) which may be readily conceived of and/or practiced by one of ordinary skill in the art without exercising the use of inventive skill.

Multi-Layered Displays

Various embodiments of the multi-touch, multi-player interactive display devices described herein may be configured or designed as a multi-layered display (MLD) which includes a plurality of multiple layered display screens.

As the term is used herein, a display device refers to any device configured to adaptively output a visual image to a person in response to a control signal. In one embodiment, the display device includes a screen of a finite thickness, also referred to herein as a display screen. For example, LCD display devices often include a flat panel that includes a series of layers, one of which includes a layer of pixilated light transmission elements for selectively filtering red, green and blue data from a white light source. Numerous exemplary display devices are described below.

The display device is adapted to receive signals from a processor or controller included in the intelligent multi-player electronic gaming system and to generate and display graphics and images to a person near the intelligent multi-player electronic gaming system. The format of the signal will depend on the device. In one embodiment, all the display devices in a layered arrangement respond to digital signals. For example, the red, green and blue pixilated light transmission elements for an LCD device typically respond to digital control signals to generate colored light, as desired.

In one embodiment, the intelligent multi-player electronic gaming system comprises a multi-touch, multi-player interactive display system which includes two display devices, including a first, foremost or exterior display device and a second, underlying or interior display device. For example, the exterior display device may include a transparent LCD panel while the interior display device includes a digital display device with a curved surface.

In another embodiment, the intelligent multi-player electronic gaming system comprises a multi-touch, multi-player interactive display system which includes three or more display devices, including a first, foremost or exterior display device, a second or intermediate display device, and a third, underlying or interior display device. The display devices are mounted, oriented and aligned within the intelligent multi-player electronic gaming system such that at least one—and potentially numerous—common lines of sight intersect portions of a display surface or screen for each display device. Several exemplary display device systems and arrangements that each include multiple display devices along a common line of sight will now be discussed.

Layered display devices may be described according to their position along a common line of sight relative to a viewer. As the terms are used herein, ‘proximate’ refers to a display device that is closer to a person, along a common line of sight, than another display device. Conversely, ‘distal’ refers to a display device that is farther from a person, along the common line of sight, than another.

In at least one embodiment, one or more of the MLD display screens may include a flat display screen incorporating flat-panel display technology such as, for example, one or more of the following (or combinations thereof): a liquid crystal display (LCD), a transparent light emitting diode (LED) display, an electroluminescent display (ELD), and a microelectromechanical device (MEM) display, such as a digital micromirror device (DMD) display or a grating light valve (GLV) display, etc. In some embodiments, one or more of the display screens may utilize organic display technologies such as, for example, an organic electroluminescent (OEL) display, an organic light emitting diode (OLED) display, a transparent organic light emitting diode (TOLED) display, a light emitting polymer display, etc. In addition, at least one display device may include a multipoint touch-sensitive display that facilitates user input and interaction between a person and the intelligent multi-player electronic gaming system.

In one embodiment, the display screens are relatively flat and thin, such as, for example, less than about 0.5 cm in thickness. In one embodiment, the relatively flat and thin display screens, having transparent or translucent capacities, are liquid crystal diodes (LCDs). It should be appreciated that the display screen can be any suitable display screens such as lead lanthanum include titanate (PLZT) panel technology or any other suitable technology which involves a matrix of selectively operable light modulating structures, commonly known as pixels or picture elements.

Various companies have developed relatively flat display screens which have the capacity to be transparent or translucent. One such company is Tralas Technologies, Inc., which sells display screens which employ time multiplex optical shutter (TMOS) technology. This TMOS display technology involves: (a) selectively controlled pixels which shutter light out of a light guidance substrate by violating the light guidance conditions of the substrate; and (b) a system for repeatedly causing such violation in a time multiplex fashion. The display screens which embody TMOS technology are inherently transparent and they can be switched to display colors in any pixel area. Certain TMOS display technology is described in U.S. Pat. No. 5,319,491.

Another company, Deep Video Imaging Ltd., has developed various types of multi-layered displays and related technology. Various types of volumetric and multi-panel/multi-screen displays are described, for example, in one or more patents and/or patent publications assigned to Deep Video Imaging such as, for example, U.S. Pat. No. 6,906,762, and PCT Pub. Nos.: WO99/42889, WO03/040820A1, WO2004/001488A1, WO2004/002143A1, and WO2004/008226A1, each of which is incorporated herein by reference in its entirety for all purposes.

It should be appreciated that various embodiments of multi-touch, multi-player interactive displays may employ any suitable display material or display screen which has the capacity to be transparent or translucent. For example, such a display screen can include holographic shutters or other suitable technology.

FIG. 40A shows an example embodiment of a portion of a multiple layered, multi-touch, multi-player interactive display configuration which may be used for implementing one more multi-touch, multi-player interactive display device/system embodiments.

As illustrated in FIG. 40, one embodiment of the display device 4064 includes two display screens 4066a and 4066b intersectable by at least one straight line of sight 4060b. The exterior and the interior display screen 4066a and 4066b are or have the capacity to be completely transparent or translucent. This embodiment includes a light source 4068.

FIG. 40B shows a multi-layered display device arrangement suitable for use with an intelligent multi-player electronic gaming system in accordance with another embodiment. In this arrangement, a multipoint input interface 4016 is arranged on top of an exterior LCD panel 4018a, an intermediate light valve 4018e and a display screen 4018d. A common line of sight 4020 passes through all four layered devices.

In some embodiments (not shown) additional intermediate display screens may be interposed between top display screen 4018a and bottom display screen 4018b. For example, in one embodiment, at least one intermediate display screen may be interposed between top display screen 4018a and light valve 4018e. In other embodiments, light valve 4018e may be omitted.

Light valve 4018e selectively permits light to pass therethrough in response to a control signal. Various devices may be utilized for the light valve 4018e, including, but not limited to, suspended particle devices (SPD), Cholesteric LCD devices, electrochromic devices, polymer dispersed liquid crystal (PDLC) devices, etc. Light valve 4018e switches between being transparent, and being opaque (or translucent), depending on a received control signal. For example, SPDs and PDLC devices become transparent when applied with a current and become opaque or translucent when little or no current is applied. On the other hand, electrochromic devices become opaque when applied with a current, and transparent when little or no current is applied. Additionally, light valve 4018e may attain varying levels of translucency and opaqueness. For example, while a PDLC device is generally either transparent or opaque, suspended particle devices and electrochromic devices allow for varying degrees of transparency, opaqueness or translucency, depending on the applied current level. Further description of a light valve suitable for use herein is described in commonly owned and co-pending patent application Ser. No. 10/755,657 and entitled “METHOD AND APPARATUS FOR USING A LIGHT VALVE TO REDUCE THE VISIBILITY OF AN OBJECT WITHIN A GAMING APPARATUS”, which is incorporated herein by reference in its entirety for all purposes.

In one embodiment, the intelligent multi-player electronic gaming system includes a multipoint or multi-touch input interface 4016 disposed outside the exterior display device 4018a. Multipoint input interface 4016 detects and senses pressure, and in some cases varying degrees of pressure, applied by one or more persons to the multipoint input interface 4016. Multipoint input interface 4016 may include a capacitive, resistive, acoustic or other pressure sensitive technology. Electrical communication between multipoint input interface 4016 and the intelligent multi-player electronic gaming system processor enable the processor to detect one or more player(s) pressing on an area of the display screen (and, for some multipoint input interfaces, how hard each player is pushing on a particular area of the display screen). Using one or more programs stored within memory of the intelligent multi-player electronic gaming system, the processor enables one or more player(s) to provide input/instructions and/or activate game elements or functions by interacting with various regions of the multipoint input interface 4016.

As the term is used herein, a common line of sight refers to a straight line that intersects a portion of each display device. The line of sight is a geometric construct used herein for describing a spatial arrangement of display devices and need not be an actual line of some sort in the intelligent multi-player electronic gaming system. If all the proximate display devices are transparent along the line of sight, then a person should be able see all the display devices along the line of sight. Multiple lines of sight may also be present in many instances. As illustrated in FIG. 40B, one suitable arrangement includes screens for two display devices 4018a and 4018d that are intersectable by a common line of sight 4020.

In at least one embodiment, bottom display screen 4018d includes a digital display device of different sizes and/or shapes. For example, in some embodiments, bottom display screen 4018d may have a substantially flat shape. In other embodiments, bottom display screen 4018d may have a curved shape.

A digital display device refers to a display device that is configured to receive and respond to a digital communication, e.g., from a processor or video card. Thus, OLED, LCD and projection type (LCD or DMD) devices are all examples of suitable digital display devices. E Ink Corporation of Cambridge Mass. produces electronic ink displays that are suitable for use in bottom display screen 4018d. Microscale container display devices, such as those produced SiPix of Fremont Calif., are also suitable for use in bottom display screen 4018d. Several other suitable digital display devices are provided below.

According to various embodiments, one or more multi-layered, multi-touch, multi-player interactive display embodiments described herein may be operable to display co-acting or overlapping images to players at the intelligent multi-player electronic gaming system. For example, according to different embodiments, players and/or other persons observing the multi-layered, multi-touch, multi-player interactive display are able to view different types of information and different types of images by looking at and through the exterior (e.g., top) display screen. In some embodiments, the images displayed at the different display screens are positioned such that the images do not overlap (e.g., the images are not superimposed). In other embodiments, portions of the content displayed at each of the separate display screens may overlap (e.g., from the viewing perspective of the player/observer). In other embodiment, the images displayed at the display screens can fade-in, fade out, and/or pulsate to create additional affects. In certain embodiments, a player can view different images and different types of information in a single line of sight.

FIGS. 41A and 41B show example embodiments of various types of content and display techniques which may be used for displaying various content on each of the different display screens of a multiple layered, multi-touch, multi-player interactive display configuration which may be used for implementing one more multi-touch, multi-player interactive display device/system embodiments described herein.

As illustrated in the example embodiments illustrated in FIGS. 41A and 41B, portions of a multi-layered display system 4100 are represented. In these embodiments, it is assumed that the multi-layered display system 4100 includes two display screens, namely a front/top/exterior screen 4102a and a back/bottom/interior screen 4102b, which configured or designed in a multi-layered display arrangement. It will be appreciated, however, that other embodiments of the multi-layered display system 4100 may include additional layers of display screens which, for example, may be interposed between screens 4102a and 4102b.

For illustrative purposes, the relative positions of the display screens 4102a and 4102b have been exaggerated in order to better highlight various aspects, features, and/or advantages of the multi-layered display system 4100.

By way of illustration, and for purposes of explanation, it will be assumed that the multi-layered display system 4100 corresponds to the multi-touch, multi-player interactive display system which forms part of the intelligent multi-player electronic gaming system 3900 (e.g., previously described with respect to FIGS. 39A-P), which has been configured as a multi-player, electronic wager-based craps gaming table.

As illustrated in the example embodiment of FIG. 41A, various types of content and display techniques may be used for displaying various content on each of the different display screens 4102a and 4102b. In this particular embodiment, it is assumed that a player (e.g., player 3903) is in the process of placing a wager for $6 (e.g., represented by virtual wagering token 3954) at a desired location (e.g., 3955) of the virtual craps table surface (e.g., 3922) via gesture interaction with virtual interactive control interface region 3914 and virtual object manipulator 3952.

In at least one embodiment, the intelligent multi-player electronic gaming system may be configured or designed to automatically and/or dynamically modify, at any given time (e.g., in real-time) the content (and appearance characteristics of such content) which is displayed at each of the display screens 4102a and 4102b in response to various types of information relating to various types of events, conditions, and/or activities which may be occurring at the intelligent multi-player electronic gaming system. In at least one embodiment, the selection of which types of content to be displayed (at any given time) on which of the display screens 4102a and 4102b may be performed (at least partially) by one or more of the gaming controller(s) of the intelligent multi-player electronic gaming system.

For example, various situations or conditions may occur at the intelligent multi-player electronic gaming system in which it is desirable to display various types of information and/or content on the multi-layered, multi-touch, multi-player interactive display surface in a manner which highlights such information/content to one or more observers of the display surface (e.g., in order to focus the observers' attention on such information/content). In other situations, it may be desirable to display various types of information and/or content on the multi-layered, multi-touch, multi-player interactive display surface in a manner which does not distract the attention of one or more observers of the display surface. In yet other situations, it may be desirable to simply present various types of content to players and/or other observers of the display surface in a manner which is unique and/or entertaining. In at least some of these situations, use of multi-layered display techniques may be well-suited for achieving the desired effects/results.

For example, in at least one embodiment, the intelligent multi-player electronic gaming system may be configured or designed to automatically and/or dynamically modify, at any given time (e.g., in real-time) the content (and appearance characteristics of such content) which is displayed at each of the display screens 4102a and 4102b in response to current actions and/or activities being performed by one or more players who are interacting with the multi-layered, multi-touch, multi-player interactive display surface, for example, in order to facilitate the observation (e.g., by one or more players) of specific content which may facilitate such players and performing their various activities at the intelligent multi-player electronic gaming system.

For example, referring to the example embodiment illustrated in FIG. 41A, the intelligent multi-player electronic gaming system may be configured or designed to monitor the activities of player 3903, and automatically and dynamically modify (e.g., in real-time) selected portions of content (and/or the appearances of such content) displayed at each of the display screens 4102a and 4102b in response to the player's various gestures and/or in a manner which may facilitates player 3903 in performing his or her current activities.

For example, in at least one embodiment, the intelligent multi-player electronic gaming system may be operable to identify portions of content which may be particularly relevant to the player in performing his or her current activities, and may dynamically cause the display of such content to be moved, for example, from the bottom screen 4108b to the top screen 4108a, where it may be more prominently observed by the player.

Thus, for example, as illustrated in the example embodiment of FIG. 41A, while player 3903 is in the process of placing a wager for $6 (e.g., represented by virtual wagering token 3954) at a desired location of the virtual craps table surface (e.g., 3922) via gesture interaction with virtual interactive control interface region 3914 and virtual object manipulator 3952, the intelligent multi-player electronic gaming system may perform one or more of the following operations (and/or combination thereof):
monitor the current activities of player 3903
automatically identify portions of displayed content (and/or content to be displayed) which may be particularly relevant and/or useful to the player in performing his or her current activities;
detect that the player 3903 is attempting to perform a wager related activity via use of the player's virtual interactive control interface region 3914;
detect that the player's virtual interactive control interface region 3914 is currently being displayed at the bottom screen 4102b of the multi-layered display system 4100;
identify the coordinates where the player's virtual interactive control interface region 3914 is currently being displayed at the bottom screen 4102b;
dynamically cause the displayed content representing player's virtual interactive control interface region 3914 to be moved from bottom screen 4102b to a corresponding coordinate location on top screen 4102a;
detect that the player's virtual object manipulator 3952 is currently being displayed at the bottom screen 4102b of the multi-layered display system 4100;
identify the coordinates where the player's virtual object manipulator 3952 is currently being displayed at the bottom screen 4102b;
dynamically cause the displayed content representing player's virtual object manipulator 3952 to be moved from bottom screen 4102b to a corresponding coordinate location on top screen 4102a;
identify display content relating to the player's virtual object manipulator 3952;
identify display content relating to the player's virtual wagering token 3954;
detect that the player's virtual object manipulator 3952 is attempting to access/select virtual wagering token 3954 for interaction;
determine whether the player's virtual object manipulator 3952 is authorized to access/select virtual wagering token 3954 for interaction;
detect that the player's virtual object manipulator 3952 is currently configured to access virtual wagering token 3954 for interaction;
detect that the player's virtual wagering token 3954 is currently being displayed at the bottom screen 4102b of the multi-layered display system 4100;
identify the coordinates where the player's virtual object manipulator 3952 is currently being displayed at the top screen 4102a;
dynamically cause the displayed content representing player's virtual wagering token 3954 to be displayed at top screen 4102a at an appropriate coordinate location relative to the current coordinate location of the player's virtual object manipulator 3952 which is also currently being displayed at top screen 4102a;
detect that the player's virtual object manipulator 3952 is currently configured to enable player 3903 to control virtual movement of virtual wagering token 3954 within wagering region 3922 for placement at a desired wagering location;
detect that the virtual wagering token 3954 is currently positioned over “place the 6” wagering region 3955;
dynamically cause the displayed content representing wagering region 3955 to be displayed at top screen 4102a at an appropriate location (e.g., 3955a) in response to detecting that virtual wagering token 3954 is currently positioned over “place the 6” wagering region 3955;
detect that the virtual wagering token 3954 is not currently positioned over “place the 6” wagering region 3955;
dynamically cause the displayed content (e.g., 3955a) representing wagering region 3955 to be displayed at bottom screen 4102b at an appropriate location (e.g., 3955) in response to detecting that virtual wagering token 3954 is not currently positioned over “place the 6” wagering region 3955;
detect that the player's virtual object manipulator 3952 is currently positioned over a first displayed virtual object; and dynamically cause displayed content representing the first displayed virtual object to be displayed at an appropriate location at top screen 4102a in response to determining that the player's virtual object manipulator 3952 is authorized to access/select the first displayed virtual object for interaction
detect that the player's virtual object manipulator 3952 is currently positioned over a first displayed virtual object; and preventing displayed content representing the first displayed virtual object from being displayed at top screen 4102a in response to determining that the player's virtual object manipulator 3952 is not authorized to access/select the first displayed virtual object for interaction;
etc.

Thus, for example, in at least one embodiment, different types of content to be displayed via the multi-touch, multi-player interactive display may be represented at one or more different display screen layers.

For example, wagering tokens stacks 3911 (FIG. 39B) may be displayed at the back or intermediate display screen layers. When the user selects one of the virtual wagering tokens (e.g., 3931), display content associated with virtual wagering token object 3931 may be moved to the front display layer.

Similarly, virtual object manipulator 3952 and virtual wagering token 3954 may be displayed on front screen while the user is manipulating hand/object. Once user places wager or releases the object, the object image may be moved from the front to the back or intermediate layers. In at least one embodiment, a previously active virtual object manipulator object may be moved to back or intermediate layers after some predetermined time of inactivity.

Thus, for example, in at least one embodiment, while not in active use, the player's virtual object manipulator 3952 may be moved to bottom screen 4102b. When the player subsequently initiates an activity requiring use of the virtual object manipulator 3952, the intelligent multi-player electronic gaming system may automatically respond by moving the displayed image of the virtual object manipulator 3952 to top screen 4102a. As the player moves his virtual object manipulator 3952 around various portions of the common wagering region 3922, it may pass over one or more virtual objects (e.g., virtual wagering tokens) which may currently be displayed at bottom screen 4102b. In one embodiment, when it is detected that virtual object manipulator 3952 is positioned over one of the displayed virtual objects, the intelligent multi-player electronic gaming system may determine whether the player's virtual object manipulator 3952 is authorized to access/select that displayed virtual object for interaction. If the intelligent multi-player electronic gaming system determines that the player's virtual object manipulator 3952 is not authorized to access/select that displayed virtual object for interaction, the intelligent multi-player electronic gaming system may continue to display the image of that virtual object at bottom screen 4102b. However, if the intelligent multi-player electronic gaming system determines that the player's virtual object manipulator 3952 is authorized to access/select that displayed virtual object for interaction, the intelligent multi-player electronic gaming system may dynamically cause the virtual object to be displayed at top screen 4102a. In this way, the player may quickly and easily identify which of the displayed virtual objects belong to that player.

In another example, it may be assumed that the player's virtual object manipulator 3952 is currently configured to enable player 3903 to control virtual movement of virtual wagering token 3954 within wagering region 3922 for placement at a desired wagering location. As the player moves his virtual object manipulator 3952 (and virtual wagering token 3954) around the common wagering region 3922, the intelligent multi-player electronic gaming system may detect that the virtual wagering token 3954 is currently positioned over a specific wagering region (e.g., “place the 6” wagering region 3955), and in response, may dynamically cause the displayed content representing wagering region 3955 to be displayed at top screen 4102a at an appropriate location (e.g., 3955a). In this way, the player is able to quickly and easily identify and verify the virtual wagering location where the player's wager will be placed.

Subsequently, if the intelligent multi-player electronic gaming system detects that detect that the virtual wagering token 3954 is no longer positioned over the wagering region 3955, it may respond by dynamically causing the displayed content (e.g., 3955a) representing wagering region 3955 to be displayed at bottom screen 4102b at an appropriate location (e.g., 3955).

In another example embodiment it may again be initially assumed that the player's virtual object manipulator 3952 is currently configured to enable player 3903 to control virtual movement of virtual wagering token 3954 within wagering region 3922 for placement at a desired wagering location. While the player is performer one or more gestures at the virtual interactive control interface region 3914 to move his virtual object manipulator 3952 (and virtual wagering token 3954) around the common wagering region 3922, the intelligent multi-player electronic gaming system may cause the virtual interactive control interface region 3914, virtual object manipulator 3952, and virtual wagering token 3954 to each be displayed at appropriate locations at top screen 4102a. Subsequently, as illustrated, for example, in FIG. 41B, one the player has placed his wager (e.g., virtual wagering token 3954) at a desired location of the virtual craps wagering region 3922, the intelligent multi-player electronic gaming system may respond by dynamically causing the virtual wagering token 3954 to be displayed at bottom screen 4102b at an appropriate location (e.g., 3955). Additionally, in at least one embodiment, if the intelligent multi-player electronic gaming system detects that the player's virtual object manipulator 3952 has currently not identified any virtual object for accessing or interacting with, it may respond by dynamically causing the virtual object control portion 3914b of the virtual interactive control interface region 3914 to be displayed at bottom screen 4102b at an appropriate location.

In at least some embodiments, a gesture which is described herein as being performed over a region of the multi-touch, multi-player interactive display surface may include both contact type gestures (e.g., involving physical contact with the multi-touch, multi-player interactive display surface) and/or non-contact type gestures (e.g., which may not involve physical contact with the multi-touch, multi-player interactive display surface). Accordingly, it will be appreciated that, in at least some embodiments, the multipoint or multi-touch input interface of the multi-touch, multi-player interactive display surface may be operable to detect non-contact type gestures which may be performed by players over various regions of the multi-touch, multi-player interactive display surface.

In at least one embodiment, a user may be permitted to personalize or customize various visual characteristics (e.g., colors, patterns, shapes, sizes, symbols, shading, etc.) of displayed virtual objects or other displayed content associated with that user.

Other types of features which may be provided at one or more intelligent multi-player electronic gaming systems may include one or more of the following (or combinations thereof):
In multi-player card game situations, one or more MLD-based techniques may be utilized to allow players to view their own cards, while keeping the cards hidden or obscured from observation by other players. In at least one embodiment, such a feature may be implemented by displaying a masking image the external (e.g., top) display while displaying the player's the cards on the lower display such that only a person viewing from the proper player's angle could see the underlying cards; the other players will only see the mask. In at least one embodiment, the masking of a player's cards may be further improved by displaying, at appropriate locations, one or more masking images on one or more intermediate screen layers of the MLD display.
In at least some embodiments where touch origination is used, the cards of a given player may only be revealed if touched by the proper player.
In at least some embodiments, the gaming system may be configured or designed to automatically and/or dynamically adjust the orientation of the displayed images of the mask(s)/card(s) to the direction of the authorized touch.
In at least one embodiment involving the use of an MLD-based interactive touch display device, touch areas on the display surface may be shifted from the underlying display, so that they are more properly aligned to conform with the perspective(s) of one or more selected players. Such a feature may be used to facilitate the ease and/or convenience of performing touch-based gestures for each player (or selected players) (e.g., based on each player's relative position of a player along the perimeter of the multi-touch, multi-player interactive display surface, and may make it difficult for a player to accurately touch another player's virtual objects.

Other aspects relating to multi-layered display technology (e.g., which may be used by and/or implemented at one or more intelligent multi-player electronic gaming system embodiments described herein) are disclosed in one or more of the following references:

U.S. patent application Ser. No. 10/213,626 (Attorney Docket No. IGT1P604/P-528), published as U.S. Patent Publication No. US2004/0029636, entitled “GAMING DEVICE HAVING A THREE DIMENSIONAL DISPLAY DEVICE”, by Wells et al., and filed Aug. 6, 2002, previously incorporated herein by reference for all purposes;

U.S. patent application Ser. No. 11/514,808 (Attorney Docket No. IGT1P194/P-1020), entitled “GAMING MACHINE WITH LAYERED DISPLAYS”, by Wells et al., filed Sep. 1, 2006, previously incorporated herein by reference for all purposes;

PCT Publication No. WO2001/015132A1, entitled “CONTROL OF DEPTH MOVEMENT FOR VISUAL DISPLAY WITH LAYERED SCREENS”, by ENGEL et al., the entirety of which is incorporated herein by reference for all purposes; and

PCT Publication No. WO2001/015127A1, entitled “DISPLAY METHOD FOR MULTIPLE LAYERED SCREENS”, by ENGEL et al., the entirety of which is incorporated herein by reference for all purposes.

FIG. 42 shows a block diagram illustrating components of a gaming system 4200 which may be used for implementing various aspects of example embodiments. In FIG. 42, the components of a gaming system 4200 for providing game software licensing and downloads are described functionally. The described functions may be instantiated in hardware, firmware and/or software and executed on a suitable device. In the system 4200, there may be many instances of the same function, such as multiple game play interfaces 4211. Nevertheless, in FIG. 42, only one instance of each function is shown. The functions of the components may be combined. For example, a single device may comprise the game play interface 4211 and include trusted memory devices or sources 4209.

The gaming system 4200 may receive inputs from different groups/entities and output various services and or information to these groups/entities. For example, game players 4225 primarily input cash or indicia of credit into the system, make game selections that trigger software downloads, and receive entertainment in exchange for their inputs. Game software content providers 4215 provide game software for the system and may receive compensation for the content they provide based on licensing agreements with the gaming machine operators. Gaming machine operators select game software for distribution, distribute the game software on the gaming devices in the system 4200, receive revenue for the use of their software and compensate the gaming machine operators. The gaming regulators 4230 may provide rules and regulations that must be applied to the gaming system and may receive reports and other information confirming that rules are being obeyed.

In the following paragraphs, details of each component and some of the interactions between the components are described with respect to FIG. 42. The game software license host 4201 may be a server connected to a number of remote gaming devices that provides licensing services to the remote gaming devices. For example, in other embodiments, the license host 4201 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 4214 may track the usage of game software on a plurality of devices in communication with the host. The game usage-tracking host 4214 may be in communication with a plurality of game play hosts and gaming machines. From the game play hosts and gaming machines, the game usage tracking host 4214 may receive updates of an amount that each game available for play on the devices has been played and on amount that has been wagered per game. This information may be stored in a database and used for billing according to methods described in a utility based licensing agreement.

The game software host 4202 may provide game software downloads, such as downloads of game software or game firmware, to various devious in the game system 4200. For example, when the software to generate the game is not available on the game play interface 4211, the game software host 4202 may download software to generate a selected game of chance played on the game play interface. Further, the game software host 4202 may download new game content to a plurality of gaming machines via a request from a gaming machine operator.

In one embodiment, the game software host 4202 may also be a game software configuration-tracking host 4213. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with example embodiments are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 4203 may be a host server connected to a plurality of remote clients that generates games of chance that are displayed on a plurality of remote game play interfaces 4211. For example, the game play host device 4203 may be a server that provides central determination for a bingo game play played on a plurality of connected game play interfaces 4211. As another example, the game play host device 4203 may generate games of chance, such as slot games or video card games, for display on a remote client. A game player using the remote client may be able to select from a number of games that are provided on the client by the host device 4203. The game play host device 4203 may receive game software management services, such as receiving downloads of new game software, from the game software host 4202 and may receive game software licensing services, such as the granting or renewing of software licenses for software executed on the device 4203, from the game license host 4201.

In particular embodiments, the game play interfaces or other gaming devices in the gaming system 4200 may be portable devices, such as electronic tokens, cell phones, smart cards, tablet PC's and PDA'S. The portable devices may support wireless communications and thus, may be referred to as wireless mobile devices. The network hardware architecture 4216 may be enabled to support communications between wireless mobile devices and other gaming devices in gaming system. In one embodiment, the wireless mobile devices may be used to play games of chance.

The gaming system 4200 may use a number of trusted information sources. Trusted information sources 4204 may be devices, such as servers, that provide information used to authenticate/activate other pieces of information. CRC values used to authenticate software, license tokens used to allow the use of software or product activation codes used to activate to software are examples of trusted information that might be provided from a trusted information source 4204. Trusted information sources may be a memory device, such as an EPROM, that includes trusted information used to authenticate other information. For example, a game play interface 4211 may store a private encryption key in a trusted memory device that is used in a private key-public key encryption scheme to authenticate information from another gaming device.

When a trusted information source 4204 is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 25, 2002 and entitled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 4200 of example embodiments may include devices 4206 that provide authorization to download software from a first device to a second device and devices 4207 that provide activation codes or information that allow downloaded software to be activated. The devices, 4206 and 4207, may be remote servers and may also be trusted information sources. One example of a method of providing product activation codes that may be used with example embodiments is describes in previously incorporated U.S. Pat. No. 6,264,561.

A device 4206 that monitors a plurality of gaming devices to determine adherence of the devices to gaming jurisdictional rules 4208 may be included in the system 4200. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 4200 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In example embodiments, the devices may be connected by a network 4216 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 4210 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 4212. For example, a software licensing billing server may generate a bill for a gaming device operator based upon a usage of games over a time period on the gaming devices owned by the operator. In another example, a software auditing server may provide reports on game software downloads to various gaming devices in the gaming system 4200 and current configurations of the game software on these gaming devices.

At particular time intervals, the software auditing server 4212 may also request software configurations from a number of gaming devices in the gaming system. The server may then reconcile the software configuration on each gaming device. In one embodiment, the software auditing server 4212 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 42. Many of the interactions are coupled. For example, methods used for game licensing may affect methods used for game downloading and vice versa. For the purposes of explanation, details of a few possible interactions between the components of the system 4200 relating to software licensing and software downloads have been described. The descriptions are selected to illustrate particular interactions in the game system 4200. These descriptions are provided for the purposes of explanation only and are not intended to limit the scope of example embodiments described herein.

Additional details relating to various aspects of gaming technology are described in one or more of the following references:

U.S. patent application Ser. No. 09/016,453, by Wanatabe et al., entitled “COORDINATE READING APPARATUS AND COORDINATE INDICATOR”, filed Jan. 30, 1998, the entirety of which is incorporated herein by reference for all purposes;

U.S. patent application Ser. No. 11/381,473, by Gururajan et al., entitled “GAMING OBJECT RECOGNITION”, filed May 3, 2006, the entirety of which is incorporated herein by reference for all purposes;

U.S. patent application Ser. No. 11/384,427, by Gururajan et al., entitled “TABLE GAME TRACKING”, filed Mar. 21, 2006, the entirety of which is incorporated herein by reference for all purposes; and

U.S. patent application Ser. No. 11/515,361, by Steil et al., entitled “GAME PHASE DETECTOR”, filed Sep. 1, 2006, the entirety of which is incorporated herein by reference for all purposes.

Other Features/Benefits/Advantages

Some embodiments of the intelligent multi-player electronic gaming system may include, but are not limited to, one or more of the following features (or combinations thereof):
Support for multiple simultaneous touch points (e.g., up to 500 multiple simultaneous touch points), for real-time multi-player interaction
visual computing surface
Infrared object recognition
Communal gaming experience
Height adjustability—e.g., 30″ tall “Poker-style” table (see, e.g., FIG. 26); 42″ tall “Blackjack-style” table (see e.g., FIG. 29); etc.
Ability to provide play of multiple different game themes, game types (e.g., multi-player blackjack, craps, poker, baccarat, roulette, pai gow, sic bo, fantan, etc.), denominations, paytables, etc.
Ability to provide concurrent of simultaneous play of multiple different game themes, game types (e.g., multi-player blackjack, craps, poker, baccarat, roulette, pai gow, sic bo, fantan, etc.), denominations, paytables, etc.
Ability to provide play of wheel bonus games (e.g., via networked, multi-table, progressive, etc.)
Ability to provide play of promotional games
Ability to detect, recognize and/or identify physical props placed on the surface (e.g., via use of infrared and/or other technologies) to activate various functions/modes of the table
Ability to automatically detect, recognize and/or identify other objects such as, player tracking cards, hotel keys, gaming chips or wagering tokens, currency, etc.
Ability to automatically detect, recognize and/or identify promotional player chips, and/or to award promotional credits go to the player based on identified chip information
Ability to automatically detect, recognize and/or identify UID devices (e.g., set it down on the display surface, tags and/or computer readable code/patterns on the device are recognized and used to activate the device and sync with wireless audio/video channels of the device, etc)

In one embodiment, the intelligent multi-player electronic gaming system may be configured or designed to be compatible with an O/S platform based, for example, on the Microsoft Windows Vista Operating System, and/or may be configured or designed to use industry standard PC technology for networking, wireless and/or other applications.

The various intelligent multi-player electronic gaming system embodiments described herein provide the first commercially available surface computing gaming table which turns an ordinary gaming tabletop into a vibrant, interactive surface. The product provides effortless interaction with digital content through natural gestures, touch and physical objects. In one embodiment, surface is a 30-inch display in a table-like form factor that's easy for individuals or small groups to interact with in a way that feels familiar, just like in the real world. In essence, it's a surface that comes to life for exploring, learning, sharing, creating, buying and much more.

In at least one embodiment, intelligent multi-player electronic gaming system embodiments described herein use cameras and/or other sensors/input mechanisms to sense objects, hand gestures and touch. This user input is then processed and the result is displayed on the surface using rear projection.

Surface computing is a new way of working with computers that moves beyond the traditional mouse-and-keyboard experience. It is a natural user interface that allows people to interact with digital content the same way they have interacted with everyday items such as photos, paintbrushes and music their entire life: with their hands, with gestures and by putting real-world objects on the surface. Surface computing opens up a whole new category of products for users to interact with.

Various attributes of surface computing may include, but are not limited to, one or more of the following (or combinations thereof):
Direct interaction. Users can actually “grab” digital information with their hands and interact with content by touch and gesture, without the use of a mouse or keyboard.
Multi-player, multi-touch contact. Surface computing recognizes many points of contact simultaneously, not just from one finger, as with a typical touch screen, but up to dozens and dozens of items at once.
Multi-user experience. The horizontal form factor makes it easy for several people to gather around surface computers together, providing a collaborative, face-to-face computing experience.
Object recognition. Users can place physical objects on the surface to trigger different types of digital responses, including the transfer of digital content.

The various intelligent multi-player electronic gaming system embodiments described herein break down the traditional barriers between people and technology, providing effortless interaction with live table gaming digital content. The various intelligent multi-player electronic gaming system embodiments described herein may change the way people will interact with all kinds of everyday content, including photos, music, a virtual concierge and games. Common, everyday table game play activities now become entertaining, enjoyable and engaging, alone or face-to-face with other players.

In at least one embodiment, the various intelligent multi-player electronic gaming system embodiments described herein enables the next evolution of communal gaming experiences on a casino floor, facilitating, for example:
Simultaneous play
Natural social interaction
Communal as well as Competitive play

Player versus House and Player versus Player have traditionally encompassed most casino game designs in the past. True Communal games have never been commercialized. This platform opens a whole new range of game mechanics.

The vision system/object recognition system can recognize various machine readable content (e.g., infrared tags, UPC symbols, etc.) some of which may be invisible to the naked eye. By tagging physical props, the table can perform a host of functions when these props are placed on the surface of the table. Invisible tags can be placed on common items, like hotel keys and player cards to facilitate promotional rewards or games. Tags can also be used for hosted table experiences, like card shoes and discard racks, etc. Cell phones and PDAs can be tagged to access onboard communication systems like Bluetooth.

In at least one embodiment, the intelligent multi-player electronic gaming system may utilize a modern PC platform running the Microsoft Windows Vista Operating System, and using off the shelf technology like USB and Ethernet, thereby allowing this table model and future models to always be network capable, via both wired and/or wireless interfaces. There is enough computing power for stand alone “thick client” gaming, and/or thin client and CDS gaming modes where game decisions are made at a server.

In at least one embodiment, the intelligent multi-player electronic gaming system may include a rugged, yet stylish “wrapper” around the core display system, which, for example, may be provided from another vendor. In at least one embodiment, the “wrapper” may be configured or designed to handle the rigors of a bar and casino environment. Peripheral devices like player tacking interfaces, bill validators and other casino specific hardware and software may be included and/or added so that the device can be used as a casino gaming device.

In at least one embodiment, various intelligent multi-player electronic gaming system embodiments described herein use 5 cameras to “see” the surface of the main display. It is not simply a touch screen type interface. Rather, the intelligent multi-player electronic gaming system may be configured or designed to see everything on the surface of the table and/or adjacent player station zones. It may simultaneously detect and process, in real time, multiple different touches from multiple different players. In at least one embodiment, each different touch point may be dynamically and automatically associated with or linked with a respective player (or other person) at the gaming table. Additionally, it is able to see things (e.g., computer readable markings) that are invisible to humans.

In at least one embodiment, the intelligent multi-player electronic gaming system may provide additional functionality which is not able to be provided by conventional touch screen type interfaces. For example, in one embodiment, four people can have all ten fingers on the surface at the same time. All forty touch points of their fingers are recognized by the computer at the same time, and linked to their associated owners. So if all four were play a tile game, all four of them could simultaneously and independently move or arrange tiles according to each player's preference. In this way, the intelligent multi-player electronic gaming system may enable multiple players to concurrently engage in multiple independent activities at the same time, on the same screen, display surface, and/or input surface. As a result, no one has to take turns, no one has to track anything. Secure, communal gaming applications can be a reality.

In at least one embodiment, the intelligent multi-player electronic gaming system may enable functionality relating to other game play concepts/features such as, for example: tournament play with multiple tables; head to head play on and/or between tables; etc. This is in addition to the simple social factor of allowing people to play together on a table, versus playing against each other or against a dealer. Also, it opens the door for traditional types of player input and/or real-time object recognition. For example, players can simply gesture to make something happen, versus pressing a button. For example, in one embodiment, a game of blackjack may be played on an intelligent multi-player electronic gaming system, and a player may be able to split their hand (e.g., of paired 8's) by simply placing their fingers over the virtual cards and spreading their cards out to cause the computer to recognize the split action.

In at least one embodiment, the intelligent multi-player electronic gaming system utilizes industry standard PC hardware and the Microsoft Windows Vista Operating System, and is fully network ready. According to different embodiments, the intelligent multi-player electronic gaming system may be operable as a stand alone device, and/or it can be operable as a server-based device. It can also plug into multi-player platforms.

In at least one embodiment, the intelligent multi-player electronic gaming system supports industry standard software development with WPF (Windows Presentation Foundation), Expressions Blend (for the artists), and Microsoft's XNA, which is used to make PC and XBox games.

It will be appreciated that the various gaming table systems described herein are but some examples from a wide range of gaming table system designs on which various aspects and/or techniques described herein may be implemented.

For example, not all suitable wager-based gaming systems have electronic displays or player tracking features. Further, some wager-based gaming systems may include a single display, while others may include multiple displays. Other wager-based gaming systems may not include any displays. As another example, a game may be generated on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from gaming environments may be displayed on portable gaming devices that are used to facilitate game play activities at the wager-based gaming system. Further a wager-based gaming system or server may include gaming logic for commanding a remote gaming device to render an image from a virtual camera in 2-D or 3-D gaming environments stored on the remote gaming device and to display the rendered image on a display located on the remote gaming device. Thus, those of skill in the art will understand that the present invention, as described below, can be deployed on most any wager-based gaming system now available or hereafter developed.

Some preferred wager-based gaming systems of the present assignee are implemented with special features and/or additional circuitry that differentiates them from general-purpose computers (e.g., desktop PC's and laptops). Wager-based gaming systems are highly regulated to ensure fairness and, in some cases, wager-based gaming systems may be operable to dispense monetary awards. Therefore, to satisfy security and regulatory requirements in a gaming environment, hardware and software architectures may be implemented in wager-based gaming systems that differ significantly from those of general-purpose computers. A description of wager-based gaming systems relative to general-purpose computing machines and some examples of the additional (or different) components and features found in wager-based gaming systems are described below.

At first glance, one might think that adapting PC technologies to the gaming industry would be a simple proposition because both PCs and wager-based gaming systems employ microprocessors that control a variety of devices. However, because of such reasons as 1) the regulatory requirements that are placed upon wager-based gaming systems, 2) the harsh environment in which wager-based gaming systems operate, 3) security requirements and 4) fault tolerance requirements, adapting PC technologies to a wager-based gaming system can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a wager-based gaming system because in a wager-based gaming system these faults can lead to a direct loss of funds from the wager-based gaming system, such as stolen cash or loss of revenue when the wager-based gaming system is not operating properly.

For the purposes of illustration, a few differences between PC systems and gaming systems will be described. A first difference between wager-based gaming systems and common PC based computers systems is that some wager-based gaming systems may be designed to be state-based systems. In a state-based system, the system stores and maintains its current state in a non-volatile memory, such that, in the event of a power failure or other malfunction the wager-based gaming system will return to its current state when the power is restored. For instance, if a player was shown an award for a table game and, before the award could be provided to the player the power failed, the wager-based gaming system, upon the restoration of power, would return to the state where the award is indicated. As anyone who has used a PC, knows, PCs are not state machines and a majority of data is usually lost when a malfunction occurs. This requirement affects the software and hardware design on a wager-based gaming system.

A second important difference between wager-based gaming systems and common PC based computer systems is that for regulation purposes, various software which the wager-based gaming system uses to generate table game play activities (such as, for example, the electronic shuffling and dealing of cards) may be designed to be static and monolithic to prevent cheating by the operator of wager-based gaming system. For instance, one solution that has been employed in the gaming industry to prevent cheating and satisfy regulatory requirements has been to manufacture a wager-based gaming system that can use a proprietary processor running instructions to generate the game play activities from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game play activities, such as adding a new device driver used by the master table controller to operate a device during generation of the game play activities can require a new EPROM to be burnt, approved by the gaming jurisdiction and reinstalled on the wager-based gaming system in the presence of a gaming regulator. Regardless of whether the EPROM solution is used, to gain approval in most gaming jurisdictions, a wager-based gaming system must demonstrate sufficient safeguards that prevent an operator or player of a wager-based gaming system from manipulating hardware and software in a manner that gives them an unfair and some cases an illegal advantage. The wager-based gaming system should have a means to determine if the code it will execute is valid. If the code is not valid, the wager-based gaming system must have a means to prevent the code from being executed. The code validation requirements in the gaming industry affect both hardware and software designs on wager-based gaming systems.

A third important difference between wager-based gaming systems and common PC based computer systems is the number and kinds of peripheral devices used on a wager-based gaming system are not as great as on PC based computer systems. Traditionally, in the gaming industry, wager-based gaming systems have been relatively simple in the sense that the number of peripheral devices and the number of functions the wager-based gaming system has been limited. Further, in operation, the functionality of wager-based gaming systems were relatively constant once the wager-based gaming system was deployed, i.e., new peripherals devices and new gaming software were infrequently added to the wager-based gaming system. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a wager-based gaming system, wager-based gaming systems still have unique device requirements that differ from a PC, such as device security requirements not usually addressed by PCs. For instance, monetary devices, such as coin dispensers, bill validators and ticket printers and computing devices that are used to govern the input and output of cash to a wager-based gaming system have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in wager-based gaming systems that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

For example, a watchdog timer may be used in International Game Technology (IGT) wager-based gaming systems to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Wager-based gaming systems of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

One method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed has been stored. This feature allows the game to recover operation to the current state of play in the event of a malfunction, loss of power, etc that occurred just prior to the malfunction. In at least one embodiment, the gaming machine is configured or designed to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

In order to ensure the success of atomic transactions relating to critical information to be stored in the gaming machine memory before a failure event (e.g., malfunction, loss of power, etc.), it is preferable that memory be used which includes one or more of the following criteria: direct memory access capability; data read/write capability which meets or exceeds minimum read/write access characteristics (such as, for example, at least 5.08 Mbytes/sec (Read) and/or at least 38.0 Mbytes/sec (Write)). Devices which meet or exceed the above criteria may be referred to as “fault-tolerant” memory devices, whereas it is which the above criteria may be referred to as “fault non-tolerant” memory devices.

Typically, battery backed RAM devices may be configured or designed to function as fault-tolerant devices according to the above criteria, whereas flash RAM and/or disk drive memory are typically not configurable to function as fault-tolerant devices according to the above criteria. Accordingly, battery backed RAM devices are typically used to preserve gaming machine critical data, although other types of non-volatile memory devices may be employed. These memory devices are typically not used in typical general-purpose computers.

Thus, in at least one embodiment, the gaming machine is configured or designed to store critical information in fault-tolerant memory (e.g., battery backed RAM devices) using atomic transactions. Further, in at least one embodiment, the fault-tolerant memory is able to successfully complete all desired atomic transactions (e.g., relating to the storage of gaming machine critical information) within a time period of 200 milliseconds (ms) or less. In at least one embodiment, the time period of 200 ms represents a maximum amount of time for which sufficient power may be available to the various gaming machine components after a power outage event has occurred at the gaming machine.

As described previously, the gaming machine may not advance from a first state to a second state until critical information that allows the first state to be reconstructed has been atomically stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Thus, for example, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the wager-based gaming system and the state of the wager-based gaming system (e.g., credits) at the time the table game was played. The game history information may be utilized in the event of a dispute. For example, a player may decide that in a previous table game that they did not receive credit for an award that they believed they won. The game history information may be used to reconstruct the state of the wager-based gaming system prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” each of which is incorporated by reference and for all purposes.

Another feature of wager-based gaming systems, such as IGT gaming computers, is that they often include unique interfaces, including serial interfaces, to connect to specific subsystems internal and external to the wager-based gaming system. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the wager-based gaming system, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a wager-based gaming system to a remote device. Often SAS is used in conjunction with a player tracking system.

IGT wager-based gaming systems may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT wager-based gaming system by monitoring security switches attached to access doors in the wager-based gaming system cabinet. Preferably, access violations result in suspension of game play and can trigger additional security operations to preserve the current state of game play. These circuits also function when power is off by use of a battery backup. In power-off operation, these circuits continue to monitor the access doors of the wager-based gaming system. When power is restored, the wager-based gaming system can determine whether any security violations occurred while power was off, e.g., via software for reading status registers. This can trigger event log entries and further data authentication operations by the wager-based gaming system software.

Trusted memory devices and/or trusted memory sources are preferably included in an IGT wager-based gaming system computer to ensure the authenticity of the software that may be stored on less secure memory subsystems, such as mass storage devices. Trusted memory devices and controlling circuitry are typically designed to not allow modification of the code and data stored in the memory device while the memory device is installed in the wager-based gaming system. The code and data stored in these devices may include authentication algorithms, random number generators, authentication keys, operating system kernels, etc. The purpose of these trusted memory devices is to provide gaming regulatory authorities a root trusted authority within the computing environment of the wager-based gaming system that can be tracked and verified as original. This may be accomplished via removal of the trusted memory device from the wager-based gaming system computer and verification of the secure memory device contents is a separate third party verification device. Once the trusted memory device is verified as authentic, and based on the approval of the verification algorithms included in the trusted device, the wager-based gaming system is allowed to verify the authenticity of additional code and data that may be located in the gaming computer assembly, such as code and data stored on hard disk drives. A few details related to trusted memory devices that may be used in the present invention are described in U.S. Pat. No. 6,685,567, filed Aug. 8, 2001 and titled “Process Verification,” and U.S. patent application Ser. No. 11/221,314, filed Sep. 6, 2005, each of which is incorporated herein by reference in its entirety and for all purposes.

In at least one embodiment, at least a portion of the trusted memory devices/sources may correspond to memory which cannot easily be altered (e.g., “unalterable memory”) such as, for example, EPROMS, PROMS, Bios, Extended Bios, and/or other memory sources which are able to be configured, verified, and/or authenticated (e.g., for authenticity) in a secure and controlled manner.

According to a specific implementation, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment of the present invention, the remote device and the trusted information source may engage in methods using zero knowledge proofs to authenticate each of their respective identities. Details of zero knowledge proofs that may be used with the present invention are described in US publication no. 2003/0203756, by Jackson, filed on Apr. 25, 2002 and entitled, “Authentication in a Secure Computerized Gaming System”, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Additional details relating to trusted memory devices/sources are described in U.S. patent application Ser. No. 11/078,966, entitled “SECURED VIRTUAL NETWORK IN A GAMING ENVIRONMENT”, naming Nguyen et al. as inventors, filed on Mar. 10, 2005, herein incorporated in its entirety and for all purposes.

Mass storage devices used in a general purpose computer typically allow code and data to be read from and written to the mass storage device. In a wager-based gaming system environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. Details using a mass storage device that may be used with the present invention are described, for example, in U.S. Pat. No. 6,149,522, herein incorporated by reference in its entirety for all purposes.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A multi-player electronic table gaming system in a gaming network comprising:
a gaming controller;
memory;
a multi-player gaming table including a primary multi-touch display system having a multi-touch display surface;
at least one interface for communicating with at least one other device in the gaming network;
the gaming system being operable to:
control a wager-based game played at the gaming system;
automatically detect a first user input event relating to a first gesture performed at or over the multi-touch display surface;
identify the first gesture;
interpret the first gesture;
map the first gesture to a first function;
initiate the first function at the gaming system;
wherein the initiation of the first function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system; and
wherein the first user input event includes at least one event selected from a group consisting of: an event relating to a player's physical gesture; an event relating to a dealer's physical gesture; an event relating to a player's verbal command; an event relating to a dealer's verbal command.

2. A multi-player electronic table gaming system in a gaming network comprising:
a gaming controller;
memory;
a multi-player gaming table including a primary multi-touch display system having a multi-touch display surface;
at least one interface for communicating with at least one other device in the gaming network;
the gaming system being operable to:
control a wager-based game played at the gaming system;
identify the first gesture using a least a portion of gesture information stored within the memory of the gaming system;
interpret the first gesture using at least a portion of information selected from a group consisting of: contemporaneous game state information; information relating to a current state of game play at the gaming system; information relating to a type of game being played by the first user at gaming system; information relating to a theme of game being played by the first user at gaming system; information relating to a current activity being performed by the first user at the gaming system; information relating to a wager-related activity being performed by the first user at the gaming system; information relating to a game-related activity being performed by the first user at the gaming system; and information relating to a bonus-related activity being performed by the first user at the gaming system;
map the first gesture to a first function, wherein the mapping of the first gesture to the first function includes selecting the first function using at least a portion of information selected from a group consisting of: contemporaneous game state information; information relating to a current state of game play at the gaming system; information relating to a type of game being played by the first user at gaming system; information relating to a theme of game being played by the first user at gaming system; information relating to a current activity being performed by the first user at the gaming system; information relating to a wager-related activity being performed by the first user at the gaming system; information relating to a game-related activity being performed by the first user at the gaming system; and information relating to a bonus-related activity being performed by the first user at the gaming system;
initiate the first function at the gaming system; and
wherein the initiation of the first function at the gaming system results in at least one state change relating to at least one condition or event at the gaming system.

3. The gaming system of claim 2 further comprising a first input mechanism for receiving cash or an indicia of credit.

4. The gaming system of claim 2 wherein the at least one state change includes at least one state change selected from a group consisting of: a change of state relating to an active game session occurring at the gaming system, a change of state relating to a wager-related activity occurring at the gaming system; and a change of state relating to a game-related activity occurring at the gaming system.

5. The gaming system of claim 2 further comprising:
a user input identification system operable to create a first association linking the first user to the first gesture.

6. The gaming system of claim 2 further comprising:
a user input identification system operable to create a first association linking the first user to the first gesture; and
a computer vision hand tracking system be operable to track at least one hand of the first user, and operable to determine at least one coordinate location of the user's at least one hand coordinates during at least one first time interval;
wherein the at least one coordinate location includes information relating to coordinates of the multi-touch display surface corresponding to tracked locations of the user's at least one hand at or over the multi-touch display surface during the at least one first time interval.

7. The gaming system of claim 2 being further operable to:
determine, using first user-related activity information, that the first user is currently engaged in an active Blackjack-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Blackjack-type game related functions consisting of: DOUBLE DOWN, SURRENDER, BUY INSURANCE, SPLIT PAIR, HIT, STAND, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

8. The gaming system of claim 2 being further operable to:
determine that the first user is currently engaged in an active Poker-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Poker-type game related functions consisting of: ANTE IN, RAISE, CALL, FOLD, DISCARD SELECTED CARD(S), INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

9. The gaming system of claim 2 being further operable to:
determine that the first user is currently engaged in an active Baccarat-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Baccarat-type game related functions consisting of: SQUEEZE DECK, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

10. The gaming system of claim 2 being further operable to:
determine that the first user is currently engaged in an active Roulette-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Roulette-type game related functions consisting of: SPIN WHEEL, ROLL BALL, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

11. The gaming system of claim 2 being further operable to:
determine that the first user is currently engaged in an active Craps-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Craps-type game related functions consisting of: SELECT DICE, ROLL DICE, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

12. The gaming system of claim 2 being further operable to:
determine that the first user is currently engaged in an active Pai Gow-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Pai Gow-type game related functions consisting of: SHUFFLE DOMINOS, SELECT DOMINOS, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

13. The gaming system of claim 2 being further operable to:
determine that the first user is currently engaged in an active Sic Bo-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Sic Bo-type game related functions consisting of: SELECT DICE, ROLL DICE, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

14. The gaming system of claim 2 being further operable to:
determine that the first user is currently engaged in an active Fantan-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of Fantan-type game related functions consisting of: REMOVE OBJECT(S) FROM PILE, COVER PILE, UNCOVER PILE, PLAY A CARD, TAKE CARD FROM PILE, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

15. The gaming system of claim 2 being further operable to:
determine that the first user is currently engaged in an active slot game-type gaming session at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of slot-type game related functions consisting of: SPIN REELS, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

16. The gaming system of claim 2 being further operable to:
determine that the first user is currently engaged in a virtual wheel-related related activity at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of virtual wheel-related related functions consisting of: SELECT WHEEL, and SPIN WHEEL;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

17. The gaming system of claim 2 being further operable to:
determine that the first user is currently engaged in a bonus game-related related activity at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of bonus game-related related functions consisting of: SELECT DICE, ROLL DICE, SPIN WHEEL, ROLL BALL, SELECT CARD, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

18. The gaming system of claim 2 being further operable to:
determine that the first user is currently engaged in a wager-related related activity at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of wager-related related functions consisting of: INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

19. The gaming system of claim 2 being further operable to:
determine that the first user is currently engaged in a card game-related activity at the gaming system;
determine that the first gesture includes at least one gesture selected from a group of gestures consisting of: a gesture comprising an initial single region of contact, followed by a drag up movement; a gesture comprising an initial single region of contact, followed by a drag down movement; a gesture comprising an initial single region of contact, followed by a drag right movement; a gesture comprising an initial single region of contact, followed by a drag left movement; a gesture comprising an initial single region of contact which is continuously maintained within a specified boundary for a continuous time interval of at least n seconds; a gesture comprising an initial single region of contact, followed by continuous drag down movements forming an “S”-shaped” pattern; a gesture comprising a sequence of two consecutive one contact region “tap” gestures on the multi-touch input interface in which continuous contact with the multi-touch input interface is broken in between each tap; a gesture comprising a sequence of two consecutive two contact region “tap” gestures on the multi-touch input interface in which continuous contact with the multi-touch input interface is broken in between each tap; a gesture comprising an initial two regions of contact, followed by concurrent drag up movements of both contact regions; a gesture comprising an initial two regions of contact, followed by concurrent drag down movements of both contact regions; a gesture comprising an initial two regions of contact, followed by concurrent drag right movements of both contact regions; a gesture comprising an initial two regions of contact, followed by concurrent drag left movements of both contact regions; a gesture comprising an initial two regions of contact, followed by a “pinch” movement, in which both contact regions are concurrently moved in respective directions towards each other of at least one contact region; a gesture comprising an initial two regions of contact, followed by a “expand” movement, in which both contact regions are concurrently moved in respective directions away from the other of at least one contact region; a gesture comprising an initial single region of contact, followed by a continuous “rotate clockwise” movement; a gesture comprising an initial single region of contact, followed by a continuous “rotate counter-clockwise” movement; a gesture comprising an initial single region of contact, followed by a continuous sequence of the following specific movements drag left movement, then drag right movement; and a gesture comprising an initial single region of contact, followed by a continuous sequence of the following specific movements: drag right movement, then drag left movement; and
select, using at least a portion of the first user-related activity information, the first function from a group of card game-related functions consisting of: PEEK AT CARD(S), CUT DECK, DEAL CARD(S), SHUFFLED DECK(S), TAKE CARD FROM PILE, DEAL ONE CARD, PLAY SELECTED CARD, SELECT CARD, INCREASE WAGER AMOUNT, DECREASE WAGER AMOUNT, CANCEL WAGER, CONFIRM PLACEMENT OF WAGER, PLACE WAGER, CLEAR ALL PLACED WAGERS, LET IT RIDE, YES, ACCEPT, NO, DECLINE, CANCEL, UNDO, and REPEAT INSTRUCTION/FUNCTION;
map the first gesture to the first selected function;
initiate the first selected function at the gaming system; and
wherein the initiation of the first selected function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.

20. A method for operating a multi-player electronic table gaming system in a gaming network, the gaming system including memory, a multi-player gaming table including a primary multi-touch display system having a multi-touch display surface, and at least one interface for communicating with at least one other device in the gaming network, the method comprising:
controlling a wager-based game played at the gaming system;
identifying the first gesture using a least a portion of gesture information stored within the memory of the gaming system;
interpreting the first gesture using at least a portion of information selected from a group consisting of: contemporaneous game state information; information relating to a current state of game play at the gaming system; information relating to a type of game being played by the first user at gaming system; information relating to a theme of game being played by the first user at gaming system; information relating to a current activity being performed by the first user at the gaming system; information relating to a wager-related activity being performed by the first user at the gaming system; information relating to a game-related activity being performed by the first user at the gaming system; and information relating to a bonus-related activity being performed by the first user at the gaming system;
mapping the first gesture to a first function, wherein the mapping of the first gesture to the first function includes selecting the first function using at least a portion of information selected from a group consisting of: contemporaneous game state information; information relating to a current state of game play at the gaming system; information relating to a type of game being played by the first user at gaming system; information relating to a theme of game being played by the first user at gaming system; information relating to a current activity being performed by the first user at the gaming system; information relating to a wager-related activity being performed by the first user at the gaming system; information relating to a game-related activity being performed by the first user at the gaming system; and information relating to a bonus-related activity being performed by the first user at the gaming system;
initiating the first function at the gaming system; and
wherein the initiating of the first function at the gaming system results in at least one state selected from a group consisting of: a change of state relating to an active game session occurring at the gaming system, a change of state relating to a wager-related activity occurring at the gaming system; and a change of state relating to a game-related activity occurring at the gaming system.
